(19) United States
(12) Patent Application Publication
(10) Pub. No.: US 2021/0049853 A1
(43) Pub. Date: Feb. 18, 2021

(54) BANKNOTE RECYCLER

(71) Applicant: Cummins-Allison Corp., Mt. Prospect, IL (US)

(72) Inventors: Marek Baranowski, Shamong, NJ (US); Glenn S. Gordon, Buffalo Grove, IL (US); Ralf Jaeger, Kildeer, IL (US); James C. Polites, Lake Zurich, IL (US); George T. Seelenbinder, Elk Grove Village, IL (US); Douglas U. Mennie, Barrington, IL (US)

(21) Appl. No.: 16/119,768

(22) Filed: Aug. 31, 2018

Related U.S. Application Data
(60) Provisional application No. 62/553,305, filed on Sep. 1, 2017.

(51) Int. Cl. G07D 11/00

(52) U.S. Cl. CPC G07D 11/0033; G07D 11/0036; G07D 11/0012; G07D 7/181; G07D 2211/00; G07D 2207/00; G07D 11/0018

(57) ABSTRACT

A generally vertical banknote recycling bay arrangement comprising a generally vertically oriented banknote recycling bay for receiving banknotes therein, the recycling bay having an upper end and a lower end. The arrangement further comprising a banknote feeding assembly for feeding banknotes, one at a time, into the recycling bay, the feeding assembly being positioned near the upper end of the recycling bay. The arrangement further comprising a banknote dispensing assembly for feeding banknotes, one at a time, out of the recycling bay, the dispensing assembly being positioned near the upper end of the recycling bay. The arrangement further comprising a pair of stacker wheels supported for rotational movement about a driven stacker wheel shaft, each stacker wheel being laterally moveable along the driven stacker wheel shaft and a stacker wheel positioning mechanism configured to adjust the lateral positions of the pair of stacker wheels along the stripper wheel shaft. During operation in which banknotes are to be fed into the recycling bay, the lateral position of the stacker wheels is adjusted by the stacker wheel positioning mechanism to an inward position such that banknotes to be fed into the recycling bay are received by the stacker wheels and stacked in the recycling bay. During operation in which banknotes are to be fed out of the recycling bay, the lateral position of the stacker wheels is adjusted by the stacker wheel positioning mechanism to an outward position such that banknotes to be fed out the recycling bay are not engaged by the stacker wheels but instead are engaged by the banknote dispensing assembly which sequentially engages the topmost banknote stacked in the recycling bay and feeds banknotes out of the recycling bay, one bill at a time.

### CLAIM OF PRIORITY AND CROSS-REFERENCE TO RELATED APPLICATION

This application claims the benefit of priority to U.S. Provisional Patent Application No. 62/553,305 filed on Sep. 1, 2017, incorporated herein by reference in its entirety.

### FIELD OF THE DISCLOSURE

The present disclosure relates generally to banknote or currency bill processing, and more particularly to apparatuses and systems for accepting, storing, and dispensing banknotes and related methods.

### BACKGROUND OF THE DISCLOSURE

Previous currency processing devices have various shortcomings.

### SUMMARY

According to some embodiments, a generally vertical banknote recycling bay arrangement comprises a generally vertically oriented banknote recycling bay for receiving banknotes therein, the recycling bay having an upper end and a lower end. According to some embodiments, the recycling bay arrangement comprises an elevator having at least one retractable banknote support. The elevator is configured to move upward and downward within and/or adjacent the recycler bay and the retractable banknote support is configured to move into and out of the recycling bay. The banknote recycling bay arrangement may further comprise a banknote feeding assembly for feeding banknotes, one at a time, into the recycling bay, the feeding assembly being positioned near the upper end of the recycling bay. The banknote recycling bay arrangement may further comprise a banknote dispensing assembly for feeding banknotes, one at a time, out of the recycling bay, the dispensing assembly being positioned near the lower end of the recycling bay.

According to some embodiments, during operation in which banknotes are to be sequentially fed into the recycling bay, the at least one retractable banknote support is extended into the recycling bay so as to provide a structure on which banknotes may be stacked within the recycling bay and wherein the elevator is raised to a level so as to facilitate the stacking of banknotes being fed into the recycling bay, one on top of the other on the at least one retractable banknote support and wherein the elevator is lowered as banknotes are fed into the recycling bay so that the top of the stack of banknotes residing within the recycling bay and onto which incoming banknotes are stacked remains at about the same level.

According to some embodiments, prior to a dispensing operation in which banknotes are to be fed out of the recycling bay, the elevator is lowered to the bottom of the recycling bay if no banknotes reside at the bottom of the recycling bay and wherein the at least one retractable banknote support is moved out of the recycling bay so that the stack of banknotes that had been supported by the at least one retractable support come to rest upon a bottom surface of the recycling bay.

According to some embodiments, prior to a dispensing operation in which banknotes are to be fed out of the recycling bay, the elevator is lowered to a location adjacent the top of a stack of banknotes resting on the bottom of the recycling bay if there are banknotes already residing at the bottom of the recycling bay and wherein the at least one retractable banknote support is moved out of the recycling bay so that the stack of banknotes that had been supported by the at least one retractable support come to rest upon the top of the stack of banknotes already residing at the bottom of the recycling bay.

According to some embodiments, the banknote dispensing assembly comprises a pair of stripping wheels supported for rotational movement about a driven stripping wheel shaft, a pair of drive rolls, and a pair of nip rollers.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, which are considered to be inventive singly or in any combination, will be readily apparent from the following detailed description of representative embodiments and modes for carrying out the present inventions when taken in connection with the accompanying drawings and the appended claims.

### BRIEF DESCRIPTION OF THE DRAWINGS

FIG. 1A is a schematic view of a banknote recycler according to some embodiments of the present disclosure;

FIG. 1B is a schematic view of the banknote recycler of FIG. 1A operating in a Currency Denominator/Counter Mode;

FIG. 1C is a schematic view of the banknote recycler of FIG. 1A operating in an Escrow Mode;

FIG. 1D is a schematic view of the banknote recycler of FIG. 1A operating in an Escrow-to-Accept Mode;

FIG. 1E is a schematic view of the banknote recycler of FIG. 1A operating in a Dispense Mode;

FIG. 1F is a schematic view of the banknote recycler of FIG. 1A operating in an Internal Audit Mode;

FIG. 1G is a schematic view of a banknote recycler according to some embodiments of the present disclosure;

FIG. 1H is a schematic view of a banknote recycler according to some embodiments of the present disclosure having a banknote cassette receiving port or container dock;

FIG. 2 is a functional block diagram of a banknote recycler according to some embodiments of the present disclosure;

FIG. 3A is a front perspective view of a banknote recycler storage bay according to some embodiments of the present disclosure having an elevator positioned near the top of the bay;

FIG. 3B is a front view of the banknote recycler storage bay of FIG. 3A.

FIG. 3C is a side sectional of the banknote recycler storage bay of FIG. 3B taken along line 3C-3C in FIG. 3B;

FIG. 3D is a perspective sectional view of a banknote recycler storage bay of FIG. 3B taken along line 3C-3C in FIG. 3B;

FIG. 3E is a left side view, FIG. 3F is a right side view, and FIG. 3G is a rear view of the banknote recycler storage bay of FIG. 3A with the elevator 510 positioned at a lower location.

FIG. 4A is a front perspective view of the banknote recycler storage bay of FIG. 3A with the elevator 510 located near the middle of the storage bay;

FIG. 4B is a front perspective view of the banknote recycler storage bay of FIG. 3A with the elevator 510 located near the bottom of the storage bay;

FIG. 5A is rear perspective view, FIG. 5B is a front top perspective view, and FIG. 5C is a top view of an elevator according to some embodiments;

FIG. 5D is a sectional view of the elevator of FIG. 5C taken along line 5D-5D;

FIG. 5E is a perspective view of a banknote support according to some embodiments;

FIG. 5F is rear perspective view and FIG. 5G is a front top perspective view and of an elevator according some embodiments.

FIG. 5H is a front sectional view of the elevator of FIG. 5F taken along axis 542_{A} shown in FIG. 5F.

FIG. 5I is a front sectional view of the elevator of FIG. 5F taken along axis 513_{A} shown in FIG. 5F.

FIG. 5J is a perspective view of a banknote support according to some embodiments.

FIGS. 6A and 6B are front perspective views of a portion of transport paths and their related transport mechanism components in an open, non-operational position located on top of a banknote recycling bay.

FIG. 6C is a front view of a portion of transport paths and their related transport mechanism components of FIGS. 6A-6B in a closed, operational position.

FIG. 7 is a front perspective view of six storage bays of a banknote recycler according to some embodiments of the present disclosure;

FIG. 8A is a front perspective view of a banknote recycler storage bay according to some embodiments of the present.

FIG. 8B is a perspective sectional view of a banknote recycler storage bay taken along line 8B-8B in FIG. 8A;

FIG. 8C is a side sectional view of a banknote recycler storage bay taken along line 8B-8B in FIG. 8A;

FIG. 8D is a side view of a banknote recycler storage bay mounted in a storage bay frame.

FIG. 8E is a side sectional view of the banknote recycler storage bay of FIG. 8D omitting the left side frame and the left side wall of the storage bay.

FIG. 9A is a rear perspective view of an alternate embodiment of an elevator, FIG. 9B is a front side perspective view of the elevator 910 of FIG. 9A, and FIG. 9C is a perspective view of a banknote support for use with the elevator of FIGS. 9A and 9B.

FIGS. 10A-10D are perspective views of a banknote recycler storage bay according to some embodiments of the present disclosure having an alternate embodiment of an elevator;

FIGS. 11A-11C are sectional views of a generally vertical recycling bay arrangement comprising a banknote recycler storage bay or recycling bay 1160 according to some embodiments of the present disclosure employing a Last-In, First-Out (LIFO) feeding scheme.

FIGS. 12A-12B are perspective views of a generally vertical recycling bay arrangement comprising a banknote recycler storage bay or generally vertically oriented banknote recycling bay 1260 according to some embodiments of the present disclosure employing a Last-In, First-Out (LIFO) feeding scheme.

FIGS. 13A and 13B are a front perspective views and FIG. 13C is a side sectional view of a banknote recycler storage bay according to some embodiments of the present disclosure.

FIG. 14A is a schematic view of a banknote recycler employing generally horizontal storage bays according to some embodiments of the present disclosure.

FIG. 14B is a top view and FIG. 14C is an end view of a generally horizontal storage bay employing banknote supports to support and move banknotes residing in the storage bay according to some embodiments of the present disclosure.

FIGS. 15A and 15B are sectional views of a generally horizontal recycling bay arrangement comprising a banknote recycler storage bay or recycling bay according to some embodiments of the present disclosure employing a Last-In, First-Out (LIFO) feeding scheme.

FIGS. 16A and 16B are sectional views of a generally horizontal recycling bay arrangement comprising a banknote recycler storage bay or recycling bay according to some embodiments of the present disclosure employing a Last-In, First-Out (LIFO) feeding scheme.

FIG. 17A is a perspective view of components of a banknote recycler having six storage bays illustrating a portion of a main transport mechanism in an open, non-operational position according to some embodiments of the present disclosure.

FIG. 17B is an end view of the banknote recycler of FIG. 17A and FIG. 17C is an enlarged view of a portion of FIG. 17A.

FIG. 17D is a further enlarged view of a feeder module of FIGS. 17A-17C.

FIG. 17E is a front view of a banknote recycler with a main transport mechanism in a closed position according to some embodiments of the present disclosure.

FIG. 17F is cross-sectional view of upper ends of banknote recycling bays of the banknote recycler of FIG. 17E.

FIG. 17G is an enlarged view of a feeder module 1900 in an operational position above one of the recycling bays of the banknote recycler of FIG. 17E.

FIG. 17G1 is an enlarged view similar to FIG. 17G illustrating an in-feed transport path and an out-feed transport path for one of the recycling bays.

FIG. 17H is an enlarged rear perspective view of a couple of recycling bays of the banknote recycler of FIG. 17E having some components removed.

FIG. 18A is a perspective view of a main transport mechanism in its closed, operational state or position, FIG. 18B is a perspective view of the main transport mechanism 1820 in an open, non-operational state, FIG. 18C is a downward perspective view of the main transport mechanism in an open, non-operational state, and FIG. 18D is a rear perspective view of the main transport mechanism in its closed, operational state or position according to some embodiments of the present disclosure.

FIG. 18E is an upward perspective view of a lower portion of the main transport mechanism according to some embodiments of the present disclosure.

FIG. 19A is a perspective view illustrating an upstream, outfeed side, FIG. 19B is a perspective view illustrating a downstream, infeed side, FIG. 19C is a cross-sectional view, FIG. 19D is a rear view, and FIG. 19E is an upward looking bottom perspective view of a feeder module according to some embodiments of the present disclosure.

FIG. 20A is a perspective view of a stacker module having a pair of stacker wheels positioned at an inward, operational deposit or feed-in position and FIG. 20B is cross-sectional view of the stacker module of FIG. 20A in plane 20B-20B indicated in FIG. 20A according to some embodiments of the present disclosure.

FIG. 20C is a perspective view of the stacker module having the pair of stacker wheels positioned at a transitional, non-operational position and FIG. 20D is front view of select components of the stacker module of FIG. 20C according to some embodiments of the present disclosure.

FIG. 20E is a front view of the stacker module having the pair of stacker wheels positioned at an outward, non-operational dispense or feed-out position and FIG. 20F is rear view of select components of the stacker module of FIG. 20E according to some embodiments of the present disclosure.

FIG. 20G is a perspective view of select components of the stacker module of FIG. 20C.

FIG. 20H is a sectional view of a stacker wheel subassembly according to some embodiments of the present disclosure.

FIG. 20I is cross-sectional view of a stacker wheels base and linkage arm support mounted about a stacker wheel shaft according to some embodiments of the present disclosure.

FIG. 21A is a side perspective view of a storage bay elevator, FIG. 21B is an upward perspective view of the elevator of FIG. 21A, and FIG. 21C is a bottom perspective view of select components of the elevator of FIG. 21A according to some embodiments of the present disclosure.

FIG. 21D is a downward perspective view of the elevator of FIG. 21A and an elevation shaft worm gear decoupling tool.

FIG. 21E is side perspective view of the elevator of FIG. 21D illustrating a use of the elevation shaft worm gear decoupling tool of FIG. 21D.

FIG. 22A is a cross-sectional perspective view of a banknote recycler chassis according to some embodiments of the present disclosure and FIG. 22B is a similar view as that of FIG. 22A but with a downstream wall of a storage bay removed.

FIG. 22C is an end view of the storage bay shown in FIG. 22B.

FIG. 22D is a cross-sectional perspective view of a banknote recycler chassis according to some embodiments of the present disclosure taken at 90 degrees from the view of FIG. 22A.

FIG. 22E is a top view of a portion of the chassis shown in FIG. 22D.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, combinations, and alternatives falling within the spirit and scope of the inventions as defined by the appended claims.

### DETAILED DESCRIPTION OF THE ILLUSTRATED EMBODIMENTS

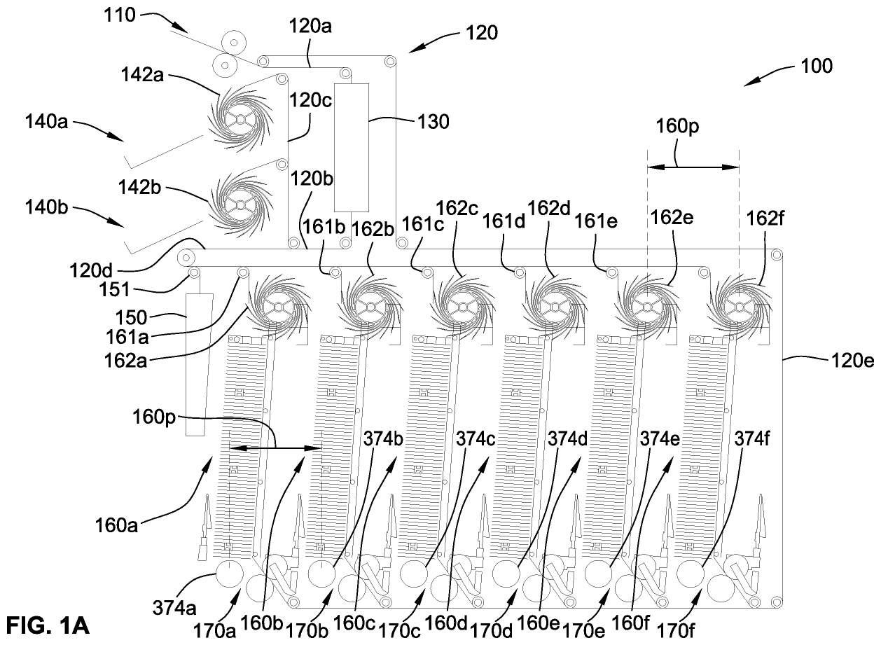

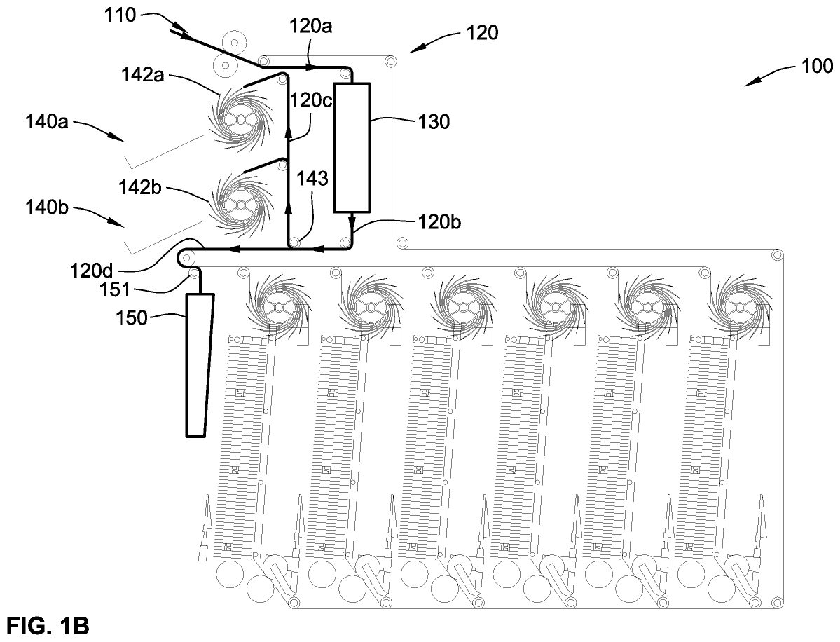

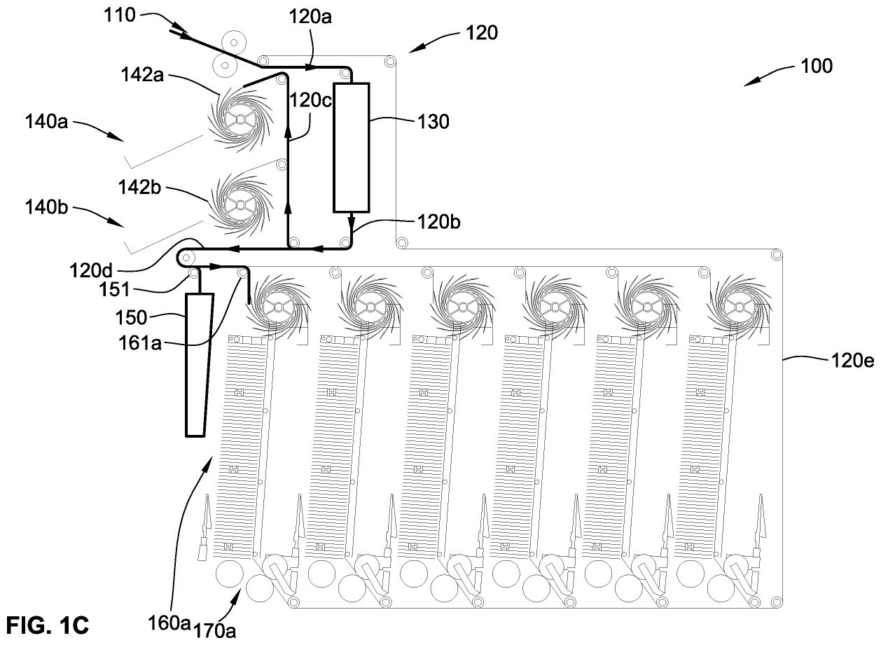

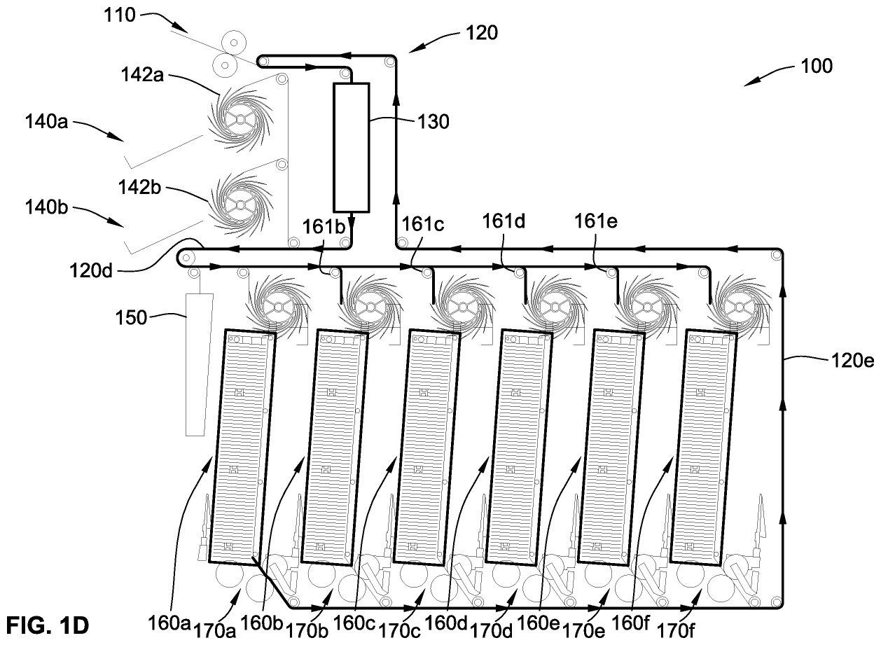

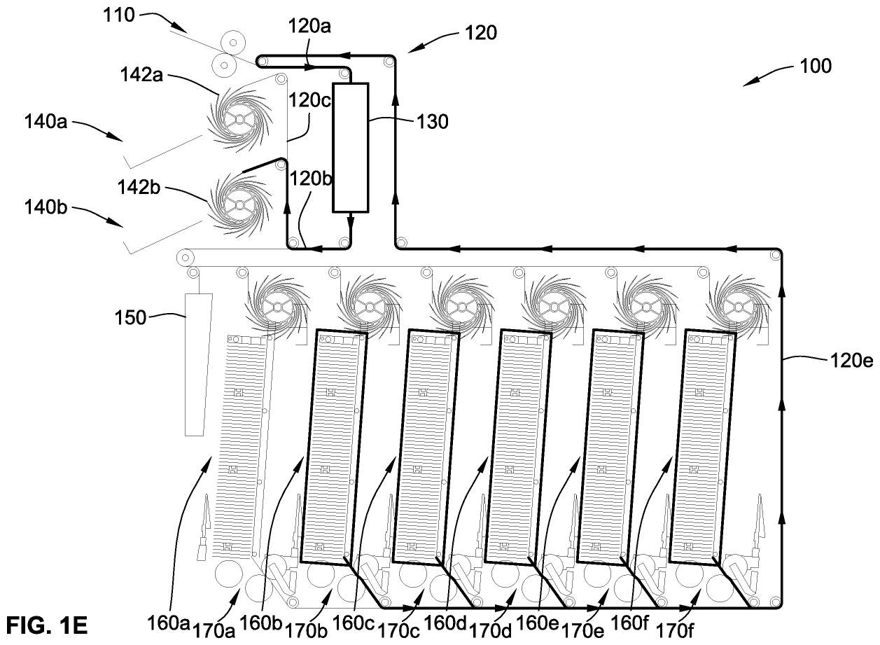

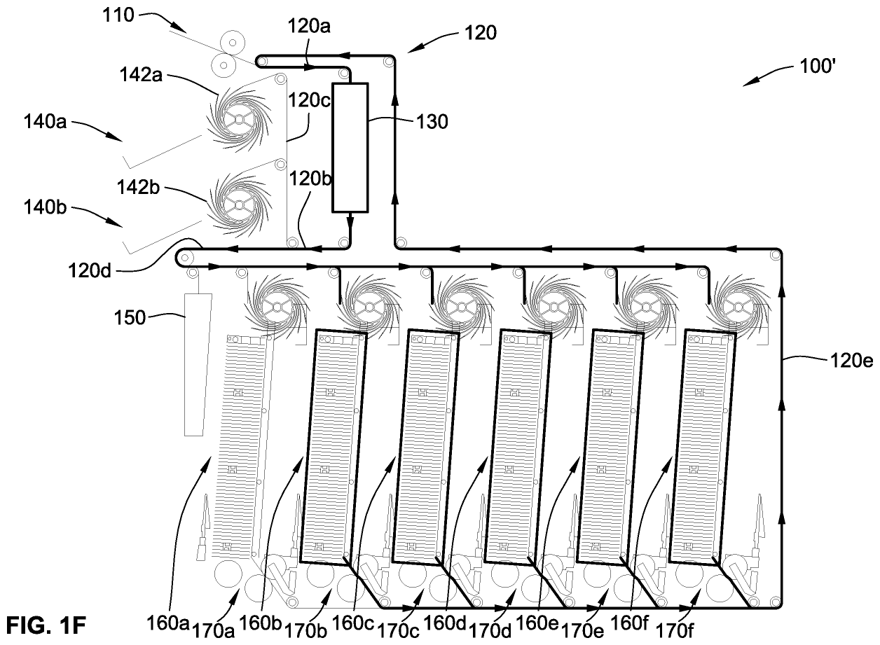

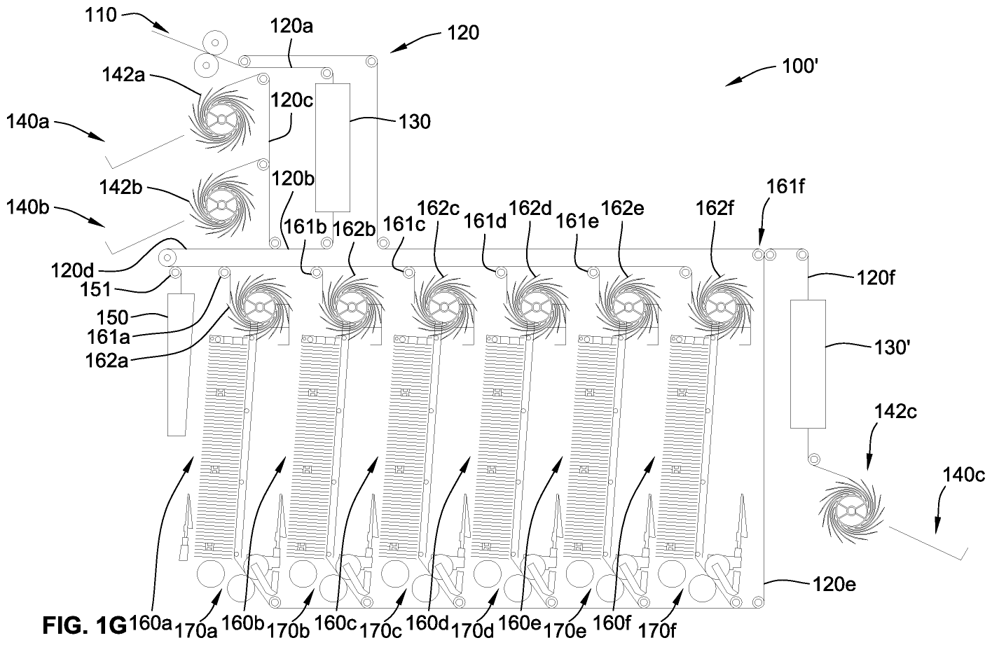

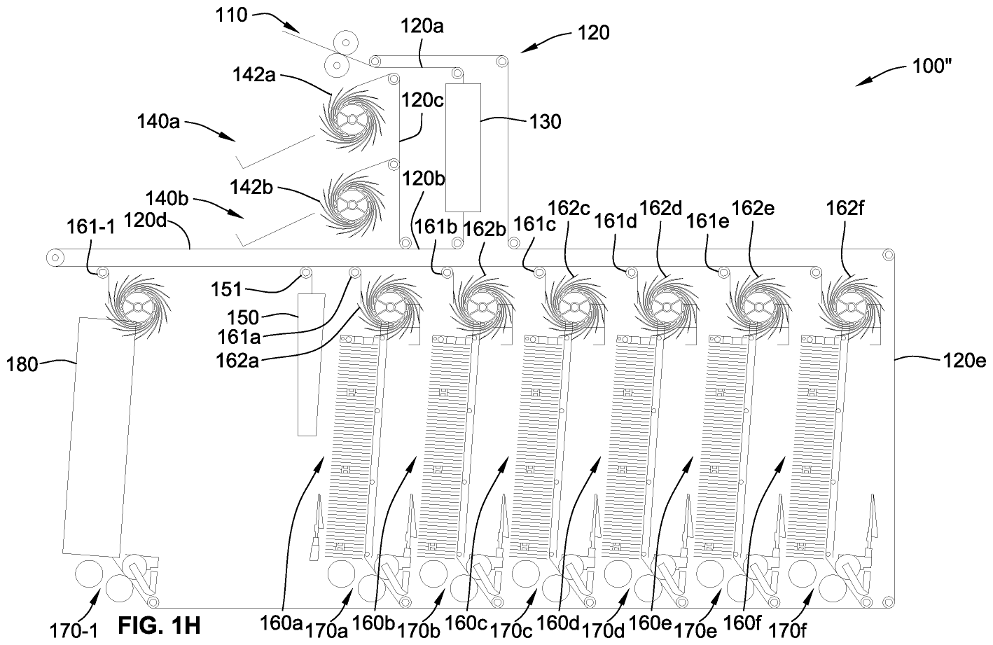

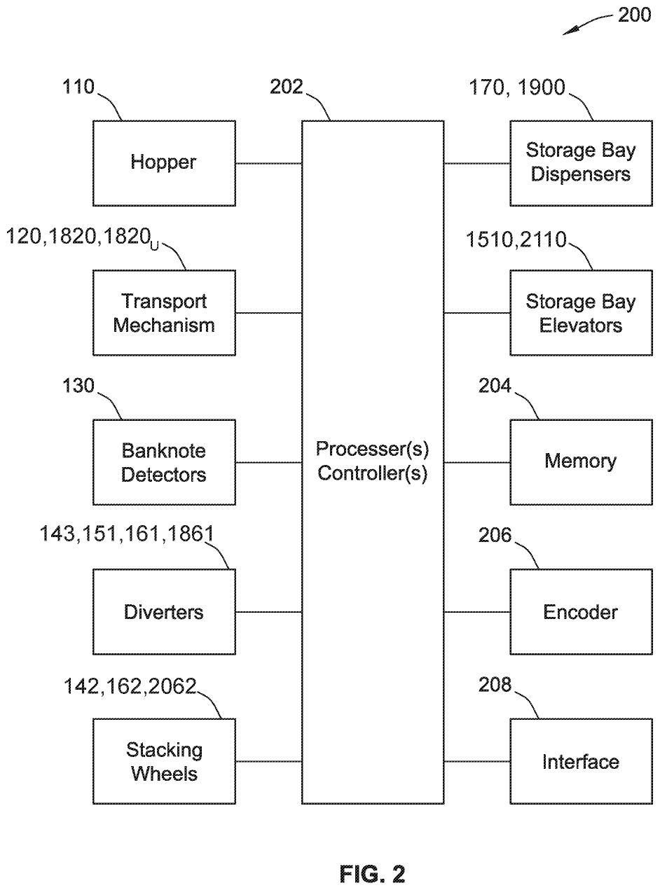

FIG. 1A is a schematic view of a currency bill or banknote recycler 100 according to some embodiments and FIG. 2 is a functional block diagram of a banknote recycler 200 such as banknote recycler 100, 100′, 100″, 1700 according to some embodiments. The banknote recycler comprises an input hopper 110 for receiving a banknote or a stack of banknotes or currency bills and a transport mechanism 120 for receiving banknotes from the input hopper 110 and delivering the banknotes to and from a number of locations in the banknote recycler. The banknote recycler further comprises a banknote detector section 130. According to some embodiments, the banknote detector section 130 comprises one or more detectors for determining various information about banknotes transported past the detectors such as, for example, the denomination and/or authenticity of the banknotes. The output of the one or more detectors of the banknote detector section 130 may be used to count, denominate, authenticate, scan, image, determine the fitness of banknotes and/or other characteristics of banknotes such as described in more detail in U.S. Pat. No. 5,295,196 [Attorney Docket 247171-000072]; U.S. Pat. No. 5,640,463 [Attorney Docket 247171-000115]; U.S. Pat. No. 6,661,910 [Attorney Docket 247171-000186USC2]; U.S. Pat. No. 6,363,164 [Attorney Docket 247171-000187USC1]; U.S. Pat. No. 6,913,260 [Attorney Docket 247171-000368USPT]; U.S. Pat. No. 7,187,795 [Attorney Docket 247171-000298USPT]; U.S. Pat. No. 7,978,899 [Attorney Docket 247171-000440USPT]; and U.S. Pat. No. 8,538,123 [Attorney Docket 247171-000533USP1], each of which is incorporated herein by reference in its entirety. The recycler 100 also comprises one or more externally accessible output receptacles 140a and 140b. Banknotes delivered to the open, externally accessible output receptacles 140a, 140b may be removed by a user such as a bank teller reaching into the output receptacles 140a, 140b and grasping the banknotes with his or her hand. According to some embodiments, the output receptacles 140a, 140b comprise stacker wheels 142a, 142b to assist in stacking the banknotes into the output receptacles. In some modes of operation, the output receptacle 140a may be used as a reject output receptacle to which rejected banknotes are delivered such as, for example, a banknote or document whose denomination was not determined by the banknote detector section 130.

According to some embodiments, the recycler 100 may further comprise a secure banknote storage bin 150. In some modes of operation, the secure banknote storage bin 150 may be used to store banknotes which are determined to be counterfeit or mutilated using the one or more detectors in the banknote detector section 130. According to some embodiments, the banknote recycler has a slot or opening in its housing permitting an operator such as a bank teller to insert banknotes (also referred to as bills or currency bills) into (but not withdraw bills from) the secure banknote storage bin 150. For example, if an operator notices that a banknote to be processed is mutilated and may cause a jam if processed by the banknote recycler, the operator may directly put such notes through the slot in the housing so that such notes may be securely stored in the secure storage bin 150. According to some embodiments, the operator may use an input/output interface 208 to enter information about the mutilated banknote(s) (such as the denomination and/or the serial number of each note) into the banknote recycler 100 so that a processor or controller 202 may update information about the related transaction to reflect all bills in a transaction, e.g., so a customer may be given credit for the deposit of all banknotes deposited in a transaction, even those that are too mutilated to be automatically processed by the banknote recycler 100.

The recycler 100 further comprises one or more banknote storage or recycle bins or bays 160a-160f. According to some embodiments, the first storage bay 160a is used as an escrow storage bay to temporarily hold banknotes being deposited into the banknote recycler 100 as will be described in more detail below. According to some embodiments, the remaining storage bays 160b-160f are each dedicated to specific denominations of banknotes, e.g., storage bay 160b may be assigned to store US $1 bills, storage bay 160c may be assigned to store US $5 bills, storage bay 160d may be assigned to store US $10 bills, storage bay 160e may be assigned to store US $20 bills, storage bay 160f may be assigned to store US $100 bills. Note, according to some embodiments, the recycler 100 may comprise fewer or more than six storage bays 160a-160f.

According to some embodiments, the storage bays 160a-160f reside within a housing of the recycler 100 having one or more security doors. The housing and security door(s) serve as a safe and may be made of high strength material such as metal and/or hard plastic. The storage bays 160a-160f are distinguishable from the output receptacles 140a, 140b in that the storage bays are secured within a housing of the recycler 100 and are not externally accessible to a typical user or operator such as a bank teller of the recycler 100 during normal operation of the recycler 100 such as during a deposit/escrow or dispense operation. Rather, to gain access to the storage bays 160a-160f and the banknotes stored therein, a security door of the recycler must be opened. According to many embodiments, the security door is locked and may only be opened by authorized personnel having a key or access code enabling the security door to be unlocked such as an authorized service technician.

In the embodiment illustrated in FIG. 1A, the storage bays 160a-160f receive bills or banknotes at their top ends and dispense or feed out bills from their bottom ends. In such embodiments, banknotes are handled in a first-in, first-out (FIFO) manner. According to some embodiments, the storage bays 160a-160f comprises dispensers 170a-170f to dispense or feed out bills from the respective storage bins 160a-160f According to some embodiments, storage bays of the banknote recycler 100 may handle banknotes in a last-in, first-out (LIFO) manner.

In the embodiment illustrated in FIG. 1A, stacker wheels 162a-162f assist in stacking bills into the respective the storage bays 160a-160f.

FIG. 1B is a schematic view of the banknote recycler 100 of FIG. 1A operating in a Currency Denominator/Counter Mode. In this mode, the operation of the banknote recycler 100 may emulate the operation of a Cummins-Allison one or two output receptacle JetScan® currency denominator or counter such as a JetScan® model 4065 or 4095 currency denominator. Examples of the operation of currency denominators are described in more detail in U.S. Pat. No. 5,815,592 [Attorney Docket 247171-000131]; U.S. Pat. No. 6,311,819 [Attorney Docket 247171-000174]; U.S. Pat. No. 7,187,795 [Attorney Docket 247171-000298USPT]; and U.S. Pat. No. 8,538,123 [Attorney Docket 247171-000533USP1], each of which is incorporated herein by reference in its entirety.

For example, in some embodiments, a stack of currency bills or banknotes is stacked in hopper 110. Banknotes in hopper 110 are fed, one after the other in a one at a time, seriatim manner, into a first transport path 120a of the transport mechanism 120 and then through the banknote detector section 130. The output of one or more sensors or detectors in the banknote detector section 130 are used to image, count, denominate, and/or authenticate the banknotes and/or to determine other characteristics of the banknotes passing through the banknote detector section 130. The banknotes are then fed out of the banknote detector section 130 along transport path 120b and then are directed to output receptacle transport path 120c via diverter 143 and then into one or more of the output receptacles 140a, 140b. Information about the banknotes received in hopper 110 and/or delivered to one or more of the output receptacles 140a, 140b such as, for example, the total value of the banknotes, the number or value of each denomination of banknote may be communicated to the operator or user of the banknote recycler 100 such as via a display, touchscreen, speaker, and/or other input/output device 208. According to some embodiments, output receptacle 140a is used as a reject output receptacle and banknotes rejected (e.g., those whose denomination could not be determined, i.e., no call bills or notes) are delivered to output receptacle 140a. Banknotes that are acceptable (e.g., those that have been successfully denominated and authenticated) are delivered to output receptacle 140b. According to some embodiments, banknotes that are determined to be counterfeit may not be returned to the user or operator via output receptacles 140a, 140b but instead may be delivered to a secure storage bin 150 accessible only to authorized personnel. Bills or banknotes to be delivered to secure storage bin 150 are not delivered to transport path 120c but instead are directed by diverter 143 along storage bay transport path 120d and are diverted from storage bay transport path 120d by diverter 151 into secure storage bin 150.

FIG. 1C is a schematic view of the banknote recycler 100 of FIG. 1A operating in an Escrow Mode. Escrow Mode operates similar to the Currency Denominator/Counter Mode described in connection with FIG. 1B, however, instead of delivering banknotes that are accepted (e.g., those that have been successfully denominated and authenticated) to externally accessible output receptacle 140b, such banknotes are delivered to a first internal storage bin or bay 160a by being diverted off of storage bay transport path 120d via diverter 161a. According to some embodiments, the Escrow Mode is used as a preliminary step in depositing banknotes into the banknote recycler 100. For example, an operator such as a bank teller may receive a stack of banknotes from a bank customer who wishes to deposit the banknotes into his or her bank account. The bank teller places the stack of banknotes into the input hopper 110 of the banknote recycler. Assuming no banknotes are rejected to reject output receptacle 140a or sent to secure storage bin 150, all banknotes in the stack are denominated and delivered into the escrow storage bay 160a. Information about the bills or banknotes to be deposited such as the total value of the banknotes is communicated to the bank teller and/or customer via an interface 208. If the customer and/or bank teller, wishes to continue with the deposit, the bank teller places the machine into the Escrow to Accept Mode (e.g., by pressing or selecting an ACCEPT key, e.g., via a touching an ACCEPT selection element on a touch screen) as will be described in connection with FIG. 1D below.

If the customer and/or bank teller does not wish to continue with the deposit, then the bank teller may cancel the deposit transaction (e.g., by pressing or selecting an CANCEL key, e.g., via a touching a CANCEL selection element on a touch screen) and banknotes in the escrow bay 160a are fed out of the escrow bay 160a using dispenser 170a onto return transport path 120e of the transport mechanism 120. According to some embodiments, the banknotes are then routed along transport path 120a through the banknote detector section 130 again and then to output receptacle 140b. The user or bank teller may then retrieve the banknotes. Although not shown, the transport mechanism 120 may be provided with a banknote detector section 130 by-pass transport path connecting transport paths 120a and 120b and/or transport paths 120e and 120b without going through the banknote detector section 130.

FIG. 1D is a schematic view of the banknote recycler 100 of FIG. 1A operating in an Escrow-to-Accept Mode. In general, in the Escrow-to-Accept Mode, banknotes are delivered from the escrow storage bay 160a and then sorted by denomination into the one or more of the denomination specific storage bays 160b-160f. For example, from the Escrow Mode described above, when an ACCEPT key is pressed or selected, banknotes in the escrow bay 160a are fed out of the escrow bay 160a onto return transport path 120e via dispenser 170a. According to some embodiments, the banknotes are then routed along transport path 120a through the banknote detector section 130 again and then to storage bay transport path 120d. According to some embodiments, banknotes are denominated again based on information detected from the banknotes via the detectors in banknote detector section 130.

According to some embodiments, information about each banknote (such as the denomination of each banknote) has already been determined before the banknotes were stored in the escrow storage bin 160a and this information has been stored in a memory 204 of the banknote recycler 100. In some such embodiments, the denomination of each bill as determined as a result of the second pass through the banknote detector section 130 is compared to the denomination of each bill as determined as a result of an earlier pass through the banknote detector section 130 where the results of that earlier determination were stored in the memory 204 of the banknote recycler 100. When the determined denomination of a banknote as determined in a second pass does not agree with the denomination of the banknote as determined in a first or earlier pass, a processor 202 of the banknote recycler may generate an error signal. In contrast, in some such embodiments, the banknotes are not re-scanned when passing through the banknote detector section 130 a second time, but instead, the information about each banknote stored in memory 204 is used to determine to which storage bay 160b-160f each banknote is to be sent. Alternatively, in some such embodiments, the banknotes are re-scanned when passing through the banknote detector section 130 a second time, and the information about each banknote as determined during the second pass through the banknote detector section 130 is what is used to determine to which storage bay 160b-160f each banknote is to be sent without using any information regarding the banknotes previously collected.

Although not shown, the transport mechanism 120 may be provided with a banknote detector section 130 by-pass transport path connecting transport paths 120a and 120b and/or transport paths 120e and 120b without going through the banknote detector section 130 and banknotes may by-pass the banknote detector section 130 on their way to storage bay transport path 120d and the information about each banknote previously stored in memory 204 is used to determine to which storage bay 160b-160f each banknote is to be sent.

Once the banknotes have been delivered to the storage bay transport path 120d, diverters 161b-161e, under the control of a controller 202, direct the banknotes into an appropriate one of the storage bays 160b-160f based on, for example, the denomination of each banknote. For example, US $1 bills may be delivered into storage bay 160b, US $5 bills may be delivered into storage bay 160c, US $10 bills may be delivered into storage bay 160d, US $20 bills may be delivered into storage bay 160e, and US $100 bills may be delivered into storage bay 160f.

FIG. 1E is a schematic view of the banknote recycler 100 of FIG. 1A operating in a Dispense Mode. In general, in the Dispense Mode, banknotes are delivered from one or more of the denomination specific storage bays 160b-160f and then to one or more of the externally accessible output receptacles 140a, 140b. In embodiments for which output receptacle 140a is used as a reject output receptacle, in the Dispense Mode, banknotes are delivered from one or more of the denomination specific storage bays 160b-160f to the externally accessible output receptacle 140b.

In operation, if a user or operator such as bank teller wished to dispense a certain amount of money, e.g., $270, the user places the banknote recycler into the Dispense Mode (e.g., via selecting a Dispense Mode key or selection element via an input/output interface 208 of the banknote recycler 100). The input/output interface 208 may then prompt the user as to the amount to be dispensed (e.g., $270) and/or the specific breakdown by denomination desired to be dispensed [e.g., a) two $100 banknote, three $20 banknotes, and one $10 banknote or b) thirteen $20 banknotes and one $10 banknote]. A processor or controller 202 of the banknote recycler then causes the appropriate number of banknotes from the appropriate ones of the storage bays 160b-160f to be fed out of the storage bays 160b-160f onto return transport path 120e via dispensers 170b-170f.

For example, where storage bay 160b stores US $1 bills, storage bay 160c stores US $5 bills, storage bay 160d stores US $10 bills, storage bay 160e stores US $20 bills, and storage bay 160f stores US $100 bills, and a dispense request for $270 is made, two $100 banknotes from storage bay 160f may be fed onto return transport path 120e, three $20 banknotes from storage bay 160e may be fed onto return transport path 120e, and one $10 banknote from storage bay 160d may be fed onto return transport path 120e. A controller or processor 202 of the banknote recycler may control the feeding of bills from the storage bays 160b-160f onto the return transport path 120e such as by controlling dispensers 170b-170f and/or the operation of the transport path 120e so that banknotes are arranged on the transport path 120e in a non-overlapping manner. Thus, for example, if a banknote has been transported onto return transport path 120e from an upstream storage bay, e.g., bay 160d relative to bay 160e, and the banknote from the upstream bay is passing a downstream bay, the processor or controller 202 would monitor the movement and location of every banknote on the transport paths and delay, if necessary, the dispensing of a banknote from a downstream bay, e.g., bay 160e in the above example, until the banknote(s) from the upstream bay or bays has past the point along the transport path 120e at which a banknote from the downstream bay would enter the transport path 120e. To aid in this control, the transport mechanisms may have a plurality of transport detectors adjacent of various locations along the various transport paths to monitor the movement and location of banknotes being transported along the transport paths by the transport mechanisms and the output of the transport detectors is coupled to one or more controllers or processors such as controller or processor 202. According to some embodiments, the banknotes are then routed along transport path 120a through the banknote detector section 130 and then to output receptacle 140b. The user or bank teller may then retrieve the banknotes. According to some embodiments, banknotes are denominated based on information detected from the banknotes via the detectors in banknote detector section 130. According to some embodiments, information about each banknote (such as the denomination of each banknote) has already been determined before the banknotes were stored in the escrow storage bin 160a and/or storage bays 160b-160f and/or the denomination of each banknote is presumed based on the storage bay 160b-160f from which it was dispensed and this information has been stored in the memory 204 of the banknote recycler 100. In some such embodiments, the denomination of each bill as determined as a result of the pass through the banknote detector section 130 in the Dispense Mode is compared to the denomination of each bill as determined as a result of an earlier pass through the banknote detector section 130 where the results of that earlier determination where stored in the memory 204 of the banknote recycler 100 (and/or based on a presumed denomination based on the storage bay 160b-160f from which a banknote was dispensed). When the determined denomination of a banknote as determined during the Dispense Mode does not agree with the denomination of the banknote as determined in a first or earlier pass (and/or based on a presumed denomination based on the storage bay 160b-160f from which a banknote was dispensed), a processor 202 of the banknote recycler may generate a Denomination Mismatch error signal. According to some embodiments, a banknote triggering a Denomination Mismatch error signal is routed to and stored in secure bin 150 and not dispensed via output receptacle 140a or 140b. According to some embodiments, when a Denomination Mismatch error signal is generated, a banknote triggering a Denomination Mismatch error signal is routed to and stored in secure bin 150 and a replacement banknote is dispensed from the appropriate storage bay 160b-160f onto return transport path 120e and to output receptacle 140a or 140b.

Although not shown, the transport mechanism 120 may be provided with a banknote detector section 130 by-pass transport path (such as via connecting transport paths 120a and 120b) without going through the banknote detector section 130. In such embodiments, the denomination of each banknote is presumed to be the denomination associated with the particular storage bay 160b-160f from which it was dispensed and/or based on the denomination previously determined by the banknote recycler and stored in memory 204.

FIG. 1F is a schematic view of the banknote recycler 100 of FIG. 1A operating in an Internal Audit Mode. In general, in the Internal Audit Mode, banknotes are delivered from one or more of the denomination specific or mixed denomination storage bays 160b-160f, through the banknote detector section 130 and then back into the one or more of the denomination specific storage bays 160b-160f. The memory 204 of the banknote recycler 100 keeps track of how many bills are stored in each of the denomination specific storage bays 160b-160f and/or their denominations. The Internal Audit Mode, is a mode which enables an operator of the banknote recycler 100 to have the banknote recycler double check to verify that the banknotes expected to be stored in one or more or all of the specific storage bays 160b-160f are actually stored therein.

In operation, a user or operator such as bank teller or a bank manager places the banknote recycler into the Internal Audit Mode (e.g., via selecting an Internal Audit Mode key or selection element via an input/output interface 208 of the banknote recycler 100). A processor or controller 202 of the banknote recycler then causes all the banknotes from the desired one or more or all of the storage bays 160b-160f to be fed out of the storage bays 160b-160f onto return transport path 120e via dispensers 170b-170f. According to some embodiments, the processor or controller 202 keeps track of how many banknotes are dispensed from each of the storage bays 160b-160f and/or their denominations and updates a total value counter and/or individual denomination counters. For example, where storage bay 160b has ten (10) US $1 bills stored therein, storage bay 160c has zero (0) US $5 bills stored therein, storage bay 160d has zero (0) US $10 bills stored therein, storage bay 160e has one hundred (100) US $20 bills stored therein, and storage bay 160f has five (5) US $100 bills stored therein, these banknotes are dispensed in an orderly, non-overlapping manner onto the return transport path 120e. During the dispensing process, the processor or controller 202 counts that ten (10) US $1 bills have been dispensed from storage bay 160b, zero (0) US $5 bills have been dispensed from storage bay 160c, zero (0) US $10 bills have been dispensed from storage bay 160d, one hundred (100) US $20 bills have been dispensed from storage bay 160e, and five (5) US $100 bills have been dispensed from storage bay 160f and/or that a total of $2510 and/or a total of 115 banknotes have been dispensed from storage bays 160b-160f.

The banknotes are then routed to transport path 120a and through or past the banknote detector section 130. The banknotes are denominated based on information detected from the banknotes via the detectors in banknote detector section 130. According to some embodiments, information about each banknote (such as the denomination of each banknote) has already been determined before the banknotes were stored in the escrow storage bin 160a and/or storage bay 160b-160f and/or the denomination of each banknote is presumed based on the storage bay 160b-160f from which it was dispensed and this information has been stored in the memory 204 of the banknote recycler 100. In some such embodiments, the denomination of each bill as determined as a result of the pass through the banknote detector section 130 in the Internal Audit Mode is compared to the denomination of each bill as determined as a result of an earlier pass through the banknote detector section 130 where the results of that earlier determination where stored in the memory 204 of the banknote recycler 100 (and/or based on a presumed denomination based on the storage bay 160b-160f from which a banknote was dispensed). When the determined denomination of a banknote as determined during the Internal Audit Mode does not agree with the denomination of the banknote as determined in a first or earlier pass (and/or based on a presumed denomination based on the storage bays 160b-160f from which a banknote was dispensed), a processor 202 of the banknote recycler may generate a Denomination Mismatch error signal. According to some embodiments, a banknote triggering a Denomination Mismatch error signal is routed to and stored in secure bin 150.

The denominated banknotes are then deposited back into the appropriate storage bays 160b-160f via transport path 120b, storage bay transport path 120d and diverters 161b-161e. During the depositing process, the processor or controller 202 counts how many banknotes are delivered into each storage bay 160b-160f. In the above example, when no error occurs, the processor 202 would count that ten (10) US $1 bills have been deposited into storage bay 160b, zero (0) US $5 bills have been deposited into storage bay 160c, zero (0) US $10 bills have been deposited into storage bay 160d, one hundred (100) US $20 bills have been deposited into storage bay 160e, and five (5) US $100 bills have been deposited into storage bay 160f and/or that a total of $2510 and/or a total of 115 banknotes have been deposited into storage bays 160b-160f.

When an error condition occurs during the Internal Audit Mode, the processor or controller 202 may generate the appropriate error signal(s) and message(s) and report the details of the error condition(s) to the user or operator of the banknote recycler 100 via the input/output interface 208. For example, in the above example when ten (10) US $1 bills were expected to reside in storage bay 160b but only nine (9) US $1 bills are dispensed from storage bay 160b, counted using the sensors of the banknote detector section 130 and re-deposited back into storage bay 160b during the operation of the banknote recycler in the Internal Audit Mode, an error condition and/or message may be generated by the processor or controller 202 to communicate to the operator that ten (10) US $1 bills were expected to reside in storage bay 160b but only nine (9) US $1 bills were dispensed from and re-deposited into storage bay 160b, and one (1) $1 bill is missing from storage bay 160b. According to some embodiments, the processor or controller 202 communicates the error condition via the interface 208 which may include a display and/or printer and/or a communication interface to communicate the information to a communication network such as the internet and/or an intranet or a local communication network.

In a similar fashion, when no error occurs in the Internal Audit Mode, the processor or controller 202 may generate the appropriate confirmation signal(s) and/or message(s) and/or report the details of the number, value, and/or breakdown of banknotes stored in the banknote recycler and/or a signal and/or message to the user or operator of the banknote recycler 100 via the input/output interface 208 that number, value, and/or breakdown of banknotes expected to be stored in the banknote recycler bays 160b-160f matches the number, value, and/or breakdown of banknotes determined to be in the banknote recycler bays 160b-160f during the Internal Audit Mode. According to some embodiments, the processor or controller 202 to communicates a confirmation (match or no error) condition via the interface 208 which may include a display and/or printer and/or a communication interface to communicate the information to a communication network such as the internet and/or an intranet or a local communication network.

According to some embodiments, the banknote recycler 100 may be programmed or configured to automatically place itself into and execute the Internal Audit Mode. For example, the banknote recycler processor 202 may be programmed to run at 2:00 a.m. each morning or after each time the safe/vault is accessed (i.e., after the security door(s) of the housing of the recycler 100 have been opened and closed/locked again). Such automatic auditing can be employed to catch a loss or shortage of banknotes.

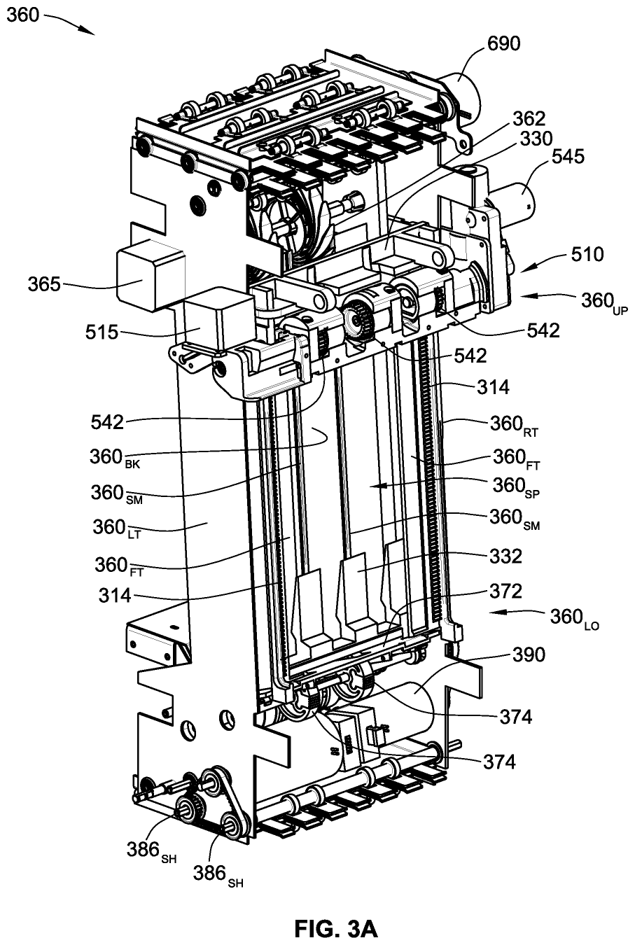

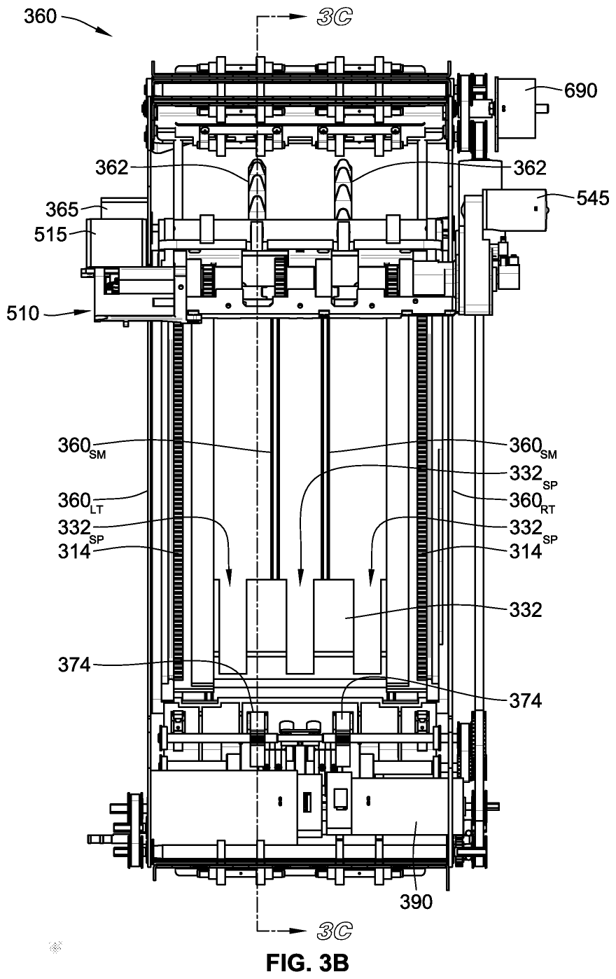

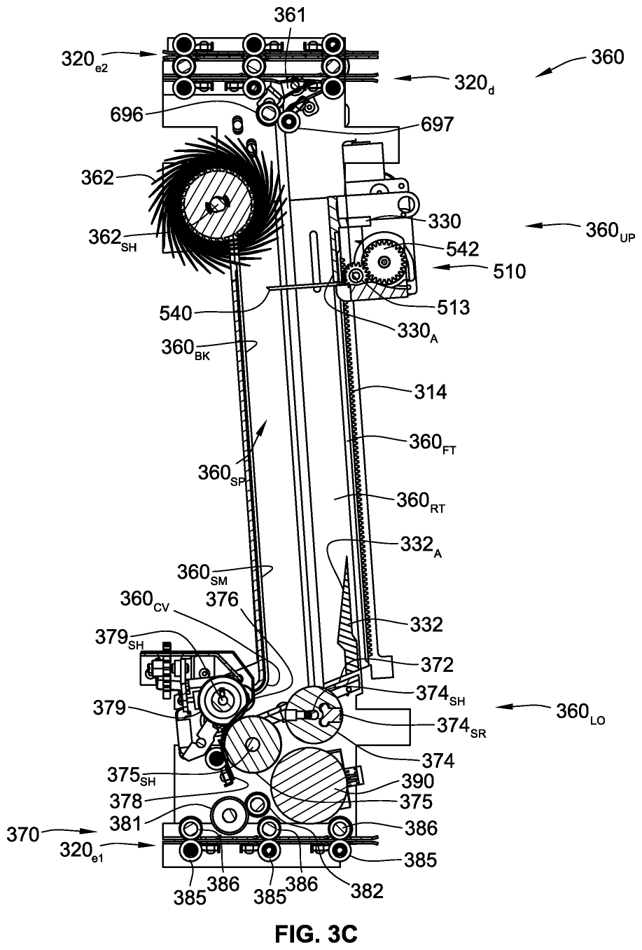

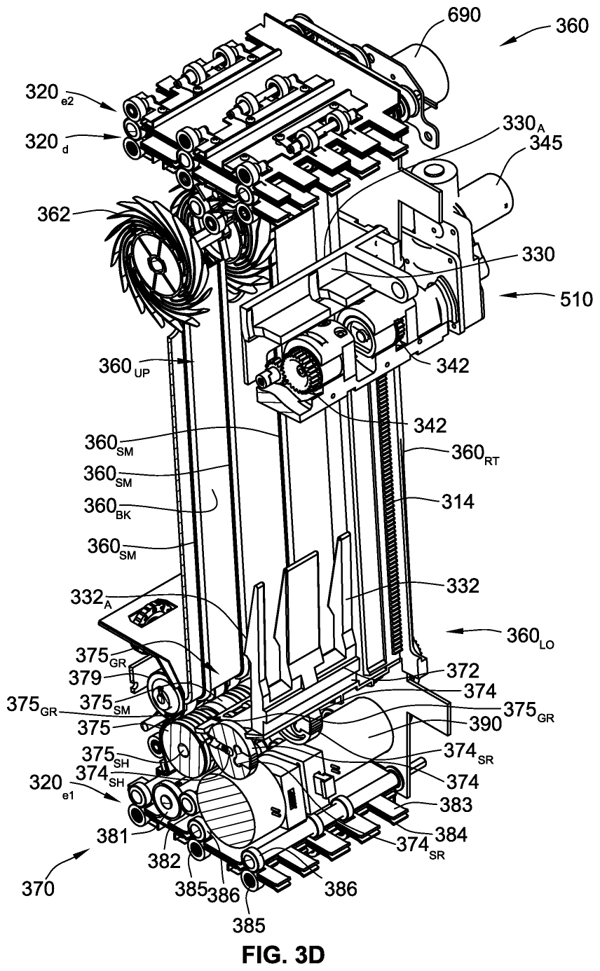

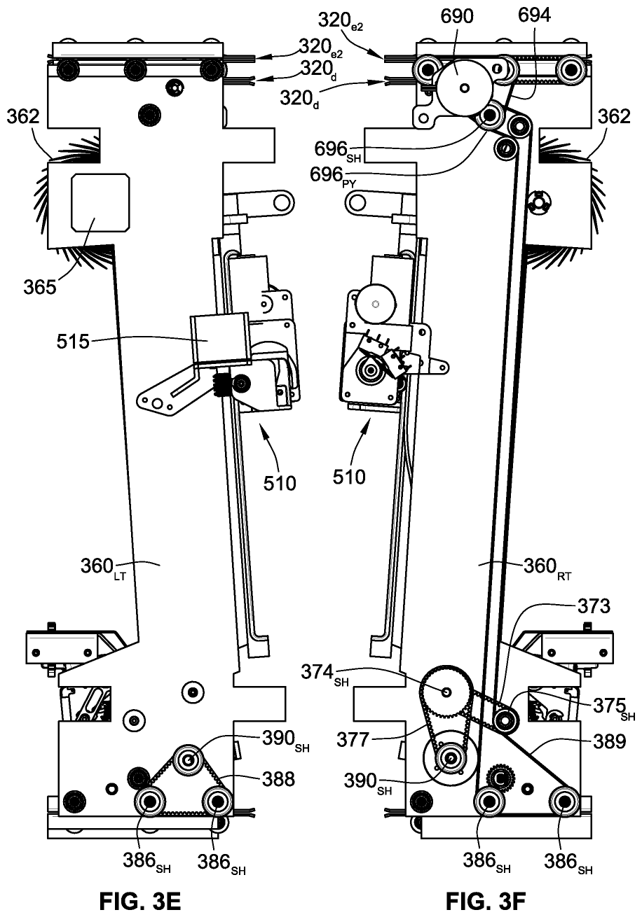

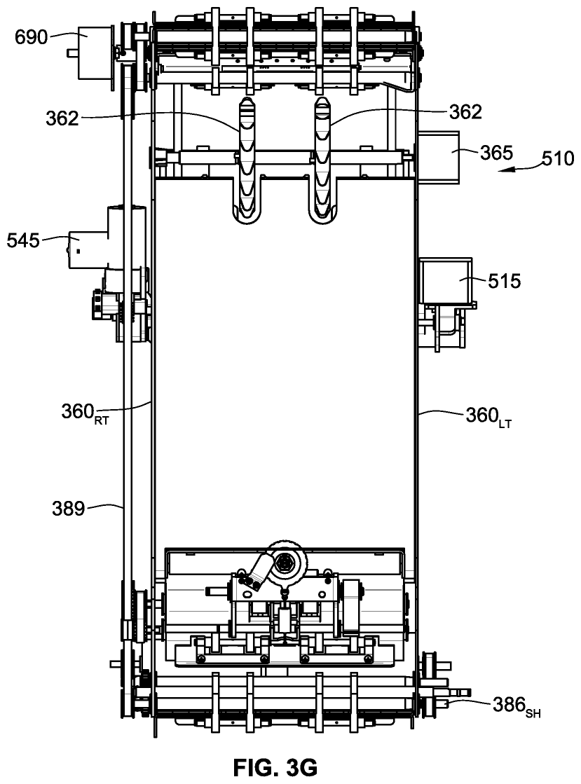

According to some embodiments, the banknote recycler 100 is configured to sit on the floor or on a counter between two operators such as between two bank tellers and to be operable by either operator from two different sides of the banknote recycler 100. According to some embodiments, the banknote recycler is configured to perform only one transaction at a time, such as a deposit transaction or a dispense (or withdrawal) transaction such as at a bank. According to some embodiments, the banknote recycle is made compact. For example, according to some embodiments, the storage bay pitch 160p of the storage bays 160a-160f (that is the horizontal distance between the same component in adjacent storage bays 160a-160f) is less than 7 inches (18 cm). For example, referring to FIG. 1A the storage bay pitch 160p is illustrated as the horizontal distance between the center of the stacker wheel 162e and the center of adjacent storage bay stacker wheel 162f. As another example, referring to FIG. 1A the storage bay pitch 160p is illustrated as the horizontal distance between the center of a stripping or auxiliary wheel 374a of storage bay 160a and the center of adjacent stripping auxiliary wheel 374b in storage bay 160b. Stripping or auxiliary wheels 374 are described more below such as in connection with FIG. 3C. According to some embodiments, the storage bay pitch 160p is less than 6 inches (16 cm). According to some embodiments, the storage bay pitch 160p is about 5¼ inches (13.3 cm).

According to some embodiments, banknotes are scanned by the banknote detector section 130 both when banknotes are being inserted or deposited into the banknote recycler 100 and when banknotes are being dispensed from the banknote recycler 100. According to some embodiments, banknotes are scanned by the banknote detector section 130 when banknotes are being inserted or deposited into the banknote recycler 100 but not when banknotes are being dispensed from the banknote recycler 100. According to some embodiments, the banknote recycler has two banknote detector sections 130. For example, FIG. 1G is a schematic view of a banknote recycler 100′ according to some embodiments of the present disclosure having a second banknote detector section 130′. When banknotes are being dispensed from storage bays 160a-160f, they may be alternatively routed to transport path 120f via a diverter 161f, through the second banknote detector section 130′ and to output receptacle 140c which may comprise stacker wheels 142c. Otherwise, the banknote recycler 100′ may be the same as banknote recycler 100. According to some such embodiments, banknote recycler 100′ may be configured to process a deposit transaction simultaneously with a withdrawal or dispense transaction. For example, the banknote recycler may be operated in a Feed-to-Escrow mode or Escrow Accept Mode as discussed above in connection with FIGS. 1C and 1D (such as at the request of a first bank teller) and be simultaneously be operated in a Dispense mode (such as at the request of a second bank teller) where banknotes to be dispensed are routed to output receptacle 140c.

According to some embodiments, banknotes of a plurality of denominations may be stored in a single banknote storage bay 160b-160f. For example, both $50 banknotes and $100 banknotes may be stored in storage bay 160f according to some embodiments. According to some such embodiments, the memory 204 and/or the processor 202 keeps track of the denomination of every banknote in the storage bay 160f (e.g., that the bottom ten bills are $100 banknotes, the next five bills are $50 bills, the next bill is a $100 bill, and the top three bills are $50 bills). This information may then be used by the banknote recycler when it is desired to dispense a $50 or $100 bill with the banknote recycler instructing the dispenser 170f to dispense the appropriate number of bills to reach the desired denomination of banknote (e.g., if one $50 is requested to be dispensed, the banknote recycler 100, via processor 202, instructs the dispenser to dispense eleven (11) banknotes from storage bay 160f, route the first ten notes bank into the storage bay 160f and route the eleventh bill to output receptacle 140b). Alternatively, the banknote recycler (via the processor 202 and/or memory 204) may keep track that $50 and $100 notes are to be stored in storage bay 160f but not the order of the denominations stacked therein. In such embodiments, the processor 202 may instruct the dispenser 170f to begin dispensing bills and route the bills through the banknote detector section 130 whereby the denomination of each note is determined. When a banknote of a desired denomination is detected, it is routed to output receptacle 140b, otherwise banknotes having undesired denominations are routed back to the storage bay from which they were dispensed. According to some embodiments, banknotes may not be sorted by denominations but instead banknotes of mixed denominations are stored in one or more of the storage bays 160b-160f and the memory 204 and/or the processor 202 may keep track of the denomination of every banknote in the storage bays 160b-160f and the order they are stored in each storage bay 160b-160f. For example, deposited banknotes may be stored in storage bay 160b until that storage bay 160b reaches its capacity and then deposited banknotes are stored in the next storage bay 160c until that storage bay 160c reaches its capacity, etc.

According to some embodiments, the first storage bay 160a is used as an escrow storage bay as discussed above. According to some embodiments, in place of or in addition to the first storage bay, the banknote recycler 100 has a banknote cassette receiving port or interface or container dock 180. FIG. 1H is a schematic view of a banknote recycler 100″ according to some embodiments of the present disclosure having a banknote cassette receiving port or container dock 180. According to some such embodiments, a cassette or automated banknote container containing banknotes may be inserted into the cassette port 180 and used to fill the storage bays 160b-160f with banknotes or additional banknotes. For example, if the banknote recycler 100″ was running low on $20 bills, a cassette containing $20 bills may be inserted into the port 180 of the banknote recycler 100″ and the banknote recycler 100″ may be placed in an Intake mode via an operator using interface 208. The port 180 may comprise a dispenser 170-1 similar to dispensers 170a-170f. Banknotes would be fed out of the cassette onto banknote return path 120e, through the banknote detectors section 130 and into the appropriate storage bay(s) 160a-160f such as based on the determined denomination of each banknote.

According to some such embodiments, the banknote cassette receiving port 180 may be used to remove banknotes in bulk from the banknote recycler 100″, such as for example, when the banknote recycler 100″ has more than a desired number of banknotes stored therein, e.g., such as more than 1900 notes of a given denomination. An empty banknote cassette may be inserted into the banknote cassette receiving port, and an operator may place the banknote recycler into an appropriate mode, e.g., a Bulk Dispense Mode, and provide instructions to the banknote recycler via the input/output interface 208 as to what notes are to be routed into the cassette, e.g., 1000 $1 bills or all bills in storage bay 160c. The appropriate banknotes would then be dispensed from the appropriate storage bays 160a-160f and then into the cassette. The banknotes may be first routed through the banknote detector section 130 and the banknote recycler 100″ may determine their denominations and/or other characteristics of the banknotes prior to being routed into the cassette. Any dispensed banknotes not to be routed into the cassette may be routed back into an appropriate one of the storage bays 160a-160f.

Additional details regarding cassettes, banknote containers, secured containers, and smart containers and banknote cassette receiving ports or interfaces or container docks 180 are disclosed in U.S. Pat. No. 9,141,876 [attorney docket 247171-000586USPT], and U.S. Pat. No. 7,600,626 [attorney docket 247171-000345USPT], each incorporated herein by reference in its entirety. According to some embodiments, filling and removing banknotes in bulk via secured cassettes and a banknote cassette receiving port 180 is not only faster but also more secure as it eliminates another point in the operation of the banknote recycler 100″ where a human is handling banknotes and/or banknotes in an unsecured location such as hopper 110 and/or output receptacles 140a, 140b. The increased security can be particularly advantageous when the banknote recycler is located in a location open to the public such as in a lobby of a bank. According to some embodiments, the banknote cassettes or containers are secured containers and/or smart containers as described in U.S. Pat. No. 9,141,876.

As mentioned above, FIG. 2 is a functional block diagram of a banknote recycler 200 such as banknote recycler 100. According to some embodiments, the banknote recycler 200 comprises one or more processors and/or controllers 202 communicatively coupled to electronic components of the hopper 110 such as, for example, hopper sensor(s) and/or motor(s) used to drive stripping wheels and/or other rollers used to feed banknotes to transport path 120a. The one or more processors and/or controllers 202 are also communicatively coupled to electronic components of the transport mechanism 120 and related transport path flow detectors, banknote detectors 130, diverters 143, 151, 161, stacking wheels 142, 162, storage bay dispensers 170, storage bay elevators 510, a memory 204, an encoder 206, and/or interface 208. Where the banknote recycler 200 comprises a plurality of processors and/or controllers 202, they may be communicatively coupled to each other. According to some embodiments, the interface 208 comprises a display, keyboard, touchscreen, touchpad, mouse, speaker, microphone, voice recognition module, biometric input device (e.g., fingerprint scanner, iris scanner, etc.) and/or other input/output devices. Examples of processors and/or controllers being communicatively coupled to and controlling the operation of various components of banknote handling devices such as input hoppers, banknote detectors, and transport mechanisms can be found in U.S. Pat. No. 5,815,592 [Attorney Docket 247171-000131] and U.S. Pat. No. 6,398,000 [Attorney Docket 247171-000246], each of which is incorporated herein by reference in its entirety.

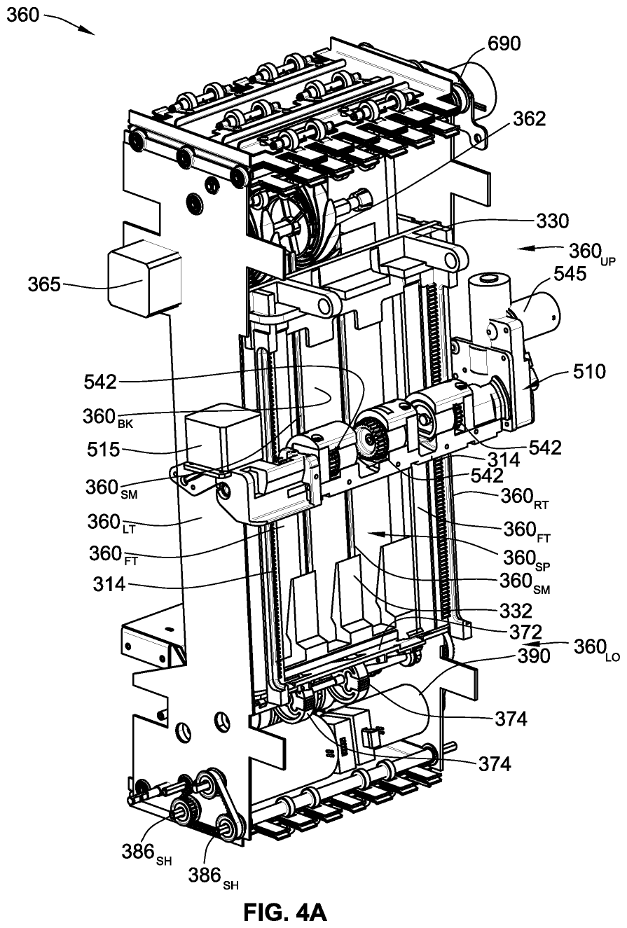

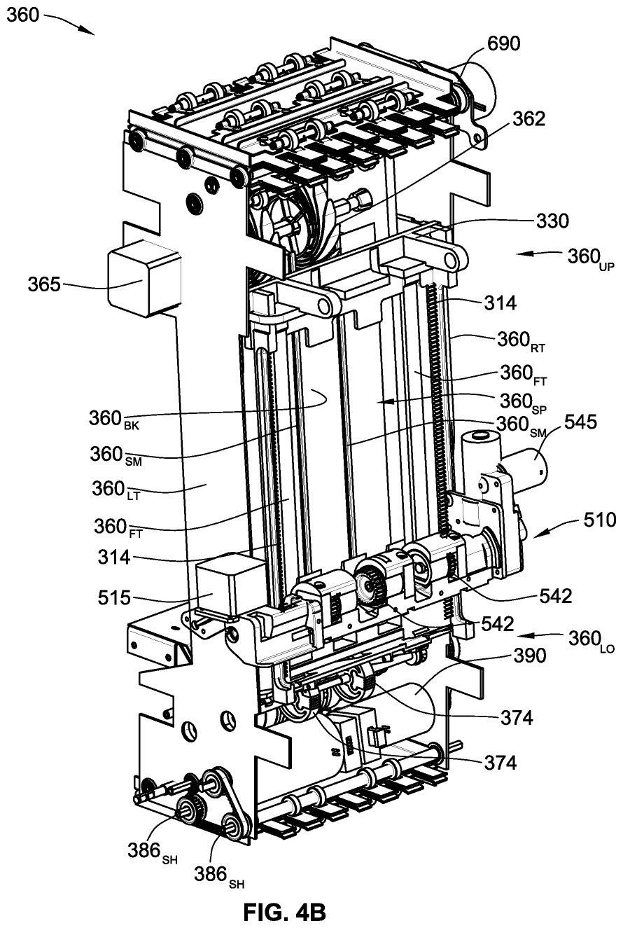

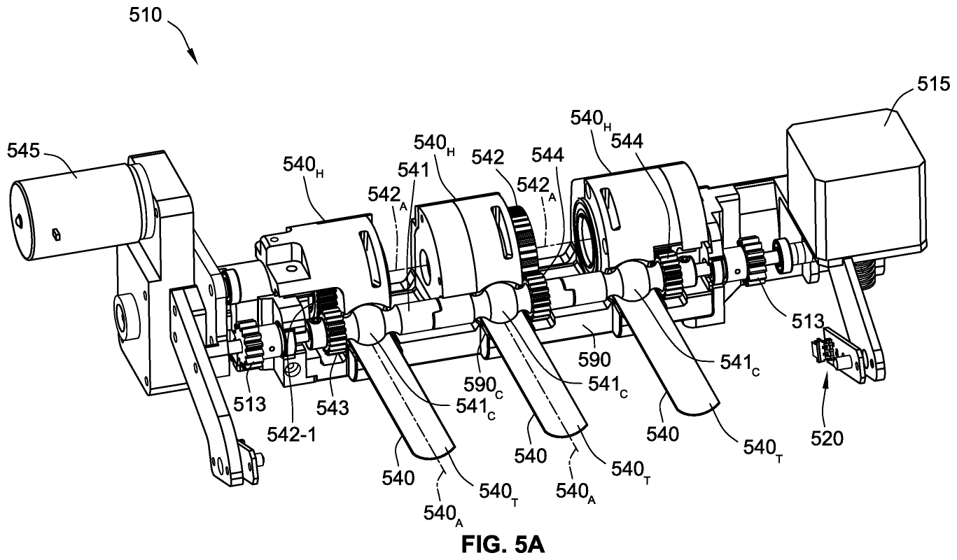

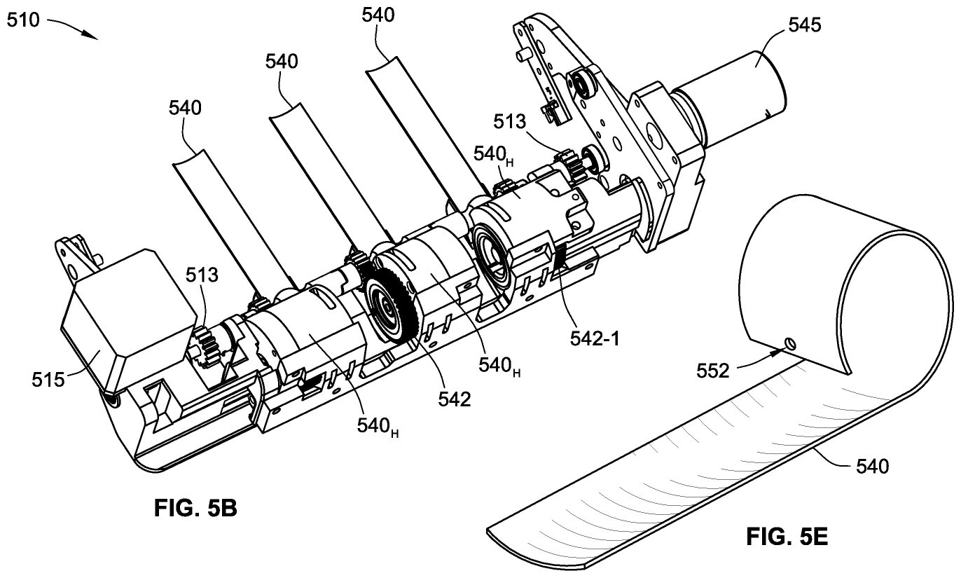

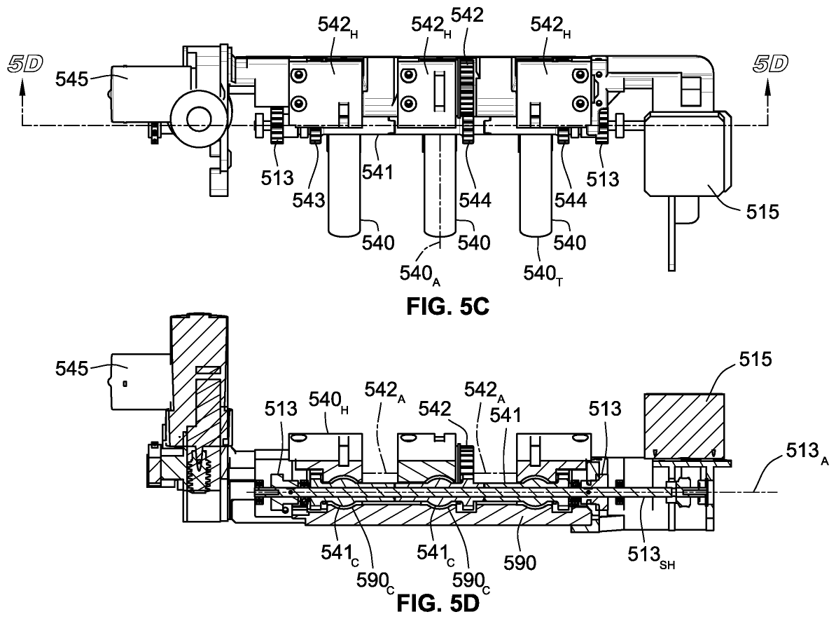

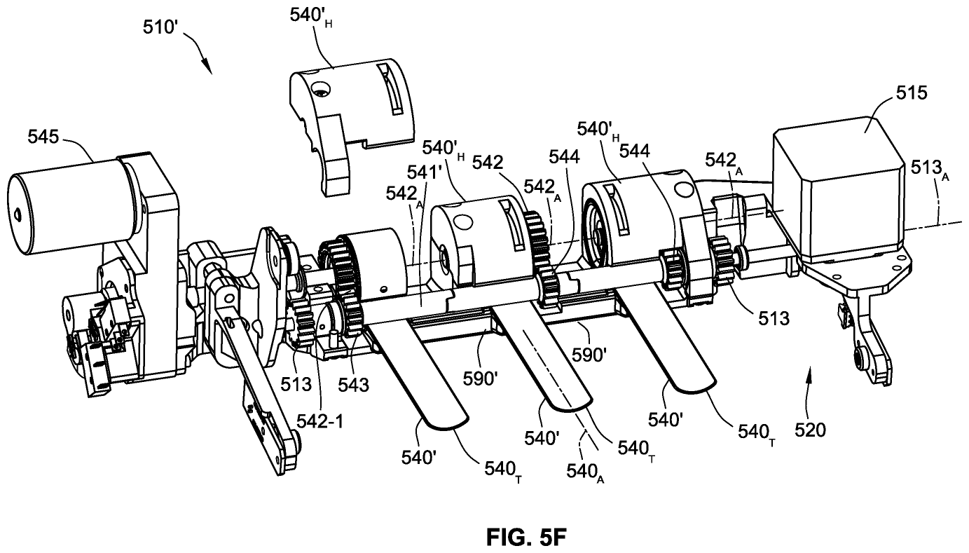

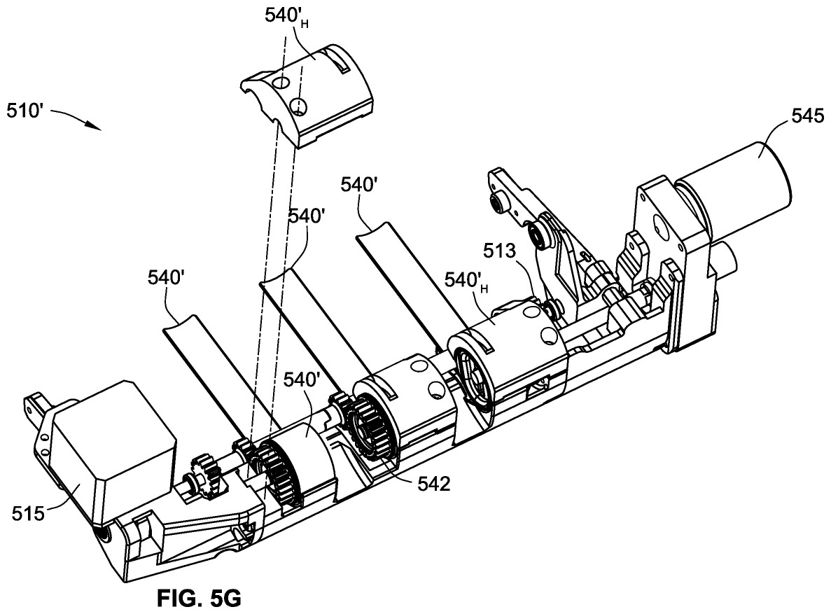

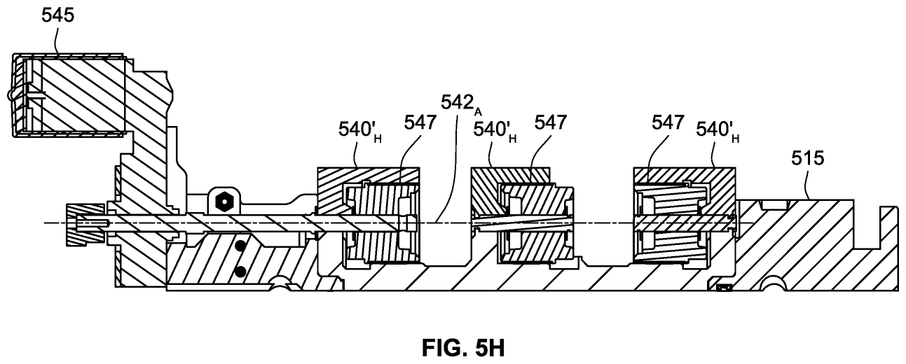

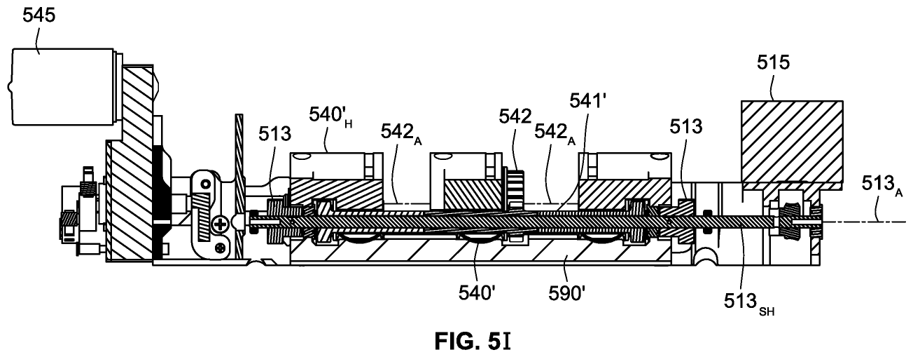

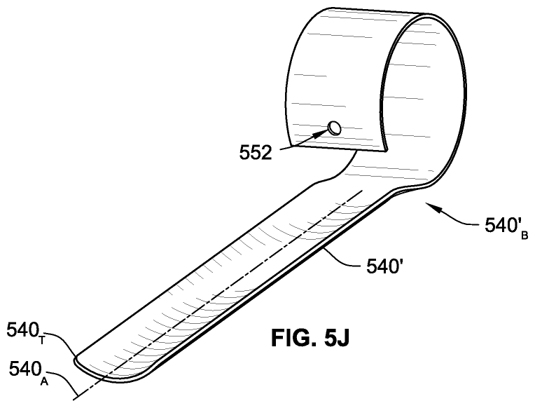

FIG. 3A is a front perspective view of a banknote recycler storage bay 360 according to some embodiments of the present disclosure having an elevator 510 positioned near the top of the bay. FIG. 3B is a front view of the banknote recycler storage bay 360 of FIG. 3A. FIG. 3C is a side sectional view (with a retractable banknote support 540 shown in an extended position) and FIG. 3D is a perspective sectional view of a banknote recycler storage bay 360 taken along line 3C-3C in FIG. 3B. FIG. 3E is a left side view, FIG. 3F is a right side view, and FIG. 3G is a rear view of the banknote recycler storage bay 360 of FIG. 3A with the elevator 510 positioned at a lower location. FIG. 4A is a front perspective view of the banknote recycler storage bay of FIG. 3A with the elevator 510 located near the middle of the storage bay. FIG. 4B is a front perspective view of the banknote recycler storage bay of FIG. 3A with the elevator 510 located near the bottom of the storage bay. FIG. 5A is rear perspective view, FIG. 5B is a front top perspective view, FIG. 5C is a top view of the elevator 510 with banknote supports 540 being in an extended position. FIG. 5D is a sectional view of elevator 510 taken along line 5D-5D in FIG. 5C. FIG. 5E is a perspective view of a banknote support 540 according to some embodiments. The storage bay 360 is an example of a storage bay that may be used as the storage bays 160a-160f of banknote recyclers 100, 100′, 100″.

The banknote recycler storage bay 360 has an upper end 360_{UP} and a lower end 360_{LO} and a right side wall 360_{RT} and a left side wall 360_{LT}. The storage bay 360 also has a back wall 360_{BK} and two front walls 360_{FT}—one on the right side of the storage bay 360 and one of the left side of the storage bay 360. The right side wall 360_{RT}, the left side wall 360_{LT}, the back wall 360_{BK}, and the two front walls 360_{FT} help to contain stacked banknotes within the storage bay 360 and serve to define a banknote space 360_{SP} of the storage bay 360.

According to some embodiments, the back wall 360_{BK} is separated from the two front walls 360_{FT} by a distance less than the narrow dimension of the banknotes to be stacked therein such that the banknotes stacked therein are angled downwardly toward the back wall 360_{BK} of the storage bay. According to some embodiments, the banknotes are stacked in the storage bay 360 at an angle of between about 10°-20°. For U.S. banknotes, the narrow dimension of the banknotes of all denominations is 2.61 inches (66 mm).

According to some embodiments, the stacking of the banknotes in the storage bay 360 at an angle relieves some of the weight of the banknotes which would otherwise by borne by a feeding plate 372. In some such embodiments, the re-allocation of the bearing of the weight of some of the banknotes in the stack from the feeding plate 372 to one or more of the walls of the storage bay 360, e.g., backwall 360_{BK}, increases the number of banknotes that may reside in the storage bay 360 and not have to be lifted up by the elevator 510 and banknote supports 540 prior to dispensing banknotes smoothly and at high speeds (e.g., at least 1000 banknotes per minutes). Such a process will be described in more detail below.

According to some embodiments, the banknotes are stacked horizontally within the storage bay 360 such as on banknote supports 540 and/or feeding plate 372 and not an angle from horizontal as discussed above.

According to some embodiments, the back wall 360_{BK} has one or more low friction surfaces to enhance the ability of the edges of banknotes residing in the banknote storage bay 360 and abutting the backwall 360_{BK} to easily slide up or down within the storage bay 360 as the result of the movement of the elevator 510 and/or the feeding out of banknotes from the bottom of the storage bay 360 as will be described in more detail below. According to some embodiments, low friction surfaces take the form of narrow low friction rails 360_{SM} extending the height of the storage bay 360. According to some embodiments, two to four low friction rails 360_{SM} are positioned on the back wall 360_{BK}.

According to some embodiments, the storage bay 360 is vertical. According to some embodiments, the storage bay is off-set from being vertical by about 4°, e.g., the backwall 360_{BK} and/or the front walls 360_{FT} are tilted at or by at least an angle of about 4° from vertical. According to some embodiments, the storage bay is off-set from being vertical by about 2°-6°. According to some embodiments, the storage bay is off-set from being vertical by about 2°-8°. According to some embodiments, the storage bay is off-set from being vertical by least about 2°. According to some embodiments, the storage bay is off-set from being vertical by least about 6°. According to some embodiments, the storage bay is off-set from being vertical by least about 8°.

Positioned near the upper end 360_{UP} of the storage bay 360 is an upper front banknote wall 330 having a banknote abutting surface 330_{A} (see FIG. 3C). According to some embodiments, positioned near the lower end 360_{LO} of the storage bay 360 is a lower front banknote angled wall 332 having an angled banknote abutting surface 332_{A}. The upper front banknote wall 330 serves as an additional structure to maintain banknotes within the storage bay 360 while the banknotes are being stacked therein. According to some embodiments, the banknote angled wall 332 takes the form of a series of prongs having a plurality of spaces 332_{SP} (see FIG. 3B) which permit extended banknote supports 540 to be moved up and/or down near the bottom 360_{LO} of the storage bay 360 as the elevator 510 moves up and/or down without contacting or being blocked by the angled wall 332.

According to some embodiments, banknotes are stacked in the storage bay 360 with the aid of a pair of stacker wheels 362 mounted on a stacker wheel shaft 362_{SH} which is rotationally driven by a motor 365. The motor 365 is controlled by a controller or processor such as controller or processor 202.

According to some embodiments, the angled banknote abutting surface 332_{A} of the angled wall 332 serves to increase the angle at which bills are stacked in the storage bay 360 near the lower end 360_{LO} of the storage bay 360 and urge the bills into greater contact with low friction rails 360_{SM} on the back wall 360_{BK} and into engagement with the input of a dispenser 370. According to some embodiments, the angled banknote abutting surface 332_{A} has a relatively high coefficient of friction, e.g., higher than that of the low friction rails 360_{SM}. Note, in FIG. 3B, the upper front banknote wall 330 has been removed to aid in illustrating the interior of the storage bay 360. As can be seen in FIG. 3C, according to some embodiments, the back wall 360_{BK} is curved at the bottom 360_{Cv}. This curve assists in helping banknotes to fan out near the bottom of the storage bay 360 which in turn can facilitate the smooth feeding and separation of banknotes by the dispenser 370 so that they may be fed off the feeding plate 372 sequentially, one bill at a time.

The elevator 510 has a pair of driven elevation gears 513 (see e.g., FIG. 3C and FIGS. 5A-5D) that engage a pair of geared elevator tracks 314 (see e.g., FIGS. 3A-3D) positioned on the outside of the two front walls 360_{FT} of the storage bay 360. The driven elevation gears 513 are driven by an elevation motor 515 coupled to the elevation gears 513. The elevation motor 515 is communicatively coupled to and controlled by a controller or processor such as controller or processor 202.

The elevator 510 has at least one retractable banknote support 540. In the illustrated embodiment in FIGS. 3A-3G and FIG. 5A-5D, there are three retractable banknote supports 540 (see, e.g., FIGS. 3C, 5A and 5B). Each retractable banknote support is moveable between at least two positions. A first position of each banknote support 540 is an extended position (as shown in FIGS. 3C, 5A and 5B) wherein the banknote support extends into the storage bay 360 and defines a platform on which banknotes may be stacked and which can support a stack of banknotes. A stack of banknotes stacked on the banknote supports 540 can be moved up and down within the storage bay by the elevator 510 being moved up and down. A second position of each banknote support 540 is a retracted position wherein the banknote support 540 does not support a stack of banknotes in the banknote space 360_{SP} of the storage bay.

In an exemplary embodiment, each banknote support 540 does not project into the banknote space 360_{SP} of the storage bay when in its retracted position but instead is wrapped about a transverse axis and is stored in a compact generally coiled configuration like a window shade. Each banknote support 540 is driven between the extended position and the retracted position via a banknote support positional gear 542. The banknote support positional gears 542 and/or the support drums (not shown, but see support drum or roller 547 in FIG. 5H) about which the banknote supports 540 are rolled are in turn driven by a motor or solenoid 545 controlled by a controller or processor such as controller or processor 202.

According to some embodiments, each of the banknote supports 540 is made of a relatively narrow strip of material that is designed to achieve an optimal balance between (a) the support strength of a platform defined by one or more banknote supports 540 when in the extended first position and (b) sufficient flexibility of the banknote supports 540 when in the retracted second position.

It has been found that a banknote support 540 made of metal having a thickness between 0.005″ and 0.02″ such as a thickness of approximately 0.01″ is sufficiently flexible to be wrapped about itself when driven between the extended first position and the retracted second position. According to some embodiments, the banknote support is made of spring steel, but other materials could be used such as, for example, plastic.

In addition, the cross-section of each banknote support 540 is selected to maximize its bending stiffness in the extended first position. In one embodiment, each banknote support 540 is curled about a longitudinal axis such that in the extended first position it has a concave upward cross-sectional shape and defines an elongated upward opening channel to increase bending stiffness of the banknote support 540 independently of the thickness of the material from which the banknote support 540 is constructed. In this way, the resultant weight bearing capability of the platform that is defined by one or more of the banknote supports 540 when in the extended first position is increased without decreasing the flexibility of the banknote supports 540 when in the second retracted position.

Turning to FIGS. 5A-5D, an example of an elevator 510 is illustrated in more detail. As discussed above, the elevator 510 comprises driven elevation gears 513 driven by an elevation motor 515 and banknote support positional gears 542 driven by a banknote support motor or solenoid 545. Turning to FIG. 5D, the driven elevation gears 513 are fixedly mounted on a rotatable elevation gear shaft 513_{SH} which is rotatable about axis 513_{A}.

Banknote support motor or solenoid 545 is operatively coupled to a first 542-1 one of the banknote support positional gears 542 to cause the first banknote support positional gear 542-1 to rotate about an axis 542_{A}. The first banknote support positional gear 542-1 operatively engages a first transmission gear 543 fixedly coupled to a rotatable transmission shaft 541 to cause the first transmission gear 543 and the rotatable transmission shaft 541 to rotate. The rotatable transmission shaft 541 is rotatably mounted about elevation gear shaft 513_{SH} and is configured to rotate independently from the rotation of the elevation gear shaft 513_{SH}. Both the rotatable transmission shaft 541 and the elevation gear shaft 513_{SH} are rotatable about axis 513_{A}, albeit independently. Additional transmission gears 544 are fixedly mounted to the transmission shaft 541 proximate additional banknote support positional gears 542. The rotation of the transmission shaft 541 causes the additional transmission gears 544 to cause the additional or remaining banknote support positional gears 542 to rotate about axis 542_{A}. As discussed above, the rotation of the banknote support positional gears 542 including the first banknote support positional gear 542-1 causes respective banknote supports 540 to move between a first, extended (wherein a respective banknote support extends into the storage bay 360 and provides a structure on which banknotes may be stacked) and a second position, retracted position (wherein the banknote support 540 does not project into the banknote space 360_{SP} of the storage bay 360).

According to some embodiments, when the banknote supports 540 are in their retracted position, they are rolled about themselves and about the transverse axis 542_{A} like a tape measure or window shade when in its retracted position and stored within banknote support housings 540_{H}. Each banknote support drum (not shown, but see support drum or roller 547 in FIG. 5H) and corresponding cover 540_{H} cooperate such that a corresponding banknote support 540 may be extended and retracted with stress to the banknote support material in transition from straight to rolled being minimized. In general, the larger the diameter of the drum, the less stress that is placed on the banknote support material when it is rolled about the drum.

To aid in maintaining the banknote supports in a curled manner about a longitudinal axis 540_{A} when in the extended position, the transmission shaft 541 comprises curved portions 541_{C}. The curved shaped of curved portion 541_{C} is mirrored by a complimentary curved shape 590_{C} of a bottom elevator housing 590. Each curved portion 541_{C} and its complimentary curved shape 590_{C} of a bottom elevator housing 590 is positioned adjacent a location at which a banknote support 540 emerges from a corresponding banknote housing 540_{H} so that when the tip 540T of a banknote support 540 emerges from its banknote housing 540_{H} it is pressed between the curved portion 541_{C} and its complimentary curved shape 590_{C} of a bottom elevator housing 590 which serve to bend the banknote support about the longitudinal axis 540_{A}.

According to some embodiments, curved portions 541_{C} and complimentary curved shape 590_{C} of a bottom elevator housing 590 are omitted. Instead each bottom elevator housing or chassis 590 includes a concave shape which matches and is located below each banknote support 540 to ensure each banknote support 540 attains the correct shape and load-bearing capacity.

According to some embodiments, the banknote supports 540 may extend into the storage bays 360 in a horizontal manner. According to other embodiments, the banknote supports may extend into the storage bays 360 at an angle from the horizontal such as, for example, from 0°-5° or at an angle from the back wall 360_{BK} such as, for example, from 0°-5°. According to some embodiments, the downward angle of the banknote supports 540 varies based on the vertical location of the elevator 510. According to some embodiments, the banknote supports 540 are perpendicular to the two front walls 360_{FT} of the storage bay 360 which may serve as a stripping wall when the elevator 510 is positioned at the upper end 360_{UP} of a storage bay 360 for loading of banknotes onto the banknote supports 540. When the elevator 510 and the banknote supports 540 are moved to the lower end 360_{LO} of a storage bay 360, the banknote supports 540 are tilted down from 0-5 degrees such as by employing a cam follower. The tilting downward of the banknote supports 540 aids in stacking the banknotes in the area near the angled banknote abutting surface 332_{A} of the lower front banknote angled wall 332 and also helps avoid the banknotes from bridging across the storage bay 360, i.e., between angled banknote abutting surface 332_{A} and the low friction rails 360_{SM} positioned on the back wall 360_{BK}. See, e.g., FIG. 3C.

According to some embodiments, the elevator 510 also comprises one or more banknote drop-off detectors 520. In operation, the banknote drop-off detector 520 senses when the elevator 510 and the banknote supports 540 are near or adjacent the top of a stack of banknotes (or the feeding plate 372) residing below the elevator 510 and/or the banknote supports in the storage bay 360. According to some embodiments, the drop-off detectors 520 employ a through light beam to detect the presence of banknotes, i.e., a light beam directed through a portion of the storage bay 360 and detected by a detector 520 wherein the presence of a banknote blocks the light beam from reaching the detector 520. According to some embodiments, one or more other types of detectors 520 may be employed instead of a through light beam detector.

In FIG. 5E, an example of a banknote support 540 is illustrated. According to some embodiments, the banknote support 540 has one or more apertures or holes 552 therein that mate with nubs on a support drum or roller (not shown, but see support drum or roller 547 in FIG. 5H) residing in the housing 540_{H}.

Turning to FIGS. 5F-5I, an example of an elevator 510′ is illustrated in more detail. The elevator 510′ is the same and its operation is the same as elevator 510 described above in connection with FIGS. 5A-5D except that the transmission shaft 541′ does not comprises curved portions 541_{C} as with transmission shaft 541. Accordingly, the same or similar reference numbers are used for FIGS. 5F-5I for the same or similar components. FIG. 5F is rear perspective view and FIG. 5G is a front top perspective view and of the elevator 510′ with banknote supports 540′ being in an extended position. FIG. 5H is a front sectional view of elevator 510 taken along axis 542_{A} shown in FIG. 5F. FIG. 5I is a front sectional view of elevator 510 taken along axis 513_{A} shown in FIG. 5F. FIG. 5J is a perspective view of a banknote support 540′ according to some embodiments. In FIG. 5J, another example of a banknote support 540′ is illustrated as employed in elevator 510′ of FIGS. 5F-5I According to some embodiments, the banknote support 540′ has one or more apertures or holes 552 therein that mate with nubs on a support drum or roller 547 (see FIG. 5H) residing in the housing 540_{H}′. Banknote support 540′ comprises a bend 540_{E} which transitions the banknote support 540′ from being generally flat in a transverse direction to being curved in the transverse direction—being curved upward about longitudinal axis 540_{A}. The bend 540_{E} assists the banknote support 540′ in curving about longitudinal axis 540_{A} without the use of the curved portions 541_{C} of transmission shaft 541. As with banknote supports 540, according to some embodiments, when the banknote supports 540′ are in their retracted position, they are rolled about themselves and about the transverse axis 542_{A} like a tape measure or window shade when in its retracted position and stored within banknote support housings 540_{H}′.

Turning back to FIGS. 3A-3G and especially FIG. 3C, at the bottom of the storage bay 360 is a dispenser 370. The dispenser 370 comprises a feeding plate 372 which forms a bottom surface of the storage bay 360 and serves as a surface on which a stack of banknotes in the storage bay may be placed. During a dispensing operation, banknotes or bills that are stacked on the feeding plate 372 are stripped, one at a time, from the bottom of the stack. The bills are stripped by a pair of stripping wheels 374 mounted on a stripping wheel driven shaft 374_{SH} which, in turn, is supported across the side walls 360_{LT}, 360_{RT}. The stripping wheels 374 project through a pair of slots formed in the feeding plate 372. According to some embodiments, part of the periphery of each stripping wheel 374 is provided with a raised high-friction surface 374_{SR} which engages the bottom bill of the stack as the stripping wheels 374 rotate, to initiate feeding movement of the bottom bill from the stack. The high-friction surfaces 374_{SR} may project radially beyond the rest of the wheel peripheries so that the stripping wheels “jog” the bill stack during each revolution so as to agitate and loosen the bottom currency bill within the stack, thereby facilitating the stripping of the bottom bill from the stack.

The stripping wheels 374 feed each stripped bill into engagement with a drive roll 375 mounted on a driven drive roll shaft 375_{SH} supported across the side walls 360_{LT}, 360_{RT}. As described and illustrated in more detail in U.S. Pat. No. 5,815,592 [Attorney Docket 247171-000131], incorporated herein by reference in its entirety, the drive roll 375 may include a central smooth friction surface 375_{SM} formed of a material such as rubber or hard plastic. This smooth friction surface 375_{SM} is sandwiched between a pair of grooved surfaces 375_{GR} having high-friction portions formed from a high-friction material.

The high-friction surfaces engage each bill after it is fed into engagement with the drive roll 375 by the stripping wheels 374, to frictionally advance the bill into the narrow arcuate passageway formed by a curved guideway 378 adjacent the rear side of the drive roll 375. The rotational movement of the drive roll 375 and the stripping wheels 374 may be synchronized so that the high-friction surfaces on the drive roll 375 and the stripping wheels 374 maintain a constant relationship to each other. Moreover, according to some embodiments, the drive roll 375 is dimensioned so that the circumference of the outermost portions of the grooved surfaces is greater than the width W of a bill, such as the width of the widest bill to be stacked in a corresponding storage bay 360, so that the bills advanced by the drive roll 375 are spaced apart from each other. That is, each bill fed to the drive roll 375 is advanced by that roll only when the high-friction surfaces come into engagement with the bill, so that the circumference of the drive roll 375 determines the spacing between the leading edges of successive bills.

According to some embodiments, the drive roll 375 and the stripping wheels 374 are driven by motor 390 controlled by a controller or processor such as controller or processor 202. As shown in FIG. 3F, according to some embodiments, stripping wheel driven shaft 374_{SH} is rotatably driven via belt 377 coupled to motor shaft 390_{SH} which is rotatably driven by motor 390 and the driven drive roll shaft 375_{SH} is rotatably driven via belt 373 coupled to motor shaft 390_{SH} which is rotatably driven by motor 390.

According to some embodiments, to avoid the simultaneous removal of multiple bills from the stack in the storage bay 360, particularly when small stacks of bills are loaded into the storage bay 360, the stripping wheels 374 may be always stopped with the raised, high-friction portions 374_{SR} positioned below the feeding plate 372 of the storage bay 360. This is accomplished by continuously monitoring the angular position of the high-friction portions of the stripping wheels 374 via an encoder such as encoder 206, and then controlling the stopping time of the drive motor so that the motor always stops the stripping wheels 374 in a position where the high-friction portions 374_{SR} are located beneath the feeding plate 372 of the storage bay 360.

According to some embodiments, in order to ensure firm engagement between the drive roll 375 and the currency bill or banknote being fed, an idler roll 376 urges each incoming bill against the smooth central surface 375_{SM} of the drive roll 375. The idler roll 376 is journalled on a pair of arms which are pivotally mounted on a support shaft 379_{SH}. Also mounted on the shaft 379_{SH}, on opposite sides of the idler roll 376, are a pair of grooved guide wheels or retard rollers 379. Grooves in these two wheels 379 are registered with the central ribs in the two grooved surfaces 375_{GR} of the drive roll 375. The wheels 379 are locked to the shaft 379_{SH}, which in turn is locked against movement in the direction of the bill movement (clockwise as view in FIG. 3C) by a one-way clutch (not shown). Each time a bill is fed into the nip between the guide wheels 379 and the drive roll 375, the clutch is energized to turn the shaft 379_{SH} just a few degrees in a direction opposite the direction of bill movement. These repeated incremental movements distribute the wear uniformly around the circumferences of the guide wheels 379. Although the idler roll 376 and the guide wheels 379 are mounted behind the guideway 378, the guideway is apertured to allow the roll 376 and the wheels 379 to engage the bills on the front side of the guideway.

At the lower end of the curved guideway 378, the bill being transported by the drive roll 375 is directed into a nip formed between rolls 381 and 382 and then onto a lower portion 320e1 of the return transport path 120e of the transport mechanism 120 according to some embodiments. With reference to, for example, FIG. 3D, the lower portion 320e1 of the return transport path 120e comprises a pair of space transport plates 383, 384 and a plurality of driven transport rolls 386 and engaging a plurality of passive transport rolls 385 positioned on the opposite side of the transport path 120e and biased into engagement with the driven transport rolls 386. According to some embodiments, the driven transport rolls 386 are driven by motor 390 controlled by a controller or processor such as controller or processor 202. According to some embodiments, the driven transport rolls 386 are coupled to rotatable shafts 386_{SH} which are rotatably driven by a belt 388 coupled to a motor shaft 390_{SH} which is rotatably driven by motor 390 (see, e.g., FIG. 3E).

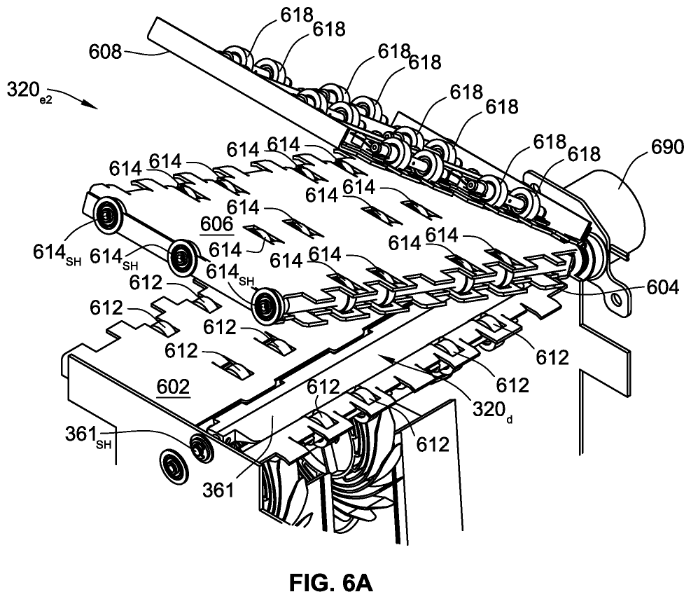

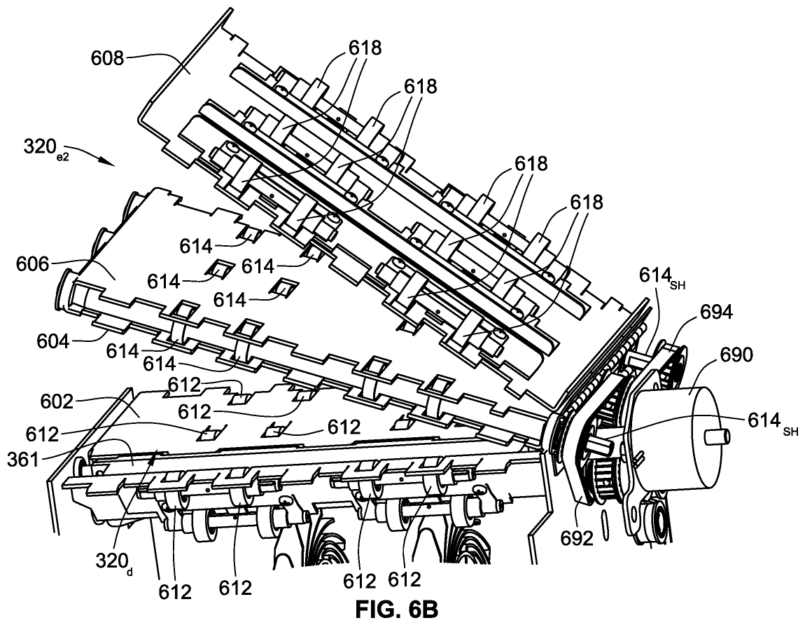

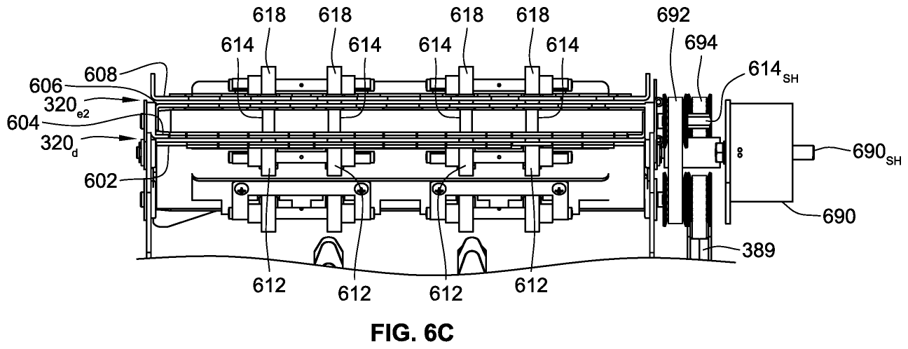

Above the storage bay 360, two portions of the transport mechanism 120 are illustrated according to some embodiments. According to some embodiments, a portion of storage bay transport path 120d of FIGS. 1A-1H takes the form of storage bay transport path 320d and an upper portion of return transport path 120e of FIGS. 1A-1H takes the form of upper return transport path 320e2. The transport paths 320d and 320e2 and their related transport mechanism components will be described primarily with reference to FIGS. 6A-6C.

FIGS. 6A and 6B are front perspective views of a portion of transport paths 320d and 320e2 and their related transport mechanism components in an open, non-operational position located on top of banknote recycling bay 360. FIG. 6C is a front view of a portion of transport paths 320d and 320e2 and their related transport mechanism components in a closed, operational position. The storage bay transport path 320d is formed between two spaced transport plates 602, 604 and the upper return transport path 320e2 is formed between two spaced transport plates 606, 608. Each transport plate 602-608 has a plurality of transport roll apertures therein through which a corresponding plurality of transport rolls project into the transport paths 320d and 320e2. More specifically, the lower transport plate 602 of the storage bay transport path 320d has a plurality of transport roll apertures through which a plurality of passive transport rolls 612 project upward into the storage bay transport path 320d so as to contact banknotes being transported along the storage bay transport path 320d. The upper transport plate 604 of the storage bay transport path 320d has a corresponding plurality of transport roll apertures through which a plurality of driven transport rolls 614 project downward into the storage bay transport path 320d so as to contact and drive banknotes along the storage bay transport path 320d. The transport roll apertures in transport plate 604 are positioned directly above the transport roll apertures in transport plate 602 so that a passive transport roll 612 protecting through each aperture comes in contact with a corresponding driven transport roll 614 when the transport plates 602 and 604 are in an operational position such as shown in FIG. 6C.

Similarly, the upper transport plate 608 of the storage bay transport path 320e2 has a plurality of transport roll apertures through which a plurality of passive transport rolls 618 project downward into the upper return transport path 320e2 so as to contact banknotes being transported along the upper return transport path 320e2. The lower transport plate 606 of the upper return transport path 320e2 has a corresponding plurality of transport roll apertures through which the plurality of driven transport rolls 614 project upward into the upper return transport path 320e2 so as to contact and drive banknotes along the upper return transport path 320e2. The transport roll apertures in transport plate 608 are positioned directly above the transport roll apertures in transport plate 606 so that a passive transport roll 618 protecting through each aperture comes in contact with a corresponding driven transport roll 614 when the transport plates 606 and 608 are in an operational position such as shown in FIG. 6C. As illustrated, according to some embodiments, the same driven transport rolls 614 are used to drive bills or banknotes both along transport paths 320d and 320e2, but in opposite directions. The driven transport rolls 614 are coupled to and rotate about shafts 614_{SH}. According to some embodiments, one side of a driven transport roll 614 projects into transport path 320d while an opposing side projects into transport path 320e2.

According to some embodiments, the driven transport rolls 614 are rotational driven about shafts 614_{SH} by a motor 390 via belts 692 and 694 which rotate shafts 614_{SH} and via belt 389 whose rotation is linked to the rotation of belt 694 via both belts 389 and 694 being coupled to a pulley 696_{PY} mounted to a shaft 696_{SH} (see FIG. 3F). Belt 389 is coupled to the shafts 386_{SH} driving the driven transport rolls 386 of the lower portion 320e1 of the return transport path 120e which in turn are driven by the motor 390. Accordingly, the same motor 390 may be used to drive the driven transport rolls in transport paths 320_{d}, 320ₑ₁, and 320ₑ₂. In some embodiments, the use of the same motor aids in synchronizing the movement of banknotes along a number of portions of the transport path 120.

The motor 390 as discussed above is controlled a processor or controller such as controller 202.

As can be seen in FIGS. 6A and 6B, according to some embodiments, the transport plates 604, 606, and 608 may be moved to an open, non-operational position to aid in clearing jams of banknotes and/or in providing maintenance or service to the transport paths 320d and 320e2 and their related transport mechanism components. According to some embodiments, transport plate 602 is fixedly coupled to the storage bay 360 and the pair of transport plates 604 and 606 are coupled together in fixed relation to each other. The transport plate 608 and the pair of transport plates 604 and 606 are hingedly coupled (via one or more hinges) to transport plate 602. According to some embodiments, as illustrated in FIGS. 6A and 6B, the transport plates 604, 606, and 608 may be moved from a closed, operational position to an open, non-operational position and back to a closed, operational position without having to remove or disconnect with belts 692, 694 used to drive the driven transport rolls 614.

Also illustrated in FIGS. 6A and 6B is a diverter 361 which serves as one example of a diverter that may be used as diverters 161 of FIGS. 1A-1H. The diverter 361 is mounted on a diverter shaft 361_{SH} which is coupled to a solenoid 690 which selectively changes the position of the diverter 361 between a non-diverting position (shown in FIGS. 6A and 6B) and a diverting position wherein a portion of the diverter projects into the storage bay transport path 320d so as to divert a banknote from continuing along storage bay transport path 320d and instead directs a bill or banknote into the storage bay 360. The solenoid 690 is controlled a processor or controller such as controller 202.

In operation, banknotes to be stored in one of the storage bays 160a-160f are routed along transport path 120d. If a banknote is to by-pass a storage bay 360, the diverter 361 (see FIGS. 3C, 6A, and 6B), is maintained in its non-diverting position and the driven transport rolls 614 advance the banknote along the transport path 320d past the diverter 361 and toward the next storage bay 360. With reference to FIGS. 3C and 3F, if a banknote is to be directed into a storage bay 360, the position of the diverter is moved to its diverting position wherein a portion of the diverter 361 will project into the transport path 320d so that the leading edge of the banknote being advanced by the driven transport rolls 614 contacts the diverter and is directed downward between a driven roll 696 and a passive roll 697 and then in between the fingers or vanes of the stacker wheels 362. The driven roll 696 is mounted on the shaft 696_{SH}. The stacker wheels 362 then stack the banknote onto the banknote supports 540 or, if there are already one or more banknotes stacked on the banknote supports 540, onto the top of the stack of banknotes being supported by banknote supports 540. The elevator 510 may be slowly lowered as more banknotes are directed into storage bay 360 so that the stacker wheels 362 may stack incoming banknotes onto the top of the stack of banknotes being supported by banknote supports 540 wherein the top of the stack of banknotes is maintained generally at the same height. According to some embodiments, the banknote recycler 100 is operated at high speeds and can deliver notes from the storage bay transport path 120d/320d into the storage bay 360 and onto and along the transport path 120e/320ₑ₁, 320ₑ₂ at a rate of at least 1000 bills/banknotes per minute.

After a transaction has been completed, such as an Escrow Accept or Internal Audit transaction and there are no more banknotes to be transported into a storage bay 360 in a given transaction, the elevator 510 may be lowered until the bottom banknote being supported by banknote supports 540 is positioned adjacent either the feeding plate 372 if there are no banknotes positioned below the banknote supports 540 or the top banknote in a stack of banknotes being supported by the feeding plate 372. According to some embodiments, the banknote drop-off detector(s) 520 aid in determining the appropriate height at which to stop lowering the elevator 510. At that point, the banknote support positional gears 542 move the banknote supports 540 from their first, extended position to their second, retracted position, thereby causing the bottom banknote previously supported by banknote supports 540 to come to rest on either the feeding plate 372 or the top banknote in a stack of banknotes previously supported by the feeding plate 372. After the banknote supports 540 have been retracted to their retracted positions, a single stack of banknotes rests on the feeding plate 372. The elevator 510 is then free to be raised above the top of the combined stack of banknotes such as to a level near the top 360_{UP} of the storage bay 360. Once the elevator 510 has reached a desired position above the top of the combined stack of banknotes, the banknote supports 540 may be extended again into the banknote storage space 360_{SP} so as to be ready to accommodate additional banknotes to be delivered into the storage bay 360 and stacked on the banknote supports 540 such as during a subsequent transaction.

To dispense bills or banknotes from the storage bay 360, the dispenser 370 is activated as discussed above to cause banknotes to be fed from the bottom of the stack of banknotes resting on feeding plate 372, one a time, onto return transport path 320e1.

According to some embodiments, the storage bays 360 are dimensioned to accommodate a stack of as many as 2000 banknotes. According to some embodiments, prior to dispensing banknotes from a storage bay 360, if there are more than a certain number of notes stacked therein, the elevator 510 and the banknote supports 540 are used to pick up the notes in the stack greater than that certain number. In some embodiments, the certain number is 700 banknotes. According to some embodiments, the certain number is adjusted to minimize feed errors and may be different for different qualities of banknotes. For example, for new, “brick” banknotes which tend to stick together, the certain number may be less than 700 banknotes, for example, 400 banknotes. In operation, the elevator 510 is moved generally vertically to the desired position with the banknote supports 540 being in their retracted position. When the elevator 510 is at the desired elevation, then the banknote supports 540 are moved to their extended position wherein a front end or tip 540T of the banknote supports 540 are pressed between notes in the stack of banknotes resting on the feeding plate 372. The banknote supports 540 are continued to be extended until the banknote supports are in their extended position. Then the elevator 510 is raised and the banknotes above the banknote supports 540 become supported by the banknote supports 540 and are no longer being supported by the feeding plate 372. The dispenser 370 is then activated to feed out notes from the storage bay 360. According to some embodiments, the dispenser 370 is operated at high speeds and can transport banknotes at a rate of at least 5000 inches per minute and/or deliver notes from the storage bay 360 onto the return transport path 120e1 at a rate of at least 1000 bills/banknotes per minute. According to some embodiments, the above procedure of using the elevator 510 and banknote supports 540 to remove the weight of some of the banknotes residing in the storage bay 360 off of the feeding plate 372 is employed to facilitate the performance of the dispenser 370 at speeds of at least 1000 banknotes per minute.

According to some embodiments, a stack of up to about 700 banknotes may be stacked on the feeding plate 372 and dispensed at high-speed (e.g., at least 1000 banknotes per minute or banknotes are transported at a rate of at least 5000 inches per minute) without having to use the elevator 510 to lift off a top portion of the stack of banknotes. According to some such embodiments, when the storage bay 360 has more than a certain number of banknotes (e.g., 700 banknotes) stored therein (e.g., a 1000 or 1800 banknotes), the elevator 510 and the banknote supports 540 may be used to lift up bankotes in the storage bay 360 greater than the certain number of banknotes such as more than 700 banknotes (e.g., to lift up the top 300 or 1100 banknotes in the above examples) so that no more than the certain number of banknotes (e.g., 700 banknotes) are being supported by the feeding plate prior to starting a banknote dispensing operation.

According to some embodiments, the banknote recycler 100 is operated at high speeds and can deliver notes from the storage bay transport path 120d/320d into the storage bay 360 at a rate of at least 1000 bills/banknotes per minute while simultaneously the dispenser 370 is operated at high speeds and can deliver notes from the storage bay 360 onto the return transport path 120e/320e1 at a rate of at least 1000 bills/banknotes per minute. According to some embodiments, banknotes are stacked into the storage bay 360 and dispensed from the storage bay 360 (either at separate times or simultaneously) at a rate of at least 600 banknotes per minutes. According to some embodiments, banknotes are stacked into the storage bay 360 and dispensed from the storage bay 360 (either at separate times or simultaneously) at a rate of at least 800 banknotes per minutes. According to some embodiments, banknotes are stacked into the storage bay 360 and dispensed from the storage bay 360 (either at separate times or simultaneously) at a rate of at least 1000 banknotes per minutes. According to some embodiments, banknotes are stacked into the storage bay 360 and dispensed from the storage bay 360 (either at separate times or simultaneously) at a rate of at least 1200 banknotes per minutes. According to some embodiments, banknotes are stacked into the storage bay 360 and dispensed from the storage bay 360 (either at separate times or simultaneously) at a rate of at least 1400 banknotes per minutes. According to some embodiments, banknotes are stacked into the storage bay 360 and dispensed from the storage bay 360 (either at separate times or simultaneously) at a rate of at least about 1600 banknotes per minutes.

According to some embodiments, banknotes are stacked into the storage bay 360 and dispensed from the storage bay 360 (either at separate times or simultaneously) at different speeds.

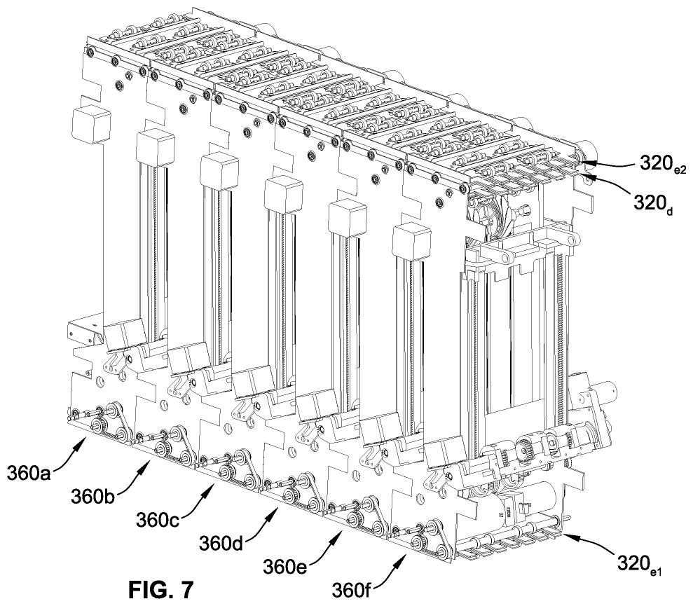

According to some embodiments, the storage bay 360 described above is modular and interchangeable and can be used as any of storage bays 160a-160f of FIGS. 1A-1H. FIG. 7 is a perspective view of six storage bays 360a-360f that may be used as storage bays 160a-160f of FIGS. 1A-1H wherein each storage bay 360a-360f corresponds to the storage bay 360 described above. According to some embodiments, the individual bays 360a-360f fit together to form seamless portions of the transport paths 120d/320d, 120e/320e1, 320e2. According to various embodiments, the banknote recycler 100 may have more or fewer storage bays than six such as for example, one, two, three, four, five, seven, eight, nine, ten, etc. storage bays.

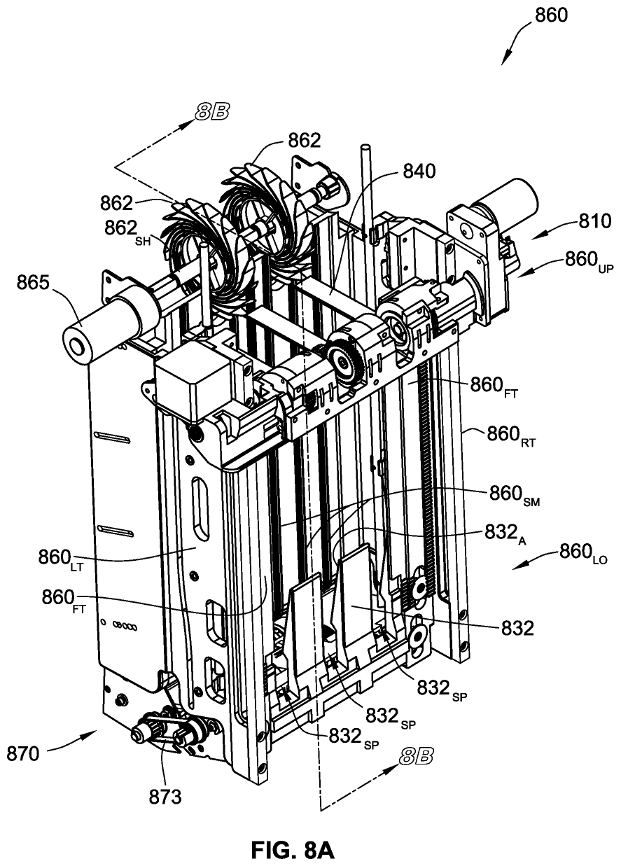

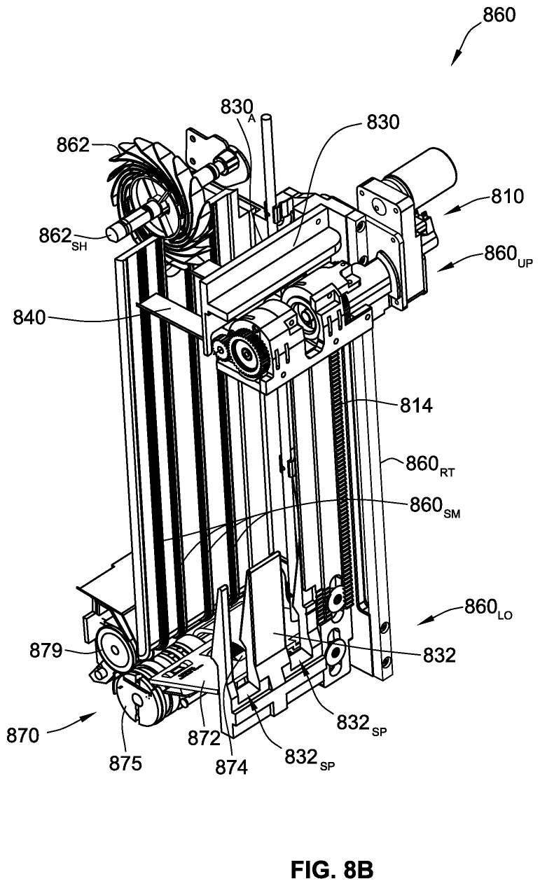

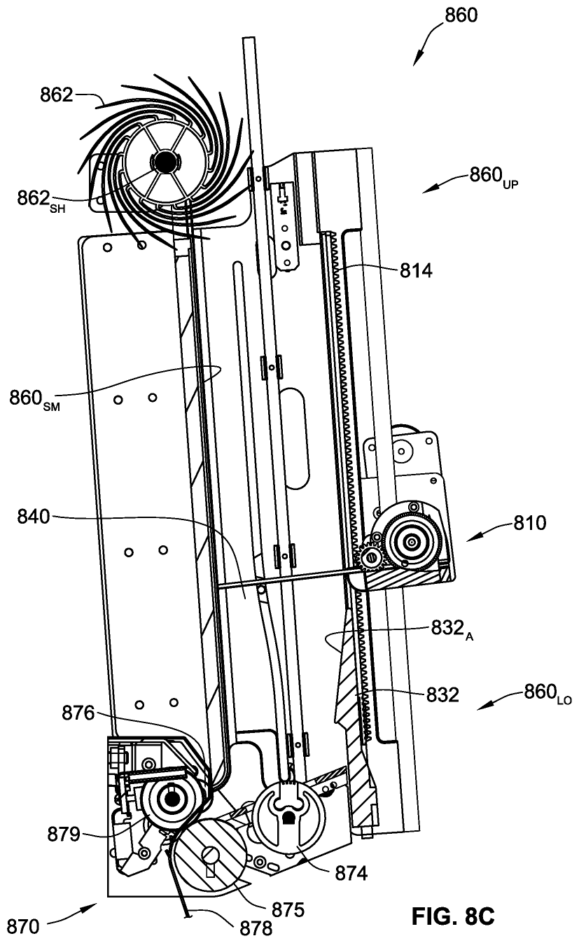

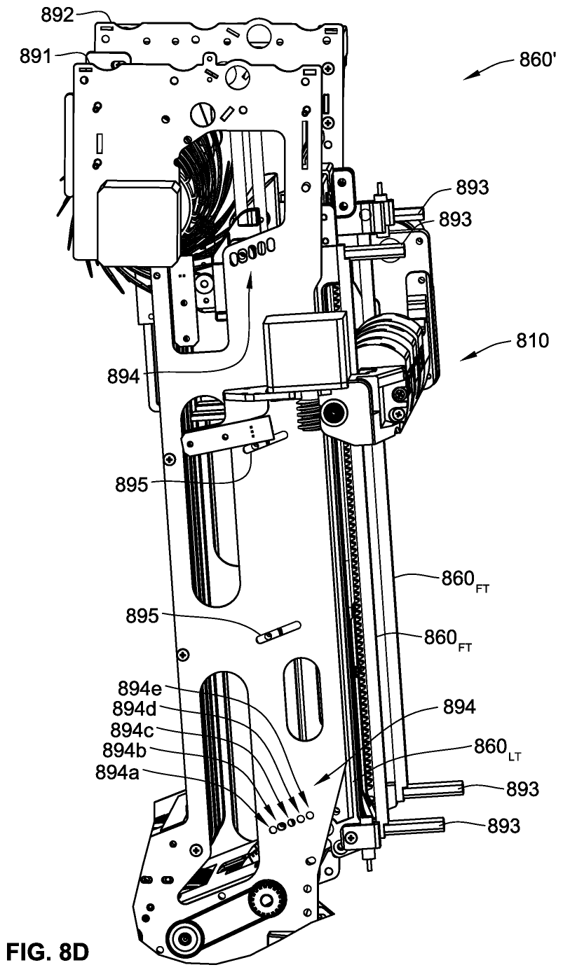

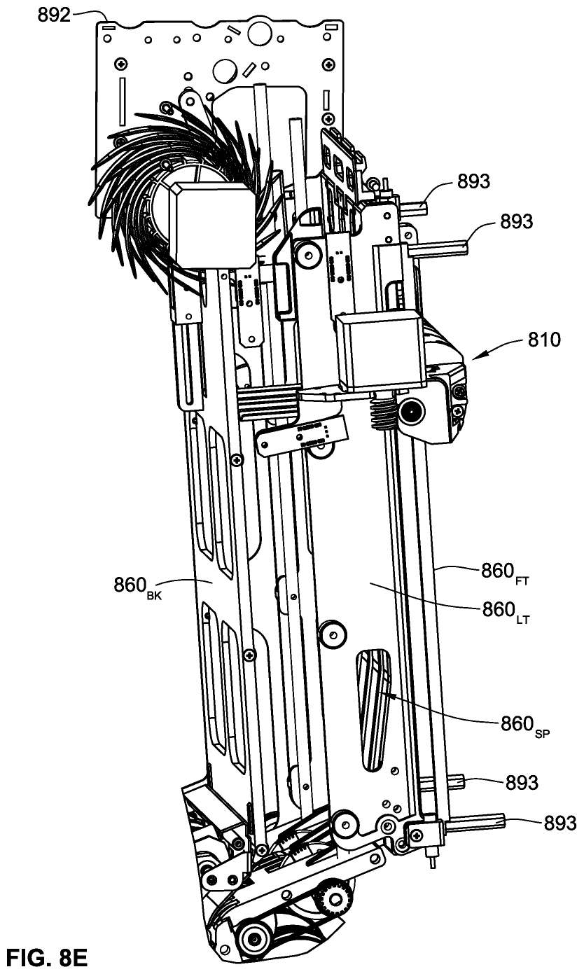

FIG. 8A is a front perspective view of a banknote recycler storage bay 860 according to some embodiments of the present. FIG. 8B is a perspective sectional view of a banknote recycler storage bay 860 taken along line 8B-8B in FIG. 8A. FIG. 8C is a side sectional view of a banknote recycler storage bay 860 taken along line 8B-8B in FIG. 8A. Storage bay 860 is an alternate embodiment of storage bay 360 and may be used as the storage bays 160a-160f of FIGS. 1A-1H.

The banknote storage bay 860 has an elevator 810. In FIGS. 8A-8C, the banknote recycler bay 860 is shown with retractable banknote supports 840 shown in their extended positions. In general, the banknote recycler bay 860 operates the same as described above in connection with banknote recycler bay 360 and has the same or similar components. In this regard, the same or similar components will be identified with the same or similar numbers (e.g., “300” and “500” series numbers are changed to “800” series numbers).

As with storage bay 360, the banknote recycler storage bay 860 has an upper end 860_{UP} and a lower end 860_{LO} and a right side wall 860_{RT} and a left side wall 860_{LT}. The storage bay 860 also has a back wall 860_{BK} and two front walls 860_{FT}—one on the right side of the storage bay 860 and one of the left side of the storage bay 860. The right side wall 860_{RT}, the left side wall 860_{LT}, the back wall 860_{BK}, and the two front walls 860_{FT} help to contain stacked banknotes within the storage bay 860 and serve to define a banknote space 860_{SP} of the storage bay 860.

According to some embodiments, the back wall 860_{BK} is separated from the two front walls 860_{FT} by a distance less than the narrow dimension of the banknotes to be stacked therein such that the banknotes stacked therein are angled downwardly toward the back wall 860_{BK} of the storage bay.

According to some embodiments, the back wall 860_{BK} has one or more low friction surfaces to enhance the ability of the edges of banknotes residing in the banknote storage bay 860 and abutting the backwall 860_{BK} to easily slide up or down within the storage bay 860 as the result of the movement of an elevator 810 and/or the feeding out of banknotes from the bottom of the storage bay 860 such as described above in connection with storage bay 360. According to some embodiments, low friction surfaces take the form of narrow low friction rails 860_{SM} extending the height of the storage bay 860. According to some embodiments, two to four low friction rails 860_{SM} are positioned on the back wall 860_{BK}.

Positioned near the upper end 860_{UP} of the storage bay 860 is an upper front banknote wall 830 having a banknote abutting surface 830A (see FIG. 8B; omitted in FIGS. 8A and 8C). According to some embodiments, positioned near the lower end 860_{LO} of the storage bay 860 is a lower front banknote angled wall 832 having an angled banknote abutting surface 832_{A}. The upper front banknote wall 830 serves as an additional structure to maintain banknotes within the storage bay 860 while the banknotes are being stacked therein. According to some embodiments, the banknote angled wall 832 takes the form of a series of prongs having a plurality of spaces 832_{SP} which permit extended banknote supports 840 to be moved up and/or down near the bottom 860_{LO} of the storage bay 860 as the elevator 810 moves up and/or down without contacting or being blocked by the angled wall 832.

According to some embodiments, banknotes are stacked in the storage bay 860 with the aid of a pair of stacker wheels 862 mounted on a stacker wheel shaft 862_{SH} which is rotationally driven by a motor 865. In FIG. 8B, only one of the stacker wheels is illustrated for clarity. The motor 865 is controlled by a controller or processor such as controller or processor 202.

According to some embodiments, the angled banknote abutting surface 832_{A} of the angled wall 832 serves to increase the angle at which bills are stacked in the storage bay 860 near the lower end 860_{LO} of the storage bay 860 and urge the bills into greater contact with low friction rails 860_{SM} of the back wall 860_{BK} and into engagement with the input of a dispenser 870.

According to some embodiments, the elevator 810 is the same as elevator 510 and thus its components and operation will not be repeated here. The pair of driven elevation gears 513 of the elevator engage a pair of geared elevator tracks 814 positioned on the outside of the two front walls 860_{FT} of the storage bay 860.

At the bottom of the storage bay 860 is a dispenser 870. According to some embodiments, the dispenser 870 is the same as dispenser 370 and thus its components and operation will not be repeated here except to point out feeding plate 872 corresponds to feeding plate 372, stripping wheels 874 corresponds to stripping wheels 374, drive roll 875 corresponds to drive roll 375, curved guideway 878 corresponds to curved guideway 378, and idler roll 876 corresponds to idler roll 376. According to some embodiments, the belt 873 corresponds to belt 373 but is located on the left side of the dispenser 870 instead of the right side.

Although not illustrated in FIG. 8A-8C, it should be understood that according to some embodiments, transport paths 320d and 320e2 are located above the storage bay 860 and transport path 320e1 is located below storage bay 860 and the components and operation for feeding banknotes onto and along these transport paths and into the storage bay 860 are the same as described above in connection with storage bay 360 and transport paths 320d, 320e1, and 320e2 and FIGS. 3A-6C.

According to some embodiments, the banknote recycler 100 is operated at high speeds and can deliver notes from the storage bay transport path 120d into the storage bay 860 and out of the storage bay 860 onto and along the transport path 120e at a rate of at least 1000 bills/banknotes per minute.

As with storage bay 360, according to some embodiments, the storage bay 860 is dimensioned to accommodate a stack of as many as 2000 banknotes and the elevator 810 and banknote supports 840 may be operated to lift a portion of a stack of banknotes so only a lower portion of a stack of banknotes is supported by the feeding plate 872 prior to activating dispenser 870.

According to some embodiments, the banknote recycler 100 is operated at high speeds and can deliver notes from the storage bay transport path 120d into the storage bay 860 at a rate of at least 1000 bills/banknotes per minute while simultaneously the dispenser 870 is operated at high speeds and can deliver notes from the storage bay 860 onto the return transport path 120e at a rate of at least 1000 bills/banknotes per minute.

FIG. 8D is a side view of a banknote recycler storage bay 860′ mounted in a storage bay frame comprising a left side frame 891 and a right side frame 892. FIG. 8E is a side sectional view of the banknote recycler storage bay 860′ omitting the left side frame 891 and the left side wall 860_{LT} of storage bay 860′. Storage bay 860′ is an alternate embodiment of storage bays 860 and 360 and may be used as the storage bays 160a-160f of FIGS. 1A-1H. The banknote storage bay 860′ has an elevator 810. In general, the banknote recycler bay 860′ operates the same as described above in connection with banknote recycler bays 360 and 860 and has the same or similar components. In this regard, the same or similar components will be identified with the same or similar numbers (e.g., “300” and “500” series numbers are changed to “800” series numbers and 800 series numbers are kept the same or designated with a prime).

According to some embodiments, the internal size (that is, the space in which banknotes are stored) of the storage bays (e.g., 160, 360, 860, 860′) may be adjusted to accommodate different sizes of banknotes, e.g., a storage bay sized to accommodate U.S. currency may be adjusted accommodate €10 banknotes or a storage bay sized to accommodate €10 banknotes may be adjusted accommodate €20 banknotes. FIGS. 8D and 8E illustrate exemplary mechanisms for facilitating the easy adjustment of the depth of storage bays. According to some embodiments, the size of storage bays may be repeatedly adjusted to accommodate different size banknotes such as by banknote recycler manufacturer service personnel at a customer location at which a banknote recycler resides.

Turning to FIGS. 8D and 8E a storage bay having a left side wall 860_{LT} and a right side wall 860_{RT}, a back wall 860_{BK} and a pair of front walls 860_{FT} is mounted between a left side frame 891 and a right side frame 892 of a storage bay frame. According to some embodiments, the back wall 860_{BK} is fixedly mounted between the left side frame 891 and the right side frame 892 such that its position relative to the left side and right side frames 891, 892 is not adjustable. Conversely, the left side wall 860_{LT}, right side wall 860_{RT}, and the pair of front walls 860_{FT} are adjustably mounted between the left side and right side frames 891, 892 of a storage bay frame in a manner in which their position relative to the left side and right side frames 891, 892 is adjustable thereby permitting the depth of the banknote space 860_{SP} of the storage bay 860′ to be adjusted based on, for example, the narrow dimension of the banknotes to be accommodated therein. According to some such embodiments, the left side wall 860_{LT} and right side wall 860_{RT} are fixedly coupled to the pair of front walls 860_{FT} and the pair of front walls 860_{FT} are slideably mounted on a plurality of storage bay depth adjustment posts 893. According to some embodiments, the pair of front walls 860_{FT} are releasably, slideably mounted on a plurality of storage bay depth adjustment posts 893 and may be locked into a fixed position relative to the storage bay depth adjustment posts 893 such as via locking screws which releasably engage the storage bay depth adjustment posts 893. According to some embodiments, the elevator 810 is coupled to the front walls 860_{FT} such that the lateral position of the front walls dictates the lateral position of the elevator 810 (while the elevator is still free to move generally vertically up and down).

According to some embodiments, the left side and right side frames 891, 892 have one or more slots 895 therein which cooperate with tabs or posts extending from the exterior sides of the left side wall 860_{LT} and the right side wall 860_{RT} of the storage bay 860′ through the slots 895 to control the movement of the left side wall 860_{LT} and the right side wall 860_{RT} relative to the left side and right side frames 891, 892, thereby limiting the direction and extent to which the left side wall 860_{LT} and the right side wall 860_{RT} may be moved relative to the back wall 860_{BK} of the storage bay 860′. Additionally or alternatively, according to some embodiments, the left side and right side frames 891, 892 have one or more plurality of preset depth adjustment apertures 894 therein which cooperate with tabs or posts extending from the exterior sides of the left side wall 860_{LT} and the right side wall 860_{FT} of the storage bay 860′ through the apertures 894 to facilitate the distance between the front walls 860_{FT} and the back wall 860_{BK} being adjustably set at a plurality of predefined distances, e.g., distances associated with accommodating U.S banknotes and a plurality of denominations of Euro banknotes. In the embodiment illustrated in FIG. 8D, a lower set of a plurality of apertures 894 comprises apertures 894a-894e.

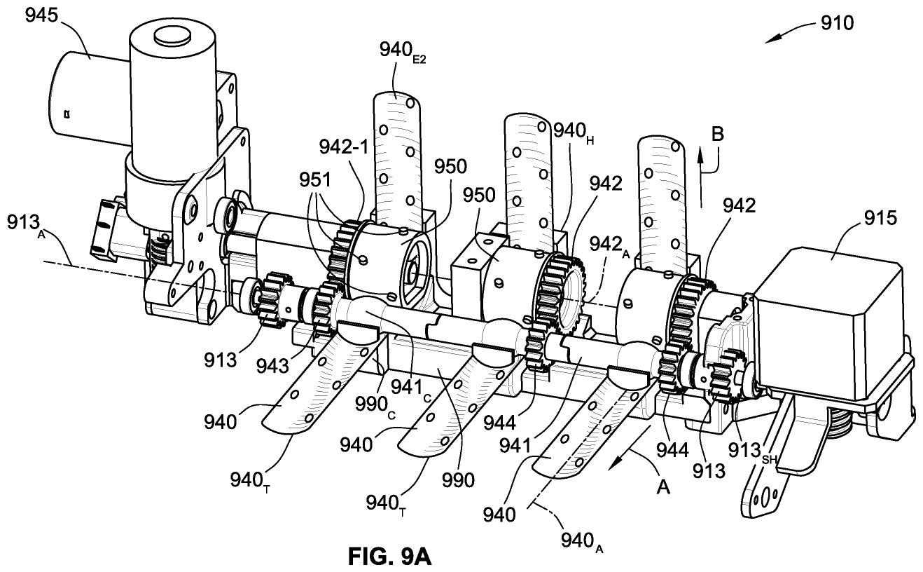

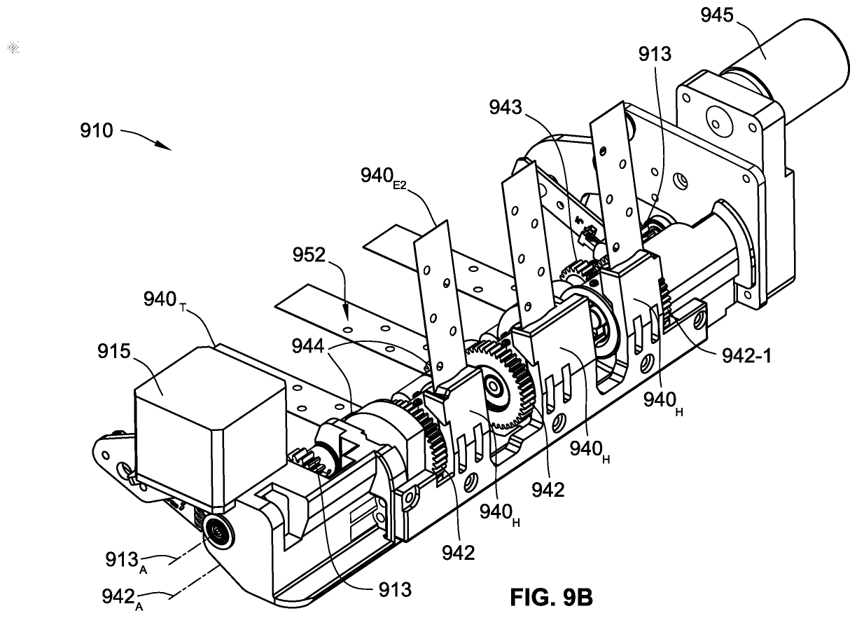

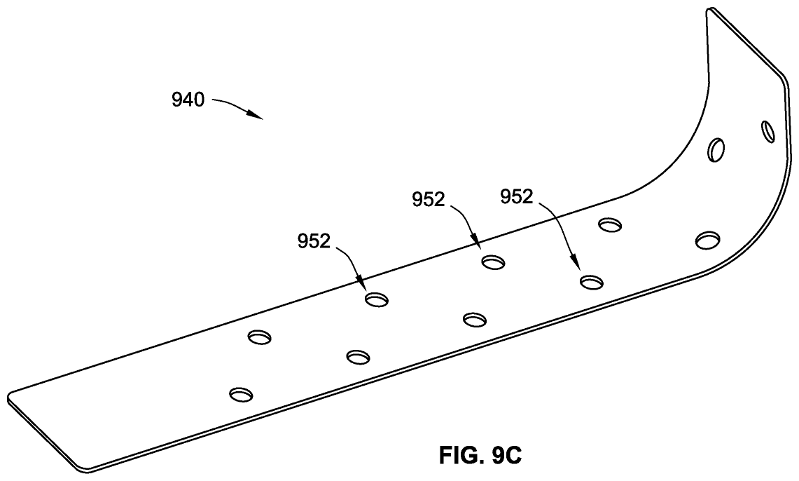

Turning to FIGS. 9A-9C, FIG. 9A is a rear perspective view of an alternate embodiment of an elevator 910, FIG. 9B is a front side perspective view of the elevator 910 of FIG. 9A, and FIG. 9C is a perspective view of a banknote support 940 for use with the elevator 910 of FIGS. 9A and 9B. In general, elevator 910 is the same as elevator 510 discussed above except that instead of rolling up the banknote support 540 like a window shade within housing 540_{H} when in its fully, retracted state, a tip 940_{T} at a first end of the banknote support 940 moves to a position near a banknote support positional gear 942 and a second end 940_{E2} of the banknote support 940 moves in generally vertical direction on the front side of the elevator 910 when in the banknote support 940 is in a fully, retracted position. In this regard, the same or similar components will be identified with the same or similar numbers (e.g., “500” series numbers are changed to “900” series numbers).

As discussed above with respect to elevator 510, the elevator 910 comprises driven elevation gears 913 driven by a motor 915 and banknote support positional gears 942 driven by an elevation motor or solenoid 945. The driven elevation gears 913 are fixedly mounted on a rotatable elevation gear shaft 913_{SH} which is rotatable about axis 913_{A}.

As discussed above with respect to elevator 510, banknote support motor or solenoid 945 is operatively coupled to a first 942-1 one of the banknote support positional gears 942 to cause the first banknote support positional gear 942-1 to rotate about an axis 942_{A}. The first banknote support positional gear 942-1 operatively engages a first transmission gear 943 fixedly coupled to a rotatable transmission shaft 941 to cause the first transmission gear 943 and the rotatable transmission shaft 941 to rotate. The rotatable transmission shaft 941 is rotatably mounted about the elevation gear shaft 913_{SH} and is configured to rotate independently from the rotation of the elevation gear shaft 913_{SH}. Both the rotatable transmission shaft 941 and the elevation gear shaft 913_{SH} are rotatable about axis 913_{A}, albeit independently. Additional transmission gears 944 are fixedly mounted to the transmission shaft 941 proximate additional banknote support positional gears 942. The rotation of the transmission shaft 941 causes the additional transmission gears 944 to cause the additional or remaining banknote support positional gears 942 to rotate about axis 942_{A}. Similar to as discussed above in connection with elevator 510, the rotation of the banknote support positional gears 942 including the first banknote support positional gear 942-1 cause respective banknote supports 940 to move between a first, extended (wherein a respective banknote support 940 extends into the storage bay 360/860 and provides a structure on which banknotes may be stacked) and a second position, retracted position (wherein the banknote support 940 does not project into the banknote storage space of an associated storage bay such as banknote space 360_{SP} of the storage bay 360 or banknote space 860_{SP} of the storage bay 860).

More specifically, each of the banknote support positional gears 942 including the first banknote support positional gear 942-1 are fixedly coupled to banknote support driving drums 950. Each drum 950 has a series of banknote support engaging nubs 951 configured to project through apertures 952 (see FIG. 9C) in the banknote supports 940. As the banknote support positional gears 942 rotate about an axis 942_{A}, so do the banknote support driving drums 950. The rotation of the banknote support driving drums 950 drives the banknote supports into and out of the associated storage bay via the nubs 951 engaging the sides of apertures 952. For example, with reference to FIG. 9A, when the drums 950 rotate in a clockwise manner, more of the length of each banknote support 940 is driven in direction A into an associated storage bay and when the drums 950 rotate in a counter-clockwise manner, more of the length of each banknote support 940 is driven in direction B out of an associated storage bay.

As with elevator 510, to aid in maintaining the banknote supports 940 in a curled manner about a longitudinal axis 940_{A} when in the extended position, the transmission shaft 941 comprises curved portions 941_{C}. The curved shaped of curved portion 941_{C} is mirrored by a complimentary curved shape 990_{C} of a bottom elevator housing 990. Each curved portion 941_{C} and its complimentary curved shape 990_{C} of a bottom elevator housing 990 is positioned adjacent a location at which a banknote support 940 enters an associated storage bay so that when the tip 940_{T} of a banknote support 940 enters an associated storage bay it is pressed between the curved portion 941_{C} and its complimentary curved shape 990_{C} of a bottom elevator housing 990 which serve to bend the banknote support about the longitudinal axis 940_{A}.

The elevator 910 also comprises a banknote housing 940_{H} for each banknote support 940 to guide the second end 940_{E2} of each banknote support 940 in a generally vertical direction on the front side of the elevator 910.

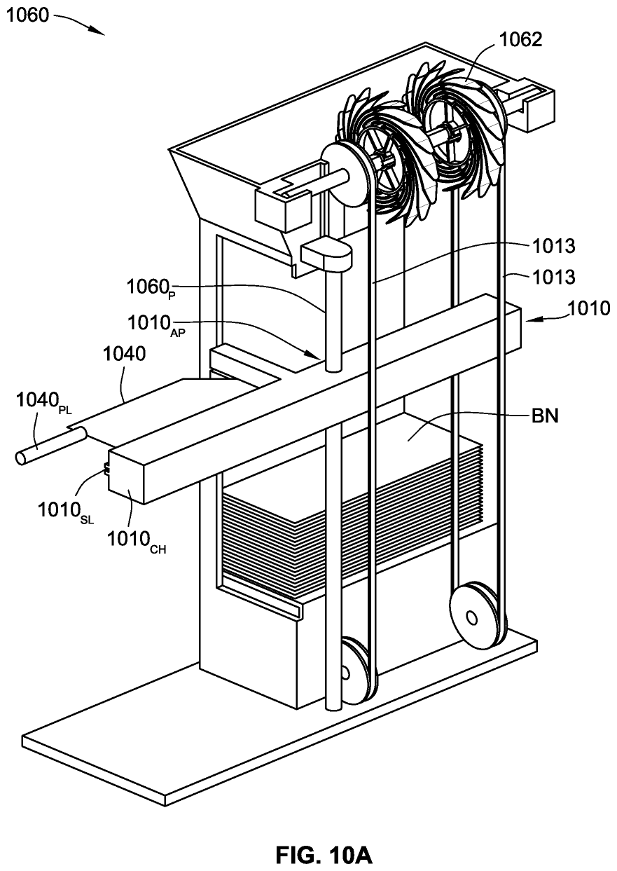

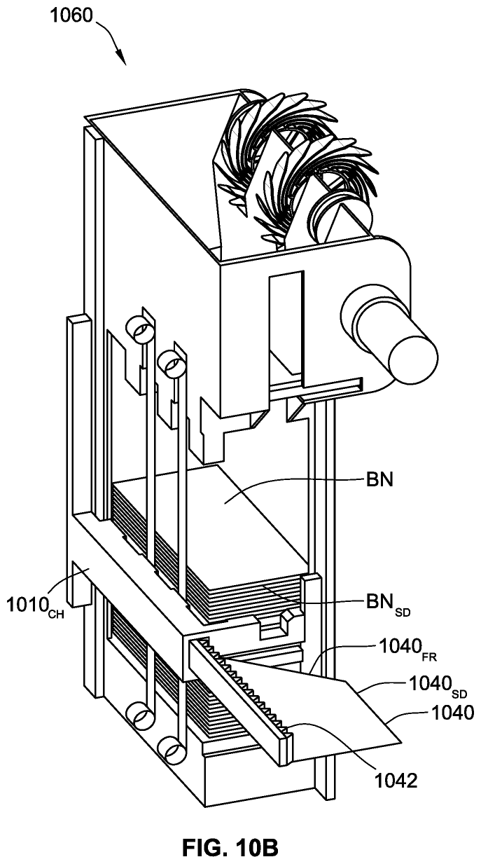

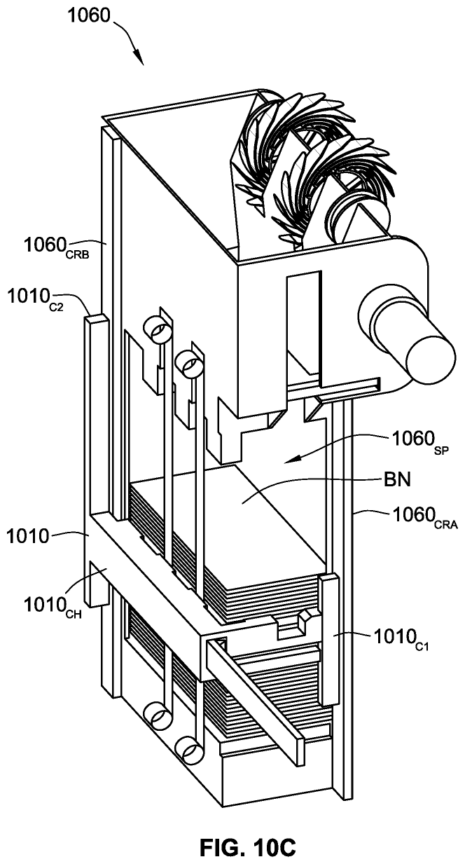

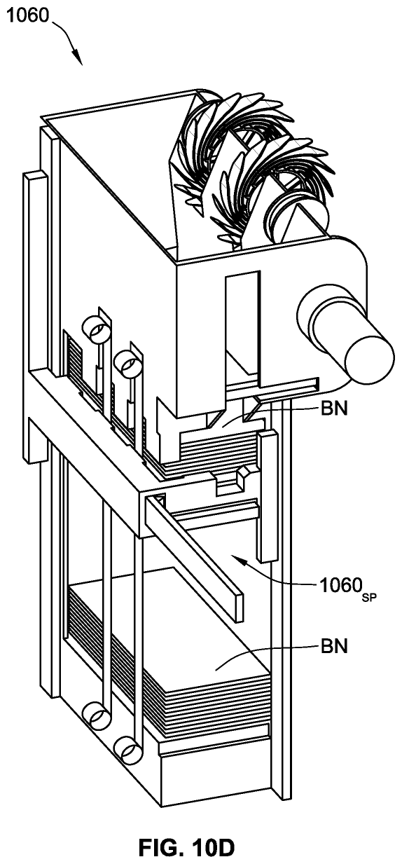

FIGS. 10A-10D are perspective views of a generally vertical banknote recycler storage bay 1060 according to some embodiments of the present disclosure having an alternate embodiment of an elevator 1010. More specifically, FIG. 10A is a rear perspective view of the banknote recycler storage bay 1060 with the elevator 1010 positioned near the middle of the bay 1060 wherein a banknote support 1040 is positioned in a retracted position; FIG. 10B is a side perspective view of the banknote recycler storage bay 1060 with the banknote support 1040 positioned in a retracted position ready to be inserted into a stack of banknotes BN residing within the storage bay 1060; FIG. 10C is a side perspective view of the banknote recycler storage bay 1060 similar to that shown in FIG. 10B but with the banknote support 1040 positioned in an extended position after being inserted between two banknotes BN in a stack of banknotes residing within the storage bay 1060; and FIG. 10D is a side perspective view of the banknote recycler storage bay 1060 similar to that shown in FIG. 10C but with the banknote support 1040 positioned in an extended position after being raised above and thereby raising some of the banknotes BN residing above the banknote support 1040 upward and away from remaining banknotes BN that remain supported by the bottom of the storage bay 1060.

Although illustrated differently, the banknote recycler storage bay 1060 may be the same as or similar to storage bays 160 and/or 360 described above and may be employed in the banknote recyclers 100, 100′, 100″ described above. The storage bay 1060 is an example of a storage bay that may be used as the storage bays 160a-160f of banknote recyclers 100, 100′, 100″. In general, except as illustrated in FIGS. 10A-10D and described herein, the banknote recycler bay 1060 may operate the same as described above in connection with banknote recycler bay 360 and may have the same or similar components. In this regard, the same or similar components will be identified with the same or similar numbers (e.g., “300” and “500” series numbers are changed to “1000” series numbers).

The elevator 1010 comprises an elevator chassis 1010_{CH} to which the banknote support 1040 is coupled. The banknote chassis 1010_{CH} is slidably coupled to sides of the banknote storage bay 1060 such as via elevator couplers 1010_{C1} and 1010_{C2} which couple portions of the elevator 1010 to portions of the storage bay 1060 such as at corner supports 1060_{CRA} and 1060_{CRB}. Alternatively or additionally, the banknote chassis 1010_{CH} may be slidably coupled to the banknote storage bay 1060 via a post 1060_{P} coupled to storage bay 1060 positioned within an aperture 1010_{AP} in the elevator chassis 1010_{CH}. According to some embodiments, the elevator may be raised and lowered via the post 1060_{P} being rotatable and threaded and cooperating with threads on chassis 1010_{CH} within aperture 1010_{AP}. Alternatively or additionally, the elevator may be raised and lowered via a drive mechanism such as one or more driven belts 1013 coupled to the chassis 1010_{CH}. As with elevator 510, the elevation position of the elevator 1010 may be driven by a motor (not shown) such as elevation motor 515 which in turn may be controlled by a controller or processor such as controller or processor 202.

As with the banknote supports 540, the banknote support 1040 may be used to lift up some and/or all of banknotes in the storage bay 1060. A first position of the banknote support 1040 is an extended or operative position (as shown in FIGS. 10C and 10D) wherein the banknote support 1040 extends into the storage bay 1060 and defines a platform on which banknotes may be stacked and which can support a stack of banknotes. A stack of banknotes stacked on the banknote supports 540 can be moved up and down within the storage bay by the elevator 1010 being moved up and down. A second position of the banknote support 1040 is a retracted position wherein the banknote support 540 does not support a stack of banknotes BN in the banknote space 1060_{SP} of the storage bay 1060 as illustrated in FIG. 10B.

In an exemplary embodiment, the banknote support 1040 does not project into the banknote space 1060_{SP} of the storage bay 1060 when in its retracted position but instead is positioned outside the banknote space 1060_{SP}. According to some embodiments, the banknote support 1040 is moved between the extended position and the retracted position via a plunger arm 1040_{PL} (FIG. 10A) coupled to a banknote support positional motor such as a motor or solenoid similar to a motor or solenoid 545 controlled by a controller or processor such as controller or processor 202. In some such embodiments, an edge of the support 1040 slides in a slot 1010_{SL} in chassis 1010_{CH}.

According to some embodiments, the banknote support 1040 is coupled to banknote a support positional gear 1042 (FIG. 10B) which is cooperatively and operatively coupled to gears (not shown) within chassis 1010_{CH} coupled to a banknote support positional motor or solenoid (not shown) similar to a motor or solenoid 545 controlled by a controller or processor such as controller or processor 202. By operation of the banknote support positional motor, a portion of the gears 1042 (and the banknote support 1040) may be moved out of the chassis 1010_{CH} to a retracted position (FIG. 10B) or moved into the chassis 1010_{CH} to an operative position (FIGS. 10C and 10D).

According to some embodiments, such as shown in, for example, FIG. 10B, the banknote support 1040 has an angled leading or front edge 1040_{FR}. The front edge 1040_{FR} is the edge of the banknote support 1040 which enters the banknote storage space 1060_{SP} first when the banknote support 1040 is moved from a retracted position to an operative position. According to some embodiments, the front edge 1040_{FR} is angled by about 45° relative to one or both of the side edges 1040_{SD} of the banknote support 1040 and/or the side edges BN_{SD} of banknotes BN stacked within the banknote storage space 1060_{SP}. The angled leading or front edge 1040_{FR} assists with allowing the banknote support 1040 to be slipped within two adjacent banknotes BN stacked within the banknote storage space 1060_{SP} when the banknote support 1040 is moved from a retracted position to an operative position.

According to some embodiments, the banknote support 1040 is made of a relatively thin strip of material such as metal or plastic.

The operation of the elevator 1010 may otherwise be same or similar to that described above in connection with elevator 510.

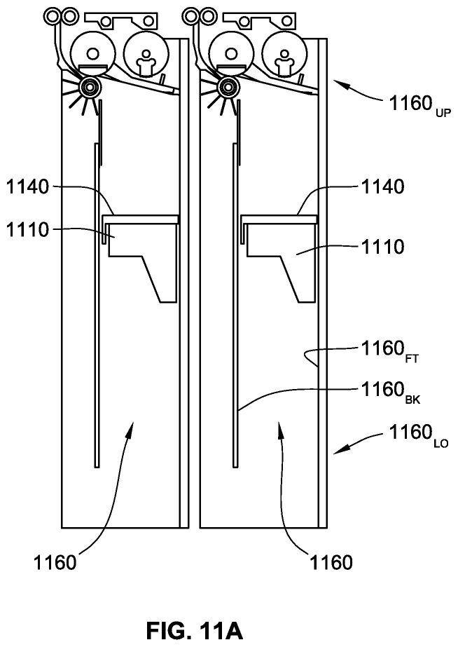

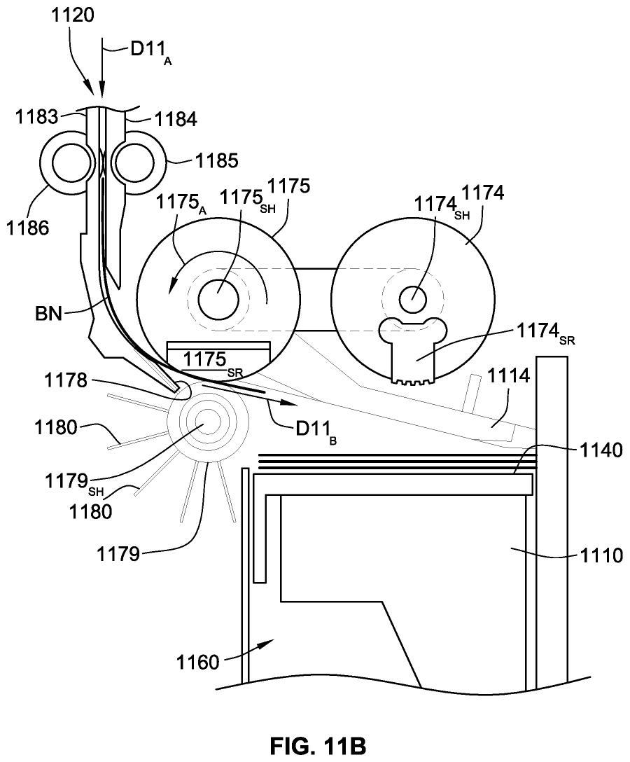

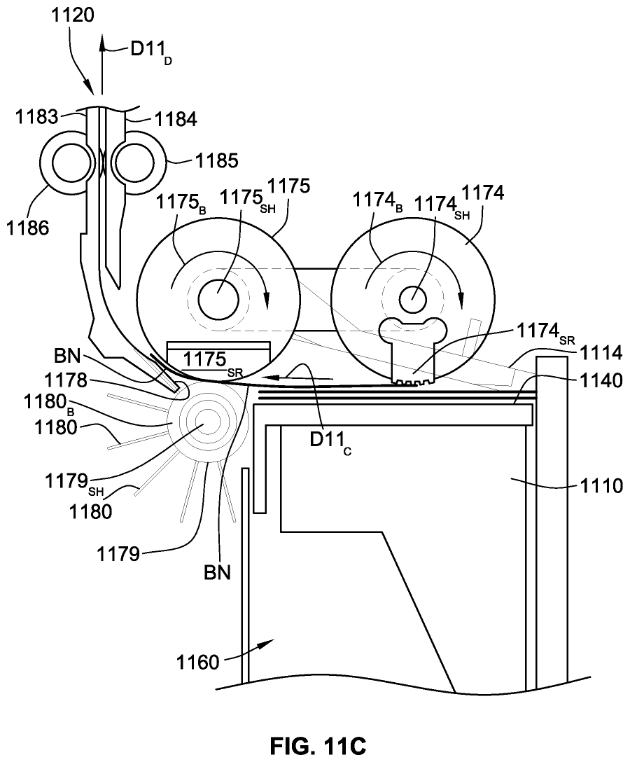

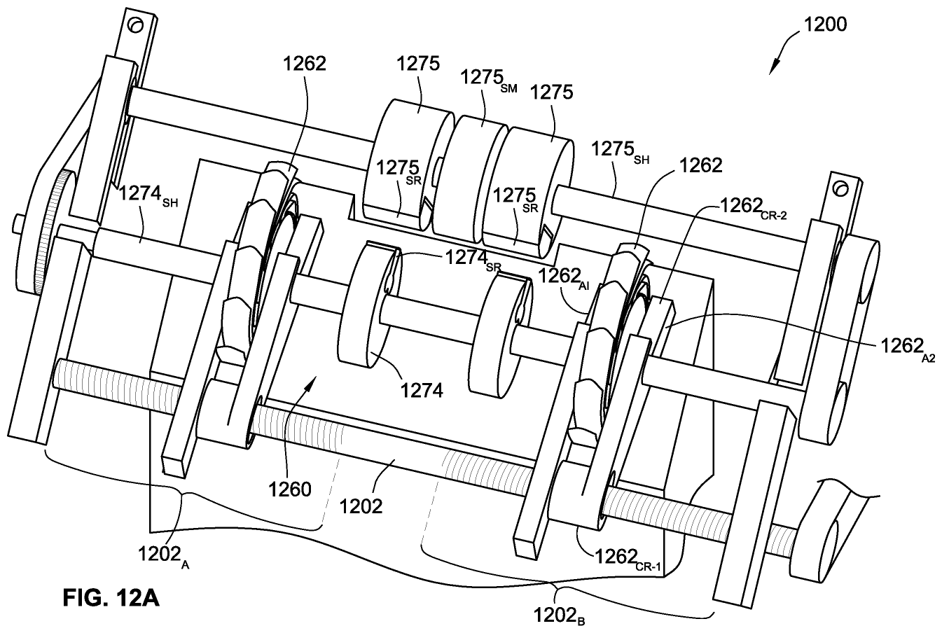

FIGS. 11A-11C are sectional views of a generally vertical recycling bay arrangement comprising a banknote recycler storage bay or generally vertically oriented banknote recycling bay 1160 according to some embodiments of the present disclosure employing a Last-In, First-Out (LIFO) feeding scheme. More specifically, FIG. 11A is a side sectional view of two banknote recycler storage bays 1160. FIG. 11B is a side sectional view of a top portion of the banknote recycler storage bay 1160 illustrating a banknote BN being fed into the storage bay 1160. FIG. 11C is a side sectional view of a top portion of the banknote recycler storage bay 1160 illustrating a banknote BN being fed out and dispensed from the storage bay 1160.

Although illustrated differently, the banknote recycler storage bay 1160 may be the same as or similar to storage bays 160 and/or 360 described above and may be employed in the banknote recyclers 100, 100′, 100″ described above. The storage bay 1160 is an example of a storage bay that may be used as the storage bays 160a-160f of banknote recyclers 100, 100′, 100″. In general, except as illustrated in FIGS. 11A-11C and described therewith, the banknote recycler bay 1160 may operate the same as described above in connection with banknote recycler bay 360 and may have the same or similar components. In this regard, the same or similar components will be identified with the same or similar numbers (e.g., “300” and “500” series numbers are changed to “1100” series numbers).

Each bay 1160 has an elevator 1110 therein having a top surface which serves as a banknote support 1140. According to some embodiments, the banknote support 1140 is a banknote stacker plate. The elevator 1110 is moved up and down to accommodate banknotes being fed into or dispensed from the corresponding storage bay 1160. Each storage bay 1160 has an upper end 1160_{UP}, a lower end 1160_{LO}, a banknote leading edge side or back side 1160_{BK}, and a banknote trailing edge side or front side 1160_{FT}.

Turning to FIG. 11B, the depositing or feeding in operation will be described. A banknote BN to be deposited into a given storage bay 1160 is routed in direction D11_{A} along an transport path 1120 between a pair of space transport plates 1183, 1184. The banknote engages and is driven along the transport path 1120 by a driven transport roll 1186 and a passive transport roll 1185 positioned on the opposite side of the transport path 1120 and biased into engagement with the driven transport roll 1186. According to some embodiments, the driven transport roll 1186 is driven by a motor (such as motor 390) controlled by a controller or processor such as controller or processor 202. A lower portion of transport plate 1183 is curved so as to direct incoming banknotes BN between a drive roll 1175 and a guide wheel 1179. The guide wheel 1179 is mounted to guide wheel shaft 1179_{SH}. The drive roll 1175 is mounted to drive wheel shaft 1175_{SH} which is driven in a counterclockwise direction 1175_{A} in FIG. 11B during a banknote depositing operation. An incoming banknote BN is then driven in direction D11_{B} into the storage bay 1160. The incoming banknote BN then engages a pair of ceiling guides 1114 which guide the leading edge of an incoming banknote BN toward the banknote support 1140 of the elevator 1110 or the top of a stack of banknotes already residing on the banknote support 1140. According to some embodiments, the drive roll 1175 is mounted to a drive roll shaft 1175_{SH} and may take the form of drive roll 375 described above. According to some embodiments, one end of each of the ceiling guides is pivotally coupled to the drive roll shaft 1175_{SH} and a second end of each of the ceiling guides 1114 are biased downward such as via a spring. As a banknote BN enters the storage bay 1160, the leading edge of the banknote BN may contact the ceiling guides 1114 and then a front wall 1160_{FT} of the storage bay 1160. In some embodiments, the ceiling guides 1114 may pivot upward slightly when a banknote BN contacts them. According to some embodiments, a damper may be positioned near the front wall 1160_{FT} of the storage bay 1160. The damper may be biased (such as via a spring) into the storage bay 1160 and move in a direction toward the front wall 1160_{FT} when a banknote BN contacts it so as to slow or control the deceleration of a banknote BN as it is deposited on top of the banknote support 1140 or banknotes already supported by banknote support 1140.

According to some embodiments, a plurality of flexible tap-down fingers 1180 are rotationally mounted to and positioned along part of the circumference of guide wheel shaft 1179_{SH}. The rotation of the tap-down fingers 1180 is controlled so that as the leading edge of a banknote BN passes the guide wheel 1179 and enters the storage bay 1160 the fingers 1180 do not intersect the transport path and the banknote BN does not contact the fingers 1180. As a banknote BN passes the position at which the guide wheel 1179 and drive roll 1175 are biased into each other, the fingers 1180 are rotated (clockwise in FIG. 11B) so as to engage the trailing edge of a banknote BN and move the trailing edge downward toward the banknote support 1140. According to some embodiments, the operation of the tap-down fingers 1180 facilitates moving the trailing edge of a banknote BN out of the way so that the leading edge of a subsequent banknote BN does not slip under the trailing edge of a previously deposited banknote BN when entering the storage bay 1160.

As discussed above such as in connection with elevator 510, the height of the banknote support 1140 and elevator 1110 can be adjusted to accommodate additional banknotes BN being deposited into the storage bay 1160.

According to some embodiments, the drive roll 1175, the guide wheel 1179, and the fingers 1180 comprise part of a banknote feeding assembly. According to some such embodiments, the banknote feeding assembly for feeding banknotes, one at a time, into the recycling bay 1160 is positioned near the upper end 1160_{UP} and banknote trailing edge side 1160_{BK} of the recycling or storage bay 1160. The drive roll 1175 may comprise a pair of drive rolls supported for rotational movement about the driven drive roll shaft 1175_{SH}. The guide wheel 1179 may take the form of a pair of nip rollers supported for rotational movement about a guide wheel or nip roller shaft 1179_{SH}, each of the nip rollers being positioned below a corresponding one of the drive rolls such that banknotes may pass between each corresponding drive roll and nip roller pair.

According to some embodiments the plurality of flexible tap-down fingers 1180 comprise part of a plurality of tap-down assemblies supported for rotational movement about the nip roller shaft 1179_{SH}, each tap-down assembly having the base 1180_{B} and a plurality of the flexible tap-down fingers or projections 1180 extending from the base 1180_{B}. The base 1180_{B} has a circumference extending around the nip roller shaft 1179_{SH} and the plurality of tap-down projections or fingers are positioned about the circumference of a corresponding base 1180_{B} such that collectively the plurality of tap-down projections or fingers 1180 extend from a corresponding base 1180_{B} over less than about 180° of the circumference of the base 1180_{B}.

According to some embodiments, the banknote feeding assembly further comprises a pair of ceiling guides 1114 positioned so as to guide the leading edge of banknotes BN emerging from between each drive roll 1175 and nip roller 1179 pair downward into the recycling bay 1160 and toward the banknote leading edge side 1160_{FT} of the recycling bay and on top of any preceding banknotes resting on the banknote support 1140.

According to some embodiments, during operation in which banknotes are to be sequentially fed into the storage or recycling bay 1160, the plurality of tap-down assemblies are rotated such that the plurality of tap-down projections or fingers 1180 push the trailing edges of banknotes BN that have been fed into the recycling bay 1160 downward so as to facilitate a subsequent banknote entering the recycling bay to be positioned on the upper side of a prior fed banknote.

Turning to FIG. 11C, the dispensing or feeding out operation will be described. When one or more banknotes BN are to be dispensed from the storage bay 1160, the elevator 1110 is raised (under control of a processor such as processor 202) to press a topmost banknote BN into engagement with a pair of stripping wheels 1174. During a dispensing operation, banknotes or bills that are stacked on the banknote support 1140 are stripped, one at a time, from the top of the stack. The banknotes are stripped by the pair of stripping wheels 1174 mounted on a driven stripping wheel shaft 1174_{SH}. According to some embodiments, part of the periphery of each stripping wheel 1174 is provided with a raised high-friction surface 1174_{SR} which engages the top bill of the stack as the stripping wheels 1174 rotate (in direction 1174_{B}, clockwise in FIG. 11C), to initiate feeding movement of the top bill from the stack. The high-friction surfaces 1174_{SR} may project radially beyond the rest of the wheel peripheries so that the high-friction surfaces 1174_{SR} intermittently contact the stack of banknotes so as to agitate and loosen the top banknote within the stack, thereby facilitating the stripping of the top banknote from the stack.

The top banknote BN is moved in direction D11_{C} into engagement with drive roll 1175 and guide wheel 1179. According to some embodiments, high-friction surfaces 1175_{SR} of drive roll 1175 engage each banknote after it is fed into the drive roll 1175 by the stripping wheels 1174, to frictionally advance the banknote into the narrow arcuate passageway 1120 formed by a curved guideway 1183 adjacent the rear side of the drive roll 1175. The rotational movement of the drive roll 1175 and the stripping wheels 1174 may be synchronized so that the high-friction surfaces on the drive roll 1175 and the stripping wheels 1174 maintain a constant relationship to each other. Moreover, according to some embodiments, the drive roll 1175 is dimensioned so that the circumference of the outermost portions of grooved surfaces of the drive roll 1175 is greater than the width W of a banknote to be dispensed from a given storage bay 1160, so that the banknotes advanced by the drive roll 1175 are spaced apart from each other. That is, each banknote fed to the drive roll 1175 is advanced by that roll only when the high-friction surfaces come into engagement with the banknote, so that the circumference of the drive roll 1175 determines the spacing between the leading edges of successive banknotes. The drive roll 1175 is mounted to drive wheel shaft 1175_{SH} which is driven in a clockwise direction 1175_{B} in FIG. 11C during a banknote dispensing operation.

According to some embodiments, the drive roll 1175 and the stripping wheels 1174 are driven by a motor (such as motor 390) controlled by a controller or processor such as controller or processor 202.

A banknote BN to be dispensed from a given storage bay 1160 is then routed in direction D11_{D} along the transport path 1120 between the pair of space transport plates 1183, 1184. The banknote engages and is driven along the transport path 1120 by a driven transport roll 1186 and a passive transport roll 1185 positioned on the opposite side of the transport path 1120 and biased into engagement with the driven transport roll 1186. According to some embodiments, the driven transport roll 1186 is driven by a motor (such as motor 390) controlled by a controller or processor such as controller or processor 202.

During a dispensing operation, according to some embodiments, the top banknote or the banknote support 1140 engages the ceiling guides 1114 and pivots them upward. During a dispensing operation, the position of the tap-down fingers 1180 is controlled (such as via controller 202) so that the fingers 1180 do not intersect the transport path 1120 and exiting banknotes BN do not contact the fingers 1180.

According to some embodiments, banknote support 1140 comprises a spring biased plate mounted to the top of elevator 1110. According to some embodiments, a pressure sensor monitors pressure on the stripping wheel driven shaft 1174_{SH}. The pressure sensor and a motor controlling the movement of elevator 1110 may be coupled to a controller or processor such as controller or processor 202. The controller monitors the pressure sensor signals and controls the elevation and/or movement of the elevator 1110 based on the information derived from the pressure sensor such as by instructing the motor controlling the elevator 1110 movement to slow down or stop.

According to some embodiments, a banknote dispensing assembly for feeding banknotes, one at a time, out of the recycling or storage bay 1160 comprises stripping wheels 1174, drive roll 1175, and guide wheel or nip roller 1179. The dispensing assembly is positioned near the upper end 1160_{UP} of the recycling or storage bay 1160. According to some embodiments, the stripping wheel 1174 comprise a pair of stripping wheels supported for rotational movement about the driven stripping wheel shaft 1174_{SH}, the drive roll 1175 comprises a pair of drive rolls, and the guide wheel 1179 comprises a pair of nip rollers.

According to some embodiments, during a dispensing operation in which banknotes are to be fed out of the recycling bay, the elevator banknote support 1140 is elevated such that the stripping wheels 1174 sequentially engage the topmost banknote stacked in the recycling or storage bay 1160 and urge the topmost banknote into contact with the pair of drive rolls 1175 which act to feed banknotes out of the recycling bay 1160, one bill at a time; and wherein during a dispensing operation the tap-down assemblies are rotationally positioned such that the plurality of tap-down projections or fingers 1180 do not extend into the recycling bay nor above the top of the nip rollers 1179.

According to some embodiments, banknotes BN may be deposited into and dispensed from storage bay 1160 at a rate of at least 1000 banknotes per minute. According to some embodiments, the distance between a front wall 1160_{FT} and a back wall 1160_{BK} is between about 2.5 and 5.0 inches for storage bays 1160 configured to accept and dispense U.S. banknotes.

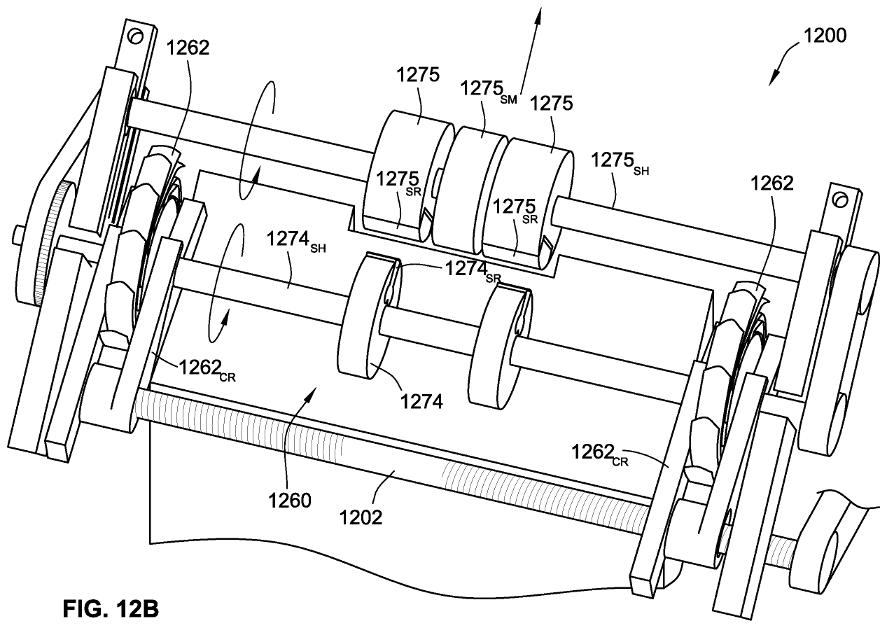

FIGS. 12A-12B are perspective views of a generally vertical recycling bay arrangement comprising a banknote recycler storage bay or generally vertically oriented banknote recycling bay 1260 according to some embodiments of the present disclosure employing a Last-In, First-Out (LIFO) feeding scheme. More specifically, FIG. 12A is a top perspective view of a banknote recycler storage bay 1260 configured to accept banknotes to be deposited into the storage bay 1260 with stacker wheels 1262 positioned in a deposit or feed-in location. FIG. 12B is a top perspective view of a banknote recycler storage bay 1260 configured to dispense banknotes from the storage bay 1260 with stacker wheels 1262 positioned in a non-operational, dispense or feed-out location. In general, the banknote recycling bay arrangement of FIGS. 12A and 12B and its operation may be the same as or similar to the banknote recycling bay arrangement of FIGS. 11A-11C except that a pair of stacker wheels 1262 are employed for depositing banknotes into the storage bay 1260 as opposed to the drive roll 1175 and the guide wheel or nip roller 1179 and the fingers 1180. The dispensing operation may operate in the same manner as described above with respect to FIGS. 11A-11C.

According to some embodiments, a generally vertical banknote recycling bay arrangement 1200 comprises a generally vertically oriented banknote recycling or storage bay 1260 for receiving banknotes therein. As with storage bay 1160, the recycling bay 1260 has an upper end and a lower end. The arrangement 1200 further comprises a banknote feeding assembly for feeding banknotes, one at a time, into the recycling bay, the feeding assembly being positioned near the upper end of the recycling bay and comprising a pair of stacker wheels 1262 supported for rotational movement about a driven stripper wheel shaft 1274_{SH}. Each stacker wheel 1262 is laterally moveable along the driven stripper wheel shaft 1274_{SH}. The feeding assembly further comprises a stacker wheel positioning mechanism such as driven positioning screw 1202 and a pair of stacker wheel carriages 1262_{CR}, each carriage 1262_{CR} having a screw end 1262_{CR-1} and a stacker wheel end 1262_{CR-2}, the screw end 1262_{CR-1} of each carriage 1262_{CR} having a threaded aperture therein through which a portion of the positioning screw 1202 is threaded, each carriage 1262_{CR} having a pair of arms 1262_{A1}, 1262_{A2}, each arm 1262_{A1}, 1262_{A2} extending from the screw end 1262_{CR-1} toward the stacker wheel end 1262_{CR-2} and at least partially conforming about the stripper wheel shaft 1274_{SH}. The pair of arms 1262_{A1}, 1262_{A2} of each carriage 1262_{CR} extend toward the stripper wheel shaft 1274_{SH} such that a corresponding stacker wheel 1262 is positioned about the stripper wheel shaft 1274_{SH} between the arms 1262_{A1}, 1262_{A2} of a corresponding carriage 1262_{CR}.

The arrangement 1200 further comprises a banknote dispensing assembly for feeding banknotes, one at a time, out of the recycling bay 1260, the dispensing assembly being positioned near the upper end of the recycling bay and comprising a pair of stripping wheels 1274 supported for rotational movement about the driven stripper wheel shaft 1274_{SH}. The pair of stripping wheels 1274 are laterally positioned about the stripper wheel shaft 1274_{SH} between the pair of stacker wheels 1262. The dispensing assembly further comprises a pair of drive rolls 1275 supported for rotational movement about a drive roll shaft 1275_{SH}.

As shown in FIG. 12A, during operation in which banknotes are to be fed or deposited into the recycling bay 1260, the lateral position of the stacker wheels 1262 is adjusted to an inward, operational position such that banknotes to be fed into the recycling bay 1260 are received by the stacker wheels 1262 and stacked in the recycling bay 1260. As shown in FIG. 12B, during operation in which banknotes are to be fed out of or dispensed from the recycling bay 1260, the lateral position of the stacker wheels 1262 is adjusted to an outward, non-operational position such that banknotes to be fed out the recycling bay are not engaged by the stacker wheels 1262 but instead are engaged by the stripping wheels 1274 which sequentially engage the topmost banknote stacked in the recycling bay 1260 and urge the topmost banknote into contact with the pair of drive rolls 1275 which act to feed banknotes out of the recycling bay arrangement, one bill at a time.

According to some embodiments, the lateral positions of the stacker wheels 1262 are adjusted by rotational movement of the stacker wheel positioning screw 1202 which serves to laterally move the pair of stacker wheel carriages 1262_{CR} laterally toward each other when driven in a first rotational direction and to laterally move the pair of stacker wheel carriages 1262_{CR} laterally away each other when driven in a second rotational direction, the lateral movement of the stacker wheel carriages 1262_{CR} imparting a corresponding lateral movement on the stacker wheels 1262.

According to some embodiments, the stacker wheel positioning screw 1202 comprises threads oriented in a first direction on a first portion 1202_{A} and threads oriented in a second opposite direction on a second portion 1202_{B}, and wherein a first one of the stacker wheel carriages 1262_{CR} threadingly engages the first portion 1202_{A} of the positioning screw and a second one of the stacker wheel carriages 1262_{CR} threadingly engages the second portion 1202_{B} of the positioning screw 1202.

As described and illustrated in more detail in U.S. Pat. No. 5,815,592 [Attorney Docket 247171-000131], incorporated herein by reference in its entirety, the drive roll 1275 may include a central smooth friction surface 1275_{SM} formed of a material such as rubber or hard plastic. This smooth friction surface 1275_{SM} is sandwiched between a pair of grooved surfaces having high-friction portions 1275_{SR} formed from a high-friction material. According to some embodiments, part of the periphery of each stripping wheel 1274 is provided with a raised high-friction surface 1274_{SR} which engages the top bill of the stack as the stripping wheels 1274 rotate, to initiate feeding movement of the top bill from the stack toward the drive roll 1275. The drive roll 1275 and stripping wheels 1274 may be the same or similar to the drive rolls 375, 1175 and stripping wheels 374, 1174 described above.

Although not illustrated, each bay 1260 has an elevator with a banknote support similar or identical to those discussed above such as elevators 510, 1110 and banknote supports 540, 1140. The elevator is moved up and down to accommodate banknotes being fed into or dispensed from the corresponding storage bay 1260 as discussed above such as with respect to elevator 510 and/or 1110.

According to some embodiments, the drive roll 1275, the stripping wheels 1274, the stacker wheels 1262, and the positional screw 1202 are driven by one or more motors (such as motor 390) controlled by a controller or processor such as controller or processor 202.

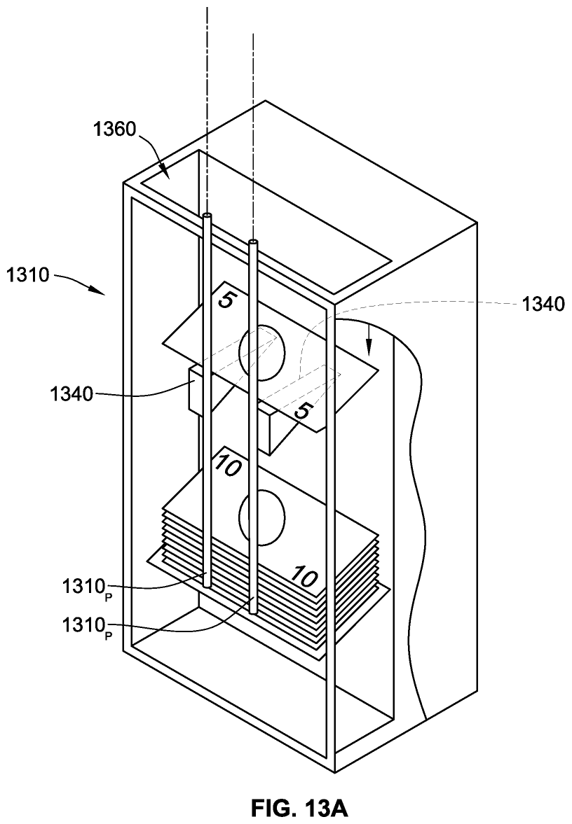

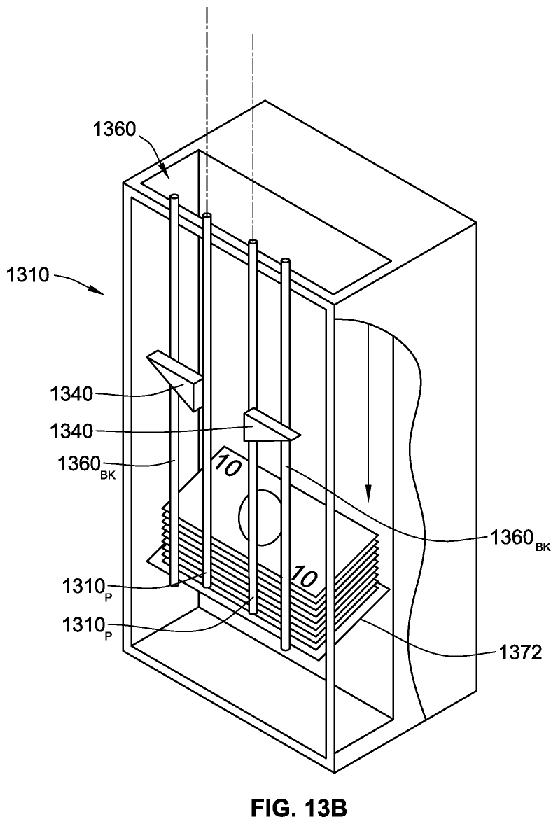

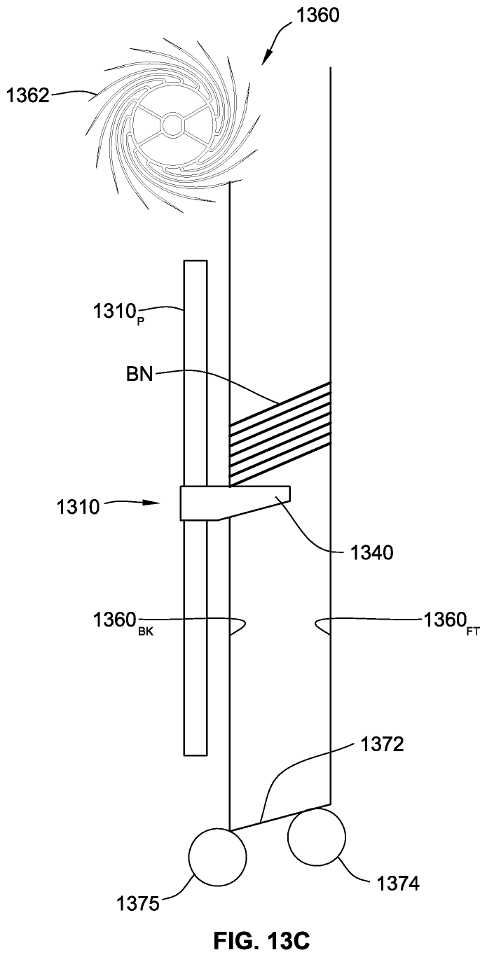

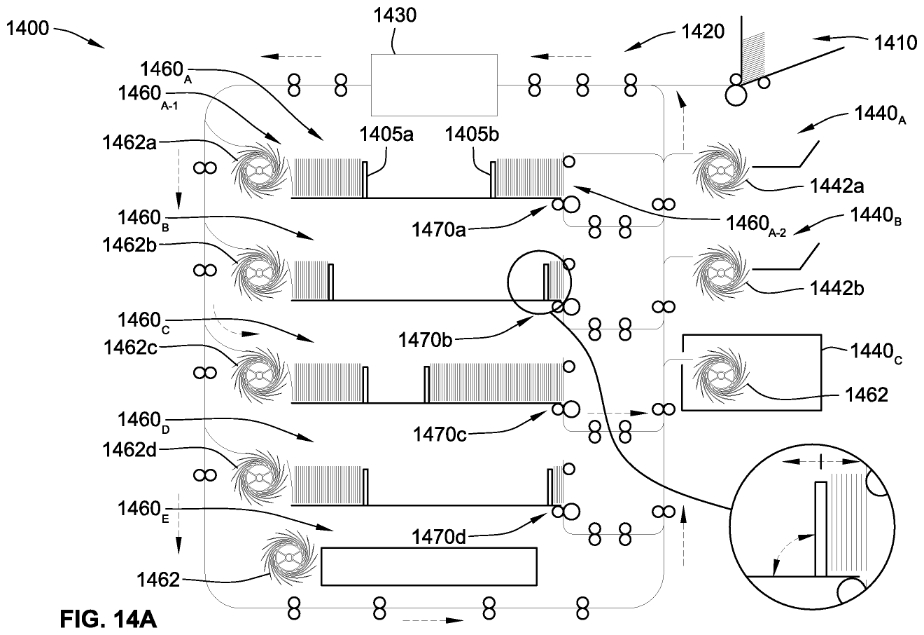

FIGS. 13A and 13B are a front perspective views and FIG. 13C is a side view of a banknote recycler storage bay 1360 according to some embodiments of the present disclosure. In general, the storage bay 1360 and its operation may be similar as or identical to that described above in connection with storage bay 360 except for the storage bay 1360 employing a different elevator 1310 and elevator system in place of elevator 510.

Although illustrated differently, the banknote recycler storage bay 1360 may be the same as or similar to storage bays 160 and/or 360 described above and may be employed in the banknote recyclers 100, 100′, 100″ described above. The storage bay 1360 is an example of a storage bay that may be used as the storage bays 160a-160f of banknote recyclers 100, 100′, 100″. In general, except as illustrated in FIGS. 13A-13C and described therewith, the banknote recycler bay 1360 may operate the same as described above in connection with banknote recycler bay 360 and may have the same or similar components. In this regard, the same or similar components will be identified with the same or similar numbers (e.g., “300” and “500” series numbers are changed to “1300” series numbers).

The storage bay 1360 comprises a front wall 1360_{FT} and a back wall 1360_{BK} spaced apart by a distance less than the narrow dimension of banknotes BN to be received therein so that banknotes stacked therein are positioned at an angle as shown in FIG. 13C. An elevator system comprises a pair of banknote supports 1340 which are threadingly coupled to a pair of elevator positioning posts 1310_{P}. According to some embodiments, the elevator positioning posts 1310_{P} are threaded shafts with one having a left-hand thread and the other having a right-hand thread. The elevator positioning posts 1310_{P} are rotationally driven by one or more motors communicatively coupled to and controlled by a controller or processor such as controller or processor 202. According to some embodiments, the elevator positioning posts 1310_{P} are geared together. The vertical position of banknote supports 1340 may be raised or lowered by rotating the elevator positioning posts 1310_{P} in one direction or the other. The banknote supports 1340 may be positioned in an operational position wherein the supports 1340 project into the storage bay 1360 as shown in FIGS. 13A and 13C thereby enabling the banknote supports 1340 to support one or more banknotes BN thereon and also to raise or lower the banknotes supported thereon as the banknote supports 1340 are raised or lowered. The banknote supports 1340 may also be positioned in a non-operational position wherein the supports 1340 do not project into the storage bay 1360 as shown in FIG. 13B thereby enabling the banknote supports 1340 to be raised or lowered without adjusting the level of banknotes residing in the storage bay 1360.

As with storage bay 360, according to some embodiments, the stacking of the banknotes in the storage bay 1360 at an angle relieves some of the weight of the banknotes which would otherwise by borne by a feeding plate 1372 which is positioned at the bottom of storage bay 1360. In some such embodiments, the re-allocation of the bearing of the weight of some of the banknotes in the stack from the feeding plate 1372 to one or more of the walls of the storage bay 1360, e.g., backwall 1360_{BK}, increases the number of banknotes that may reside in the storage bay 1360 and not have to be lifted up by the elevator 1310 and banknote supports 1340 prior to dispensing banknotes smoothly and at high speeds (e.g., at least 1000 banknotes per minutes). As with storage bay 360, stripping wheels 1374 and drive roll 1375 form part of a dispensing mechanism at the bottom of storage bay 1360 which may be similar or identical in construction and operation as stripping wheels 374 and drive roll 375 of storage bay 360.

During a depositing or feed-in operation, banknote supports 1340 are positioned in an operational position and are raised near the top of storage bay 1360 so that banknotes from stacker wheels 1362 may be deposited onto and supported by the banknote supports 1340. As with storage bay 360, the banknote supports 1340 may be lowered as more banknotes are stacked thereon so as to maintain the top of the stack of banknotes supported by the banknote supports 1340 at generally the same elevation.

During a dispensing or feed-out operation, the banknote supports 1340 may be lowered so that any banknotes being supported thereon may be lowered so as that they may come to rest upon feeding plate 1372 or the top of a stack banknotes already being supported by feeding plate 1372. The banknote supports may be moved (rotated) to a non-operational position thereby transferring the banknotes previously supported thereon to the feeding plate 1372 or the top of a stack banknotes already being supported by feeding plate 1372. Banknotes on the feeding plate 1372 may be dispensed as discussed above in connection with storage bay 360.

While maintaining the banknote supports 1340 in a non-operational position, the banknote supports may be raised above the stack of banknotes supported by feeding plate 1372. Once above the stack of banknotes, the banknote supports 1340 may be moved (rotated) back to an operational position and raised to be in position to receive additional banknotes from stacker wheels 1362.

According to some embodiments, to move or rotate the banknote supports 1340 between the operational and non-operational positions, the banknote supports 1340 are coupled to one or more banknote support positional motors communicatively coupled to and controlled by a controller or processor such as controller or processor 202. According to some embodiments, the banknote supports 1340 are maintained or locked in operational positions while being raised or lowered in the middle of the storage bay 1360 and can only be moved out of the operational positions when the banknotes supports 1340 are near the bottom of the storage bay 1360 and can only be move into operational positions when near the top of the storage bay 1360.

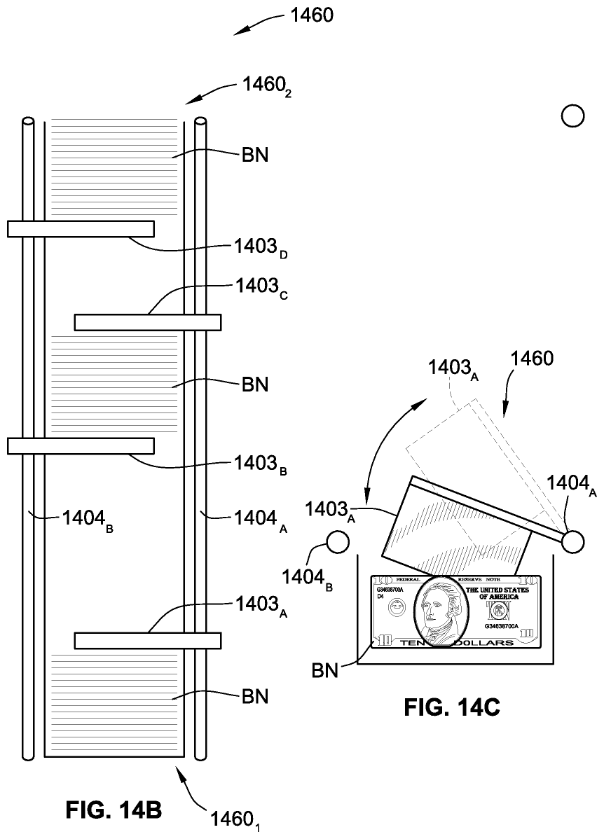

According to some embodiments, while in the operational positions and being lowered within the storage bay 1360, the banknote supports 1340 are laterally constrained by a slot in the back wall 1360_{BK} so as to prevent the banknote supports 1340 from rotating about the axes of the elevator positioning posts 1310_{P}. The lateral constraint ends prior to the banknote supports 1340 reaching the bottom of their travel along elevator positioning posts 1310_{P} so that when the banknote supports 1340 reach the bottom of their travel, the rotation of elevator positioning posts 1310_{P} causes the banknote supports 1340 to pivot about the axes of the elevator positioning posts 1310_{P} repositioning the banknote supports 1340 into their non-operational positions wherein the supports 1340 do not project into the storage bay 1360 as shown in FIG. 13B. According to some embodiments, as the banknote supports 1340 rotate out of their operational position, they snap into rotational detents which hold the banknote supports 1340 in their non-operational position. Upon reversal of the rotation direction of the elevator positioning posts 1310_{P}, the banknote supports 1340 may be driven in their non-operational positions to the top of the storage bay 1360. The detents prevent the banknote supports 1340 from rotating into their operational positions while being raised. As the banknote supports 1340 reach the top of the storage bay 1360, the constraint of the detents is removed and the rotation of elevator positioning posts 1310_{P} causes the banknote supports 1340 to pivot about the axes of the elevator positioning posts 1310_{P} repositioning the banknote supports 1340 into their operational positions wherein the supports 1340 do project into the storage bay 1360 as shown in FIGS. 13A and 13C. FIG. 14A is a schematic view of a banknote recycler 1400 employing generally horizontal storage bays 1460_{A}-1460_{D} according to some embodiments. In general, the banknote recycler 1400 and its operation may be similar to or identical to the banknote recycler 100 except that the banknote recycler 1400 employs generally horizontal storage bays 1460_{A}-1460_{D} whereas banknote recycler 100 employs generally vertical storage bays 160a-160f.

The banknote recycler 1400 comprises an input hopper 1410 for receiving a banknote or a stack of banknotes and a transport mechanism 1420 for receiving banknotes from the input hopper 110 and delivering the banknotes to and from a number of locations in the banknote recycler 1400. The banknote recycler 1400 further comprises a banknote detector section 1430 which may be the same or similar to banknote detector section 130 discussed above. The recycler 1400 also comprises one or more externally accessible output receptacles 1440_{A} and 1440_{B}. Banknotes delivered to the output receptacles 1440_{A}, 1440_{B} may be removed by a user reaching into the output receptacles 1440_{A}, 1440_{B} and grasping the banknotes with his or her hand. According to some embodiments, the output receptacles 1440_{A}, 1440_{B} comprise stacker wheels 1442a, 1442b to assist in stacking the banknotes into the output receptacles 1440_{A}, 1440_{B}. In some modes of operation, the output receptacle 1440_{A} may be used as a reject output receptacle to which rejected banknotes are delivered such as, for example, a banknote or document whose denomination was not determined by the banknote detector section 1430.

According to some embodiments, the recycler 1400 further comprises a secure banknote storage bin 1440_{C}. In some modes of operation, the secure banknote storage bin 1440_{C} may be used store banknotes which are determined to be counterfeit or mutilated using the one or more detectors in the banknote detector section 1430. According to some embodiments, the banknote recycler has a slot or opening in its housing permitting an operator to insert banknotes into (but not withdraw bills from) the secure banknote storage bin 1440_{C}. For example, if an operator notices that a banknote to be processed is mutilated and may cause a jam if processed by the banknote recycler 1400, the operator may directly put such notes through the slot in the housing so that such notes may be securely stored in the secure storage bin 1440_{C}. According to some embodiments, the operator may use an input/output interface (such as interface 208) to enter information about the mutilated banknote(s) (such as the denomination and/or the serial number of each note) into the banknote recycler 1400 so that a processor or controller 202 may update information about the related transaction to reflect all bills in a transaction, e.g., so a customer may be given credit for the deposit of all banknotes deposited in a transaction, even those that are too mutilated to be automatically processed by the banknote recycler 1400.

The recycler 1400 further comprises one or more generally horizontal banknote storage bins or bays 1460_{A}-1460_{D}. According to some embodiments, the first storage bay 1460_{A} is used as an escrow storage bay to temporarily hold banknotes being deposited into the banknote recycler 1400 as described above in connection with storage bay 160a. According to some embodiments, the remaining storage bays 1460_{B}-1460_{D} are each dedicated to specific denominations of banknotes, e.g., storage bay 1460_{B} may be assigned to store US $1 bills, storage bay 1460_{C} may be assigned to store US $5 bills, storage bay 1460_{D} may be assigned to store US $10 bills. Although not illustrated, the recycler may comprise additional storage bays such as a storage bay assigned to store US $20 bills and a storage bay to store US $100 bills. According to some embodiments, the recycler may also comprise one or more overflow storage bays such as storage bay 1460_{E}. Note, according to some embodiments, the recycler 1400 may comprise fewer or more than four to seven storage bays 1460_{A}-1460_{E}. The storage bays 1460_{A}-1460_{E} are distinguishable from the output receptacles 1440_{A}, 1440_{B} in that the storage bays 1460 are secured within a housing of the recycler 1400 and are not externally accessible to a typical user or operator of the recycler 1400. Rather, to gain access to the storage bays 1460_{A}-1460_{E} and the banknotes stored therein, a security door of the recycler must be opened. According to many embodiments, the security door is locked and may only be opened by authorized personnel having a key or access code enabling the security door to be unlocked.

In the embodiment illustrated in FIG. 14A, each of the storage bays 1460_{A}-1460_{D} receive bills or banknotes at a receiving end (e.g., 1460_{A-1}) and dispense or feed out bills from their other end (e.g., 1460_{A-2}). In such embodiments, banknotes are handled in a first-in, first out (FIFO) manner. According to some embodiments, the storage bays 1460_{A}-1460_{D} comprises dispensers 1470a-1470d to dispense or feed out bills from the respective storage bins 1460_{A}-1460_{D}. According to some embodiments, the overflow storage bay 1460_{E} does not include a dispenser. According to other embodiments, the overflow storage bay 1460_{E} does include a dispenser. According to some embodiments, storage bays of the banknote recycler 1400 may handle banknotes in a last-in, first out (LIFO) manner.

In the embodiment illustrated in FIG. 14A, stacker wheels 1462a-1462d, 1462 assist in stacking bills into the respective the storage bays 1460_{A}-1460_{E}. According to some embodiments, the stacker wheels 1462a-1462d, 1462 stack bills on their edges within the storage bays 1460_{A}-1460_{E}.

According to some embodiments, the storage bays 1460_{A}-1460_{E} comprises one or more moveable partitions or banknote supports 1405a, 1405b. The moveable partitions or banknote supports 1405a, 1405b may be horizontally moveable (such as in a manner similar to the one or more vertical elevators and banknote supports described above are moveable. For example, a first moveable partition 1405a may be positioned near a receiving end 1460_{A-1} of a storage bay 1460_{A}. During a depositing or feed-in operation, the banknote support may be positioned near stacker wheel 1462a and move horizontally away from the stacker wheel (to the right in FIG. 14A) as more and more banknotes are stacked within the storage bay 1460_{A}. Likewise, a banknote support 1405b may be positioned closer to the dispensing end 1460_{A-2} of storage bay 1460. The horizontal position of the banknote support may be adjusted to aid in the dispensing of banknotes by the dispenser 1470a such as by pressing banknotes into engagement with the dispenser 1470a and moving toward the dispensing end 1460_{A-2} as banknotes are fed out of the storage bay 1460_{A}. Similar banknote supports may be positioned in the other generally horizontal storage bays 1460_{B}-1460_{E}.

According to some embodiments, the generally horizontal storage bays 1460_{A}-1460_{D} may also comprises a means for moving stacks of banknotes from the receiving ends (e.g., 1460_{A-1}) of the storage bays toward the dispensing ends (e.g., 1460_{A-2}). For example, as will be described in more detail with respect to FIGS. 14B and 14C, the storage bays 1460_{A}-1460_{D} may comprise banknote supports 1405 that may be raised out of (or into) and lowered into (or out of) storage bays 1460_{A}-1460_{D}. For example, the banknote supports 1405 may have operational positions in which they extend into the storage bays 1460_{A}-1460_{D} and support banknotes within the storage bays 1460_{A}-1460_{D} and non-operational positions in which they do not extend into the storage bays 1460_{A}-1460_{D} and support banknotes within the storage bays 1460_{A}-1460_{D}. To move a stack of banknotes, two banknote supports 1405 may be positioned on either side of a stack of banknotes to be moved and then moved to their operational positions. Then such two banknote supports 1405 may then be moved horizontally in tandem so as to keep the banknotes therebetween standing on their edges until the stack of banknotes abuts the dispensing end (e.g., 1460_{A-2}) or a banknote support supporting a stack of banknotes against the dispensing end (e.g., 1460_{A-2}). Then the banknote support or supports near the dispensing end (e.g., 1460_{A-2}) may be moved to its or their non-operational position(s) so that one end of the moved stack of banknotes abuts the dispenser or an end of a stack of banknotes already positioned at the dispensing end (e.g., 1460_{A-2}).

Alternatively, banknotes may be continued to be deposited into a storage bay until a first banknote support (e.g., 1405a) is sufficiently close to a second banknote support (e.g., 1405b) that the first (and/or second) banknote support may be moved to a non-operational position (such as by moving or folding down into or through a floor of the storage bay) and the banknotes may be merged into a single stack of banknotes resting on their edges.

FIG. 14B is a top view and FIG. 14C is an end view of a generally horizontal storage bay 1460 employing banknote supports 1403_{A}-1403_{D} to support and move banknotes BN residing in storage bay 1460. According to some embodiments, the banknote supports 1403_{A}-1403_{D} may be similar to the paddles described in U.S. Pat. No. 6,398,000, incorporated herein by reference in its entirety (see e.g., FIG. 3a of U.S. Pat. No. 6,398,000). According to some embodiments, the means for moving stacks of banknotes from the receiving ends (e.g., 1460_{A-1}) of the storage bays toward the dispensing ends (e.g., 1460_{A-2}) of the generally horizontal storage bays 1460_{A}-1460_{D} employ the banknote supports 1403_{A}-1403_{D} illustrated in FIGS. 14B and 14C. For example, the storage bays 1460_{A}-1460_{D} may comprise banknote supports 1403_{A}-1403_{D} that may be raised or pivoted out of and lowered or pivoted into storage bays 1460_{A}-1460_{D}. For example, the banknote supports 1403_{A}-1403_{D} have operational positions in which they extend into the storage bays 1460_{A}-1460_{D} and support banknotes within the storage bays 1460_{A}-1460_{D} and non-operational positions in which they do not extend into the storage bays 1460_{A}-1460_{D} and support banknotes within the storage bays 1460_{A}-1460_{D}. To move a stack of banknotes, two banknote supports such as 1403_{B} and 1403_{C} may be positioned on either side of a stack of banknotes to be moved and then moved to their operational positions. Then the two banknote supports 1403_{B}, 1403_{C} may be moved horizontally in tandem so as to keep the banknotes therebetween standing on their edges until the stack of banknotes abuts the dispensing end 1460₂ or a banknote support supporting a stack of banknotes against the dispensing end (e.g., banknote support 1403_{D}). Then the banknote support or supports 1403_{C}, 1403_{D} near the dispensing end 1460₂ may be moved to its or their non-operational position(s) so that one end of the moved stack of banknotes abuts the dispenser 1460₂ or an end of a stack of banknotes already positioned at the dispensing end.

According to some embodiments, the banknote supports 1403_{A}-1403_{D} are pivotally mounted to respective guide posts 1404_{A}, 1404_{B} positioned near and generally parallel the top of storage bay 1460. The posts 1404_{A}, 1404_{B} may extend from a receiving end 1460₁ to a dispensing end 1460₂ of the storage bay 1460 and be positioned on opposite sides of the storage bay 1460. The banknote supports 1403_{A}-1403_{D} may be pivoted into and out of the storage bay 1460. One or more motors communicatively coupled to and controlled by a controller or processor such as controller or processor 202 may move the banknote supports 1403_{A}-1403_{D} into and out of the storage bays (into and out of operational positions) and along the guide posts 1404_{A}, 1404_{B}.

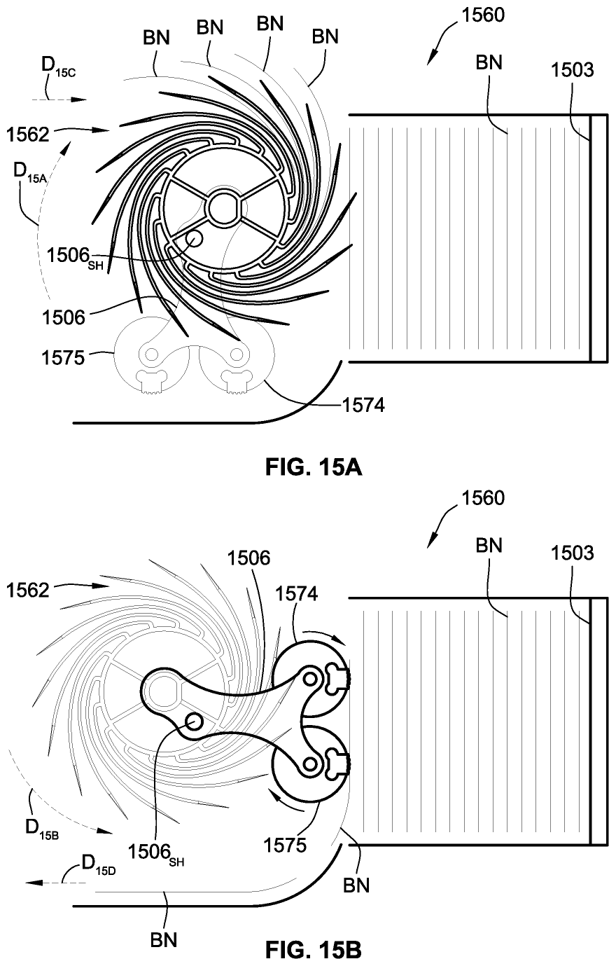

FIGS. 15A and 15B are sectional views of a generally horizontal recycling bay arrangement comprising a banknote recycler storage bay or recycling bay 1560 according to some embodiments of the present disclosure employing a Last-In, First-Out (LIFO) feeding scheme. During a depositing or feed-in operation illustrated in FIG. 15A, banknotes BN are received in a pair of stacker wheels 1562 and stacked on their edges in the storage bay 1560. The stacking wheels 1562 are coupled to a rotatable stacking wheel/dispenser carriage 1506 configured to rotate about carriage axis 1506_{SH}. To switch from a depositing operation to a dispensing operation as shown in FIG. 15B, the carriage is rotated (via a motor communicatively coupled to and controlled by a controller or processor such as controller or processor 202) so as to rotate the stacker wheels 1562 away from an open end of the storage bay 1560 and rotate a dispenser mechanism into position near the open end of the storage bay 1560. As illustrated in FIG. 15B, the rotation is in a counter-clockwise direction D_{15B}. The dispenser mechanism may comprise stripping wheels 1574 and drive rolls 1575 that may be the same as or similar to in both construction and operation as the stripping wheels (e.g., 374, 874, 1174, 1274) and drive rolls (e.g., 375, 875, 1175, 1275) described above. Banknotes BN may be fed out of storage bay 1560 via the dispenser mechanism such as in direction D_{15D}. A generally horizontally moveable banknote support 1503 assists with maintaining banknotes stacked on their edges within banknote storage bay 1560 and into engagement with the stripping wheels 1574 during a dispensing operation. To switch from a dispensing operation to a depositing operation as shown in FIG. 15A, the carriage is rotated (via a motor communicatively coupled to and controlled by a controller or processor such as controller or processor 202) so as to rotate the stacker wheels 1562 into position near an open end of the storage bay 1560 and rotate a dispenser mechanism away from the open end of the storage bay 1560. As illustrated in FIG. 15A, the rotation is in a clockwise direction D_{15A}. Banknotes may be fed into the stacker wheels 1562 such as in direction D_{15C}.

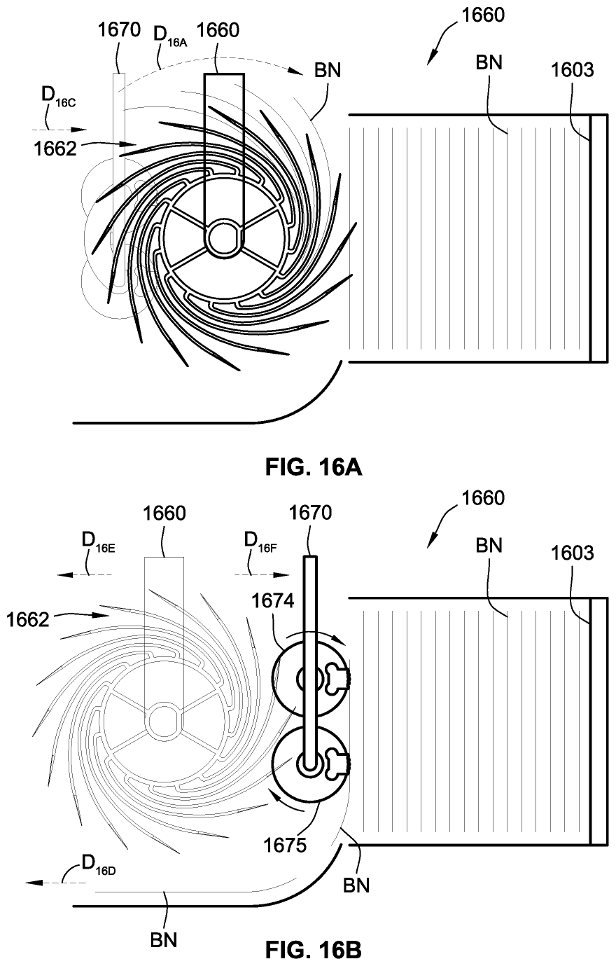

FIGS. 16A and 16B are sectional views of a generally horizontal recycling bay arrangement comprising a banknote recycler storage bay or recycling bay 1660 according to some embodiments of the present disclosure employing a Last-In, First-Out (LIFO) feeding scheme. In general, the arrangement of FIGS. 16A and 16B is similar or identical in construction and operation as described above in connection with FIGS. 15A and 15B except that in FIGS. 16A and 16B the stacker wheels 1662 are on a separate carriage 1660 than the dispensing mechanism carriage 1670 while in FIGS. 15A and 15B, the stacker wheels 1562 and the dispensing mechanism are on the same carriage 1506. During a depositing or feed-in operation illustrated in FIG. 16A, banknotes BN are received in a pair of stacker wheels 1662 and stacked on their edges in the storage bay 1660. The stacking wheels 1662 are coupled to a moveable stacking wheel carriage 1660 configured to move in front of an open end of storage bay 1660 and away from the open end of storage bay 1660 (e.g., in directions D_{16E} and D_{16F} shown in FIG. 16B). Likewise, a dispensing mechanism comprising stripping wheels 1674 and drive rolls 1675 are coupled to a moveable dispenser carriage 1670 configured to move in front of an open end of storage bay 1660 and away from the open end of storage bay 1660 (e.g., in directions D_{16E} and D_{16F} shown in FIG. 16B). The stripping wheels 1674 and drive rolls 1675 that may be the same as or similar to in both construction and operation as the stripping wheels (e.g., 374, 874, 1174, 1274) and drive rolls (e.g., 375, 875, 1175, 1275) described above. To switch from a depositing operation to a dispensing operation as shown in FIG. 16B, the stacker wheel carriage 1660 is moved (via a motor communicatively coupled to and controlled by a controller or processor such as controller or processor 202) so that the stacker wheels 1662 are moved away from an open end of the storage bay 1660 (e.g., in direction D_{16E}) and the dispenser mechanism carriage 1670 is moved so that the dispenser mechanism is positioned near the open end of the storage bay 1660 (e.g., in direction D_{16F}). Banknotes BN may be fed out of storage bay 1660 via the dispenser mechanism such as in direction D_{16D}. A generally horizontally moveable banknote support 1603 assists with maintaining banknotes stacked on their edges within banknote storage bay 1660 and into engagement with the stripping wheels 1674 during a dispensing operation. To switch from a dispensing operation to a depositing operation as shown in FIG. 16A, the stacker wheel carriage 1660 is moved (via a motor communicatively coupled to and controlled by a controller or processor such as controller or processor 202) so that the stacker wheels 1662 are moved near an open end of the storage bay 1660 (e.g., in direction D_{16F}) and the dispenser mechanism carriage 1670 is moved so that the dispenser mechanism is positioned away from the open end of the storage bay 1660 (e.g., in direction D_{16E}). Banknotes may be fed into the stacker wheels 1662 such as in direction D_{16C}.

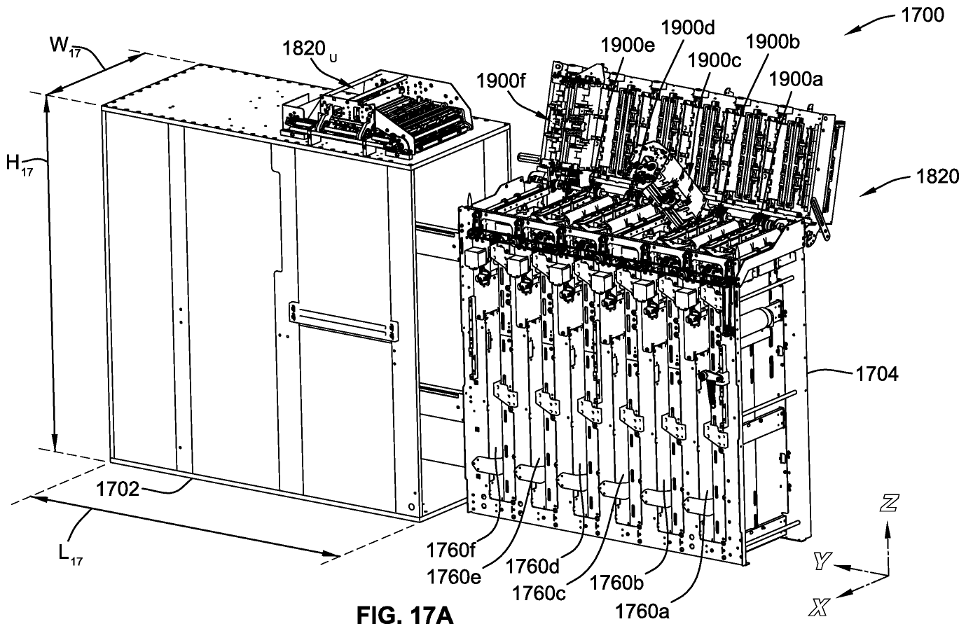

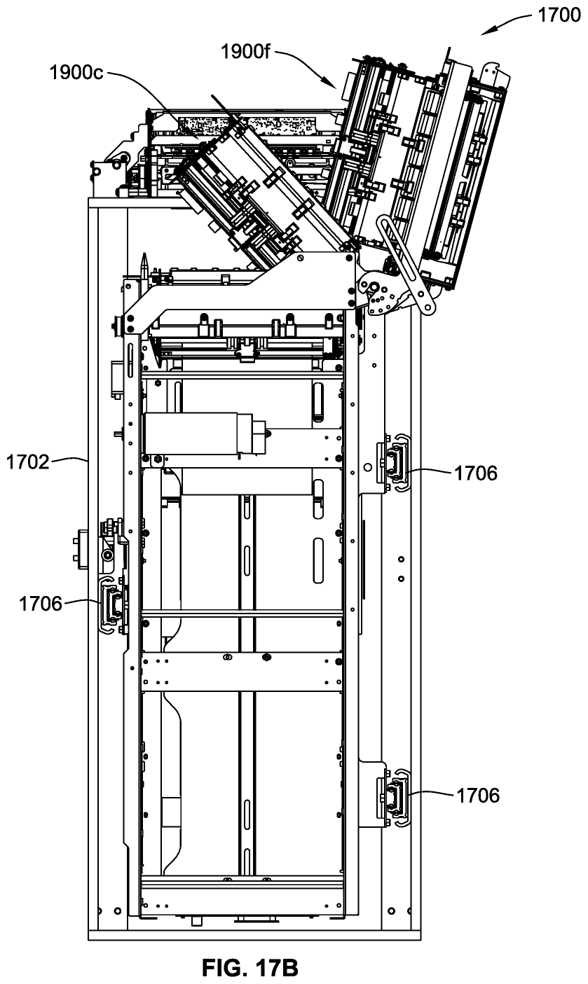

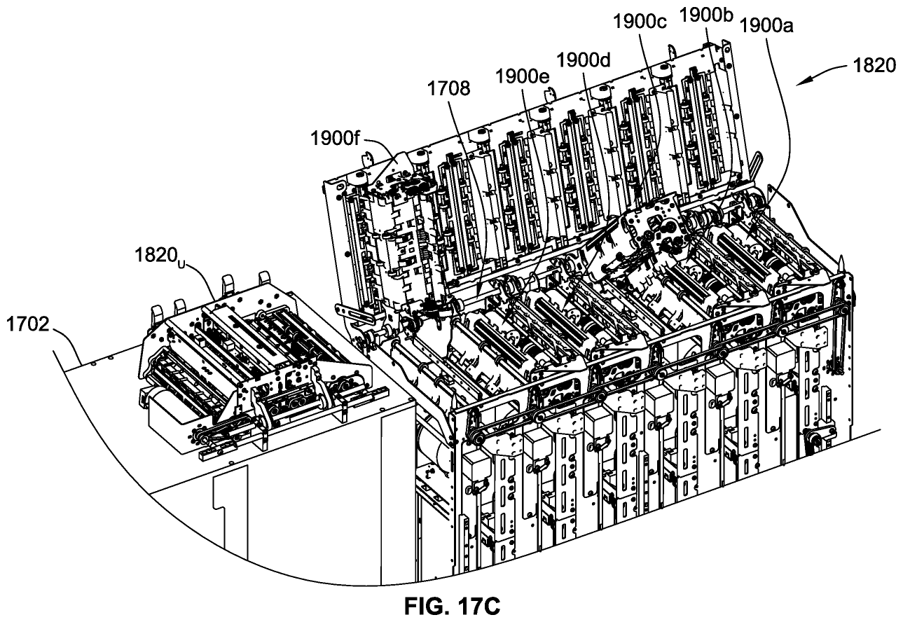

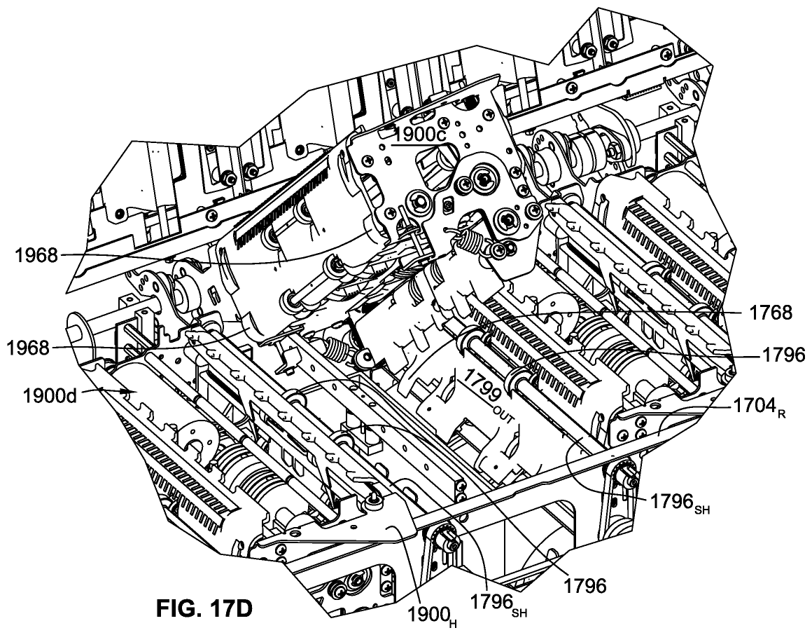

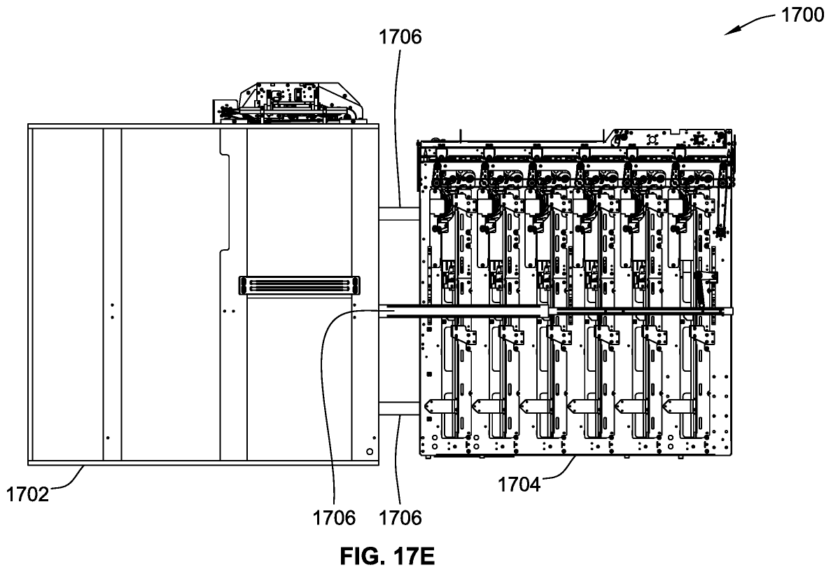

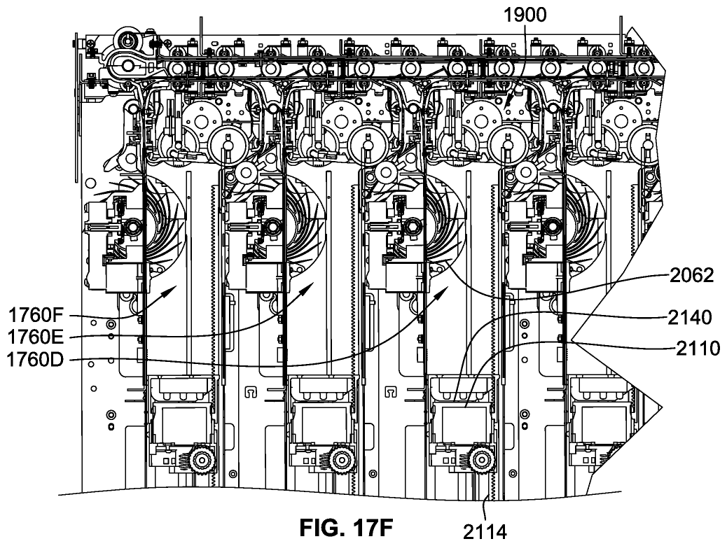

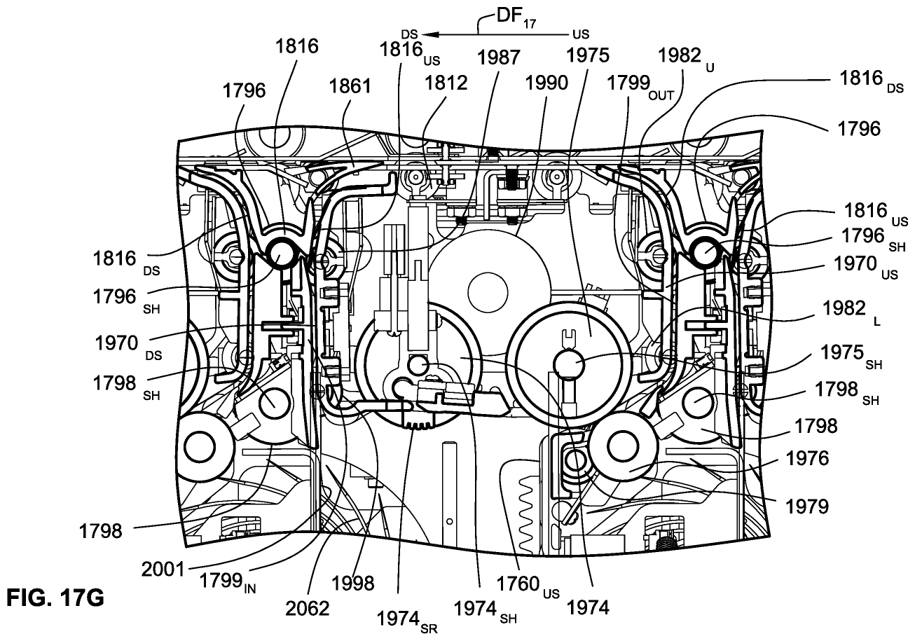

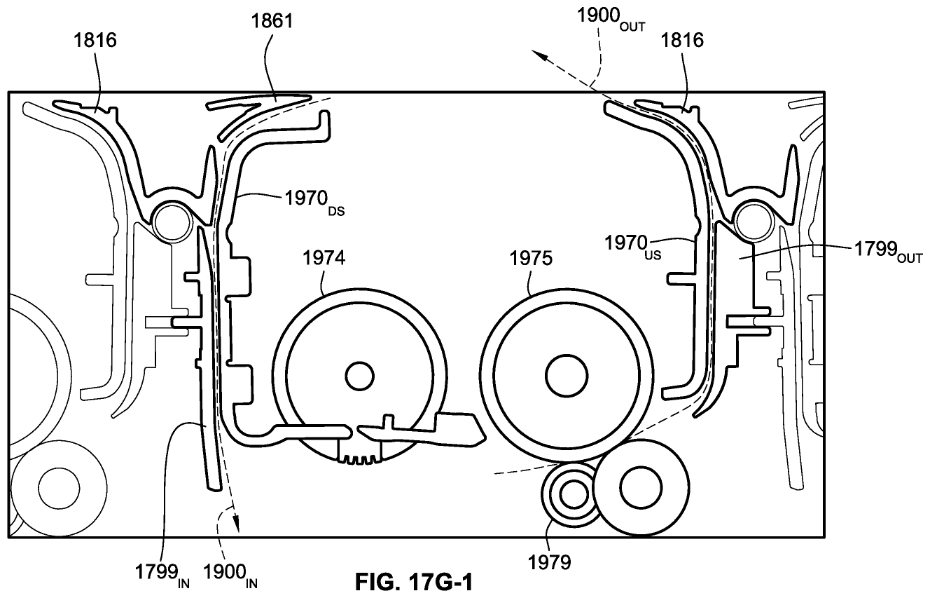

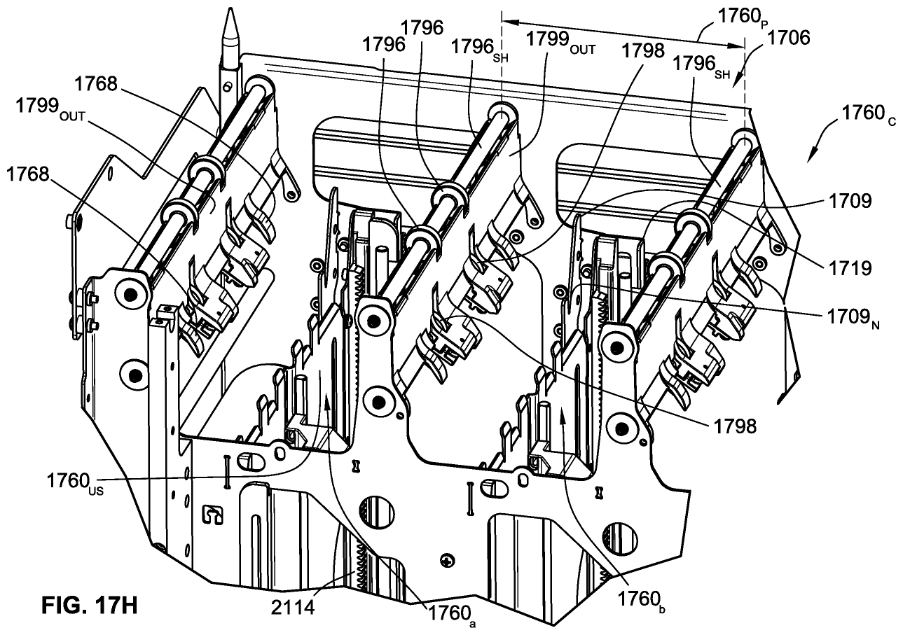

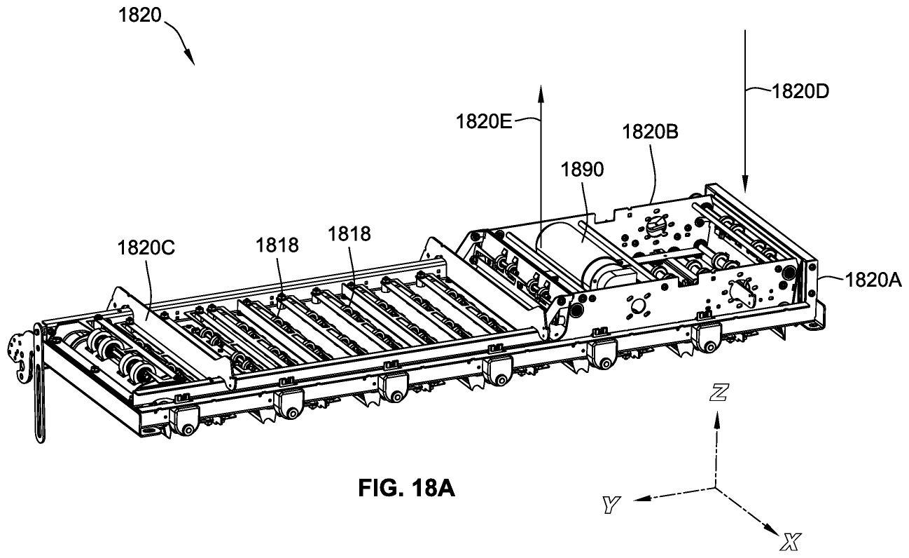

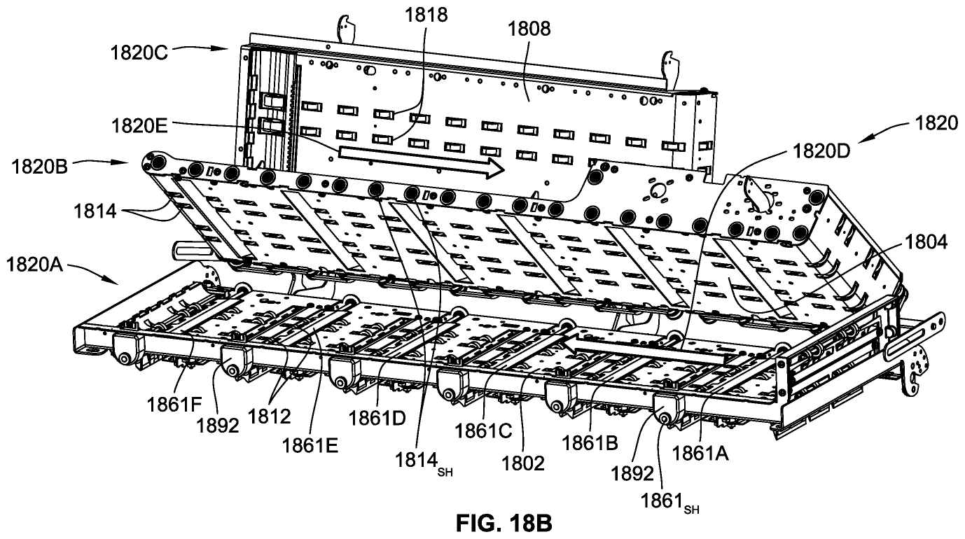

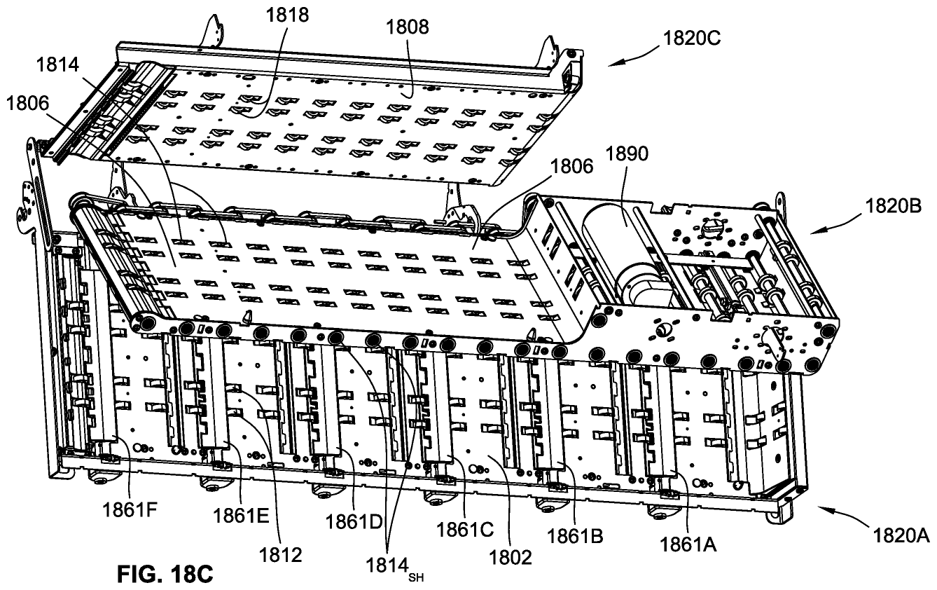

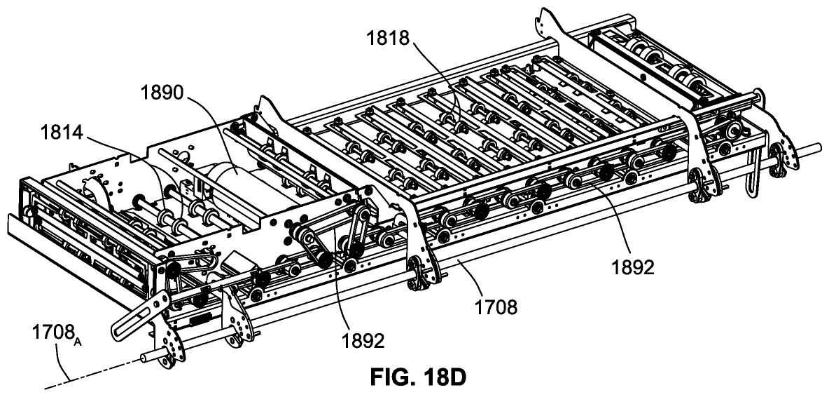

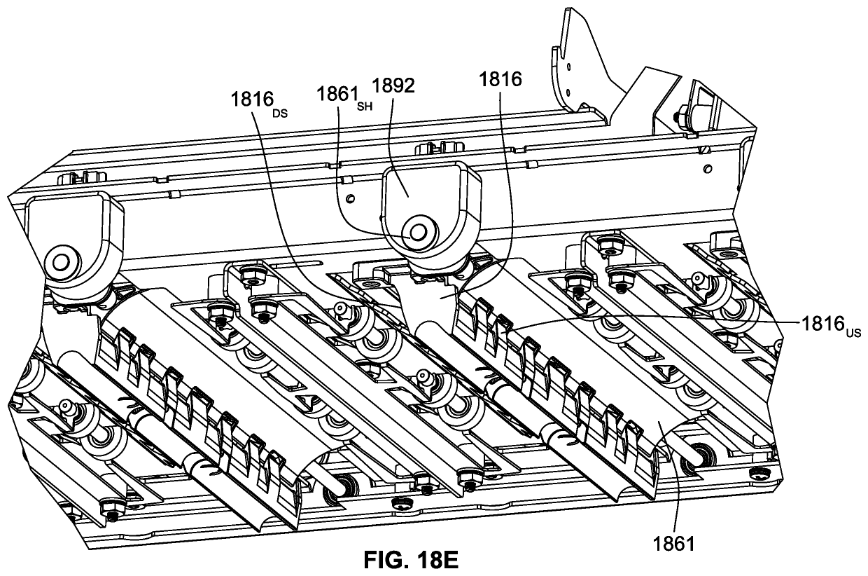

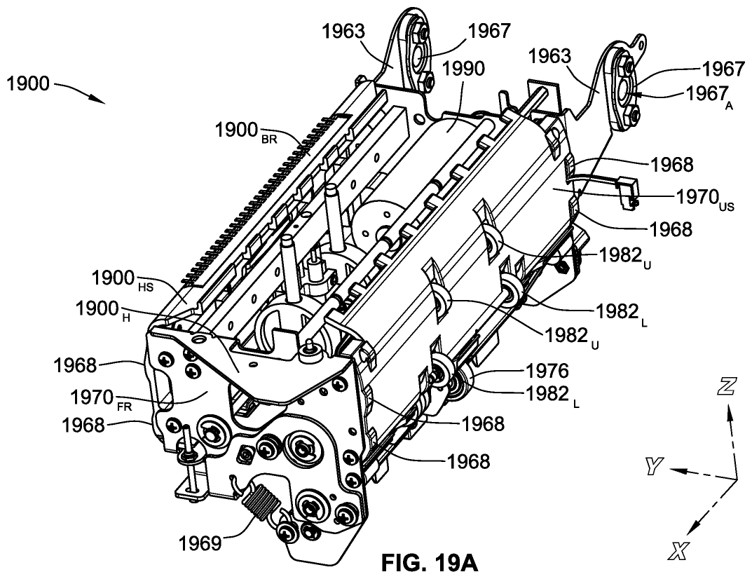

FIG. 17A is a perspective view of components of a banknote recycler 1700 having six recycler storage bays or generally vertically oriented banknote recycling bays 1760a-1760f according to some embodiments of the present disclosure. FIG. 17B is an end view of the banknote recycler 1700 of FIG. 17A and FIG. 17C is an enlarged view of a portion of FIG. 17A. In FIGS. 17A-17C a portion of a main transport mechanism 1820 is shown in an open, non-operational position and depicting a plurality of banknote feeding modules 1900a-1900f residing at the top of respective storage bays 1760a-1760f. FIG. 17D is a further enlarged view of a feeder module 1900c of FIGS. 17A-17C. FIG. 17E is a front view of banknote recycler 1700 with a main transport mechanism 1820 in a closed position. FIG. 17F is cross-sectional view of upper ends of banknote recycling bays 1760d-1760f. FIG. 17G is an enlarged view of a feeder module 1900 in an operational position above one of the recycling bays 1760a-1760f. FIG. 17G1 is an enlarged view similar to FIG. 17G illustrating an in-feed transport path 1900_{IN} and an out-feed transport path 1900_{OUT} for one of the recycling bays 1760a-1760f. FIG. 17H is an enlarged rear perspective view of a couple of recycling bays 1760a-1760b having some components such as the main transport mechanism 1820 and feeder modules 1900 removed. In FIG. 17G, a direction of banknote transport DF₁₇ along transport path 1820D (see FIG. 18B) is illustrated with indication of the upstream US end and the downstream DS end.

The banknote recycler 1700 comprises a multiple storage bay chassis 1704 and a housing 1702. According to some embodiments, the housing has an exterior width W₁₇ less than or equal to about 18 inches (46 cm), an exterior height H₁₇ less than or equal to about 38 inches (97 cm), and an exterior length L₁₇ less than or equal to about 39 inches (99 cm). In FIGS. 17A-17C multiple storage bay chassis 1704 is illustrated in an extended, non-operational position outside of housing 1702. In an operational position, transport mechanism 1820 is placed in a closed, operational position (see, e.g., FIGS. 17E, 17F, 18A, 18D) and the multiple storage bay chassis 1704 is nested inside of housing 1702 (not shown). According to some embodiments, the multiple storage bay chassis 1704 is supported on retractable bearing arms 1706 (see FIGS. 17B and 17E) which permit the multiple storage bay chassis 1704 to be moved out of and back into the housing 1702. According to some embodiments, the multiple storage bay chassis 1704 is alternatively or additionally supported on wheels to facilitate the multiple storage bay chassis 1704 being moved out of and into the housing 1702.

The banknote recycler 1700 comprises a banknote transport mechanism comprising a main transport mechanism 1820 and an upper transport mechanism 1820_{U}. Although not illustrated in FIGS. 17A-17C, the upper transport mechanism 1820_{U} is communicatively coupled to an input receptacle to permit banknotes to be received or deposited into the banknote recycler such as input receptacle or hopper 110 shown in, for example, FIG. 1A and open, externally accessible output receptacles to permit banknotes to be dispensed from the banknote recycler such as open, externally accessible output receptacles 140a, 140b. Likewise, the upper transport mechanism 1820_{U} may include or be communicatively coupled a banknote detector section 130 as described above.

According to some embodiments, the banknote recycler 1700 operates similar as described above in connection with banknote recyclers 100, 100′, and/or 100″ described in connection with FIGS. 1A-1H and 2 above with the exception that banknotes are fed into and out of individual storage bays 1760a-1760f at the top of each storage bay 1760 as opposed to being fed in at the top and fed out at the bottom of each bay 160. As a result, banknote recycler 1700 employs a Last-In, First-Out (LIFO) feeding scheme as opposed to the first-in, first-out (FIFO) feeding scheme of FIGS. 1A-1H. Accordingly, according to some embodiments, banknote recycler may comprise secure storage bin 150, a banknote detector section 130′, and/or a banknote cassette receiving port or interface or container dock 180. Accordingly, banknote recycler 1700 is similar to banknote recycler 1200 described above in connection with FIGS. 12A-12B. Additionally, whereas in some embodiments or modes of operations banknotes may be deposited into and dispensed from a given storage bay 160/360 simultaneously, banknotes may be either deposited into or dispensed from a given storage bay 1760 at a given time but both operations may not be performed simultaneously for a given storage bay 1760. For example, in an Internal Audit Mode, instead of feeding banknotes out of a particular bay, e.g., bay 1760b and immediately back into the same bay, e.g., bay 1760b, the banknotes may be first routed to and stored in an empty bay such as an escrow bay, e.g., bay 1760a. Likewise, in an Internal Audit Mode, the contents of each storage bay, e.g., bays 1760b-1760f, may be audited in a sequential manner in conjunction with an empty bay such as an escrow bay, e.g., first banknotes from storage 1760b are fed out and past banknote detector 130 and into storage bay 1760a and once all the banknotes have been verified and transferred into storage bay 1760a, they are then transferred from storage bay 1760a back into storage bay 1760b. Then banknotes from storage 1760c are fed out and past banknote detector 130 and into storage bay 1760a and once all the banknotes have been verified and transferred into storage bay 1760a, they are then transferred from storage bay 1760a back into storage bay 1760c. This process may then be continued until the contents of all remaining storage bays, e.g., 1760d-1760f, have been audited. As another example, for embodiments wherein banknotes of a plurality of denominations are stored in a single storage bay, an empty bay such as an escrow bay (e.g., storage bay 1760a) may be used to hold banknotes that are dispensed from given one of such storage bays (e.g., storage bay 1760b) but not to be dispensed to an output receptacle 140a, 140b until dispensing from the given one of such storage bays (e.g., storage bay 1760b) is ended, e.g., when it is determined that a desired number of banknotes of a particular denomination have been dispensed to one of the output receptacles 140a, 140b and/or have been detected by banknote detector 130. After a processer such as processor 202 determines that no more banknotes need to be dispensed from the given storage bay (e.g., storage bay 1760b), the storage bay (e.g., storage bay 1760b) may be placed into a deposit configuration and the banknotes stored in the escrow bay (e.g., storage bay 1760a) may to transferred back into the given storage bay (e.g., storage bay 1760b). Otherwise, the operation of the banknote recycler 1700 may be the same as that described above in connection with FIGS. 1A-1H, 2 and FIGS. 12A-12B including having the various modes of operation as described above in connection with FIGS. 1A-1H.

The banknote recycler 1700 comprises a main transport mechanism 1820, a plurality of storage bays 1760, with each storage bay 1760 having associated therewith a feeding module 1900, a stacker module 2000, and an elevator 2110.

In general, except as illustrated in FIGS. 17A-22E and described therewith, the banknote recycler bay 1760 may operate the same as described above in connection with banknote recycler bay 160, 360 and 1260 and may have the same or similar components. In this regard, the same or similar components will be identified with the same or similar numbers (e.g., “300” series numbers are changed to “1700” series numbers, “500” series numbers are changed “2100” series numbers, “100” series numbers are changed to one or more of “1700” series, “1800” series, “1900” series, “2000” series numbers) For example, in FIGS. 1A-1H, diverters 161a-161f divert banknotes into storage bays 160a-160f whereas for recycler 1700 the corresponding diverters are designated diverters 1861A-1861F. Similarly, for recycler 1700 the storage bay stacker wheels are designated storage bay stacker wheels 2062a-2062f corresponding to the designations of storage bay stacker wheels 162a-162f in FIGS. 1A-1H. Likewise, except as illustrated in FIGS. 12A-12B and described therewith, a banknote recycler such as recylcers 100, 100′, and 100″ having an arrangement 1200 may operate the same or similar as described below in connection with banknote recycler bay 1760.

According to some embodiments, the first storage bay 1760a is used as an escrow storage bay to temporarily hold banknotes being deposited into the banknote recycler 1700 as will be described in more detail below. According to some embodiments, the remaining storage bays 1760b-1760f are each dedicated to specific denominations of banknotes, e.g., storage bay 1760b may be assigned to store US $1 bills, storage bay 1760c may be assigned to store US $5 bills, storage bay 1760d may be assigned to store US $10 bills, storage bay 1760e may be assigned to store US $20 bills, storage bay 1760f may be assigned to store US $100 bills. Note, according to some embodiments, the recycler 100 may comprise fewer or more than six storage bays 1760a-1760f such as for example, one, two, three, four, five, seven, eight, nine, ten, etc. storage bays 1760.

According to some embodiments, the storage bays 1760a-1760f reside within a housing such as housing 1702 of the recycler 1700 having one or more security doors. The housing and security door(s) serve as a safe and may be made of high strength material such as metal and/or hard plastic. The storage bays 1760a-1760f are distinguishable from the open output receptacles 140a, 140b in that the storage bays are secured within a housing of the recycler 1700 and are not externally accessible to a typical user or operator of the recycler 1700 and are not externally accessible while the banknote recycler 1700 is operating under normal operating conditions such as when an operator is using the banknote recycler to deposit notes into the banknote recycler 1700 via an input receptacle such as input receptacle 110 and/or when an operator is using the banknote recycler 1700 to dispense banknotes to one or more externally accessible, open output receptacles such as open output receptacles 140a, 140b shown in FIG. 1A. Rather, to gain access to the storage bays 1760a-1760f and the banknotes stored therein, a security door of the recycler must be opened. According to many embodiments, the security door is locked and may only be opened by authorized personnel having a key or access code enabling the security door to be unlocked. According to some embodiments, the housing 1702 having one or more security doors constitutes a safe complying with UL 291 standard.

The main transport mechanism 1820 is described in more detail in connection with FIGS. 18A-18E. FIG. 18A is a perspective view of the main transport mechanism 1820 in its closed, operational state or position, FIG. 18B is a perspective view of the main transport mechanism 1820 in an open, non-operational state, FIG. 18C is a downward perspective view of the main transport mechanism 1820 in an open, non-operational state, and FIG. 18D is a rear perspective view of the main transport mechanism 1820 in its closed, operational state or position. FIG. 18E is an upward perspective view of a lower portion of the main transport mechanism 1820. The main transport mechanism 1820 comprises a lower transport section 1820A, a middle transport section 1820B, and an upper transport section 1820C.

A lower storage bay transport path 1820D is formed between the middle transport section 1820B and the lower transport section 1820A and an upper transport path 1820E is formed between the middle transport section 1820B and the upper transport section 1820C. The lower transport section comprises an upper transport plate 1802, the middle transport section 1820B comprises a lower transport plate 1804 and an upper transport plate 1806, and the upper transport section 1820C comprises a lower transport plate 1808. When in their closed operational position, the transport plates 1802 and 1804 are slightly spaced apart from each other and define the lower transport path 1820D therebetween and the transport plates 1806 and 1808 are slightly spaced apart for each other and define the upper transport path 1820E therebetween. Each transport plate 1802-1808 has a plurality of transport roll apertures therein through which a corresponding plurality of transport rolls project into the transport paths 1820D and 1820E. More specifically, the transport plate 1802 has a plurality of transport roll apertures through which a plurality of passive transport rolls 1812 project upward into the lower transport path 1820D so as to contact banknotes being transported along the lower transport path 1820D. The transport plate 1804 has a corresponding plurality of transport roll apertures through which a plurality of driven transport rolls 1814 project downward into the lower transport path 1820D so as to contact and drive banknotes along the lower transport path 1820D. The transport roll apertures in transport plate 1804 are positioned directly above the transport roll apertures in transport plate 1802 so that a passive transport roll 1812 protecting through each aperture comes in contact with a corresponding driven transport roll 1814 when the transport plates 1802 and 1804 are in an operational position such as shown in FIG. 18A.

Similarly, the transport plate 1808 has a plurality of transport roll apertures through which a plurality of passive transport rolls 1818 project downward into the upper return transport path 1820E so as to contact banknotes being transported along the upper return transport path 1820E. The transport plate 1806 has a corresponding plurality of transport roll apertures through which the plurality of driven transport rolls 1814 project upward into the upper return transport path 1820E so as to contact and drive banknotes along the upper return transport path 1820E. The transport roll apertures in transport plate 1808 are positioned directly above the transport roll apertures in transport plate 1806 so that a passive transport roll 1818 protecting through each aperture comes in contact with a corresponding driven transport roll 1814 when the transport plates 1806 and 1808 are in an operational position such as shown in FIG. 18A. As illustrated, according to some embodiments, the same driven transport rolls 1814 are used to drive bills or banknotes both along portions of transport paths 1820D and 1820E, but in opposite directions. The driven transport rolls 1814 are coupled to and rotate about shafts 1814_{SH}. According to some embodiments, one side of a driven transport roll 1814 projects into transport path 1820D while an opposing side projects into transport path 1820E.

As best seen if FIG. 18D, according to some embodiments, the driven transport rolls 1814 are rotational driven about shafts 1814_{SH} by a motor 1890 via belts 1892. In some embodiments, the use of the same motor aids in synchronizing the movement of banknotes along a number of portions of the transport path 120/1820. The motor 1890 may be similar to motor 390 discussed above and is controlled a processor or controller such as controller 202.

As can be seen in FIGS. 18B and 18C, according to some embodiments, the transport plates 1804, 1806, and 1808 may be moved to an open, non-operational position to aid in clearing jams of banknotes and/or in providing maintenance or service to the transport paths 1820D and 1820E and their related transport mechanism components as well as to gain access to feeding modules 1900a-1900f and/or into storage bays 1760a-1760f. According to some embodiments, the pair of transport plates 1804 and 1806 are coupled together in fixed relation to each other. The transport sections 1820A-1820C and their associated transport plates 1802, 1804, 1806, and 1808 are pivotally coupled to a pivot bar 1708 (see FIGS. 18D and 17C) having a longitudinal axis 1708_{A}. According to some embodiments, as illustrated in FIGS. 18A and 18B, the transport plates 1804, 1806, and 1808 may be moved from a closed, operational position to an open, non-operational position and back to a closed, operational position without having to remove or disconnect with belts 1892 used to drive the driven transport rolls 1814. According to some embodiments, when a transport section 1820A-1820C is moved to an open position, it is configured to remain in the open position. As can be seen if FIGS. 18B-18C, according to some embodiments, transport sections 1820B-1820C may be opened relative to each other and/or transport section 1820A to provide access to the entire transport paths 1820D and 1820E; thus, facilitating the clearing of jams of banknotes and/or in providing maintenance or service to the transport paths 1820D and 1820E and their related transport mechanism components.

Also illustrated in FIGS. 18B and 18C are diverters 1861A-1861F which serves as one example of a diverter that may be used as diverters 161 of FIGS. 1A-1H. The diverters 1861 are mounted on respective diverter shafts 18616_{SH} which are each coupled to a respective solenoid 1892 which selectively changes the position of a respective diverter 1861 between a non-diverting position (shown in FIGS. 18B and 18C) and a diverting position wherein a portion of the diverter projects into the lower transport path 1820D so as to divert a banknote from continuing along lower transport path 1820D and instead directs a bill or banknote into a respective storage bay 1760. The solenoid 1892 is controlled a processor or controller such as controller 202.

Referring to FIGS. 17A and 18A, when the banknote recycler is in a normal operating condition, the chassis 1704 is positioned within and secured in housing/safe 1702. In such a normal operable position, the right side of the main transport mechanism 1820 is positioned below the upper transport mechanism 1820_{U} so that banknotes placed in hopper 110 (not shown in FIG. 17A; see, e.g., FIG. 1A) are fed into the upper transport mechanism 1820_{U} and then into the main transport mechanism 1820, being received in the main transport mechanism 1820 in the direction as indicated in FIG. 18A by arrow 1820D. Likewise, in such an normal operable position, the right side of the main transport mechanism 1820 is positioned below the upper transport mechanism 1820_{U} so that banknotes may be transported from the main transport mechanism 1820 to the upper transport mechanism 1820_{U} in the direction as indicated in FIG. 18A by arrow 1820E and from the upper transport mechanism 1820_{U} to one or more open output receptacles such as output receptacles 140a, 140b (see, e.g., FIG. 1A). While being transported within the upper transport mechanism 1820_{U} banknotes may be routed through and analyzed (e.g., denominated, authenticated, etc.) by a banknote detector section 130 as described above in connection with FIGS. 1A-1H.

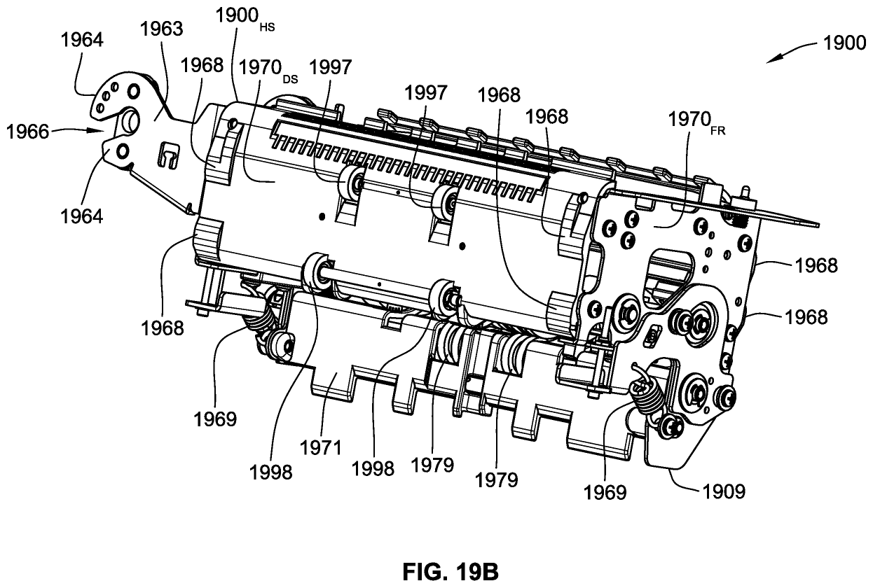

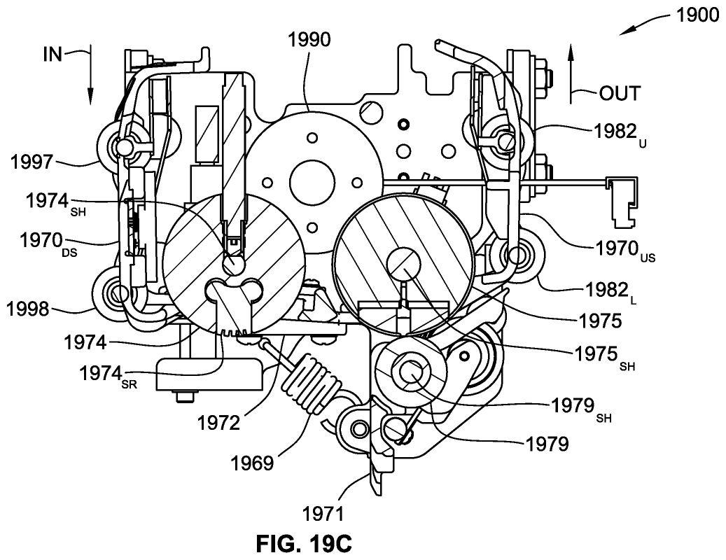

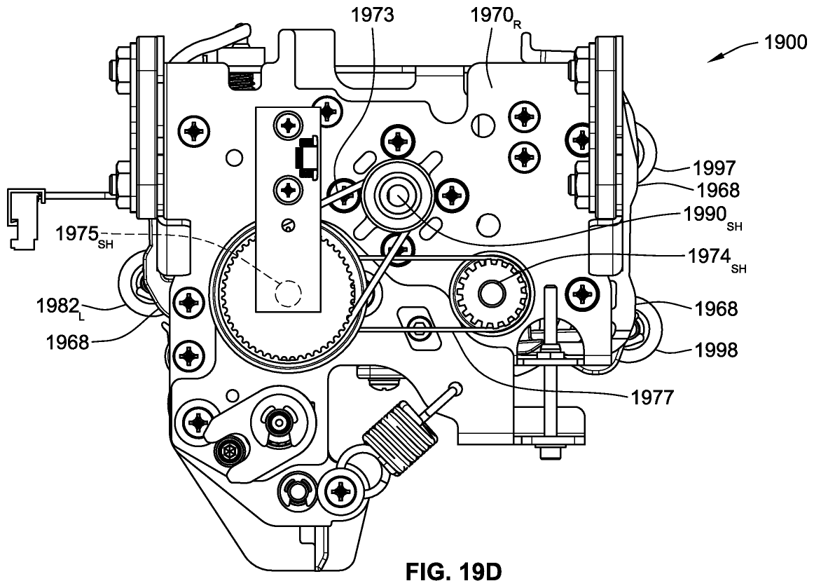

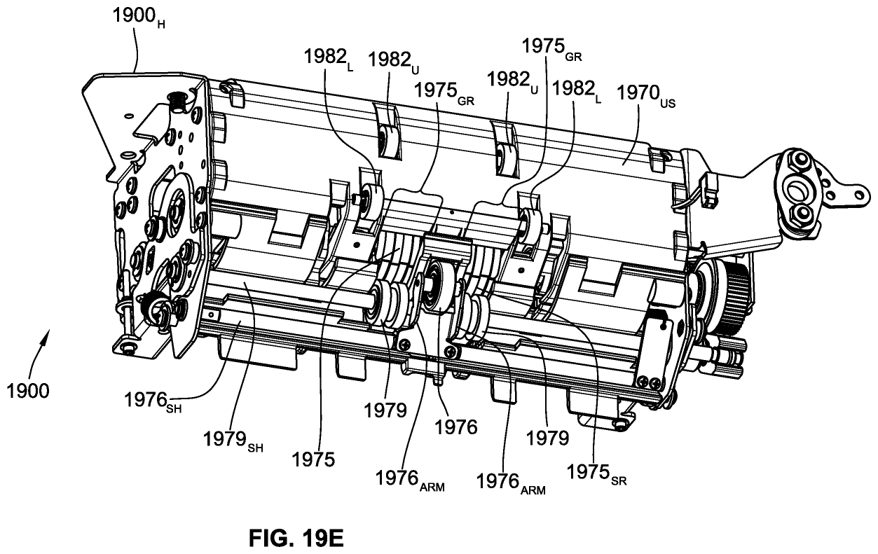

One of the feeder modules 1900 is described in more detail in connection with FIGS. 19A-19E. FIG. 19A is a perspective view illustrating an upstream, outfeed side 1970_{US}, FIG. 19B is a perspective view illustrating a downstream, infeed side 1970_{DS}, FIG. 19C is a cross-sectional view, FIG. 19D is a rear view, and FIG. 19E is an upward looking bottom perspective view of a feeder module 1900.

The feeder module 1900 may comprise a housing 1900_{HS} comprising an upstream side 1970_{US}, a downstream side 1970_{DS}, a front side 1970_{FR}, and a rear side 1970_{R}. The feeder module 1900 may also comprise one or more of a guide feeder entry wall 1971, a feeding plate 1972, positioning tabs 1968, upper in-feed passive rolls 1997, lower in-feed passive rolls 1998, feeder springs 1969, upper out-feed passive rolls 1982_{U}, lower out-feed passive rolls 1982_{L}, a feeder module motor 1990, stripping or auxiliary wheels 1974, a drive roll 1975, retard rollers 1979, and an idler roll 1976.

According to some embodiments, the feeder module 1900 assists with both the feeding of banknotes into a corresponding storage bay 1760 but also feeding of banknotes out of the storage bay. According to some embodiments, the feeder module 1900 comprises a banknote dispensing assembly that may comprises one or more stripping or auxiliary wheels 1974 and one or more drive rolls 1975. According to some embodiments, the dispensing assembly may also comprise one or more retard rollers 1979, one or more idler rolls 1976, and/or the feeder module motor 1990.

According to some embodiments, each feeder module 1900 have one or more electrostatic brushes 1900_{BR} (see, e.g., FIG. 19A). As banknotes enter the in-feed path 1900_{IN} (see, e.g., FIG. 17G-1), the banknotes engage the electrostatic brush 1900_{BR} will serves to remove or reduce the amount of electrostatic electricity existing on the banknotes. According to some embodiments, the electrostatic brushes 1900_{BR} are made of an electrically conductive material such as a metal such as copper and are electrically grounded.

According to some embodiments, the feeder modules 1900 have one or more arms 1963 extending from a rear side of the feeder module housing 1900_{HS}. Each arm 1963 has a pair of flanges 1964 with a slot 1966 therebetween. The feeder module 1900 may be pivotally coupled to the pivot bar 1708 (see FIGS. 18D and 17C) of the multiple storage bay chassis 1704 by fitting the flanges 1964 about the bar 1708 so that the bar 1708 is positioned within the slot 1966. According to some embodiment, the flanges 1964 may be secured to mounting brackets 1967 positioned about the bar 1708 passing through an aperture 1967_{A} of the mounting brackets 1967. According to some embodiments, the flanges 1964 are coupled to the mounting bracket 1967 using screws, nuts and bolts, or the like. To remove a feeder module 1900 from the banknote recycler 1700, the main transport mechanism 1820 is pivoted about bar 1708 and placed in an open, non-operational state such as shown in FIG. 17A, the feeder module 1900 is pivoted up so the front of the feeder module clears the multiple storage bay chassis 1704 (such as the position of feeder module 1900c shown in FIG. 17A) and the flanges 1964 of the feeder module 1900 are slid off of the bar 1708. If coupled to mounting brackets 1967, the flanges 1964 are decoupled from the mounting brackets 1967 (such as by unscrewing screws or removing bolts) prior to sliding the flanges 1964 off of the bar 1708. To install a feeder module 1900 into the banknote recycler, the flanges 1964 are slid about bar 1708 and the feeder module 1900 is pivoted downward into an operational position such as the position of feeder module 1900a shown in FIG. 17A. The flanges 1964 may then be coupled to mounting brackets 1967, if present. When removing a first feeder module 1900 from the banknote recycler 1700, for example, when the feeder module 1900 is not operating properly or otherwise needs service, a service personnel or technician may quickly disconnect any associated electrical connections (e.g., power, communications lines to one or more processors such as processor 202), remove the first feeder module 1900 as described above, insert another second feeder module 1900 as described above and reconnect the associated electrical connections.

Additionally, according to some embodiments, the feeder modules 1900 and the storage bay chassis 1704 are configured to allow a feeder module 1900 to self-center itself when lowered into its operating position (e.g., when lowered from the positions of feeder module 1900d shown in FIG. 17D to the position of feeder module 1900d shown in FIG. 17D) and/or when a replacement feeder module 1900 is installed during service of the banknote recycler 1700 by a service personnel or technician. Referring to, for example, FIGS. 17D and 17H, the storage bay chassis 1704 has a plurality of feeder module positioning flanges 1768 located on the upstream side and/or the downstream side near the top of each storage bay 1760. Similarly, referring to, for example, FIGS. 17D and 19A-19B, each feeder module has a plurality of feeder module positioning flanges 1968 located on the upstream side 1970_{US} and/or the downstream side 1970_{US} of the housing 1900_{HS} of the feeding module 1900.

According to some embodiments, when the feeder module 1900 is moved into its operational position, the positioning flanges 1968 of the feeding module contact the infeed upper wall 1799_{IN} and the outfeed upper wall 1799_{OUT} (see FIGS. 17G, 17G-1, 17D and 17H) and operate to accurately self-position the feeder module 1900 into its correct upstream-downstream position and vertical orientation above a given storage bay 1760.

According to some embodiments, the feeder module 1900 and chassis 1704 also comprise one or more components to ensure a feeder module 1900 when lower into its operational position is also accurately vertically positioned at a desired height. According to some embodiments, the feeder module 1900 comprises a front lower positioning flange 1909 (FIG. 19B) and the chassis 1704 has coupled thereto a feeder module positioning flange 1709 which according to some embodiments has a positioning receiving notch 1709_{N}. According to some embodiments, when the feeder module 1900 is moved into its operational position, the feeder module positioning flange 1709 nests into the bottom of the positioning receiving notch 1709_{N}. Accordingly, the height of the bottom of the positioning receiving notch 1709_{N} can be set to ensure the front of the feeder module self-positions itself at a desired height. Furthermore, according to some embodiments, the location of the positioning receiving notch 1709_{N} in a direction transverse to the upstream-downstream direction (in a front-back direction) can be set so that when the feeder module 1900 is moved into its operational position and the feeder module positioning flange 1709 nests into the bottom of the positioning receiving notch 1709_{N}, the front-back position of the feeder module is accurately set at a desired location. According to some embodiments, the vertical position of the rear of the feeder module 1900 may be accurately controlled by vertical position of the pivot bar 1708 and the configuration of the arms 1963 of the feeder module coupled to or engaging the pivot bar. As a result, according to some embodiments, a service personnel or technician does not need to spend time adjusting the position of a feeder module 1900 after it has been lowered into its operational position and the feeder module 1900 and mating components ensure the feeder module 1900 becomes automatically and accurately positioned in a proper upstream-downstream, front-back, vertical, and/or orientation.

According to some embodiments, other feeder module 1900 positioning components may be alternatively or additionally employed. For example, according to some embodiments, when the feeder module 1900 is moved into its operational position, pairs of the positioning flanges 1768, 1968 contact each other and self-position the feeder module 1900 into its correct position above a given storage bay 1760. For example, one positioning flange 1768 near the top of a given storage bay 1760 is located so as to contact a corresponding positioning flange 1968 located on a feeder module 1900 when the feeder module is lowered into and/or is in its operational position. According to some embodiments, there is at least one set of positioning flanges 1768, 1968 on both the upstream side and the downstream side above each storage bay 1760. According to some embodiments, each pair of positioning flanges 1768, 1968 has a complimentary shape so that the chassis positioning flanges 1786 support the feeder modules 1900 via the feeder module positioning flanges 1968 and limit the depth to which a feeder module 1900 moves when lowered into an operational position. In this way, according to some embodiments, the positioning flanges 1768, 1968 position both vertically and horizontally (upstream-downstream) a feeder module above a given storage bay 1760 in a desired operational position. According to some embodiments, however, the positioning flanges 1768, 1968 position horizontally (upstream-downstream) a feeder module above a given storage bay 1760 in a desired operational position whereas the vertical position of the front of the feeder module 1900 is controlled by a bottom surface of a handle 1900_{H} of the feeder module 1900 resting upon a front chassis rail 1704_{R} (see FIG. 17D) while the vertical position of the rear of the feeder module 1900 is controlled by coupling of the arms 1963 of the feeder module to the pivot bar 1708. As a result, according to some embodiments, a service personnel or technician does not need to spend time adjusting the position of a feeder module 1900 after it has been lowered into engagement with the chassis positioning flanges 1768.

According to some embodiments, each of the feeder modules 1900a-1900f are identical and interchangeable modules that may be quickly inserted into and/or removed from a storage bay 1760. Thus, when servicing banknote recycler 1700, if one or more of the feeder modules is not working properly, a service technician may quickly and easily remove a malfunctioning feeder module 1900 and replace it with another modular feeder module 1900. According to such embodiments, the banknote recycler may then be quickly serviced and placed back into normal operational use. According to some such embodiments, a malfunctioning feeder module may then be serviced at a different location such as at a service technician's or manufacturer's facility so as to minimize time during which a service technician would need to interfere with the normal operation and use of the banknote recycler such as by bank tellers.

Depositing/in-Feeding

With particular reference to FIGS. 17G, 17H and 19A-19E, in operation, banknotes to be stored in one of the storage bays 1760a-1760f are routed along transport path 1820D. If a banknote is to by-pass a storage bay 1760, the corresponding diverter 1861 is maintained in its non-diverting position and the driven transport rolls 1814 advance the banknote along the lower transport path 1820D past the diverter 1861 and toward the next storage bay 1760. If a banknote is to be directed into a storage bay 1760, the position of the corresponding diverter 1861 is moved to its diverting position wherein a portion of the diverter 1861 will project into the transport path 1820D so that the leading edge of the banknote being advanced by the driven transport rolls 1814 contacts the diverter 1861 and is directed downward along a lower surface of the diverter 1861, along an in-feed path defined between a downstream side 1970_{DS} of a feeding module 1900 on one side of the in-feed path and an upstream surface 1816_{US} of a banknote guide 1816 on the downstream side of the storage bay 1760 and an infeed upper wall 1799_{IN} above the storage bay 1760 on the other side of the in-feed path. While proceeding along the in-feed path, a banknote proceeds past one or more driven feeder rolls 1796 located on a downstream side of an upper end of a corresponding storage bay 1760 and one or more upper in-feed passive rolls 1997 and between one or more second driven feeder rolls 1798 located on an downstream side of the upper end of a corresponding storage bay 1760 and one or more lower in-feed passive rolls 1998 and then in between the fingers of the stacker wheels 2062. The driven feeder rolls 1796 are mounted on a feeder roll shaft 1796_{SH} and the driven feeder rolls 1798 are mounted on a feeder roll shaft 1798_{SH}.

The stacker wheels 2062 then stack the banknote onto a banknote support 2140 or, if there are already one or more banknotes stacked on the banknote support 2140, onto the top of the stack of banknotes being supported by banknote support 2140. The elevator 2110 may be slowly lowered as more banknotes are directed into storage bay 1760 so that the stacker wheels 2062 may stack incoming banknotes onto the top of the stack of banknotes being supported by banknote support 2140 wherein the top of the stack of banknotes is maintained generally at the same height. As the banknotes are not perfectly flat and may, in fact, have wrinkles and creases therein, as a stack of banknotes grows on the banknote support 2140, the stack of banknotes becomes to have a degree of vertical sponginess. According to some embodiments, the banknote recycler 1700 is operated at high speeds and can deliver notes from the storage bay transport path 1820D into a storage bay 1760 and onto and along the transport path 1820D and 1820E at a rate of at least 1000 bills/banknotes per minute.

Dispensing/Out-Feeding

Also with particular reference to FIGS. 17G, 17H and 19A-19E, at the top of the storage bay 1760 is a dispenser 1970. The dispenser 1970 comprises a feeding plate 1972 which forms a top surface of the storage bay 1760 and serves as a surface against which a stack of banknotes in the storage bay may be pressed during a dispensing or feeding out operation. During a dispensing operation, banknotes or bills that are stacked on an elevator banknote support 2140 of an elevator 2110 are stripped, one at a time, from the top of the stack. The bills are stripped by a pair of stripping wheels 1974 mounted on a stripping wheel driven shaft 1974_{SH} which, in turn, is supported across the front and rear walls 1970_{FR} and 1970_{R} of the feeder module 1900. The stripping wheels 1974 project through a pair of slots formed in the feeding plate 1972. According to some embodiments, part of the periphery of each stripping wheel 1974 is provided with a raised high-friction surface 1974_{SR} which engages the top bill of the stack as the stripping wheels 1974 rotate (counter-clockwise in FIG. 17G), to initiate feeding movement of the top bill from the stack. The high-friction surfaces 1974_{SR} may project radially beyond the rest of the wheel peripheries so that the stripping wheels intermittently contact the bill stack during each revolution so as to agitate and loosen the top currency bill within the stack, thereby facilitating the stripping of the top bill from the stack.

The stripping wheels 1974 feed each stripped bill into engagement with a drive roll 1975 mounted on a driven drive roll shaft 1975_{SH} supported across the front and rear walls 1970_{FR} and 1970_{R} of the feeder module 1900. As described and illustrated in more detail in U.S. Pat. No. 5,815,592 [Attorney Docket 247171-000131], incorporated herein by reference in its entirety, the drive roll 1975 may include a central smooth friction surface formed of a material such as rubber or hard plastic. This smooth friction surface is sandwiched between a pair of grooved surfaces 1975_{GR} having high-friction portions formed from a high-friction material. The drive roll 1975 is mounted to drive wheel shaft 1975_{SH} which is driven in a counter-clockwise in FIG. 17G during a banknote dispensing operation.

The high-friction surfaces engage each bill after it is fed into engagement with the drive roll 1975 by the stripping wheels 1974, to frictionally advance the bill along a narrow passageway. The rotational movement of the drive roll 1975 and the stripping wheels 1974 may be synchronized so that the high-friction surfaces on the drive roll 1975 and the stripping wheels 1974 maintain a constant relationship to each other. Moreover, according to some embodiments, the drive roll 1975 is dimensioned so that the circumference of the outermost portions of the grooved surfaces is greater than the width W of a bill, such as the width of the widest bill to be stacked in a corresponding storage bay 1760, so that the bills advanced by the drive roll 1975 are spaced apart from each other. That is, each bill fed to the drive roll 1975 is advanced by that roll only when the high-friction surfaces come into engagement with the bill, so that the circumference of the drive roll 1975 determines the spacing between the leading edges of successive bills.

According to some embodiments, the drive roll 1975 and the stripping wheels 1974 are driven by motor 1990 controlled by a controller or processor such as controller or processor 202. As shown in FIG. 19D, according to some embodiments, stripping wheel driven shaft 1974_{SH} is rotatably driven via belt 1977 coupled to driven drive roll shaft 1975_{SH} which is turn is coupled to motor shaft 1990_{SH} via belt 1973 which is rotatably driven by motor 1990.

According to some embodiments, to assist with stopping of feeding of banknotes from the stack in the storage bay 1760 on an exact note, independent of the size of the stack, the stripping wheels 1974 may be always stopped with the raised, high-friction portions 1974_{SR} positioned above the feeding plate 1972 of the storage bay 1760. This is accomplished by continuously monitoring the angular position of the high-friction portions of the stripping wheels 1974 via an encoder such as encoder 206, and then controlling the stopping time of the feeder module motor 1990 so that the motor 1990 always stops the stripping wheels 1974 in a position where the high-friction portions 1974_{SR} are located above the feeding plate 1972 of the storage bay 1760.

According to some embodiments, in order to ensure firm engagement between the drive roll 1975 and a currency bill or banknote being fed, an idler roll 1976 urges each incoming bill against the smooth central surface of the drive roll 1975. The idler roll 1976 is journalled on a pair of arms 1976_{ARM} (see FIG. 19E) which are pivotally mounted on a support shaft 1976_{SH}. Mounted on the shaft 1979_{SH}, on opposite sides of the idler roll 1976, are a pair of grooved guide wheels or retard rollers 1979. Grooves in these two retard rollers 1979 are registered with the central ribs in the two grooved surfaces 1975_{GR} of the drive roll 1975. The retard rollers 1979 are locked to the shaft 1979_{SH}, which in turn is locked against movement in the direction of the bill movement (clockwise as view in FIG. 17G) by a one-way clutch (not shown). Each time a bill is fed into the nip between the retard rollers 1979 and the drive roll 1975, the clutch is energized to turn the shaft 1979_{SH} just a few degrees in a direction opposite the direction of bill movement. These repeated incremental movements distribute the wear uniformly around the circumferences of the retard rollers 1979. Although the idler roll 1976 and the retard rollers 1979 are mounted behind a guideway, the guideway is apertured to allow the roll 1976 and the retard rollers 1979 to engage the bills being fed along the banknote passageway.

Turning back to FIGS. 17G and 19E, as mentioned above, when one or more banknotes are to be dispensed from the storage bay 1760, the elevator 2110 is raised (under control of a processor such as processor 202) to press a topmost banknote into engagement with a pair of stripping wheels 1974. The top banknote is moved into engagement with drive roll 1975 and retard rollers 1979. According to some embodiments, high-friction surfaces 1975_{SR} of drive roll 1975 engage each banknote after it is fed into the drive roll 1975 by the stripping wheels 1974, to frictionally advance the banknote into an out-feed path or passageway defined between an upstream side 1970_{US} of a feeding module 1900 on one side of the out-feed path and an outfeed upper wall 1799_{OUT} above the storage bay 1760 and a downstream upstream surface 1816_{DS} of a banknote guide 1816 on the upstream side of the storage bay 1760 on the other side of the out-feed path. While preceding along the out-feed path, a banknote proceeds between one or more second driven feeder rolls 1798 located on an upstream side of the upper end of a corresponding storage bay 1760 and one or more lower out-feed passive rolls 1982_{L} and one or more driven feeder rolls 1796 located on an upstream side of the upper end of a corresponding storage bay 1760 and one or more upper out-feed passive rolls 1982_{U} and then onto the transport path 1820D.

A banknote to be dispensed from a given storage bay 1760 is then routed along the transport path 1920d between the pair of spaced transport plates 1802, 1804. The banknote engages and is driven along the transport path 1820D by the driven transport rolls 1814 and a passive transport rolls 1812 positioned on the opposite side of the transport path 1820D and biased into engagement with the driven transport rolls 1814.

As can be seen in FIGS. 17D, 17G and 17H driven feeder rolls 1796 and 1798 are located above and between two storage bays 1760. According to some embodiments, one set of feeder rolls 1796 and 1798 positioned above and between two adjacent storage bays (e.g., 1760d and 1760e) is employed both to advance banknotes along an in-feed path at the downstream side of a first storage bay 1760, e.g., storage bay 1760d, and to advance banknotes along an out-feed path at the upstream side of an adjacent second storage bay 1760, e.g., storage bay 1760e. As illustrated, according to some embodiments, the driven feeder rolls 1796, 1798 are used to drive bills or banknotes both along in-feed and outfeed transport paths 1900_{IN} and 1900_{OUT}, but in opposite directions. The driven feeder rolls 1796 are coupled to and rotate about shafts 1796_{SH} and the driven feeder rolls 1798 are coupled to and rotate about shafts 1798_{SH}. According to some embodiments, one side of a driven feeder roll 1796, 1798 projects into the in-feed transport path 1900_{IN} of first storage bay 1760, e.g., storage bay 1760d, while an opposing side of the driven feeder roll 1796, 1798 projects into the out-feed transport path 1900_{OUT} of an adjacent second storage bay 1760, e.g., storage bay 1760e. The dual use of such driven feeder rolls 1796, 1798 contributes to a reduction in the number of components of the banknote recycler 1700 and also contributes to allowing adjacent storage bays 1760 to be positioned closer together. For example, according to some embodiments, the storage bay pitch 1760p of the storage bays 1760a-1760f (that is the horizontal distance between the same component in adjacent storage bays 1760a-1760f) is less than 7 inches (18 cm). For example, referring to FIG. 17H the storage bay pitch 1760p is illustrated as the horizontal distance between the center of the driven roll 1796 positioned between a first storage bay and second storage bay, e.g., storage bays 1760a and 1760b) and the center of a horizontally adjacent driven roll 1796 positioned between the second storage bay and a third storage bay, e.g., storage bays 1760b and 1760c). According to some embodiments, the storage bay pitch 1760p is less than 6 inches (15¼ cm). According to some embodiments, the storage bay pitch 1760p is about 5.3 inches (13.5 cm).

According to some embodiments, the use of the springs 1969 aids in biasing the retard rollers 1979 into contact with banknotes traveling along the out-feed transport path 1900_{OUT} while allowing the use of smaller retard rollers 1979 which in turn aids in making the feeder module 1900 and the overall recycler 1700 more compact.

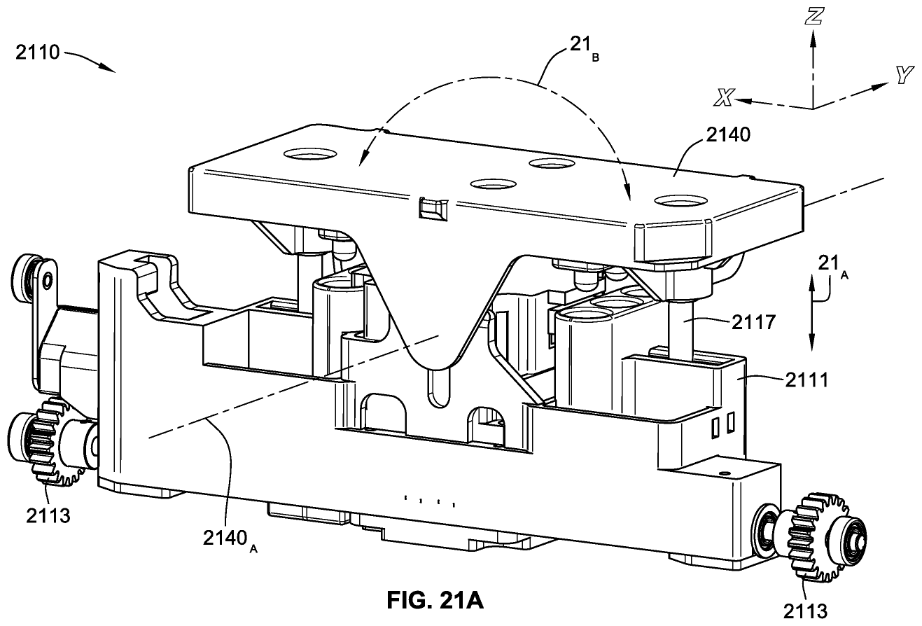

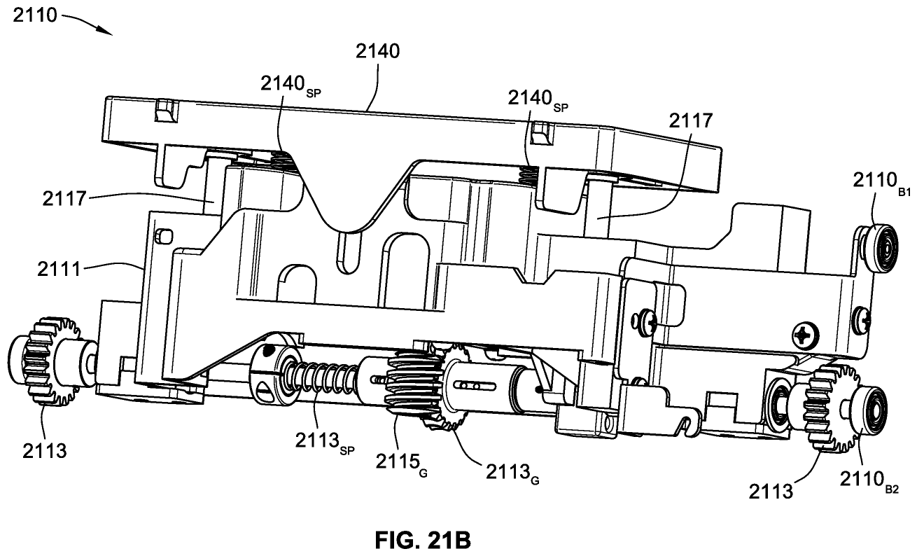

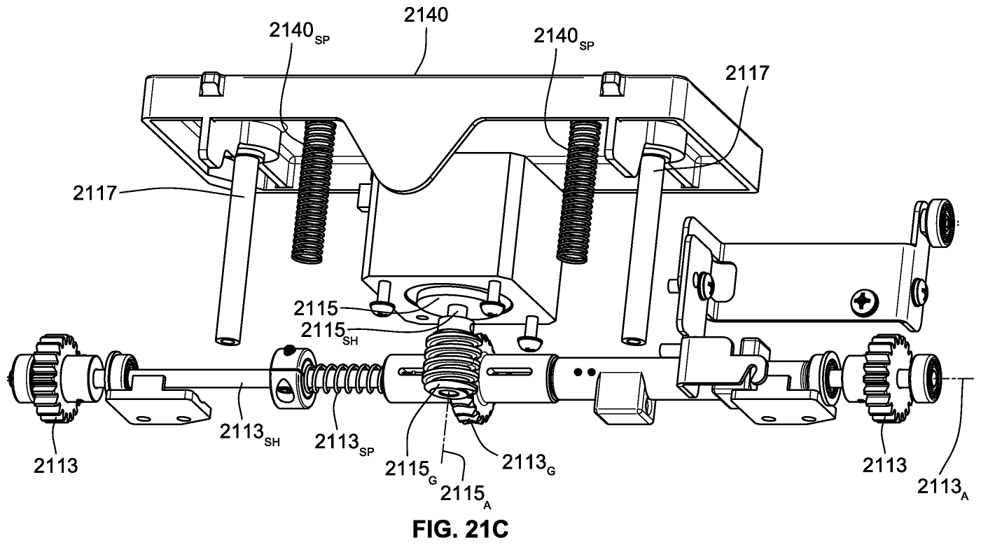

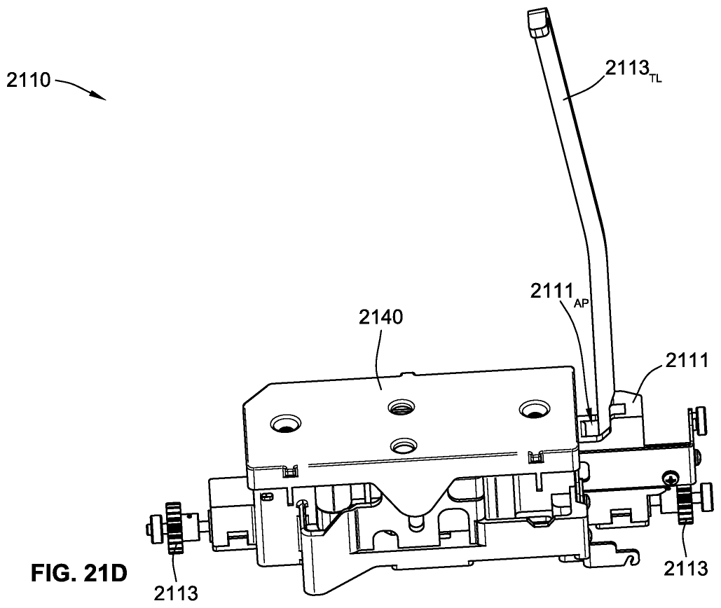

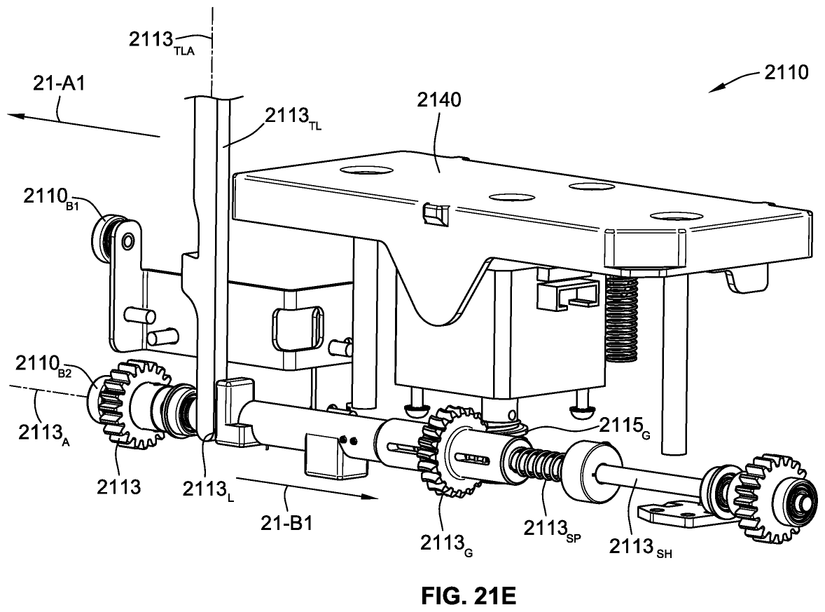

According to some embodiments, as will be described more in connection with FIGS. 21A-21C, elevator 2110 comprises a spring biased banknote support or platform 2140 mounted to the top of elevator 2110. According to some embodiments, a pressure sensor monitors pressure on the stripping wheel driven shaft 1974_{SH}. The pressure sensor and a motor controlling the movement of elevator 2110 may be coupled to a controller or processor such as controller or processor 202. The controller monitors the pressure sensor signals and controls the elevation and/or movement of the elevator 2110 based on the information derived from the pressure sensor such as by instructing the motor controlling the elevator 2110 movement to slow down or stop.

According to some embodiments, a banknote dispensing assembly 1970 for feeding banknotes, one at a time, out of the recycling or storage bay 1760 comprises stripping wheel 1974, drive roll 1975, and retard roller or nip roller 1979. The dispensing assembly 1970 is positioned near the upper end 1760_{UP} of the recycling or storage bay 1760. According to some embodiments, the stripping wheel 1974 comprises a pair of stripping wheels supported for rotational movement about the driven stripping wheel shaft 1974_{SH}, the drive roll 1975 comprises a pair of drive rolls, and the retard roller 1979 comprises a pair of nip rollers.

According to some embodiments, banknotes may be deposited into and dispensed from storage bay 1760 at a rate of at least 1000 banknotes per minute.

According to some embodiments, the distance between an upstream wall 1760_{US} and a downstream wall 1760_{PS} is between about 2.5 and 5.0 inches for storage bays 1760 configured to accept and dispense U.S. banknotes. According to some embodiments, the distance between an upstream wall 1760_{US} and a downstream wall 1760_{PS} is about 2¾ inches for storage bays 1760 configured to accept and dispense U.S. banknotes.

Stacker Modules

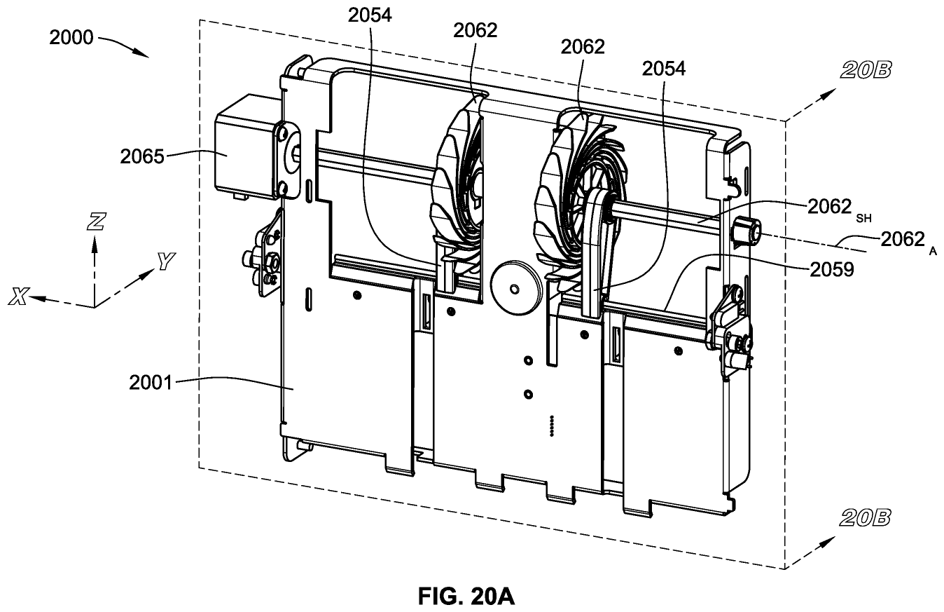

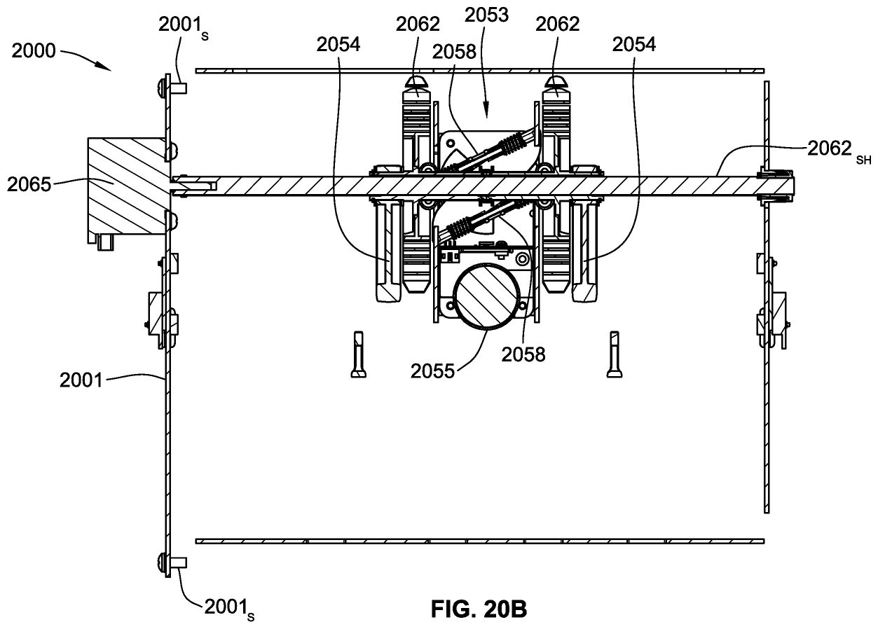

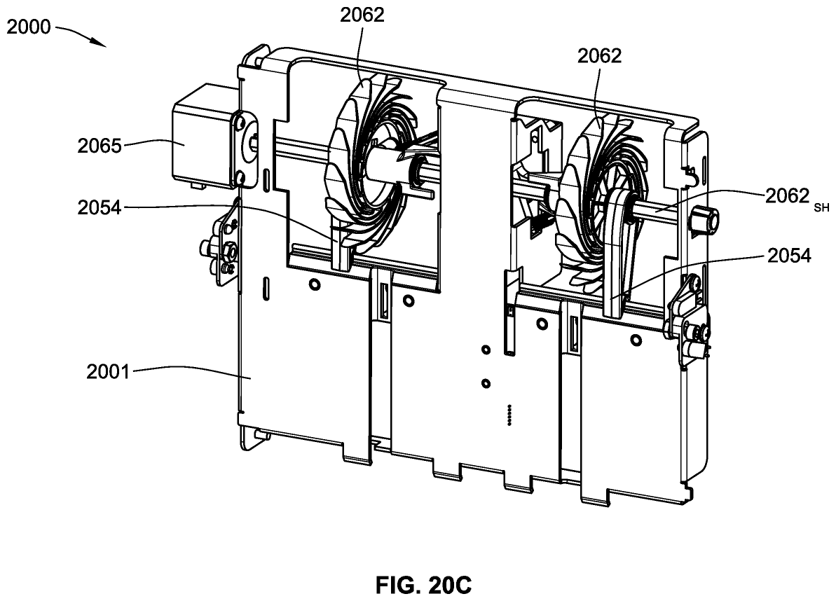

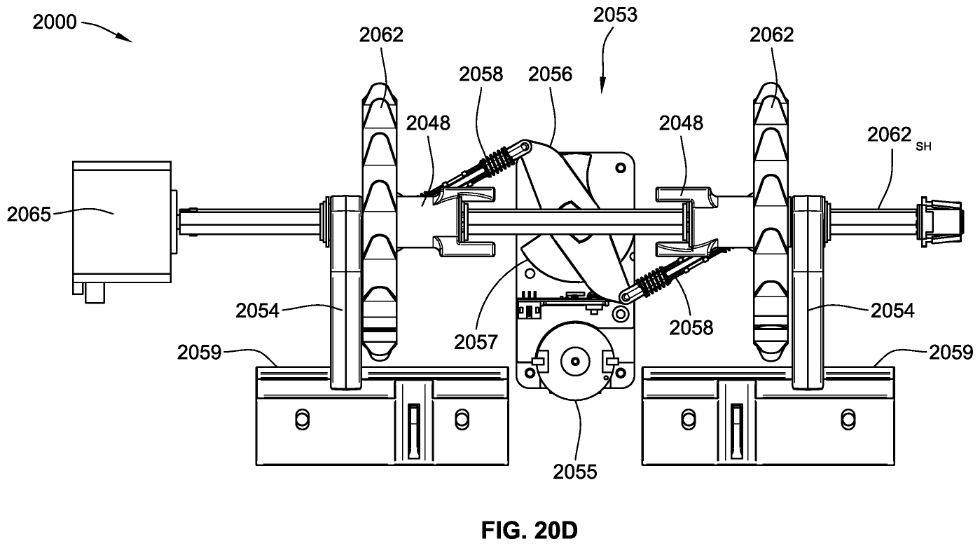

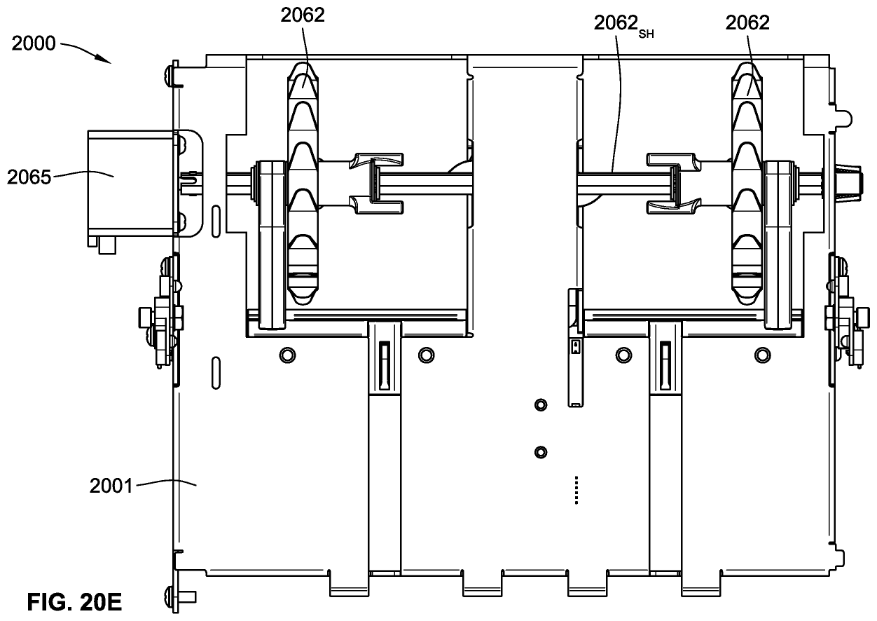

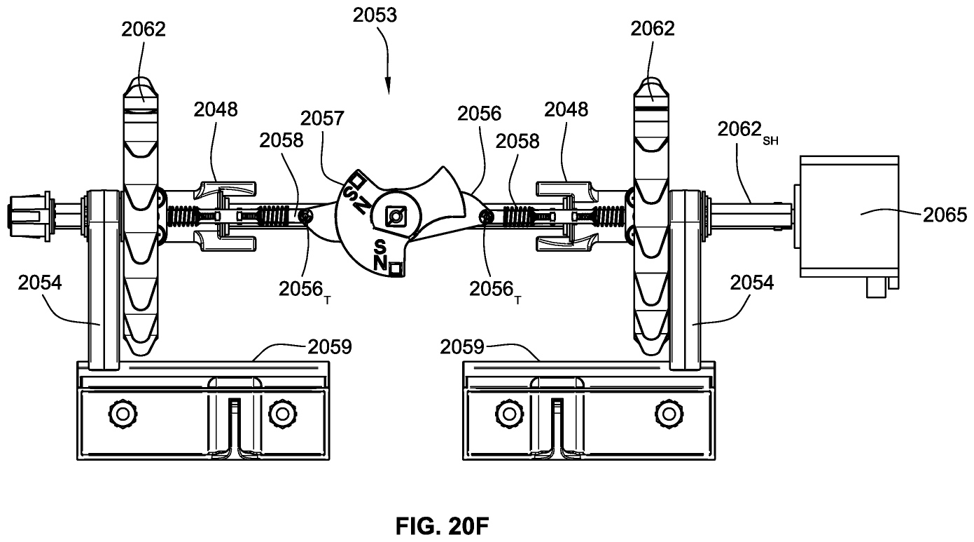

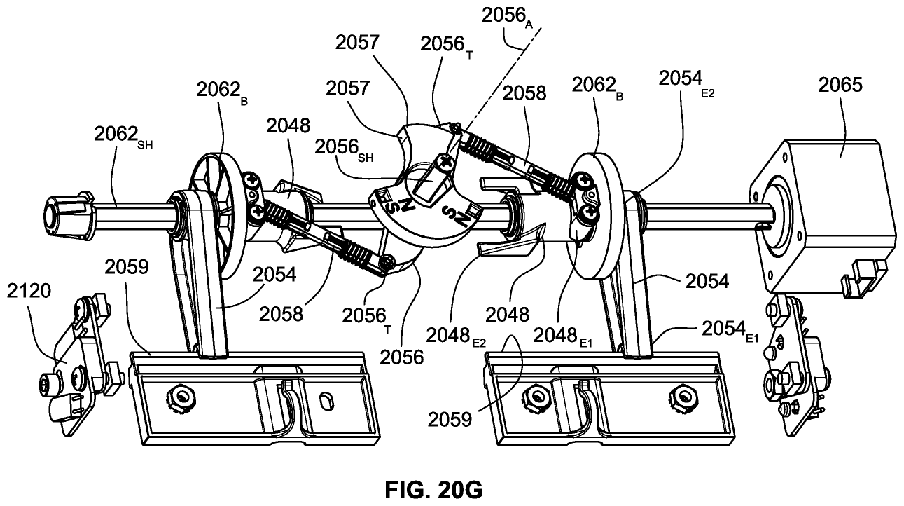

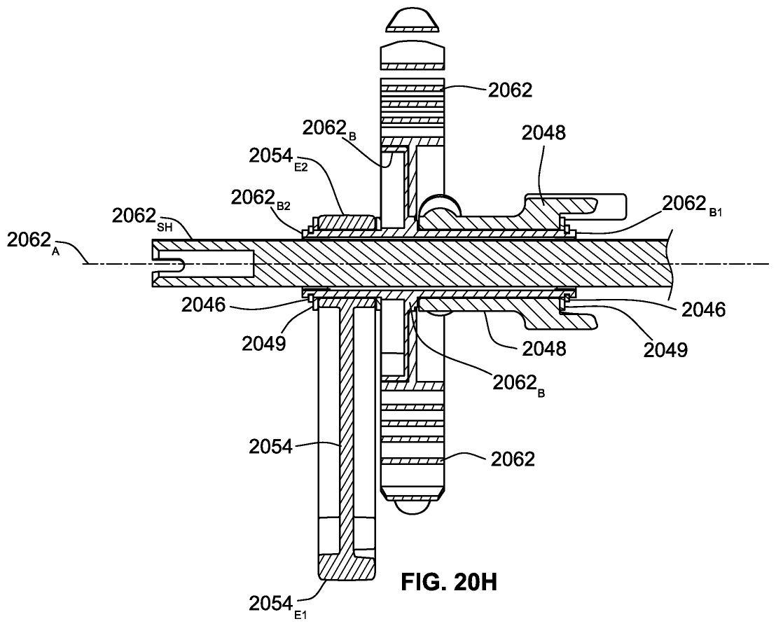

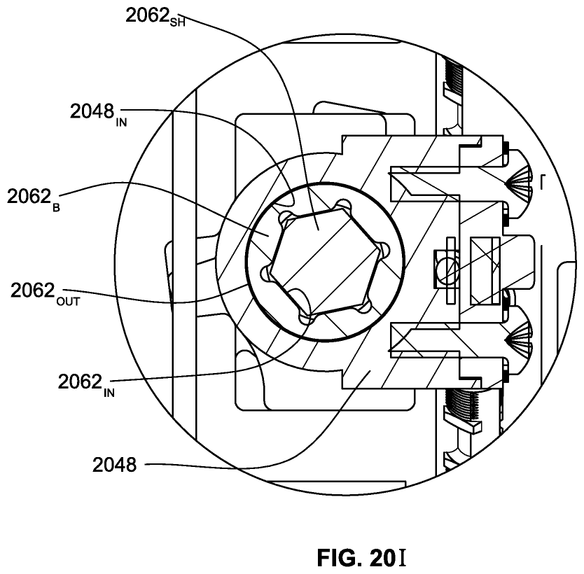

FIG. 20A is a perspective view of a stacker module 2000 having a pair of stacker wheels 2062 positioned at an inward, operational deposit or feed-in position and FIG. 20B is cross-sectional view of the stacker module of FIG. 20A in plane 20B-20B indicated in FIG. 20A. FIG. 20C is a perspective view of the stacker module 2000 having the pair of stacker wheels 2062 positioned at a transitional, non-operational position and FIG. 20D is front view of select components of the stacker module of FIG. 20C. FIG. 20E is a front view of the stacker module 2000 having the pair of stacker wheels 2062 positioned at an outward, non-operational dispense or feed-out position and FIG. 20F is rear view of select components of the stacker module of FIG. 20E. FIG. 20G is a perspective view of select components of the stacker module of FIG. 20C. FIG. 20H is a sectional view of a stacker wheel subassembly. FIG. 20I is cross-sectional view of a stacker wheels base 2062_{B} and linkage arm support 2048 mounted about a stacker wheel shaft 2062_{SH}.

According to some embodiments, banknotes are stacked in a respective one of the storage bays 1760a-1760f with the aid of a pair of stacker wheels 2062 mounted on a stacker wheel shaft 2062_{SH} which is rotationally driven by a stacker wheel motor 2065. The motor 2065 is controlled by a controller or processor such as controller or processor 202.

The pair of stacker wheels 2062 are supported for rotational movement about a driven stripper wheel shaft 2062_{SH}. The stripper wheel shaft 2062_{SH} is rotationally driven about a longitudinal axis 2062_{A} by the motor 2065. Each stacker wheel 2062 is laterally moveable along the stripper wheel shaft 2062_{SH}. The stacker module 2000 further comprises a stacker wheel positioning mechanism 2053 that adjusts the lateral positions of the pair of stacker wheels 2062 along the stripper wheel shaft 2062_{SH}.

According to some embodiments, the stacker module 2000 further comprises a pair of banknote stripping walls 2054. Referring to FIG. 20G, each banknote stripping wall 2054 has a first stripping wall end 2054_{E1} which may slide laterally along a recovery rail 2059 and a second stripping wall end 2054_{E2}. The first end 2054_{E1} of each banknote stripping wall 2054 has a notch therein configured accept therein the recovery rail 2059. The banknote stripping walls 2054 serve to strip banknotes residing in the fingers or vanes of the stripping wheels 2062 and cause them to be deposited onto the top of the elevator platform 2140 or the top of a stack of banknotes supported by the elevator platform 2140 residing in a storage bay 1760a-1760f.

During a banknote in-feed or deposit operation in which one or more banknotes are to be fed into a respective storage bay 1760a-1760f, the stacker wheels 2062 are moved into an inward, operational deposit or feed-in position as shown in FIGS. 20A-20B. During a banknote out-feed or dispense operation in which one or more banknotes are to be fed from a respective storage bay 1760a-1760f, the stacker wheels 2062 are moved to an outward, non-operational dispense or feed-out position as shown in FIGS. 20E-20F. FIGS. 20C-20D illustrate the stacker wheels 2062 in transition between the operational deposit and the non-operational dispense positions. The stacker wheel positioning mechanism 2053 is configured to adjust the lateral positions of the pair of stacker wheels 2062 along the stripper wheel shaft 2062_{SH} to the operational deposit and the non-operational dispense positions and the transitional positions therebetween. According to some embodiments, the stacker wheel positioning mechanism 2053 comprises a stacker wheel positioning motor or solenoid 2055, an elongated rotatable cam crank 2056, a pair of linkage arms 2058, a pair of stacker wheel bases 2062_{B} and a pair of linkage arm supports 2048. The motor or solenoid 2055 is configured to rotate the elongated rotatable cam crank 2056 about a cam axis 2056_{A}. According to some embodiments, the motor 2055 rotates a cam shaft 2056_{SH} about the cam axis 2056_{A} and the cam shaft 2056_{SH} rotates the cam crank 2056. The motor 2055 is controlled by a controller or processor such as controller or processor 202. A first end of each linkage arm 2058 is coupled to a respective outer end 2056_{T} of the elongated cam crank 2056 and a second end of each linkage arm 2058 is coupled to respective linkage arm supports 2048. Each linkage arm support 2048 comprises an outer end 2048_{E1} positioned away from the cam axis 2056_{A} and an inner end 2048_{E2} positioned closer to the cam axis 2056_{A} than the respective outer end 2048_{E1}. While the linkage arms 2058 are illustrated having an adjustable length, they may have a fixed length such as each being a bar or rod.

Referring to FIGS. 20H and 20I, according to some embodiments, each stacker wheel 2062 is fixedly coupled to an elongated stacker wheel base 2062_{B} having a central aperture in which a portion the stacker wheel shaft 2062_{SH} is positioned. The elongated stacker wheel base 2062_{B} has a first longitudinal end 2062_{B1} and a second longitudinal end 2062_{B2} wherein the first longitudinal end 2062_{B1} is positioned closer to the cam axis 2056_{A} than the respective second longitudinal end 2062_{B2}. According to some embodiments, the exterior cross-section of the stacker wheel shaft 2062_{SH} is non-circular (such as being hexagonal) and interior walls 2062_{IN} of the stacker wheel base 2062_{B} defining the aperture of stacker wheel base 2062_{B} have a conforming non-circular shape (such as hexagonal). Accordingly, when the stacker wheel shaft 2062_{SH} is rotated about its longitudinal axis 2062_{A}, the stacker wheel base 2062_{B} and the stacker wheel 2062 coupled thereto also rotate about the longitudinal axis 2062_{A}. Conversely, the outer wall 2062_{OUT} of the stacker wheel base 2062_{B} has a circular cross-section.

Each linkage arm support 2048 has a central longitudinal aperture therein having a interior wall 2048_{IN} having a circular cross-section. Each linkage arm support 2048 is positioned about the outer wall of the first longitudinal end 2062_{B1} of the stacker wheel base 2062_{B} such that that the first longitudinal end 2060_{B1} of the stacker wheel base 2062_{B} resides inside the central longitudinal aperture of the linkage arm support 2048. In similar fashion, the second stripping wall end 2054_{E2} of each stripping wall 2054 has a central longitudinal aperture therein having a circular cross-section and each second stripping wall end 2054_{E2} of each stripping wall 2054 is positioned about the outer wall of the second longitudinal end 2062_{B2} of the stacker wheel base 2062_{B} such that that the second longitudinal end 2062_{B2} of the stacker wheel base 2062_{B} resides inside the central longitudinal aperture of the second stripping wall end 2054_{E2} of each stripping wall 2054. According to some embodiments, a pair of retaining rings 2046 fixedly coupled to the ends of the stacker wheel base 2062_{B} keep the linkage arm support 2048 and the second stripping wall end 2054_{E2} of each stripping wall 2054 from sliding off of the first and second longitudinal ends 2062_{B1}, 2062_{B2} of the stacker wheel base 2062_{B} as the linkage arm support 2048, the stacker wheel base 2062_{B}, and the second stripping wall end 2054_{E2} of each stripping wall 2054 move longitudinally along the stacker wheel shaft 2062_{SH} (left and right in FIG. 20H). According to some embodiments, a pair of low friction washers 2049 are positioned between the ends of the stacker wheel base 2062_{B} and the retainer rings 2046.

While the stacker wheel base 2062_{B} and the stacker wheel 2062 coupled thereto also rotate about the longitudinal axis 2062_{A} when the stacker wheel shaft 2062_{SH} is rotated about its longitudinal axis 2062_{A}, due to the circular cross-sections of the outer wall of the stacker wheel base 2062_{B}, the central longitudinal aperture of the linkage arm support 2048, and the central longitudinal aperture of the second stripping wall end 2054_{E2} of each stripping wall 2054, the stacker wheel base 2062_{B} is free to rotate about the longitudinal axis 2062_{A} while the linkage arm support 2048 and stripping wall 2054 do not rotate about the longitudinal axis 2062_{A}. The connection of each linkage arm support 2048 to a linkage arm 2048 inhibits the linkage arm support 2048 from rotating about the longitudinal axis 2062_{A}. Likewise, the recovery rail 2059 residing in the notch in each first end 2054_{E1} of each banknote stripping wall 2054 inhibits each banknote stripping wall 2054 from rotating about the longitudinal axis 2062_{A}.

In FIG. 20G, the stacker wheels 2062 have been omitted in this figure to more clearly show the stacker wheel bases 2062_{B}, it being understood stacker wheels 2062 are coupled to the stacker wheel bases 2062_{B} such as shown in FIGS. 20A-20F and 20H. Referring to FIG. 20G which illustrates the stacker wheel bases 2062_{B} in transitional positions, to move the stacker wheels 2062 into the operational deposit position, the cam crank 2056 is rotated in a counter-clockwise direction (as viewed in FIG. 20G). Conversely, to move the stacker wheels 2062 into the non-operational dispense position, the cam crank 2056 is rotated in a clockwise direction (as viewed in FIG. 20G). According to some embodiments, the lateral position of the stacker wheels 2062 and/or components having a related laterally position such as, for example, the stripping walls 2054, the linkage arm support 2048, etc. are monitored and/or the rotational position and/or movement of the cam shaft 2056_{SH} is monitored and/or the timing of operation of the motor 2055 and electronic feedback is provided to a processor controlling the operation of the motor 2055 to assist with the movement of the stacker wheels 2062 from their operational, deposit position to their non-operational, dispense position and vice versa. Referring to FIG. 20G, according to some embodiments, a multi-position rotational indicator 2057 is coupled the cam shaft 2056_{SH}. In the embodiment shown in FIG. 20G, the indicator has two magnet positions with one having its north pole positioned radially outward and one having its south pole positioned radially outward and a third position having no magnet. An associated detector detects and monitors the rotational movement of the cam shaft 2056_{SH} by monitoring the movement of each of these positions past the detector which may be, for example, a Hall effect sensor. Other arrangements and/or sensors may alternatively or additionally be employed to monitor the movement of the stacker wheels 2062 such as switches, using a stepper motor with an encoder, placing physically stops to the movement of the stripper wheels when they reach either their operational, deposit position or their non-operational, dispense position and monitoring the resistance to the movement of the cam shaft 2056_{SH}, etc.

While the stacker wheels 2062 and stacker wheel bases 2062_{B} have been illustrated as two separate components, in some embodiments, each stacker wheel and stacker wheel base may be combined into a single integral part and/or comprise more than two parts.

The various components of the stacker module 2000 are coupled directly or indirectly to a removable stacker module mounting plate 2001. The stacker module mounting plate 2001 is mounted to near the upper end of a storage bay 1760a-1760f (see, e.g., FIG. 17F). According to some embodiments, the stacking module mounting plate 2001 is coupled to the storage bay chassis 1704 or walls of a storage bay 1760 using a few couplers such as nuts and bolts and/or screws 2001s so that an individual stacker module mounting plate 2001 may be quickly and easily installed and/or removed from a respective storage bay 1760a-1760f. According to some embodiments, the stacking module mounting plate 2001 is coupled to the storage bay chassis 1704 or walls of a storage bay 1760 using two nuts and bolts and/or screws 2001s. For example, if a first one of the stacker modules 2000 in a particular storage bay 1760a-1760f is not operating properly or otherwise needs service, a service personnel or technician may quickly disconnect the corresponding first stacker module mounting plate 2001 and associated electrical connections (e.g., power, communications lines to one or more processors such as processor 202), remove the corresponding first stacker module mounting plate 2001 from the top of the storage bay 1760a-1760f, insert another second stacker module 2000 coupled to another second stacker module mounting plate 2001, couple the second stacker module mounting plate 2001 to the frame or walls of the corresponding storage bay 1760a-1760f, and reconnect the associated electrical connections. According to some embodiments, the replacement of a second stacker module mounting plate 2001 may be accomplished by a service technician by first placing a portion of the transport mechanism 1820 in an open, non-operational position such as shown in FIG. 17A, moving a corresponding one of the feeder modules 1900a-1900f to an upper, non-operational position such as the position of feeder module 1900f in FIG. 17A and/or removing the corresponding feeder module 1900 from the chassis 1704, and then reaching into the top of the corresponding storage bay 1760a-1760f and removing the first stacker module mounting plate 2001 such as by uncoupling it from the chassis 1704 such as by removing screws or bolts 2001s.

According to some embodiments to replace a first stacker module 2000, a service personnel or technician may quickly disconnect the corresponding first stacker module mounting plate 2001 and associated electrical connections associated with a stacker module 2000 to be removed, remove the corresponding first stacker module mounting plate 2001 from a side of the storage bay 1760a-1760f such as via a front side of chassis 1704_{F}, insert another second stacker module 2000 coupled to another second stacker module mounting plate 2001 through the side of the storage bay 1760a-1760f such as via a front side of chassis 1704_{F}, couple the second stacker module mounting plate 2001 to the frame or walls of the corresponding storage bay 1760a-1760f, and reconnect the associated electrical connections. According to some such embodiments, a feeder module 1900 above the storage bay 1760 in which a stacker module 2000 is to be replaced does not have to be raised for removal of the stacker module 2000 or the insertion of a replacement stacker module 2000. According to some embodiments, each of the stacker modules 2000a-2000f are identical and interchangeable modules that may be quickly inserted into and/or removed from a storage bay 1760. Thus, when servicing banknote recycler 1700, if one or more of the stacker modules is not working properly, a service technician may quickly and easily remove a malfunctioning stacker module 2000 and replace it with another modular stacker module 2000. According to such embodiments, the banknote recycler may then be quickly serviced and placed back into normal operational use. According to some such embodiments, a malfunctioning stacker module may then be serviced at a different location such as at a service technician's or manufacturer's facility so as to minimize time during which a service technician would need to interfere with the normal operation and use of the banknote recycler such as by bank tellers.

As shown in FIG. 20A, during operation in which banknotes are to be fed or deposited into a recycling bay 1760, the lateral position of the stacker wheels 2062 is adjusted to the inward, operational position such that banknotes to be fed into the recycling bay 1760 are received by the stacker wheels 2062 and stacked onto top of an elevator platform 2140 or on top of a stack of banknotes being supported on the elevator platform 2140 of an elevator 2110 in the associated storage or recycling bay 1760. As shown in FIG. 20E, during operation in which banknotes are to be fed out of or dispensed from the recycling bay 2060, the lateral position of the stacker wheels 2062 is adjusted to an outward, non-operational position such that banknotes to be fed out the recycling bay are not engaged by the stacker wheels 2062 but instead are engaged by the stripping wheels 1974 which sequentially engage the topmost banknote stacked in the recycling bay 1760 and urge the topmost banknote into contact with the pair of drive rolls 1975 which act to feed banknotes out of the recycling bay, one bill at a time.

According to some embodiments, the stacking module 2000 also comprises one or more banknote drop-off detectors 2120. In operation, the banknote drop-off detector 2120 senses when the elevator 2110 and the banknote platform 2140 or top of the stack of banknotes are near or adjacent the stacking wheels 2062. According to some embodiments, the drop-off detectors 2120 employ a through light beam to detect the presence of banknotes, i.e., a light beam directed through a portion of the storage bay 1760 and detected by a detector 2120 wherein the presence of a banknote or the banknote platform 2140 blocks the light beam from reaching the detector 2120. According to some embodiments, one or more other types of detectors 2120 may be employed instead of a through light beam detector. The signal or signals from the detectors may be coupled to a processor such as processor 202 so that the elevator 2110 may be positioned at a desirable height to facilitate smooth stacking of banknotes onto the elevator platform 2140 or on to the top of a stack of banknotes residing thereon.

According to some embodiments, during operation in which banknotes are to be fed or deposited into a recycling bay 1760, a coordinated set of tamping devices will make repeated hits against the edges of the banknotes as the banknotes are engaged in the stacker wheels 2062 and against the edges of the top-most portion of the stack of banknotes being supported on the elevator platform 2140 of an elevator 2110. In operation, the coordinated set of tamping devices will urge the edges of the banknotes to be in alignment, so as to reduce or eliminate the chance a banknote will be in a position which will cause an error when that banknote is to be fed out of the recycling bay 1760. According to some embodiments, the coordinated set of tamping devices act only on the short or narrow sides of the banknotes, moving them to be centered about the stripping wheels 1974. According to some embodiments, the coordinated set of tamping devices act only on the wide or long side of the banknotes which are against downstream wall 1760_{PS}. According to some embodiments, the coordinated set of tamping devices act only on the wide or long side of the banknotes which are against upstream wall 1760_{US}. According to some embodiments, the coordinated set of tamping devices act on the wide or long side of the banknotes which are against downstream wall 1760_{DS} and the narrow or short sides of the banknotes. According to some embodiments, the coordinated set of tamping devices act on the wide or long side of the banknotes which are against upstream wall 1760_{US} and the narrow or short sides of the banknotes. According to some embodiments, the coordinated set of tamping devices act on the wide, long sides of the banknotes which are against downstream wall 1760_{DS} and on the wide, long side of the banknotes which are against the upstream wall 1760_{US} and the narrow, short sides of the banknotes. According to some embodiments, the coordinated set of tamping devices are actuated to make repeated hits against the edges of the banknotes by direct or indirect contact with cam devices located on the stacker wheel shaft 2062_{SH}. According to some embodiments, some of the coordinated set of tamping devices are actuated to make repeated hits against the edges of the banknotes by a motor or solenoid controlled by one or more processors or controllers such as processor 202.

Elevator

FIG. 21A is a side perspective view of a storage bay elevator 2110, FIG. 21B is an upward perspective view of the elevator 2110, and FIG. 21C is a bottom perspective view of select components of the elevator 2110.

The elevator 2110 has a lower housing 2111 and a banknote support or platform 2140. According to some embodiments, the platform 2140 is flexibly coupled to the lower housing 2110 such that the platform 2140 may move up and down (see arrow 21_{A}) relative to the lower housing 2110. According to some embodiments, the platform 2140 is also pivotally coupled to the lower housing 2111 such that it may rotate about a pivot axis 2140_{A} (see arrow 21_{B}) with the pivot axis 2140_{A} also being moveable up and down (see arrow 21_{A}). According to some embodiments, the banknote support or platform 2140 is biased such as by one or more platform springs 2140_{SP} upward away from the lower housing 2111 in each storage bay 1760a-1760f in a generally horizontal manner. According to some embodiments, the platform springs 2140_{SP} permit a range of pivot or tilt of the platform 2140 about the pivot axis 2140_{A} and a range of downward movement of the platform 2140 relative to the lower housing 2111 while the spacers 2117 limit that range of tilt and/or downward movement. According to some embodiments, the spacers 2117 allow the banknote support or platform 2140 to pivot about axis 2140_{A} as previously described without allowing the banknote support or platform 2140 to pivot in any other direction. According to some embodiments, the spacers 2117 may be molded as an integral part of the platform 2140 or may be form as separate parts from the platform 2140

The elevator 2110 also comprises a pair of driven elevation gears 2113 that engage a pair of geared elevator tracks 2114 (see e.g., FIGS. 17F-17H) positioned on and coupled to an upstream wall 1760_{US} of each storage bay 1760a-1760f. The driven elevation gears 2113 are fixedly mounted on a rotatable elevation gear shaft 2113_{SH} which is rotatable about axis 2113_{A}. The driven elevation gears 2113 are driven by an elevation motor 2115 coupled to the elevation gears 2113. The elevation motor 2115 is communicatively coupled to and controlled by a controller or processor such as controller or processor 202.

According to some embodiments, the elevation motor 2115 drives an elevation motor shaft 2115_{SH} to rotate about an elevation motor shaft axis 2115_{A}. An elevation motor worm gear 2115_{G} is fixedly coupled to the elevation motor shaft 2115_{SH} and drives one or more elevation shaft worm gears 2113_{G} fixedly coupled to the elevation gear shaft 2113_{SH}. As illustrated in FIGS. 21B-21E, a single elevation shaft worm gear 2113_{G} is employed. According to some embodiments, the elevation gear shaft 2113_{SH} is arranged at a right angle to the elevation motor shaft 2115_{SH}.

A banknote or a stack of banknotes stacked on the banknote support or platform 2140 can be moved up and down within a storage bay 1760a-1760f by the elevator 2110 being moved up and down.

Depositing/in-Feeding

As explained above, during a depositing, in-feed operation, the stacker wheels 2062 stack an in-coming banknote onto the banknote support 2140 or, if there are already one or more banknotes stacked on the banknote support 2140, onto the top of the stack of banknotes being supported by banknote support 2140. The elevator 2110 (under control of a processor or controller such as controller 202) may be slowly lowered as more banknotes are directed into storage bay 1760 so that the stacker wheels 2062 may stack incoming banknotes onto the top of the stack of banknotes being supported by banknote support 2140 wherein the top of the stack of banknotes is maintained generally at the same height. As the banknotes are not perfectly flat and may, in fact, have wrinkles and creases therein, as a stack of banknotes grows on the banknote support 2140, the stack of banknotes becomes to have a degree of vertical sponginess.

According to some embodiments, when a number of banknotes below a certain threshold are stacked on the banknote platform 2140, the platform springs 2140_{SP} bias the banknote platform 2140 upward away from the lower housing 2111 and when more than the threshold number of banknotes are stacked on the banknote platform 2140, the weight of the stack of banknotes overcomes the bias of the platform springs 2140_{SP} such that the banknote platform 2140 moves to its lowest point relative to the lower housing 2111 as may be dictated by spacers 2117. According to some embodiments, the platform springs 2140_{SP} are selected so that threshold number of banknotes is relatively low, e.g., about 30 banknotes. According to some embodiments, the platform springs 2140_{SP} are selected so that threshold number of banknotes is, e.g., about 300 banknotes. According to some embodiments, the platform springs 2140_{SP} are selected so that threshold number of banknotes is, e.g., about 250 banknotes. According to some embodiments, the platform springs 2140_{SP} are selected so that threshold number of banknotes is between about 240-360 banknotes. According to some embodiments, the platform springs 2140_{SP} are selected so that threshold number of banknotes is higher such that the banknote platform 2140 remains biased away from the lower housing 2111 even when a relatively large number of banknotes are stacked on the platform.

Dispensing/Out-Feeding/Contact Force Measurement

During a feed-out or dispense operation, as discussed above in connection with FIG. 17G, when one or more banknotes are to be dispensed from the storage bay 1760, the elevator 2110 is raised (under control of a processor such as processor 202) to press a topmost banknote into engagement with the pair of stripping wheels 1974. According to some embodiments, the pressure or contact force the top of the stack of banknotes applies to the stripping wheels 1974 and/or the feeding plate 1972 is monitored and the feedback from monitoring this pressure is used to control the elevation of the elevator 2110 and/or banknote platform 2140 so that the applied pressure or contact force is maintained within an acceptable range. According to some embodiments, one or more pressure sensors are employed to monitor the pressure or contact force exerted on the stripping wheels 1974 and/or the feeding plate 1972. The one or more pressure sensors generate a pressure signal indicative of the amount of pressure measured by a corresponding pressure sensor.

The output of the one or more sensors may be communicatively coupled to a controller or processor such as controller or processor 202 that controls the operation of elevation motor 2115 that controls the movement of the elevator 2110 (and/or the other elevators described herein) such as by communicating a pressure sensor to the processor. The controller or processor monitors the pressure sensor signal(s) and controls the elevation and/or movement of the elevator 2110 based on the information derived from the pressure sensor(s) such as by instructing the elevation motor 2115 controlling the elevator 2110 movement to slow down or stop or reverse direction so that the applied pressure or contact force by the top of the stack of banknotes on the stripping wheels 1974 and/or the feeding plate 1972 is maintained within an acceptable range. If the measured pressure is within the acceptable range, the feeding out operation is continued, e.g., stripping wheels 1974 and drive roll 1975 continue to rotate, and the elevator 2110 is maintained at its current position. When the measured pressure falls below a lower threshold value for the acceptable range, the elevator 2110 is raised (by signaling the elevator motor 2115 to rotate so as to raise the elevator) until the measured pressure again until the measured pressure is within the acceptable range, at which point the elevator 2110 is held at its current position (by signaling the elevator motor 2115 to stop) The feeding out operation is then continued, e.g., stripping wheels 1974 and drive roll 1975 rotate. This automated, self-regulating process continues until banknotes are no longer to be feed out of a corresponding storage bay 1760 and the feed-out or dispense operation is discontinued.

According to some embodiments, upon the initiation of a dispensing operation, the elevator 2110 is slowly raised and the controller monitors the pressure sensor signal. When the pressure sensor signal exceeds a first target threshold indicative that the amount of pressure is at a desired or optimal level, the controller instructs the elevator motor 2115 to stop causing the elevator 2110 to stop being raised. The controller then instructs a banknote dispensing assembly to start so that banknotes begin to be fed out of the banknotes storage bay. According to embodiments employing the feeder module 1900, the controller is communicatively coupled to feeder motor 1990 and instructs it to begin rotating which in turn causes stripping wheels 1974 and drive roll 1975 to being rotating. As banknotes are fed out of the storage bay, the level of the pressure sensor signal will begin to fall. When the pressure sensor signal falls below a first lower threshold, the controller instructs the elevator motor 2115 to begin rotating to cause the elevator 2110 to begin being raised. When the pressure sensor signal again exceeds the first target threshold indicative that the amount of pressure is at a desired or optimal level, the controller instructs the elevator motor to stop causing the elevator 2110 to stop being raised. According to some embodiments, between the time when the pressure sensor signal falls below the first lower threshold and the time it again exceeds the first target threshold, the controller signals the feeder motor 1990 to stop rotating. According to some alternative embodiments, between the time when the pressure sensor signal falls below the first lower threshold and the time it again exceeds the first target threshold, the feeder motor 1990 continues to rotate. According to some such alternative embodiments, the controller may signal the feeder motor 1990 to stop rotating if the pressure sensor signal falls below a second lower threshold which is lower than the first lower threshold.

The applied pressure or contact force by the top of the stack of banknotes on the stripping wheels 1974 and/or the feeding plate 1972 can be sensed either directly or indirectly. An embodiment for measuring the contact force indirectly can be understood with reference to FIG. 19F. FIG. 19F is a schematic view of a pressure or contact force sensor 1974_{SN} used to measure a displacement of the stripping wheel driven shaft 1974_{SH}. Referring to FIG. 19F, according to some embodiments, the pressure exerted by banknotes on the stripping wheels is monitored indirectly by a sensor 1974_{SN} which monitors the vertical displacement of the stripping wheel driven shaft 1974_{SH} such as by repeatedly measuring the gap, G, between the sensor 1974_{SN} and the stripping wheel driven shaft 1974_{SH}. According to some embodiments, the controller 202 and sensor 1974_{SN} operate in a self-calibrating manner by using measurements from sensor 1974_{SN} when the elevator 2110 has been lowered so that the top banknote does not contact the stripping wheels 1974 and/or the feeding plate 1972 (such as when the elevator 2110 and the banknotes stacked thereon are in an in-feed, receiving position) and using such measurements to establish a no-load baseline for the sensor 1974_{SN}. Generally speaking, in such a position, at any given stripping wheel 1974 rotary position, for embodiments in which the contact force is measured directly, the controller 202 sets the measured force to correspond to “zero” contact force between stripping wheels and the top of the stack. For embodiments in which the contact force is measured indirectly by measuring displacement of some portion or portions of the stripping wheel(s) 1974 or stripping wheel shaft 1974_{SH}, the controller 202 sets the measured displacement/position as corresponding to a “zero” contact force between stripping wheels 1974 and the top of the stack of banknotes. According to some embodiments employing indirect measurement by measuring the amount of deflection of the stripping wheel shaft 1974_{SH} (such as shown in FIG. 19F) the controller factors into consideration a known spring constant for the stripping wheel shaft 1974_{SH}.

According to some embodiments, upon the initiation of a feed-out or dispense operation, the stripping wheels 1974 and drive roll 1975 are not rotated while the stack of banknotes supported by banknote platform 2140 is raised. As the top of the stack of banknotes starts to contact the stripping wheels 1974 a contact force begins to build up as the elevator 2114 continues to rise and the stack of banknotes begins to compress. Once the measured contact force reaches a target threshold value within the acceptable range, the controller 202 stops raising the elevator (by instructing the elevator motor 2115 to stop). At this point, the controller 2002 may initiate feeding out banknotes by instructing the feeder module motor 1990 to rotate the stripping wheel shaft 1974_{SH} and the drive roll shaft 1975_{SH}.

The controller 202 continues to monitor the contact as the stripping wheel shaft 1974_{SH} rotates and as banknotes are being fed out. According to some embodiments, since realistic parts will have tolerances and run-outs associated with them, the controller 202 may average measurements over a single or a plurality of revolution cycles. According to some embodiments, the controller 202 could monitor the contract force mapped based on encoder position(s) and compare to an encoder-position based calibration. In conjunction with the sponginess of the note stack (or on shorter stacks with the help of the paddle springs) this will guarantee a fairly consistent contact pressure.

As explained above, the pressure or contact force between the top of a stack of banknotes and stripping wheels 1974 and/or the feeding plate 1972 can be sensed either directly or indirectly. According to some embodiments and with reference to FIG. 19F, the stripping wheel shaft 1974_{SH} is employed as a spring whereby the middle part of the stripping wheel shaft 1974_{SH} is allowed it to flex up in the center as a stack of banknotes is pressed into the stripping wheels 1974. One or more sensors 1974_{SN} is positioned vertically above stripping wheel shaft 1974_{SH} and measures the distance G between the sensor 1974_{SN} and the top of the stripping wheel shaft 1974_{SH}. The measurements are used to determine the amount of deflection (as a displacement measurement) of the stripping wheel shaft 1974_{SH} as an indirect measure for the contact load by the top of the banknotes onto the stripping wheels 1974. The spring constant of the shaft 1974_{SH} (as a in bending deflecting spring is either known by design or determined by experiment) may be employed in determining the contact force. According to some such embodiments, the shaft deflection is measured/sensed in or near the center of the shaft 1974_{SH} (as shown in FIG. 19F), but alternatively could be measured in other locations along the shaft 1974_{SH}. According to some such embodiments, sensor 1974_{SN} is a proximity sensor such as a coil is oriented vertically above the shaft 1974_{SH}, sensing directly the change in the vertical gap, G.

According to some embodiments, the contact force is determined by measuring the 1974_{SH} bending strain.

According to some embodiments, a stiffer stripping wheel shaft 1974_{SH} is employed and has bearings at each end thereof guided in such a way that the ends of the shaft 1974_{SH} can move up and down. According to some such embodiments, the ends of the shaft 1974_{SH} are spring loaded with known spring constants downward. According to such embodiments, the shaft 1974_{SH} can move up and down as a whole and the position of the shaft is measured as an indication of the contact force of the top of the stack of banknotes on the stripping wheels 1974.

According to some embodiments and with reference to FIG. 19F, the stripping wheel shaft 1974_{SH} is employed as a spring whereby the middle part of the stripping wheel shaft 1974_{SH} is allowed it to flex up in the center as a stack of banknotes is pressed into the stripping wheels 1974 and one or more sensors 1974_{SN} are positioned horizontally to the side of the stripping wheel shaft 1974_{SH}, near the middle of the stripping wheel shaft 1974_{SH}. The horizontally offset sensor(s) 1974_{SN} measure the shaft displacement. According to some such embodiments, a sensor arrangement 1974_{SN} comprises two integral hall effect sensors, slightly vertically offset with respect to each other, positioned within a common housing. The two integral hall effect sensors look at the shaft 1974_{SH} horizontally. The sensor arrangement 1974_{SN} measures the signal differential between the two hall effect sensors only. For example, when the shaft 1974_{SH} moves (deflects) up, the upper sensor reads more signal and the lower sensor less and when the shaft 1974_{SH} moves (deflects) down, the upper sensor reads less signal and the lower sensor more. According to some embodiments, if the shaft 1974_{SH} moves (within limits) horizontally to and from sensor arrangement 1974_{SN}, there is no change to the signal differential and hence no vertical deflection is (correctly) detected.

According to some embodiments, shaft displacement stripping wheel shaft 1974_{SH} may measured by two sensors by measuring the vertical displacement of each of two spring loaded bearing/bearing blocks at the ends of the stripping wheel shaft 1974_{SH}.

According to some embodiments, force sensors are placed over vertically guided bearing blocks at each end of the stripping wheel shaft 1974_{SH}. As the shaft gets pushed up, force sensors generate a direct force read-out (signal).

According to some embodiments including those described in the preceding paragraphs, measuring the displacement of the rotating shaft 1974_{SH} is performed by one or more non-contact sensors such as hall effect sensors, proximity sensors (coils) or optical sensors. Alternatively or additionally, according to some embodiments including those described in the preceding paragraphs, measuring the displacement of the rotating shaft 1974_{SH} is performed by one or more sensors that require contact with the rotating shaft 1974_{SH} (e.g. by an LVDT or a contact lever leading to a sensor or even by a micro switch set to a certain trigger point) and may employ a bearing added to make the area of contact non-rotating if need be.

According to some embodiments, a bearing is added to the center of the shaft 1974_{SH}, creating a non-rotating area onto which a lever can contact may be employed to allow for a direct force measurement in or near the center of the shaft.

According to some embodiments, a combination of compression or extension springs and limit switches are employed to provide feedback to the elevator motor 2115 and may be employed to maintain near constant contact pressure of the top of the stack of banknotes against stripping rollers 1974. According to some such embodiments, the use of the combination of compression or extension springs and limit switches does not require constant monitoring the pressure or contact force on the shaft 1974_{SH}, and thus, may be employed to reduce the duty cycle of the motor 2115.

As discussed above, the platform 2140 is initially maintained in a generally horizontal manner or plane as banknotes are deposited on top of the platform 2140. However, because banknotes may be crinkled and/or creased as banknotes are stacked on top of each other, the top banknote may become to lie in a non-horizontal plane. During a feed-out or dispense operation, as discussed above in connection with FIG. 17G, when one or more banknotes are to be dispensed from a storage bay 1760, the elevator 2110 is raised (under control of a processor such as processor 202) to press a topmost banknote into engagement with the pair of stripping wheels 1974. To accommodate for the fact that the top banknote may come to lie in a tilted, non-horizontal manner, as described above the platform 2140 is flexibly coupled to the lower housing 2110 such that the platform 2140 may move up and down (see arrow 21_{A}) relative to the lower housing 2110 and to also rotate about a pivot axis 2140_{A} (see arrow 21_{B}) with the pivot axis 2140_{A} also being moveable up and down (see arrow 21_{A}). The ability of the platform 2140 to pivot helps compensate for the height of one side of a stack of banknotes differing from the height of another side of the stack of banknotes. For example, when a stack of banknotes has an uneven height, e.g, the height left side of the stack is greater than the height of the right side of the stack, when the top banknote is pressed into engagement with a pair of stripping wheels 1974 the elevator platform 2140 can pivot so that a more even amount of pressure may be applied over the face of the top banknote as it is pressed against the stripping wheels 1974 and/or the feeding plate 1972, such as by the left side of elevator platform pivoting or being compressed downward due to the greater height of the left side of the stack of banknotes, provided the weight of the stack of banknotes has not overcome the upward bias forces of the platform springs 2140_{SP}. Additionally, the sponginess of the stack of banknotes may also help to even amount of pressure may be applied over the face of the top banknote as it is pressed against the stripping wheels 1974 and/or the feeding plate 1972 as the stack of banknote initially compresses as it is pressed against the stripping wheels 1974 and/or the feeding plate 1972.

Additionally, the initial sponginess of a stack of banknotes and/or the ability of the platform 2140 which is spring-biased upward to tilt and/or move downward also assist in maintaining the amount of pressure or contact force by which the top banknote is pressed against the stripping wheels 1974 and/or the feeding plate 1972 within an acceptable range such as by providing some forgiveness without necessarily having to make fine adjustments to the level of the elevator 2110. For example, as banknotes are fed out of the storage bay 1760, one by one, and the weight of the remaining banknotes is not sufficient to overcome the upward bias of the platform springs 2140_{SP}, the platform springs 2140_{SP} will cause the platform 2140 to slowly rise, assisting with maintaining the contact force within the acceptable range without having to raise the elevator 2110. For larger stacks of banknotes even where the weight of the remaining banknotes is sufficient to overcome the upward bias of the platform springs 2140_{SP}, as banknotes are fed out of the storage bay 1760, one by one, the sponginess of a stack of banknotes assists with maintaining the contact force within the acceptable range without having to raise the elevator 2110, that is, as notes are feed out of the storage bay, the sponginess of the remaining notes forces the topmost banknote upward against the stripping wheels 1974 without requiring the elevator 2110 to be moved upward.

However, as described above, in some embodiments, the weight of a sufficiently large number of banknotes overcomes the upward bias forces of the platform springs 2140_{SP} such that the banknote platform 2140 moves to its lowest point relative to the lower housing 2111 and no longer provides a mechanism for assisting maintaining the contact force within an acceptable range as the top banknote is pressed against the stripping wheels 1974 and/or the feeding plate 1972. Accordingly, at such point, the position of the elevator 2110 must be adjusted as described above when the contact pressure falls outside the acceptable range.

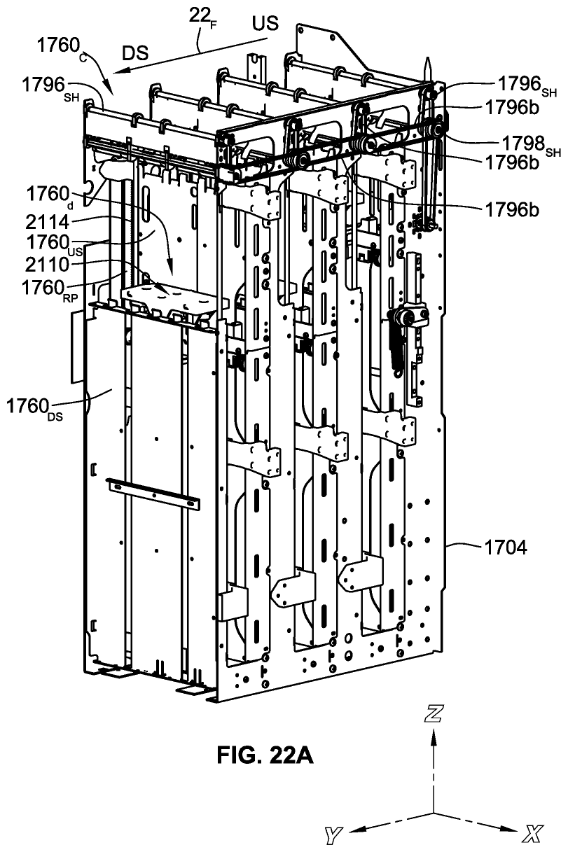

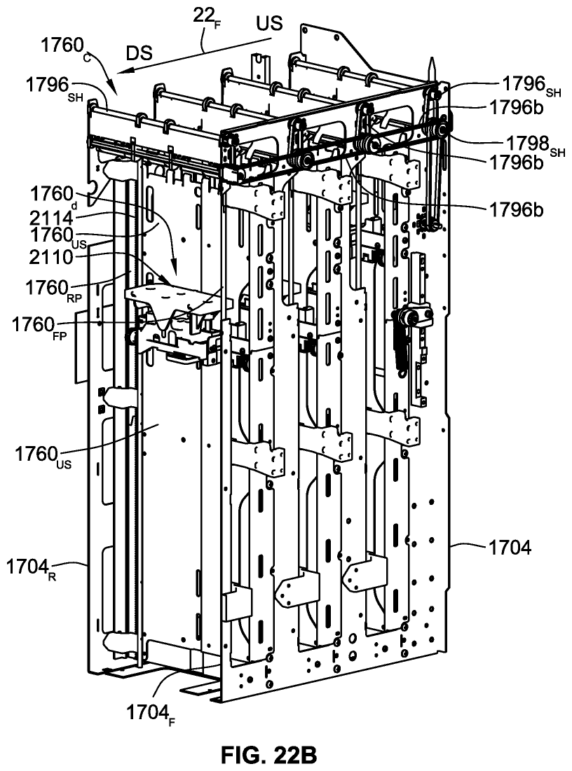

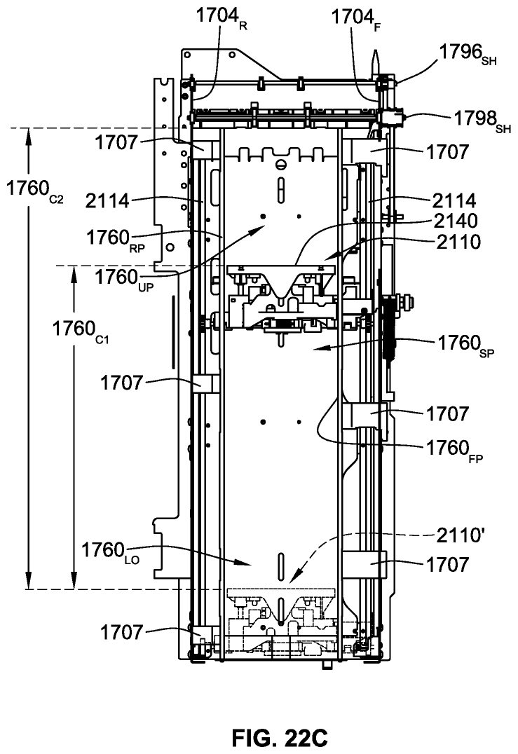

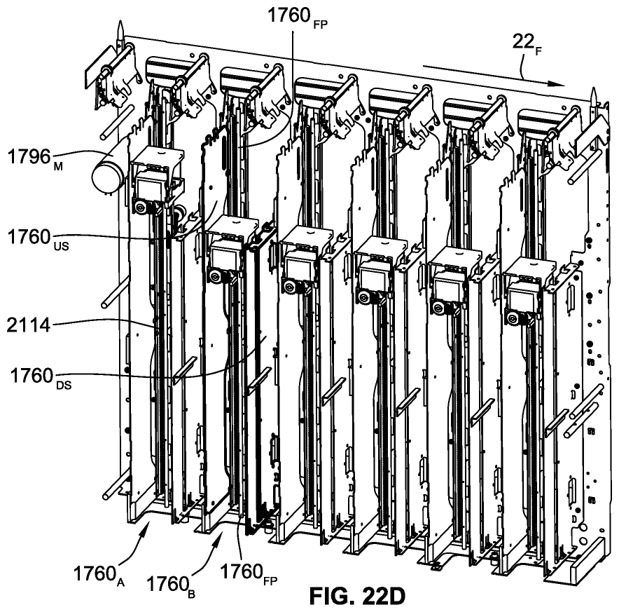

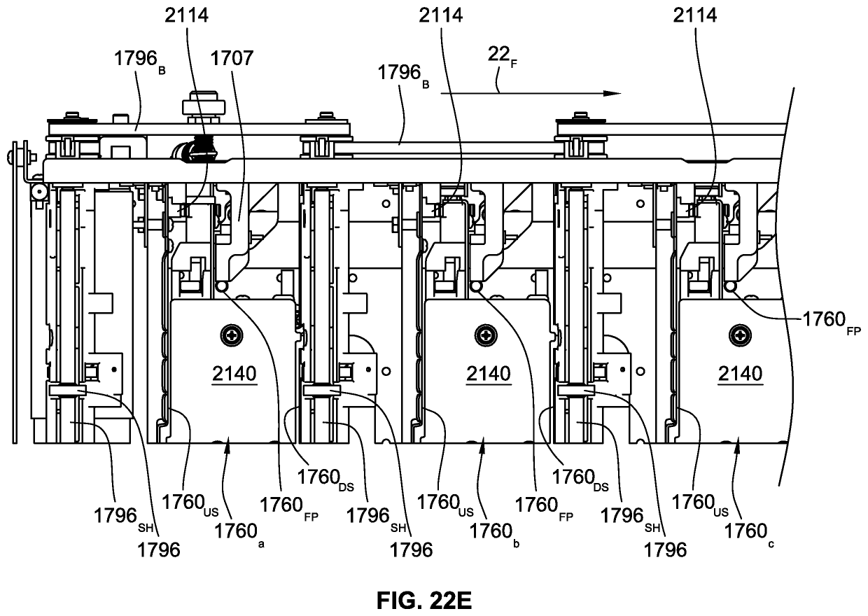

According to some embodiments, the elevator lower housing 2111 is held generally horizontal in the storage bay 1760a-f in the long direction by the alignment of the left and right gears 2113 on the gear tracks 2114. The elevator lower housing 2111 (and therefore the banknote support or platform 2140) is held generally horizontal in the storage bay 1760a-f in the narrow or short direction by one or more bearings such as bearing 2110_{B1} which is separated by some distance from the elevation gear shaft 2113_{SH}, and made to run vertically in a bearing track 1719 (see FIG. 17H) coupled to the inside of one of the chassis housing walls 1704_{F}, 1704_{R} to be described below in conjunctions with FIGS. 22A-22E. According to some embodiments, a bearing 2110_{B2} is coupled at each end of the elevation gear shaft 2113_{SH} and run vertically in bearing tracks (such as bearing track 1719 for the bearing 2110_{B2} positioned at the same end of the elevator 2110 and below bearing 2110_{B1}) coupled to the inside the chassis housing walls 1704_{F}, 1704_{R}. The bearings 2110_{B2} and the bearing tracks operate to ensure the elevation gears 2113 remain operably engaged with the gear tracks 2114.

According to some embodiments, each of the elevators 2110 are identical and interchangeable that may be quickly inserted into and/or removed from a storage bay 1760. Thus, when servicing banknote recycler 1700, if one or more of the elevators 2110 is not working properly, a service technician may quickly and easily remove a malfunctioning elevator 2110 and replace it with another modular elevator 2110. According to such embodiments, the banknote recycler may then be quickly serviced and placed back into normal operational use. According to some such embodiments, a malfunctioning elevator 2110 may then be serviced at a different location such as at a service technician's or manufacturer's facility so as to minimize time during which a service technician would need to interfere with the normal operation and use of the banknote recycler such as by bank tellers.

FIG. 21D is a downward perspective view of elevator 2110 and elevation shaft worm gear decoupling tool 2113_{TL}. FIG. 21E is side perspective view of elevator 2110 illustrating a use of the elevation shaft worm gear decoupling tool 2113_{TL}. Referring to FIGS. 21D-21E, according to some embodiments, the elevator 2110 is inserted into and/or removed from a storage bay 1760 from the top end of the storage bay 1760 with the assistance of an elevation shaft worm gear decoupling tool 2113_{TL} which disengages the elevation gear shaft worm gear 2113_{G} from the elevation motor worm gear 2115_{G}. According to some embodiments, the elevation gear shaft worm gear 2113_{G} is mounted about the elevation gear shaft 2113_{SH} so as to permit it to slide longitudinally along the axis 2113_{A} of the elevation gear shaft 2113_{SH}. An elevation gear shaft spring 2113_{SP} biases the elevation gear shaft worm gear 2113_{G} into an operable position whereat it will be engaged by the elevation motor worm gear 2115_{G}. At least when it the operable position, the elevation gear shaft worm gear 2113_{G} is rotationally, fixedly coupled to the elevation gear shaft 2113_{SH} so that when the elevation motor worm gear 2115_{G} causes the elevation gear shaft worm gear 2113_{G} to rotate, the elevation gear shaft worm gear 2113_{G} causes the elevation gear shaft 2113_{SH} to rotate about its longitudinal axis 2113_{A}. According to some embodiments, to remove the elevator 2110 from a storage bay 1760, the elevation shaft worm gear decoupling tool 2113_{TL} may inserted by a service technician into a vertical aperture 2111_{AP} in the housing 2111 and a lower end of the tool 2113_{TL} is positioned adjacent a decoupling flange 2113_{L} mounted about elevation gear shaft 2113_{SH} and coupled to elevation gear shaft worm gear 2113_{G}. As seen in FIG. 21E, the upper end of the tool 2113_{TL} may be moved in a direction 21-A1 away from elevation gear shaft worm gear 2113_{G} so that it pivots about a portion of lower housing 2111, or the tool may be twisted about its longitudinal axis 2113_{TLA}, causing the lower end of the tool 2113_{TL} to press the decoupling flange 2113_{L} and the elevation gear shaft worm gear 2113_{G} in direction 21-B1 until the elevation gear shaft worm gear 2113_{G} becomes decoupled from the elevation motor worm gear 2115_{G}. Once decoupled, the elevation gear shaft worm gear 2113_{G} and the elevation gear shaft 2113_{SH} are free to rotate independently of the elevation motor worm gear 2115_{G} and the elevator 2110 may be manually raised with the elevation gears 2113 running along the geared elevator tracks 2114 until the elevation gears 2113 run off the top of the elevator tracks 2114. The elevator 2010 may then be move out of the top of the storage bay 1760.

According to some embodiments, to install an elevator 2110 into a bay 1760, the elevation gear shaft worm gear 2113_{G} is decoupled from the elevation motor worm gear 2115_{G}, the elevation gears 2113 are coupled to the elevator tracks 2114 and the elevator 2110 is manually lowered down the tracks 2114. Then the lower end of tool 2113_{TL} may be positioned on the opposite side of decoupling flange 2113_{L} and the top of the tool 2113_{TL} may move moved in the direction opposite to direction 21-A1 toward from elevation gear shaft worm gear 2113_{G} so that it pivots about a portion of lower housing 2111 causing the lower end of the tool 2113_{TL} to pull the decoupling flange 2113_{L} and the elevation gear shaft worm gear 2113_{G} in direction opposite of direction 21-B1 until the elevation gear shaft worm gear 2113_{G} becomes coupled from the elevation motor worm gear 2115_{G}.

According to some embodiments, absent the presence of the tool 2113_{TL}, the elevation gear shaft spring 2113_{SP} biases the elevation gear shaft worm gear 2113_{G} into the operable position into engagement with the elevation motor worm gear 2115_{G}. According to such embodiments, the bottom of the tool 2113_{TL} must remain pushing flange decoupling flange 2113_{L} in direction 21-B1 while the elevator is manually raised or lowered along the tracks 2114.

According to some embodiments, a service technician may instruct the processor or controller controlling the elevation motor 2115 such as controller 202 (such via an interface such as interface 208) to raise the elevator 2110 to the top of tracks 2114 where it may be manually removed and/or to lower the elevator 2110 down the tracks 2114 after the elevator 2110 has be coupled to the tracks 2114.

When removing a first elevator 2110 from the banknote recycler 1700, for example, when the elevator 2110 is not operating properly or otherwise needs service, a service personnel or technician may quickly disconnect any associated electrical connections (e.g., power, communications lines to one or more processors such as processor 202), remove the first elevator 2110 as described above, insert another elevator 2110 as described above and reconnect the associated electrical connections.

FIG. 22A is a cross-sectional perspective view of chassis 1704. FIG. 22B is a similar view as that of FIG. 22A but with a downstream wall 1760_{DS} of storage bay 1760d removed. FIG. 22C is an end view of the storage bay 1760d shown in FIG. 22B. FIG. 22D is a cross-sectional perspective view of the chassis 1704 taken at 90 degrees from the view of FIG. 22A. FIG. 22E is a top view of a portion of the chassis 1704 shown in FIG. 22D.

Referring to FIGS. 22A-22E, the direction of flow in which banknotes are transported along transport path 1820D (see, e.g., FIG. 18B) is represented by arrow 22_{F} and orients the upstream (US) side of various components from the downstream (DS) side. According to some embodiments, banknotes are transported by the transport mechanisms 1820 and 1820_{U} in a wide-edge leading manner along the various transport paths including 1820D and 1820E.

According to some embodiments, each storage bay 1760 comprises an upstream wall or plate 1760_{US} and a downstream wall or plate 1760_{DS}. According to some embodiments, each storage bay 1760 comprises a means for maintaining the position of banknotes stack in a storage bay in transverse direction such as a front wall and a rear wall. In some embodiments, the front walls and rear walls are replaced with front retaining post 1760_{FP} and a rear retaining post 1760_{RP}. According to some embodiments, the upstream walls 1760_{US} and the downstream walls 1760_{DS} may be replaced with one or more posts. Each banknote recycler storage bay 1760 has an upper end 1760_{UP} and a lower end 1760_{LO}. The upstream wall 1760_{US}, the downstream wall 1760_{DS}, the front retaining post 1760_{FP}, and the rear retaining post 1760_{RP} help to contain stacked banknotes within the storage bay 1760 and serve to define a banknote space 1760_{SP} of the storage bay 1760. According to some embodiments, banknotes are transported in a wide-edge leading manner and stacked each the storage bay 1760 with their wide edges being adjacent the upstream wall 1760_{US} and the downstream wall 1760_{DS} and their narrow edges being adjacent the front retaining post 1760_{FP}, and the rear retaining post 1760_{RP}.

According to some embodiments, the feeder shafts 1796_{SH} and 1798_{SH} on which driven feeder rolls 1796 and 1798, respectively, are mounted, are rotationally driven by one or more motors such as motor 1796_{M}. According to some embodiments, the feeder shafts 1796_{SH} and 1798_{SH} are rotationally driven by one or more belts 1796_{B} operatively coupled to the one or motors 1796_{M}. According to some embodiments, a single motor 1796_{M} drives a plurality of feeder shafts 1796_{SH} and a plurality of shafts 1798_{SH}. According to some embodiments, a single motor 1796_{M} drives a plurality of feeder shafts 1796_{SH} and a plurality of shafts 1798_{SH} associated with in-feed transport paths 1900_{IN} and out-feed transport paths 1900_{OUT} associated with a plurality of storage bays 1760. According to some embodiments, a single motor 1796_{M} drives all the feeder shafts 1796_{SH} and all the shafts 1798_{SH} of the banknote recycler 1700. According to some embodiments, the chassis 1704 has a front wall 1704_{F} and a rear wall 1704_{R}. According to some embodiments, the feeder shafts 1796_{SH} and 1798_{SH} are rotationally coupled to a front wall 1704_{F} and a rear wall 1704_{R}.

According to some embodiments, the internal size (that is, the space in which banknotes are stored) of the storage bays 1760a-1760f may be adjusted to accommodate different sizes of banknotes, e.g., a storage bay sized to accommodate U.S. currency may be adjusted accommodate €10 banknotes or a storage bay sized to accommodate €10 banknotes may be adjusted accommodate €20 banknotes as described above in connection with FIGS. 8D and 8E and the chassis 1704 and/or storage bays 1760 may contain one or more of the exemplary mechanisms for facilitating the easy adjustment of the depth of storage bays described above in connection with FIGS. FIGS. 8D and 8E. For example, the upstream wall 1760_{US} and/or the downstream wall 1760_{DS} may be slideably mounted on a plurality of storage bay depth adjustment posts (see storage bay depth adjustment posts 893 in FIGS. 8D and 8E) and one or both of the walls 1760_{US}, 1760_{DS} are releasably, slideably mounted on the plurality of storage bay depth adjustment posts and may be locked into a fixed position relative to the storage bay depth adjustment posts such as via locking screws which releasably engage the storage bay depth adjustment posts. Likewise, according to some embodiments, the left side and right side frames of chassis 1704 may have one or more slots (see slots 895 in FIG. 8D) therein which cooperate with tabs or posts extending from the exterior sides of one or both of the walls 1760_{US}, 1760_{DS} of the storage bay 1760 through the slots 895 to control the movement of the wall 1760_{US}, and/or wall 1760_{DS} relative to the front side and rear side frames of the chassis 1704, thereby limiting the direction and extent to which the wall 1760_{US}, and/or wall 1760_{DS} may be moved relative to each other. Additionally or alternatively, according to some embodiments, the left side and right side frames of the chassis 1704 may have one or more plurality of preset depth adjustment apertures (see apertures 894 in FIG. 8D) therein which cooperate with tabs or posts extending from the exterior sides of the wall 1760_{US}, and/or wall 1760_{DS} of the storage bay 1760 through the apertures 894 to facilitate the distance between the wall 1760_{US}, and wall 1760_{DS} being adjustably set at a plurality of predefined distances, e.g., distances associated with accommodating U.S banknotes and a plurality of denominations of Euro banknotes. In the embodiment illustrated in FIG. 8D, a lower set of a plurality of apertures 894 comprises apertures 894a-894e and such apertures may be included in the frame of chassis 1704 near one or more of the storage bays 1760a-1760f.

According to some embodiments, the front retaining post 1760_{FP} and the rear retaining post 1760_{RP} are coupled to the chassis 1704 via storage bay wall retainers 1707. According to some embodiments, the wide or long horizontal dimension of the banknote space 1760_{SP} of a storage bay 1760 may be adjusted by uses storage bay wall retainers 1707 of different lengths so as to adjust the distance between a front retaining post 1760_{FP} or rear retaining post 1760_{RP} and a corresponding front wall 1704_{F} and a rear wall 1704_{R} of the chassis. According to some embodiments, the storage bay wall retainers 1707 may have a slidably, adjustable length in the front-back direction (parallel to a wide-dimension of a storage bay 1760) of the storage bay such that one or both of the front-back positions of the front retaining post 1760_{FP} and/or rear retaining post 1760_{RP} may be adjusted. According to some such embodiments, the storage bay wall retainers 1707 may have preset engagement positions corresponding to wide-dimensions associated with banknotes having different wide dimensions, e.g., a first present engagement position for U.S. banknotes, a second preset engagement position for €10 banknotes, a third preset engagement position for €20 banknotes, etc. According to some embodiments, the storage bay wall retainers 1707 snap into the various preset engagement positions as the front retaining post 1760_{FP} and/or rear retaining post 1760_{RP} are pulled or push in a front-back (parallel to a wide-dimension of a storage bay 1760) direction.

According to some embodiments, the storage bays 1760a-1760f are dimensioned to accommodate a stack of as many as 5000 banknotes. For recyclers 1700 having six storage bays with one being used as an escrow bay, the five remaining storage bays, e.g., bays 1760b-1760f may accommodate and store as many as 25,000 banknotes. According to some embodiments, each storage bay 1760a-1760f is dimensioned to accommodate a stack of at least 4,5000 banknotes. According to some embodiments, each storage bay 1760a-1760f is dimensioned to accommodate a stack of at least 4000 banknotes. According to some embodiments, each storage bay 1760a-1760f is dimensioned to accommodate a stack of at least 3000 banknotes. According to some embodiments, each storage bay 1760a-1760f is dimensioned to accommodate a stack of at least 1000 banknotes. According to some embodiments, each storage bay 1760a-1760f is dimensioned to accommodate a stack of at least 2000 banknotes. According to some embodiments, each storage bay 1760a-1760f is dimensioned to accommodate a stack of at least 2500 banknotes.

According to some embodiments, referring to FIG. 22C, the distance 1760_{C1} between the height of the top of the banknote platform 2140 when the elevator 2110 is lowered to its lowest position and the height of the top of the banknote platform 2140 with no banknotes stacked therein when the elevator 2110 is raised to receive an initial banknote from the stacking wheels 2062 is about 22 inches (56 cm). According to some embodiments, the distance 1760_{C2} between the height of the top of the banknote platform 2140 when the elevator 2110 is lowered to its lowest position and the bottom of the feeding plate 1972 is about 26 inches (66 cm). According to some embodiments, the storage bay 1760 capacities described in the preceding paragraph are achieved for storage bays having the 1760_{C1} and 1760_{C2} vertical dimensions above including being able to accommodate a stack of as many as 5000 banknotes in a storage bay having a 1760_{C1} dimension of less than or about 22 inches and a 1760_{C2} dimension of less than or about 26 inches within a housing 1702 having an exterior width W₁₇ less than or equal to about 18 inches (46 cm), an exterior height H₁₇ less than or equal to about 38 inches (97 cm), and an exterior length L₁₇ less than or equal to about 39 inches (99 cm).

According to some embodiments, banknotes may be deposited into and dispensed from storage bay 1760 at a rate of at least 1000 banknotes per minute.

According to some embodiments, the transport mechanism 1820 is operated at high speeds and can transport banknotes at a rate of at least 5000 inches per minute and/or deliver notes from the transport path 1820D into a storage bay 1760 at a rate of at least 1000 bills/banknotes per minute and/or deliver notes from a storage bay 1760 onto the transport path 1820D at a rate of at least 1000 bills/banknotes per minute.

According to some embodiments, a stack of up to about 5000 banknotes may be stacked on the elevator platform 2140 and dispensed at high-speed (e.g., at least 1000 banknotes per minute or banknotes are transported at a rate of at least 5000 inches per minute). According to some embodiments, a stack of at least about 4500 banknotes may be stacked on the elevator platform 2140 and dispensed at high-speed (e.g., at least 1000 banknotes per minute or banknotes are transported at a rate of at least 5000 inches per minute). According to some embodiments, a stack of at least about 3000 banknotes may be stacked on the elevator platform 2140 and dispensed at high-speed (e.g., at least 1000 banknotes per minute or banknotes are transported at a rate of at least 5000 inches per minute). According to some embodiments, a stack of at least about 2000 banknotes may be stacked on the elevator platform 2140 and dispensed at high-speed (e.g., at least 1000 banknotes per minute or banknotes are transported at a rate of at least 5000 inches per minute). According to some embodiments, a stack of at least about 1000 banknotes may be stacked on the elevator platform 2140 and dispensed at high-speed (e.g., at least 1000 banknotes per minute or banknotes are transported at a rate of at least 5000 inches per minute).

According to some embodiments, the banknote recycler 1700 is operated at high speeds and can deliver notes from the storage bay transport path 1820D into a storage bay 1760 at a rate of at least 1000 bills/banknotes per minute. According to some embodiments, banknotes are stacked into a storage bay 1760 and dispensed from the storage bay 1760 at a rate of at least 600 banknotes per minutes. According to some embodiments, banknotes are stacked into the storage bay 1760 and dispensed from the storage bay 1760 at a rate of at least 800 banknotes per minutes. According to some embodiments, banknotes are stacked into the storage bay 1760 and dispensed from the storage bay 1760 at a rate of at least 1000 banknotes per minutes.

According to some embodiments, banknotes are stacked into the storage bay 1760 and dispensed from the storage bay 1760 at different speeds.

According to some embodiments, the storage bays 1760 described above are modular and interchangeable with each other.

### Further Embodiments

Embodiment 1. A generally vertical banknote recycling bay arrangement comprising:

a generally vertically oriented banknote recycling bay for receiving banknotes therein, the recycling bay having an upper end and a lower end and at least one generally vertically side;

an elevator having at least one retractable banknote support, the elevator configured to move upward and downward with respect to the at least one generally vertically side of the recycler bay, the retractable banknote support configured to move into and out of the recycling bay;

a banknote feeding assembly for feeding banknotes, one at a time, into the recycling bay, the feeding assembly being positioned near the upper end of the recycling bay;

a banknote dispensing assembly for feeding banknotes, one at a time, out of the recycling bay, the dispensing assembly being positioned near the lower end of the recycling bay and comprising:

a pair of stripping wheels supported for rotational movement about a driven stripping wheel shaft,

a pair of drive rolls, and

a pair of nip rollers;

wherein during operation in which banknotes are to be sequentially fed into the recycling bay, the at least one retractable banknote support is extended into the recycling bay so as to provide a structure on which banknotes may be stacked within the recycling bay and wherein the elevator is raised to a level so as to facilitate the stacking of banknotes being fed into the recycling bay, one on top of the other on the at least one retractable banknote support and wherein the elevator is lowered as banknotes are fed into the recycling bay so that the top of the stack of banknotes residing within the recycling bay and onto which incoming banknotes are stacked remains at about the same level;

wherein prior to a dispensing operation in which banknotes are to be fed out of the recycling bay, the elevator is lowered to a bottom of the recycling bay if no banknotes reside at the bottom of the recycling bay and wherein the at least one retractable banknote support is moved out of the recycling bay so that the stack of banknotes that had been supported by the at least one retractable support come to rest upon a bottom surface of the recycling bay;

wherein prior to a dispensing operation in which banknotes are to be fed out of the recycling bay, the elevator is lowered to a location adjacent the top of a stack of banknotes resting on the bottom of the recycling bay if there are banknotes already residing at the bottom of the recycling bay and wherein the at least one retractable banknote support is moved out of the recycling bay so that the stack of banknotes that had been supported by the at least one retractable support come to rest upon the top of the stack of banknotes already residing at the bottom of the recycling bay.

Embodiment 2. A generally vertical banknote recycling bay arrangement comprising:

a generally vertically oriented banknote recycling bay for receiving banknotes therein, the recycling bay having an upper end and a lower end and at least one generally vertically side;

an elevator having at least one retractable banknote support, the elevator configured to move upward and downward with respect to the at least one generally vertically side of the recycler bay, the retractable banknote support configured to move into and out of the recycling bay;

a banknote feeding assembly for feeding banknotes, one at a time, into the recycling bay, the feeding assembly being positioned near the upper end of the recycling bay;

a banknote dispensing assembly for feeding banknotes, one at a time, out of the recycling bay, the dispensing assembly being positioned near the lower end of the recycling bay;

wherein during operation in which banknotes are to be sequentially fed into the recycling bay, the at least one retractable banknote support is extended into the recycling bay so as to provide a structure on which banknotes may be stacked within the recycling bay and wherein the elevator is raised to a level so as to facilitate the stacking of banknotes being fed into the recycling bay, one on top of the other on the at least one retractable banknote support and wherein the elevator is lowered as banknotes are fed into the recycling bay so that the top of the stack of banknotes residing within the recycling bay and onto which incoming banknotes are stacked remains at about the same level;

wherein prior to a dispensing operation in which banknotes are to be fed out of the recycling bay, the elevator is lowered to the bottom of the recycling bay if no banknotes reside at the bottom of the recycling bay and wherein the at least one retractable banknote support is moved out of the recycling bay so that the stack of banknotes that had been supported by the at least one retractable support come to rest upon a bottom surface of the recycling bay;

wherein prior to a dispensing operation in which banknotes are to be fed out of the recycling bay, the elevator is lowered to a location adjacent the top of a stack of banknotes resting on the bottom of the recycling bay if there are banknotes already residing at the bottom of the recycling bay and wherein the at least one retractable banknote support is moved out of the recycling bay so that the stack of banknotes that had been supported by the at least one retractable support come to rest upon the top of the stack of banknotes already residing at the bottom of the recycling bay.

Embodiment 3. A generally vertical banknote recycling bay arrangement comprising:

a generally vertically oriented banknote recycling bay for receiving banknotes therein, the recycling bay having an upper end and a lower end, the recycling bay having a banknote leading edge side and a banknote trailing edge side;

an elevator banknote stacker plate configured to move upward and downward within the recycler bay;

a banknote feeding assembly for feeding banknotes, one at a time, into the recycling bay, the feeding assembly being positioned near the upper end and banknote trailing edge side of the recycling bay and comprising:

a pair of drive rolls supported for rotational movement about a driven drive roll shaft,

a pair of nip rollers supported for rotational movement about a nip roller shaft, each of the nip rollers being positioned below a corresponding one of the drive rolls such that banknotes may pass between each corresponding drive roll and nip roller pair,

a plurality of tap down assemblies supported for rotational movement about the nip roller shaft, each tap down assembly having a base and a plurality of flexible tap down projections extending from the base, the base having a circumference extending around the nip roller shaft, the plurality of tap down projections being positioned about the circumference of a corresponding base such that collectively the plurality of tap down projections extend from a corresponding base over less than about 180° of the circumference of the base, and

a pair of ceiling guides positioned so as to guide the leading edge of banknotes emerging from between each drive roll and nip roller pair downward into the recycling bay and toward the banknote leading edge side of the recycling bay and on top of any preceding banknotes resting on the elevator banknote stacker plate;

a banknote dispensing assembly for feeding banknotes, one at a time, out of the recycling bay, the dispensing assembly being positioned near the upper end of the recycling bay and comprising:

a pair of stripping wheels supported for rotational movement about a driven stripping wheel shaft,

the pair of drive rolls, and

the pair of nip rollers;

wherein during operation in which banknotes are to be sequentially fed into the recycling bay, the plurality of tap down assemblies are rotated such that the plurality of tap down projections push the trailing edges of banknotes that have been fed into the recycling bay downward so as to facilitate a succeeding banknote entering the recycling bay to be positioned on the upper side of a prior fed banknote;

wherein during a dispensing operation in which banknotes are to be fed out of the recycling bay, the elevator banknote stacker plate is elevated such that the stripping wheels sequentially engage the topmost banknote stacked in the recycling bay and urge the topmost banknote into contact with the pair of drive rolls which act to feed banknotes out of the recycling bay arrangement, one bill at a time; and wherein during a dispensing operation the tap down assemblies are rotationally positioned such that the plurality of tap down projections do not extend into the recycling bay nor above the top of the nip rollers.

Embodiment 4. A generally vertical banknote recycling bay arrangement comprising:

a generally vertically oriented banknote recycling bay for receiving banknotes therein, the recycling bay having an upper end and a lower end, the recycling bay having a banknote leading edge side and a banknote trailing edge side;

an elevator banknote stacker plate configured to move upward and downward within the recycler bay;

a banknote feeding assembly for feeding banknotes, one at a time, into the recycling bay, the feeding assembly being positioned near the upper end and banknote trailing edge side of the recycling bay and comprising:

one or more tap down assemblies supported for rotational movement about a shaft, each tap down assembly having a base and a plurality of flexible tap down projections extending from the base, the base having a circumference extending around the shaft, the plurality of tap down projections being positioned about the circumference of a corresponding base such that collectively the plurality of tap down projections extend from a corresponding base over less than about 180° of the circumference of the base, and

a banknote dispensing assembly for feeding banknotes, one at a time, out of the recycling bay, the dispensing assembly being positioned near the upper end of the recycling bay;

wherein during operation in which banknotes are to be sequentially fed into the recycling bay, the plurality of tap down assemblies are rotated such that the plurality of tap down projections push the trailing edges of banknotes that have been fed into the recycling bay downward so as to facilitate a succeeding banknote entering the recycling bay to be positioned on an upper side of a prior fed banknote;

wherein during a dispensing operation in which banknotes are to be fed out of the recycling bay, the elevator banknote stacker plate is elevated such that the banknote feeding assembly sequentially engages the topmost banknote stacked in the recycling bay and feeds banknotes out of the recycling bay arrangement, one bill at a time; and wherein during a dispensing operation the tap down assemblies are rotationally positioned such that the plurality of tap down projections do not extend into the recycling bay.

Embodiment 5. The banknote recycling bay arrangement of embodiment 4 wherein the banknote feeding assembly further comprises one or more of drive rolls supported for rotational movement about a driven drive roll shaft, one or more pair of nip rollers supported for rotational movement about a nip roller shaft, each of the nip rollers being positioned below a corresponding one of the drive rolls such that banknotes may pass between each corresponding drive roll and nip roller pair.

Embodiment 6. The banknote recycling bay arrangement of embodiments 4 or 5 further comprising one or more of ceiling guides positioned so as to guide the leading edge of banknotes emerging from between each drive roll and nip roller pair downward into the recycling bay and toward the banknote leading edge side of the recycling bay and on top of any preceding banknotes resting on the elevator banknote stacker plate.

Embodiment 7. The banknote recycling bay arrangement of any of embodiments 4-6 wherein the dispensing assembly comprises: one or more of stripping wheels supported for rotational movement about a driven stripping wheel shaft, one or more pair of drive rolls, and one or more pair of nip rollers.

Embodiment 8. The banknote recycling bay arrangement of either embodiment 6 or embodiment 7 wherein during a dispensing operation the tap down assemblies are rotationally positioned such that the plurality of tap down projections do not extend into the recycling bay nor above the top of the one or more nip rollers.

Embodiment 9. A generally vertical banknote recycling bay arrangement comprising:

a generally vertically oriented banknote recycling bay for receiving banknotes therein, the recycling bay having an upper end and a lower end;

a banknote feeding assembly for feeding banknotes, one at a time, into the recycling bay, the feeding assembly being positioned near the upper end of the recycling bay and comprising:

a pair of stacker wheels supported for rotational movement about a driven stacker wheel shaft;

each stacker wheel being laterally moveable along the driven stacker wheel shaft;

a stacker wheel positioning screw,

a pair of stacker wheel carriages, each carriage having a screw end and a stacker wheel end, the screw end of each carriage having a threaded aperture therein through which a portion of the positioning screw is threaded, each carriage having a pair of arms, each arm extending from the screw end toward the stacker wheel end and at least partially conforming about the stacker wheel shaft, the pair of arms of each carriage extending toward the stacker wheel shaft such that a corresponding stacker wheel is positioned about the stacker wheel shaft between the arms of a corresponding carriage; and

a banknote dispensing assembly for feeding banknotes, one at a time, out of the recycling bay, the dispensing assembly being positioned near the upper end of the recycling bay and comprising:

a pair of stripping wheels supported for rotational movement about the driven stacker wheel shaft, the pair of stripping wheels being laterally positioned about the stacker wheel shaft between the pair of stacker wheels, and

a pair of drive rolls supported for rotational movement about the drive roll shaft;

wherein during operation in which banknotes are to be fed into the recycling bay, the lateral position of the stacker wheels is adjusted to an inward position such that banknotes to be fed into the recycling bay are received by the stacker wheels and stacked in the recycling bay;

wherein during operation in which banknotes are to be fed out of the recycling bay, the lateral position of the stacker wheels is adjusted to an outward position such that banknotes to be fed out the recycling bay are not engaged by the stacker wheels but instead are engaged by the stripping wheels which sequentially engage the topmost banknote stacked in the recycling bay and urge the topmost banknote into contact with the pair of drive rolls which act to feed banknotes out of the recycling bay arrangement, one bill at a time;

wherein the lateral positions of the stacker wheels are adjusted by rotational movement of the stacker wheel positioning screw which serves to laterally move the pair of stacker wheel carriages laterally toward each other when driven in a first rotational direction and to laterally move the pair of stacker wheel carriages laterally away each other when driven in a second rotational direction, the lateral movement of the stacker wheel carriages imparting a corresponding lateral movement on the stacker wheels.

Embodiment 10. The generally vertical banknote recycling bay arrangement of embodiment 9 wherein the stacker wheel positioning screw comprises threads oriented in a first direction on a first portion and threads oriented in a second opposite direction on a second portion, and wherein a first one of the stacker wheel carriages threadingly engages the first portion of the positioning screw and a second one of the stacker wheel carriages threadingly engages the second portion of the positioning screw.

Embodiment 11. A method of operating a generally vertical banknote recycling bay arrangement comprising a generally vertically oriented banknote recycling bay for receiving banknotes therein, the recycling bay having an upper end and a lower end and at least one generally vertical side, the recycling bay comprising an elevator configured to move upward and downward with respect to the at least one generally vertical side of the recycler bay, a banknote feeding assembly for feeding banknotes, one at a time, into the recycling bay, the feeding assembly being positioned near the upper end of the recycling bay, and a banknote dispensing assembly for feeding banknotes, one at a time, out of the recycling bay, the dispensing assembly being positioned near the lower end of the recycling bay, the method comprising the acts of: feeding banknotes into the recycling bay; and simultaneously feeding banknotes out of the recycling bay.

Embodiment 12. The method of embodiment 11 wherein the elevator has at least one retractable banknote support and the retractable banknote support configured to move into and out of the recycling bay.

Embodiment 13. A method of operating a generally vertical banknote recycling bay arrangement comprising a generally vertically oriented banknote recycling bay for receiving banknotes therein, the recycling bay having an upper end and a lower end, a banknote feeding assembly for feeding banknotes, one at a time, into the recycling bay, the feeding assembly being positioned near the upper end of the recycling bay, and a banknote dispensing assembly for feeding banknotes, one at a time, out of the recycling bay, the dispensing assembly being positioned near the lower end of the recycling bay, the method comprising the acts of: feeding banknotes into the recycling bay; and simultaneously feeding banknotes out of the recycling bay.

Embodiment 14. The method according to any of embodiments 11-13 wherein the act of feeding banknotes into the recycling bay is performed at a rate of at least 600 banknotes per minutes and wherein the act of simultaneously feeding banknotes out of the recycling bay is performed at a rate of at least 600 banknotes per minutes.

Embodiment 15. The method according to any of embodiments 11-13 wherein the act of feeding banknotes into the recycling bay is performed at a rate of at least 800 banknotes per minutes and wherein the act of simultaneously feeding banknotes out of the recycling bay is performed at a rate of at least 800 banknotes per minutes.

Embodiment 16. The method according to any of embodiments 11-13 wherein the act of feeding banknotes into the recycling bay is performed at a rate of at least 1000 banknotes per minutes and wherein the act of simultaneously feeding banknotes out of the recycling bay is performed at a rate of at least 1000 banknotes per minutes.

Embodiment 17. The method according to any of embodiments 11-13 wherein the act of feeding banknotes into the recycling bay is performed at a rate of at least 1200 banknotes per minutes and wherein the act of simultaneously feeding banknotes out of the recycling bay is performed at a rate of at least 1200 banknotes per minutes.

Embodiment 18. A generally vertical banknote recycling bay arrangement comprising:

a generally vertically oriented banknote recycling bay for receiving banknotes therein, the recycling bay having an upper end and a lower end and at least one generally vertically side;

an elevator having at least one retractable banknote support, the elevator configured to move upward and downward with respect to the at least one generally vertically side of the recycler bay, the retractable banknote support configured to move into and out of the recycling bay;

wherein during operation in which banknotes are to be sequentially fed into the recycling bay, the at least one retractable banknote support is extended into the recycling bay so as to provide a structure on which banknotes may be stacked within the recycling bay and wherein the elevator is raised to a level so as to facilitate the stacking of banknotes being fed into the recycling bay, one on top of the other on the at least one retractable banknote support and wherein the elevator is lowered as banknotes are fed into the recycling bay so that the top of the stack of banknotes residing within the recycling bay and onto which incoming banknotes are stacked remains at about the same level;

wherein prior to a dispensing operation in which banknotes are to be fed out of the recycling bay, the elevator is lowered to the bottom of the recycling bay if no banknotes reside at the bottom of the recycling bay and wherein the at least one retractable banknote support is moved out of the recycling bay so that the stack of banknotes that had been supported by the at least one retractable support come to rest upon a bottom surface of the recycling bay;

wherein prior to a dispensing operation in which banknotes are to be fed out of the recycling bay, the elevator is lowered to a location adjacent the top of a stack of banknotes resting on the bottom of the recycling bay if there are banknotes already residing at the bottom of the recycling bay and wherein the at least one retractable banknote support is moved out of the recycling bay so that the stack of banknotes that had been supported by the at least one retractable support come to rest upon the top of the stack of banknotes already residing at the bottom of the recycling bay.

Embodiment 19. A generally vertical banknote recycling bay arrangement comprising:

a generally vertically oriented banknote recycling bay for receiving banknotes therein, the recycling bay having an upper end and a lower end and at least one generally vertically side;

an elevator having at least one retractable banknote support, the elevator configured to move upward and downward with respect to the at least one generally vertically side of the recycler bay, the retractable banknote support configured to move into and out of the recycling bay;

wherein during operation in which banknotes are to be sequentially fed into the recycling bay, the at least one retractable banknote support is extended into the recycling bay so as to provide a structure on which banknotes may be stacked within the recycling bay.

Embodiment 20. A generally vertical banknote recycling bay arrangement comprising:

a generally vertically oriented banknote recycling bay for receiving banknotes therein, the recycling bay having an upper end and a lower end, the recycling bay having a banknote leading edge side and a banknote trailing edge side;

an elevator banknote stacker plate or support configured to move upward and downward within the recycler bay;

a banknote feeding assembly for feeding banknotes, one at a time, into the recycling bay, the feeding assembly being positioned near the upper end and banknote trailing edge side of the recycling bay and comprising:

a pair of drive rolls supported for rotational movement about a driven drive roll shaft,

a pair of nip rollers supported for rotational movement about a nip roller shaft, each of the nip rollers being positioned below a corresponding one of the drive rolls such that banknotes may pass between each corresponding drive roll and nip roller pair,

a plurality of tap down assemblies supported for rotational movement about the nip roller shaft, each tap down assembly having the base and a plurality of flexible tap down projections extending from the base, the base having a circumference extending around the nip roller shaft, the plurality of tap down projections being positioned about the circumference of a corresponding base such that collectively the plurality of tap down projections extending from a corresponding base over less than about 180° of the circumference of the base, and

a banknote dispensing assembly for feeding banknotes, one at a time, out of the recycling bay, the dispensing assembly being positioned near the upper end of the recycling bay;

wherein during operation in which banknotes are to be sequentially fed into the recycling bay, the plurality of tap down assemblies are rotated such that the plurality of tap down projections push the trailing edges of banknotes that have been fed into the recycling bay downward so as to facilitate a succeeding banknote entering the recycling bay to be positioned on the upper side of a prior fed banknote;

wherein during a dispensing operation in which banknotes are to be fed out of the recycling bay, the elevator banknote stacker plate or support is elevated to urge a topmost banknote against the banknote dispensing assembly; and wherein during a dispensing operation the tap down assemblies are rotationally positioned such that the plurality of tap down projections do not extend into the recycling bay nor above the top of the nip rollers.

Embodiment 21. A generally vertical banknote recycling bay arrangement comprising:

a generally vertically oriented banknote recycling bay for receiving banknotes therein, the recycling bay having an upper end and a lower end;

a banknote feeding assembly for feeding banknotes, one at a time, into the recycling bay, the feeding assembly being positioned near the upper end of the recycling bay;

a banknote dispensing assembly for feeding banknotes, one at a time, out of the recycling bay, the dispensing assembly being positioned near the upper end of the recycling bay;

a pair of stacker wheels supported for rotational movement about a driven stacker wheel shaft, each stacker wheel being laterally moveable along the driven stacker wheel shaft;

a stacker wheel positioning mechanism configured to adjust the lateral positions of the pair of stacker wheels along the stripper wheel shaft;

wherein during operation in which banknotes are to be fed into the recycling bay, the lateral position of the stacker wheels is adjusted by the stacker wheel positioning mechanism to an inward position such that banknotes to be fed into the recycling bay are received by the stacker wheels and stacked in the recycling bay;

wherein during operation in which banknotes are to be fed out of the recycling bay, the lateral position of the stacker wheels is adjusted by the stacker wheel positioning mechanism to an outward position such that banknotes to be fed out the recycling bay are not engaged by the stacker wheels but instead are engaged by the banknote dispensing assembly which sequentially engages the topmost banknote stacked in the recycling bay and feeds banknotes out of the recycling bay, one bill at a time.

Embodiment 22. The generally vertical banknote recycling bay arrangement of embodiment 21 wherein a stacker wheel positioning mechanism comprises:

a stacker wheel positioning screw; and

a pair of stacker wheel carriages, each carriage having a screw end and a stacker wheel end, the screw end of each carriage having a threaded aperture therein through which a portion of the positioning screw is threaded, each carriage having a pair of arms, each arm extending from the screw end toward the stacker wheel end and at least partially conforming about the stacker wheel shaft, the pair of arms of each carriage extending toward the stacker wheel shaft such that a corresponding stacker wheel is positioned about the stacker wheel shaft between the arms of a corresponding carriage;

wherein the lateral positions of the stacker wheels are adjusted by rotational movement of the stacker wheel positioning screw which serves to laterally move the pair of stacker wheel carriages laterally toward each other when driven in a first rotational direction and to laterally move the pair of stacker wheel carriages laterally away each other when driven in a second rotational direction, the lateral movement of the stacker wheel carriages imparting a corresponding lateral movement on the stacker wheels.

Embodiment 23. The generally vertical banknote recycling bay arrangement of embodiment 22 wherein the stacker wheel positioning screw comprises threads oriented in a first direction on a first portion and threads oriented in a second opposite direction on a second portion, and wherein a first one of the stacker wheel carriages threadingly engages the first portion of the positioning screw and a second one of the stacker wheel carriages threadingly engages the second portion of the positioning screw.

Embodiment 24. The generally vertical banknote recycling bay arrangement of any of embodiments 21-23 further comprising:

a banknote dispensing assembly for feeding banknotes, one at a time, out of the recycling bay, the dispensing assembly being positioned near the upper end of the recycling bay and comprising:

one or more stripping wheels supported for rotational movement about the driven stacker wheel shaft, the pair of stripping wheels being laterally positioned about the stacker wheel shaft between the pair of stacker wheels, and

one or more drive rolls supported for rotational movement about the drive roll shaft; and

wherein during operation in which banknotes are to be fed out of the recycling bay, the lateral position of the stacker wheels is adjusted by the stacker wheel positioning mechanism to an outward position such that banknotes to be fed out the recycling bay are not engaged by the stacker wheels but instead are engaged by the one or more stripping wheels which sequentially engages the topmost banknote stacked in the recycling bay and urges the topmost banknote into contact with the one or more drive rolls which act to feed banknotes out of the recycling bay arrangement, one bill at a time.

Embodiment 25. The generally vertical banknote recycling bay arrangement of embodiment 21 wherein a stacker wheel positioning mechanism comprises:

a stacker wheel positioning motor or solenoid, an elongated rotatable cam crank comprising two ends, a pair of linkage arms comprising two ends, and a pair of linkage arm supports.

Embodiment 26. The generally vertical banknote recycling bay arrangement of embodiment 25

wherein one end of a first one of the linkage arms is coupled to a first one of the ends of the cam crank and a second end of the first one of the linkage arms is couple to a first one of the linkage arm supports,

wherein one end of a second one of the linkage arms is coupled to a second one of the ends of the cam crank and a second end of the second one of the linkage arms is couple to a second one of the linkage arm supports,

wherein each stacker wheel is rotatably coupled to a respective one of the linkage arm supports.

Embodiment 27. The generally vertical banknote recycling bay arrangement of embodiment 26 wherein the motor or solenoid is configured to rotate the elongated rotatable cam crank about a cam axis causing the ends of the cam crank to rotate about the cam axis thereby causing the linkage arm supports and the stacker wheels coupled thereto to move either laterally closer to each other or laterally away from each other.

Embodiment 28. The generally vertical banknote recycling bay arrangement of any of embodiments 25-27 further comprising a controller or processor communicatively coupled to and controlling the motor or solenoid.

Embodiment 29. The generally vertical banknote recycling bay arrangement of any of embodiments 25-28 further comprising a pair of stacker wheel bases and wherein each stacker wheel is fixedly coupled to a respective one of the stacker wheel bases and wherein each stacker wheel base is rotatably coupled to a respective one of the linkage arm supports.

Embodiment 30. A banknote stacker wheel assembly for stacking banknotes in a banknote receptacle comprising:

a pair of stacker wheels supported for rotational movement about a driven stacker wheel shaft, each stacker wheel being laterally moveable along the driven stacker wheel shaft;

a stacker wheel positioning mechanism configured to adjust the lateral positions of the pair of stacker wheels along the stripper wheel shaft.

Embodiment 31. The banknote stacker wheel assembly of embodiment 30 wherein a stacker wheel positioning mechanism comprises a stacker wheel positioning motor or solenoid, an elongated rotatable cam crank comprising two ends, a pair of linkage arms comprising two ends, and a pair of linkage arm supports.

Embodiment 32. The banknote stacker wheel assembly of embodiment 31

wherein one end of a first one of the linkage arms is coupled to a first one of the ends of the cam crank and a second end of the first one of the linkage arms is couple to a first one of the linkage arm supports,

wherein one end of a second one of the linkage arms is coupled to a second one of the ends of the cam crank and a second end of the second one of the linkage arms is couple to a second one of the linkage arm supports,

wherein each stacker wheel is rotatably coupled to a respective one of the linkage arm supports.

Embodiment 33. The banknote stacker wheel assembly of embodiment 32 wherein the motor or solenoid is configured to rotate the elongated rotatable cam crank about a cam axis causing the ends of the cam crank to rotate about the cam axis thereby causing the linkage arm supports and the stacker wheels coupled thereto to move either laterally closer to each other or laterally away from each other.

Embodiment 34. The banknote stacker wheel assembly of any of embodiments 31-33 further comprising a controller or processor communicatively coupled to and controlling the motor or solenoid.

Embodiment 35. The banknote stacker wheel assembly of any of embodiments 31-34 further comprising a pair of stacker wheel bases and wherein each stacker wheel is fixedly coupled to a respective one of the stacker wheel bases and wherein each stacker wheel base is rotatably coupled to a respective one of the linkage arm supports.

Embodiment 36. The banknote stacker wheel assembly of embodiment 30 wherein a stacker wheel positioning mechanism comprises:

a stacker wheel positioning screw; and

a pair of stacker wheel carriages, each carriage having a screw end and a stacker wheel end, the screw end of each carriage having a threaded aperture therein through which a portion of the positioning screw is threaded, each carriage having a pair of arms, each arm extending from the screw end toward the stacker wheel end and at least partially conforming about the stacker wheel shaft, the pair of arms of each carriage extending toward the stacker wheel shaft such that a corresponding stacker wheel is positioned about the stacker wheel shaft between the arms of a corresponding carriage;

wherein the lateral positions of the stacker wheels are adjusted by rotational movement of the stacker wheel positioning screw which serves to laterally move the pair of stacker wheel carriages laterally toward each other when driven in a first rotational direction and to laterally move the pair of stacker wheel carriages laterally away each other when driven in a second rotational direction, the lateral movement of the stacker wheel carriages imparting a corresponding lateral movement on the stacker wheels.

Embodiment 37. The banknote stacker wheel assembly of embodiment 36 wherein the stacker wheel positioning screw comprises threads oriented in a first direction on a first portion and threads oriented in a second opposite direction on a second portion, and wherein a first one of the stacker wheel carriages threadingly engages the first portion of the positioning screw and a second one of the stacker wheel carriages threadingly engages the second portion of the positioning screw.

Embodiment 38. The banknote stacker wheel assembly of any of embodiments 30-37

wherein during operation in which banknotes are to be fed into the banknote receptacle, the lateral position of the stacker wheels is adjusted by the stacker wheel positioning mechanism to an inward position such that banknotes to be fed into the banknote receptacle are received by the stacker wheels and stacked in the banknote receptacle;

wherein during operation in which banknotes are to be fed out of the banknote receptacle, the lateral position of the stacker wheels is adjusted by the stacker wheel positioning mechanism to an outward position such that banknotes to be fed out the recycling bay are not engaged by the stacker wheels but instead are engaged by a banknote dispensing assembly which sequentially engages a topmost banknote stacked in the banknote receptacle and feeds banknotes out of the banknote receptacle, one bill at a time.

Embodiment 39. A banknote stacker wheel module for stacking banknotes in a banknote receptacle comprising a removable stacker module mounting plate having coupled thereto: a pair of stacker wheels supported for rotational movement about a driven stacker wheel shaft, each stacker wheel being laterally moveable along the driven stacker wheel shaft; and a stacker wheel positioning mechanism configured to adjust the lateral positions of the pair of stacker wheels along the stripper wheel shaft.

Embodiment 40. The banknote stacker wheel module of embodiment 39 wherein a stacker wheel positioning mechanism comprises: a stacker wheel positioning motor or solenoid, an elongated rotatable cam crank comprising two ends, a pair of linkage arms comprising two ends, and a pair of linkage arm supports.

Embodiment 41. The banknote stacker wheel module of embodiment 40

wherein one end of a first one of the linkage arms is coupled to a first one of the ends of the cam crank and a second end of the first one of the linkage arms is couple to a first one of the linkage arm supports,

wherein one end of a second one of the linkage arms is coupled to a second one of the ends of the cam crank and a second end of the second one of the linkage arms is couple to a second one of the linkage arm supports,

wherein each stacker wheel is rotatably coupled to a respective one of the linkage arm supports.

Embodiment 42. The banknote stacker wheel module of embodiment 41 wherein the motor or solenoid is configured to rotate the elongated rotatable cam crank about a cam axis causing the ends of the cam crank to rotate about the cam axis thereby causing the linkage arm supports and the stacker wheels coupled thereto to move either laterally closer to each other or laterally away from each other.

Embodiment 43. The banknote stacker wheel module of any of embodiments 40-42 further comprising an electrical connections interface configured to be coupled to an external mating electrical connections interface not residing in the stacker wheel module such that when the two electrical connections interfaces are connected an external processor is communicatively coupled to the motor or solenoid.

Embodiment 44. The banknote stacker wheel module of any of embodiments 40-43 further comprising a pair of stacker wheel bases and wherein each stacker wheel is fixedly coupled to a respective one of the stacker wheel bases and wherein each stacker wheel base is rotatably coupled to a respective one of the linkage arm supports.

Embodiment 45. The banknote stacker wheel module of any of embodiments 39-44 wherein during operation in which banknotes are to be fed into the banknote receptacle, the lateral position of the stacker wheels is adjusted by the stacker wheel positioning mechanism to an inward position such that banknotes to be fed into the banknote receptacle are received by the stacker wheels and stacked in the banknote receptacle; wherein during operation in which banknotes are to be fed out of the banknote receptacle, the lateral position of the stacker wheels is adjusted by the stacker wheel positioning mechanism to an outward position such that banknotes to be fed out the recycling bay are not engaged by the stacker wheels but instead are engaged by a banknote dispensing assembly which sequentially engages a topmost banknote stacked in the banknote receptacle and feeds banknotes out of the banknote receptacle, one bill at a time.

Embodiment 46. The banknote stacker wheel module of any of embodiments 39-45 wherein the removable stacker module mounting plate is removeably coupled to a portion of the banknote receptacle by one or more coupling devices.

Embodiment 47. The banknote stacker wheel module of embodiment 46 wherein the coupling devices comprise one or more screws.

Embodiment 48. The banknote stacker wheel module of embodiment 46 wherein the coupling devices comprise one or more bolts.

Embodiment 49. A feeder module for feeding banknotes into a banknote receptacle and feeding banknotes out of the banknote receptacle comprising:

a housing, the housing comprising a first side and an opposing a second side, wherein banknotes to be fed into the banknote receptacle are received adjacent the first side of the housing and are transported into the banknote receptacle along an in-feed transport path adjacent the first side, and wherein banknotes to be fed out of the banknote receptacle are received adjacent the second side of the housing and are transported out of the banknote receptacle along an out-feed transport path adjacent the second side;

a banknote dispensing assembly for feeding banknotes, one at a time, out of the banknote receptacle, the dispensing assembly being positioned near the upper end of the banknote receptacle and comprising:

one or more stripping wheels supported for rotational movement about the driven stacker wheel shaft, the pair of stripping wheels being laterally positioned about the stacker wheel shaft between the pair of stacker wheels, and

one or more drive rolls supported for rotational movement about the drive roll shaft;

wherein the banknote dispensing assembly feeds banknotes urged against the one or more stripping wheels into and along the out-feed transport path.

Embodiment 50. A banknote recycler comprising:

a chassis comprising a banknote storage bay; and

a feeder module positioned above the storage bay;

wherein the feeder module comprises:

a feeder module housing, the feeder module housing comprising a first side and an opposing a second side; and

a banknote dispensing assembly for feeding banknotes, one at a time, out of the banknote receptacle;

wherein the chassis comprises an infeed upper wall, an outfeed upper wall, and a plurality of driven feeder rolls, the infeed upper wall being positioned adjacent to the first side of the feeder module housing and defining an in-feed path therebetween, the outfeed upper wall being positioned adjacent to the second side of the feeder module housing and defining an out-feed path therebetween, at least a first one of the driven feeder rolls protects into the in-feed path and isoperable to transport banknotes along the in-feed path, and at least a second one of the driven feeder rolls protects into the out-feed path and is operable to transport banknotes along the out-feed path;

wherein banknotes to be fed into the banknote receptacle are received adjacent the first side of the housing and are transported along the in-feed transport path adjacent the first side and into the banknote receptacle, and wherein banknotes to be fed out of the banknote receptacle are received adjacent the second side of the housing and are transported out of the banknote receptacle along an out-feed transport path adjacent the second side; and

wherein the banknote dispensing assembly feeds banknotes in the storage bay, one at a time, into the out-feed transport path.

Embodiment 51. A banknote recycler comprising:

a chassis comprising a plurality of banknote storage bays positioned adjacent each other in an upstream/downstream direction; and

a feeder module positioned above each storage bay;

wherein each feeder module comprises:

a feeder module housing, the feeder module housing comprising a first side and an opposing a second side; and

a banknote dispensing assembly for feeding banknotes, one at a time, out of the banknote receptacle;

wherein the chassis comprises a plurality of infeed upper walls, a plurality of outfeed upper walls, and a plurality of driven feeder rolls, the chassis comprising:

a first infeed upper wall being positioned adjacent to the first side of a first feeder module housing of a first feeder module and defining a first in-feed path therebetween, a first outfeed upper wall being positioned adjacent to the second side of the first feeder module housing of the first feeder module and defining a first out-feed path therebetween,

a second infeed upper wall being positioned adjacent to the first side of a second feeder module housing of a second feeder module and defining a second in-feed path therebetween, a second outfeed upper wall being positioned adjacent to the second side of the second feeder module housing of the second feeder module and defining a second out-feed path therebetween, wherein the second feeder module is located downstream of the first feeder module,

a third infeed upper wall being positioned adjacent to the first side of a third feeder module housing of a third feeder module and defining a third in-feed path therebetween, a third outfeed upper wall being positioned adjacent to the second side of the third feeder module housing of the third feeder module and defining a third out-feed path therebetween, wherein the third feeder module is located upstream of the first feeder module,

wherein at least a first one of the driven feeder rolls protects through the first infeed upper wall into the first in-feed path and is operable to transport banknotes along the first in-feed path,

wherein the first one of the driven feeder rolls also protects through the second outfeed upper wall into the second out-feed path and is operable to transport banknotes along the second out-feed path;

wherein at least a second one of the driven feeder rolls protects through the first outfeed upper wall into the first out-feed path and is operable to transport banknotes along the first out-feed path;

wherein the second one of the driven feeder rolls also protects through the third outfeed upper wall into the third in-feed path and is operable to transport banknotes along the third in-feed path,

Embodiment 52. The banknote recyclers of embodiment 50 or embodiment 51 wherein each feeder module comprises one or more first positioning tabs located on a respective first side of the feeder module housing of the associated feeder module, and/or one or more second positioning tabs located on a respective second side of the feeder module housing of the associated feeder module, wherein each first positioning tab is configured to engage the infeed upper wall adjacent the associated first side of the feeder module housing, wherein each second positioning tab is configured to engage the outfeed upper wall adjacent the associated second side of the feeder module housing, and wherein the first positioning tabs and/or the second positioning tabs are configured to accurately position each feeder module between the associated infeed and outfeed upper walls of the chassis.

Embodiment 53. A banknote storage bay elevator comprising a lower housing; and a banknote platform positioned above the lower housing, wherein the platform is flexibly coupled to the lower housing such that the platform may move up and down relative to the lower housing.

Embodiment 54. The banknote storage bay elevator of embodiment 53 further comprising one or more platform springs biasing the banknote platform upward away from the lower housing.

Embodiment 56. The banknote storage bay elevator of embodiment 53 further wherein the one or more platform springs biasing the banknote platform upward away from the lower housing such that an upper surface of the platform lies in a generally horizontal plane.

Embodiment 57. The banknote storage bay elevator of any of embodiments 53-56 wherein the platform has a long dimension and a narrow dimension and wherein the platform is pivotally coupled to the lower housing such that the platform may rotate about a pivot axis transverse to the long dimension of the platform.

Embodiment 58. The banknote storage bay elevator of embodiment 57 further comprising one or more spacers coupled to either the platform or the lower housing and wherein a range of downward movement of the platform relative to the lower housing is limited by the spacers.

Embodiment 59. The banknote storage bay elevator of embodiment 57 wherein the spacers allow the banknote support or platform to pivot about the pivot axis without allowing the banknote support or platform to pivot in any other direction.

Embodiment 60. The banknote storage bay elevator of any of embodiments 53-57 further comprising one or more spacers coupled to either the platform or the lower housing and wherein a range of downward movement of the platform relative to the lower housing is limited by the spacers.

Embodiment 61. The banknote storage bay elevator of any of embodiments 53-60 further comprising one or more driven elevation gears fixedly mounted on a rotatable elevation gear shaft and a motor operable couple to and configured to rotate the elevation gear shaft.

Embodiment 62. A generally vertical banknote recycling bay arrangement comprising:

a generally vertically oriented banknote recycling bay for receiving banknotes therein, the recycling bay having an upper end and a lower end;

an elevator comprising an elevator banknote platform or support configured to move upward and downward within the recycler bay, the elevator banknote platform or support supporting a stack of banknotes thereon;

an elevator motor configured to move the elevator upward and downward within the recycler bay;

a banknote dispensing assembly for feeding banknotes, one at a time, out of the recycling bay, the dispensing assembly being positioned above the recycling bay;

a pressure sensor configured to generate a pressure signal; and

a processor communicatively coupled to the pressure sensor and the elevator motor and configured to control the operation of the elevator motor and receive the pressure signal from the pressure sensor;

wherein during a dispensing operation,

the elevator motor raises the elevator so as a top banknote residing in the stack of banknotes contacts the dispensing assembly,

wherein the pressure sensor is configured to measure the amount of pressure the top banknote applies to the dispensing assembly and communicate the amount of pressure to the processor via the pressure signal,

wherein the processor monitors the pressure signal and

a) when the processor detects the amount of pressure exceeds a first target threshold, the processor instructs the elevator motor to stop, and

b) when the processor detects the amount of pressure falls below a first lower threshold, the processor instructs the motor to raise the elevator.

Embodiment 63. The generally vertical banknote recycling bay arrangement of embodiment 62 wherein the processor is communicatively coupled to the dispensing assembly and wherein the processor instructs the dispensing assembly to begin feeding banknotes out of the recycling bay.

Embodiment 64. The generally vertical banknote recycling bay arrangement of any of embodiments 62-63 wherein the dispensing assembly comprises a stripping wheel mounted on a stripping wheel shaft and wherein the top banknote residing in the stack of banknotes contacts the dispensing assembly by contacting the stripping wheel and wherein the stripping wheel shaft is configured to deflect upward under contact pressure from the top banknote, and wherein the pressure sensor measures the amount of pressure by measuring the amount of deflection exhibited by the stripping wheel shaft.

While the concepts disclosed herein are susceptible to various modifications and alternative forms, specific embodiments thereof have been shown by way of example in the drawings and herein described in detail. It should be understood, however, that it is not intended to limit the inventions to the particular forms disclosed, but on the contrary, the intention is to cover all modifications, equivalents, and alternatives falling within the spirit and scope of the inventions as defined by the appended claims

1-6. (canceled)

7. A generally vertical banknote recycling bay arrangement; comprising:
a generally vertically oriented banknote recycling bay for receiving banknotes therein, the recycling bay having an upper end and a lower end;
a banknote feeding assembly for feeding banknotes, one at a time, into the recycling bay, the banknote feeding assembly being positioned near the upper end of the recycling bay;
a banknote dispensing assembly for feeding banknotes, one at a time, out of the recycling bay, the banknote dispensing assembly being positioned near the upper end of the recycling bay;
a pair of stacker wheels supported for rotational movement about a driven stacker wheel shaft, each stacker wheel being laterally moveable along the driven stacker wheel shaft; and
a stacker wheel positioning mechanism configured to adjust lateral positions of the pair of stacker wheels along the stacker wheel shaft,
wherein, during operation in which banknotes are to be fed into the recycling bay, the lateral position of the pair of stacker wheels is adjusted by the stacker wheel positioning mechanism to an inward position such that banknotes to be fed into the recycling bay are received by the pair of stacker wheels and stacked in the recycling bay, and
wherein, during operation in which banknotes are to be fed out of the recycling bay, the lateral position of the pair of stacker wheels is adjusted by the stacker wheel positioning mechanism to an outward position such that banknotes to be fed out the recycling bay are not engaged by the pair of stacker wheels but instead are engaged by the banknote dispensing assembly which sequentially engages a topmost banknote stacked in the recycling bay and feeds banknotes out of the recycling bay, one bill at a time.

8. The generally vertical banknote recycling bay arrangement of claim 7, wherein the stacker wheel positioning mechanism comprises:
a stacker wheel positioning screw; and
a pair of stacker wheel carriages, each carriage having a screw end and a stacker wheel end, the screw end of each carriage having a threaded aperture therein through which a portion of the stacker wheel positioning screw is threaded, each carriage having a pair of arms, each arm extending from the screw end toward the stacker wheel end and at least partially conforming about the stacker wheel shaft, the pair of arms of each carriage extending toward the stacker wheel shaft such that a corresponding stacker wheel is positioned about the stacker wheel shaft between the arms of a corresponding carriage,
wherein the lateral positions of the pair of stacker wheels are adjusted by rotational movement of the stacker wheel positioning screw which serves to laterally move the pair of stacker wheel carriages laterally toward each other when driven in a first rotational direction and to laterally move the pair of stacker wheel carriages laterally away each other when driven in a second rotational direction, lateral movement of the pair of stacker wheel carriages imparting a corresponding lateral movement on the pair of stacker wheels.

9. The generally vertical banknote recycling bay arrangement of claim 8, wherein the stacker wheel positioning screw comprises threads oriented in a first direction on a first portion and threads oriented in a second opposite direction on a second portion, and wherein a first one of the pair of stacker wheel carriages threadingly engages the first portion of the stacker wheel positioning screw and a second one of the pair of stacker wheel carriages threadingly engages the second portion of the stacker wheel positioning screw.

10. The generally vertical banknote recycling bay arrangement of claim 7, wherein the banknote dispensing assembly comprises:
one or more stripping wheels supported for rotational movement about the driven stacker wheel shaft, the one or more stripping wheels being laterally positioned about the stacker wheel shaft between the pair of stacker wheels; and
one or more drive rolls supported for rotational movement about a drive roll shaft,
wherein, during operation in which banknotes are to be fed out of the recycling bay, the lateral position of the pair of stacker wheels is adjusted by the stacker wheel positioning mechanism to the outward position such that banknotes to be fed out the recycling bay are not engaged by the pair of stacker wheels but instead are engaged by the one or more stripping wheels which sequentially engages the topmost banknote stacked in the recycling bay and urges the topmost banknote into contact with the one or more drive rolls which act to feed banknotes out of the recycling bay arrangement, one bill at a time.

11. The generally vertical banknote recycling bay arrangement of claim 7, wherein the stacker wheel positioning mechanism comprises:
a stacker wheel positioning motor or solenoid, an elongated rotatable cam crank comprising two ends, a pair of linkage arms comprising two ends, and a pair of linkage arm supports.

12. The generally vertical banknote recycling bay arrangement of claim 11, wherein one end of a first one of the pair of linkage arms is coupled to a first one of the ends of the cam crank and a second end of the first one of the pair of linkage arms is coupled to a first one of the pair of linkage arm supports,
wherein one end of a second one of the pair of linkage arms is coupled to a second one of the ends of the cam crank and a second end of the second one of the pair of linkage arms is coupled to a second one of the pair of linkage arm supports, and
wherein each stacker wheel is rotatably coupled to a respective one of the pair of linkage arm supports.

13. The generally vertical banknote recycling bay arrangement of claim 12, wherein the stacker wheel positioning motor or solenoid is configured to rotate the elongated rotatable cam crank about a cam axis causing the ends of the cam crank to rotate about the cam axis thereby causing the pair of linkage arm supports and the pair of stacker wheels coupled thereto to move either laterally closer to each other or laterally away from each other.

14. The generally vertical banknote recycling bay arrangement of claim 13, further comprising a controller or processor communicatively coupled to and controlling the stacker wheel positioning motor or solenoid.

15. The generally vertical banknote recycling bay arrangement of claim 14, further comprising a pair of stacker wheel bases and wherein each stacker wheel is fixedly coupled to a respective one of the stacker wheel bases and wherein each stacker wheel base is rotatably coupled to a respective one of the pair of linkage arm supports.

16. A banknote stacker wheel assembly for stacking banknotes in a banknote receptacle, comprising:
a pair of stacker wheels supported for rotational movement about a driven stacker wheel shaft, each stacker wheel being laterally moveable along the driven stacker wheel shaft; and
an automatic stacker wheel positioning mechanism configured to adjust lateral positions of the pair of stacker wheels along the stacker wheel shaft,
wherein, during operation in which banknotes are to be fed into the banknote receptacle, the lateral position of the pair of stacker wheels is automatically adjusted by the automatic stacker wheel positioning mechanism to a position such that banknotes to be fed into the banknote receptacle are received by the pair of stacker wheels and stacked in the banknote receptacle.

17. The banknote stacker wheel assembly of claim 16, wherein a stacker wheel positioning mechanism comprises:
a stacker wheel positioning motor or solenoid, an elongated rotatable cam crank comprising two ends, a pair of linkage arms comprising two ends, and a pair of linkage arm supports.

18. The banknote stacker wheel assembly of claim 17,
wherein one end of a first one of the pair of linkage arms is coupled to a first one of the ends of the cam crank and a second end of the first one of the pair of linkage arms is coupled to a first one of the pair of linkage arm supports,
wherein one end of a second one of the pair of linkage arms is coupled to a second one of the ends of the cam crank and a second end of the second one of the pair of linkage arms is coupled to a second one of the pair of linkage arm supports, and
wherein each stacker wheel is rotatably coupled to a respective one of the pair of linkage arm supports.

19. The banknote stacker wheel assembly of claim 18, wherein the stacker wheel positioning motor or solenoid is configured to rotate the elongated rotatable cam crank about a cam axis causing the ends of the cam crank to rotate about the cam axis thereby causing the pair of linkage arm supports and the pair of stacker wheels coupled thereto to move either laterally closer to each other or laterally away from each other.

20. The banknote stacker wheel assembly of claim 16,
wherein the position is an inward position, and
wherein, during operation in which banknotes are to be fed out of the banknote receptacle, the lateral position of the pair of stacker wheels is adjusted by the automatic stacker wheel positioning mechanism to an outward position such that banknotes to be fed out a recycling bay are not engaged by the pair of stacker wheels but instead are engaged by a banknote dispensing assembly which sequentially engages a topmost banknote stacked in the banknote receptacle and feeds banknotes out of the banknote receptacle, one bill at a time.

21. The generally vertical banknote recycling bay arrangement of claim 9, wherein the banknote dispensing assembly comprises:
one or more stripping wheels supported for rotational movement about the driven stacker wheel shaft, the one or more stripping wheels being laterally positioned about the stacker wheel shaft between the pair of stacker wheels; and
one or more drive rolls supported for rotational movement about a drive roll shaft,
wherein, during operation in which banknotes are to be fed out of the recycling bay, the lateral position of the pair of stacker wheels is adjusted by the stacker wheel positioning mechanism to the outward position such that banknotes to be fed out the recycling bay are not engaged by the pair of stacker wheels but instead are engaged by the one or more stripping wheels which sequentially engages the topmost banknote stacked in the recycling bay and urges the topmost banknote into contact with the one or more drive rolls which act to feed banknotes out of the recycling bay arrangement, one bill at a time.

22. The generally vertical banknote recycling bay arrangement of claim 11, further comprising a controller or processor communicatively coupled to and controlling the stacker wheel positioning motor or solenoid.

23. The generally vertical banknote recycling bay arrangement of claim 11, further comprising a pair of stacker wheel bases and wherein each stacker wheel is fixedly coupled to a respective one of the stacker wheel bases and wherein each stacker wheel base is rotatably coupled to a respective one of the pair of linkage arm supports.

24. The banknote stacker wheel assembly of claim 16, wherein the automatic stacker wheel positioning mechanism comprises:
a stacker wheel positioning screw; and
a pair of stacker wheel carriages, each carriage having a screw end and a stacker wheel end, the screw end of each carriage having a threaded aperture therein through which a portion of the stacker wheel positioning screw is threaded, each carriage having a pair of arms, each arm extending from the screw end toward the stacker wheel end and at least partially conforming about the stacker wheel shaft, the pair of arms of each carriage extending toward the stacker wheel shaft such that a corresponding stacker wheel is positioned about the stacker wheel shaft between the arms of a corresponding carriage,
wherein the lateral positions of the pair of stacker wheels are adjusted by rotational movement of the stacker wheel positioning screw which serves to laterally move the pair of stacker wheel carriages laterally toward each other when driven in a first rotational direction and to laterally move the pair of stacker wheel carriages laterally away each other when driven in a second rotational direction, lateral movement of the pair of stacker wheel carriages imparting a corresponding lateral movement on the pair of stacker wheels.

25. The banknote stacker wheel assembly of claim 24, wherein the stacker wheel positioning screw comprises threads oriented in a first direction on a first portion and threads oriented in a second opposite direction on a second portion, and wherein a first one of the pair of stacker wheel carriages threadingly engages the first portion of the stacker wheel positioning screw and a second one of the pair of stacker wheel carriages threadingly engages the second portion of the stacker wheel positioning screw.

26. The banknote stacker wheel assembly of claim 17,
wherein the position is an inward position, and
wherein, during operation in which banknotes are to be fed out of the banknote receptacle, the lateral position of the pair of stacker wheels is adjusted by the stacker wheel positioning mechanism to an outward position such that banknotes to be fed out a recycling bay are not engaged by the pair of stacker wheels but instead are engaged by a banknote dispensing assembly which sequentially engages a topmost banknote stacked in the banknote receptacle and feeds banknotes out of the banknote receptacle, one bill at a time.
